(19) United States
(12) Patent Application Publication
(10) Pub. No.: US 2020/0234003 A1
(43) Pub. Date: Jul. 23, 2020

(54) METHOD, SYSTEM AND APPARATUS FOR GENERATING, EDITING, AND DEPLOYING NATIVE MOBILE APPS AND UTILIZING DEEP LEARNING FOR INSTANT DIGITAL CONVERSION

(71) Applicant: Alex Bakman, Center Ossipee, NH (US)

(72) Inventor: Alex Bakman, Center Ossipee, NH (US)

(21) Appl. No.: 16/595,424

(22) Filed: Oct. 7, 2019

Related U.S. Application Data
(63) Continuation-in-part of application No. 15/443,683, filed on Feb. 27, 2017, now abandoned.
(60) Provisional application No. 62/827,174, filed on Mar. 31, 2019.

(51) Int. Cl. G06F 40/174; H04L 29/08; H04M 1/725; G06K 9/46; G06K 9/00; G06F 40/20; G06K 9/62; G06N 3/08

(52) U.S. Cl. CPC G06F 40/174; H04L 67/1097; H04M 1/72552; G06K 9/46; G06K 2209/01; G06F 40/20; G06K 9/6217; G06N 3/08; G06K 9/00449

(57) ABSTRACT

Cloud based mobile app building platform, or Snappii, that enables rapid development, testing, deployment, new version distribution and analysis of all apps facilitating app development, updates and changes. Apps can be published and distributed with a click of a button. Platform also enables real time, or nearly instant, conversion of written document or form to an app or electronic format with fillable fields or other interactive and/or I/O features. OCR and other tools can be deployed to facilitate app creation from written documents and/or forms and/or digital images thereof. AI, including neural networks, and/or blockchain technologies and methodologies facilitate efficient and/or secure storage and/or authentication and/or data collection and/or object recognition.

### CROSS-REFERENCE TO RELATED APPLICATIONS

This application is a continuation in part application of U.S. patent application Ser. No. 15/443,683, filed Feb. 27, 2017, which claims priority to prior U.S. Provisional Patent Application No. 62/300,919 filed Feb. 28, 2016, the contents of which (including all attachments filed therewith) are hereby incorporated by reference in their entirety. This application also claims priority to prior U.S. Provisional Patent Application No. 62/827,174 filed Mar. 31, 2019, the contents of which (including all attachments filed therewith) is hereby incorporated by reference in its entirety.

### BACKGROUND OF THE INVENTION

The matters exemplified in this description are provided to assist in a comprehensive understanding of exemplary embodiments of the invention. Accordingly, those of ordinary skill in the art will recognize that various changes and modifications of the embodiments described herein can be made without departing from the scope and spirit of the claimed invention. Also, descriptions of well-known functions and constructions are omitted for clarity and conciseness. Throughout this description, reference is made to “SNAPPII” or “Snappi” which herein is used to reference a platform and/or methodology provided by exemplary embodiments of the present invention.

### SUMMARY OF THE INVENTION

Exemplary embodiments of the present invention provide a cloud based mobile app building platform, or Snappii, that enables rapid development, testing, deployment, new version distribution and analysis of all apps. Building apps visually facilitates app development, updates and changes. According to exemplary embodiments of the present invention, apps are published and distributed with the click of a button.

Exemplary implementations of embodiments of the present invention can facilitate faster and easier method of development of feature rich native apps than using SDKs or Frameworks. Development work that takes months to complete using SDKs can be done in just days according to exemplary implementations of the present invention. In yet other exemplary implementations, app updates to all user devices can also be immediately distributed with the single click of a button.

Exemplary implementations of embodiments of the present invention facilitate building apps visually in the Snappii WYSIWYG editor, saving and seeing the changes immediately on all test devices. Submit apps to public and private app stores or update existing apps essentially in real time.

Further exemplary implementations of embodiments of the present invention facilitate creation of a distributed mobile app platform for maximum scalability, performance and code re-use. The architecture facilitates creation of enterprise apps that access data from back end and cloud based servers.

According to yet further exemplary implementations, using the Snappii platform, development teams can work collaboratively in parallel work streams. The Snappii WYSIWYG Visual Editor and the live build Preview App enable teams to build and update apps quickly, instantly view changes on their devices and provide immediate feedback. This dramatically compresses the development cycle, improves time to market, and lowers costs.

According to still further exemplary embodiments of the present disclosure provide a cloud based mobile app platform, or Snappii, that enables real time, or nearly instant, conversion of written document or form to an app or electronic format with fillable fields or other interactive and/or I/O features. In exemplary implementations, a written document and/or any portion thereof can comprise a digital file, such as a file created by or readable with documents tools such as PDF, and/or an image for example including written information.

Yet another exemplary implementation of the disclosed exemplary embodiments provides digital document processing to facilitate conversion from paper to app. Yet further exemplary implementation can also employ and/or provide tools such as OCR to facilitate app creation from written documents and/or forms and/or digital images thereof.

Still further exemplary implementations of the disclosed exemplary embodiments can utilize AI, including neural networks, and/or blockchain technologies and methodologies for facilitate efficient and/or secure storage and/or authentication and/or data collection and object recognition.

### BRIEF DESCRIPTION OF THE DRAWINGS

The above and other exemplary features, aspects and advantages of the disclosure will become more apparent from the following detailed description of illustrative embodiments thereof when taken in conjunction with the accompanying drawings in which:

FIGS. 1 and 2 show a graphical representations illustrating example of app building/editing and distribution according to exemplary embodiments of the disclosure.

FIG. 3 shows a graphical representation illustrating an example of process flow according to exemplary embodiments of the disclosure.

FIG. 4 shows a graphical representation illustrating an example of platform and functional interactions according to exemplary embodiments of the disclosure.

FIG. 5 shows a graphical representation illustrating an example of app cycle management according to exemplary embodiments of the disclosure

FIGS. 6-199 show graphical representations of screen displays illustrating examples of user interactions and functionality according to exemplary embodiments of the disclosure

FIGS. 200-248 show graphical representations of screen displays illustrating examples of user interactions and functionality according to further exemplary embodiments of the disclosure.

FIGS. 249-288 show graphical representations of screen displays illustrating examples of features of a platform provided according to exemplary embodiments of the disclosure.

FIGS. 289-294 show graphical representations of screen displays illustrating examples of user-accessible functionality according to exemplary embodiments of the disclosure.

FIGS. 294-300 diagramatically show method steps of automated form conversion according to exemplary embodiments of the disclosure.

FIG. 301 is process flow chart showing various options and scenarios that are can be followed when using optical field recognition technology according to exemplary embodiments of the disclosure.

FIGS. 302-357 show exemplary implementations of a user interface and method steps for an optical field recognition technology according to the exemplary embodiments of the disclosure.

### DETAILED DESCRIPTION OF EXEMPLARY EMBODIMENTS

Detailed descriptions of exemplary implementations of embodiments of the present invention are disclosed in the context of the following non-limiting examples of implementations of certain exemplary embodiments of the present invention and with reference to accompanying drawing figure which aid in the description of technology associated therewith.

An illustrative example of the method, system, and/or apparatus according to exemplary embodiments and/or implementations of the present invention are described in the form of a Snappii User Guide.

Further illustrative examples of the method, system, and/or apparatus according to exemplary embodiments and/or implementations of the present invention are described in an app editor.

Further illustrative examples of the method, system, and/or apparatus according to exemplary embodiments and/or implementations of the present invention are described in a features set.

Further illustrative examples of the method, system, and/or apparatus according to exemplary embodiments and/or implementations of the present invention describe GUI that facilitate user interaction in Snappii.

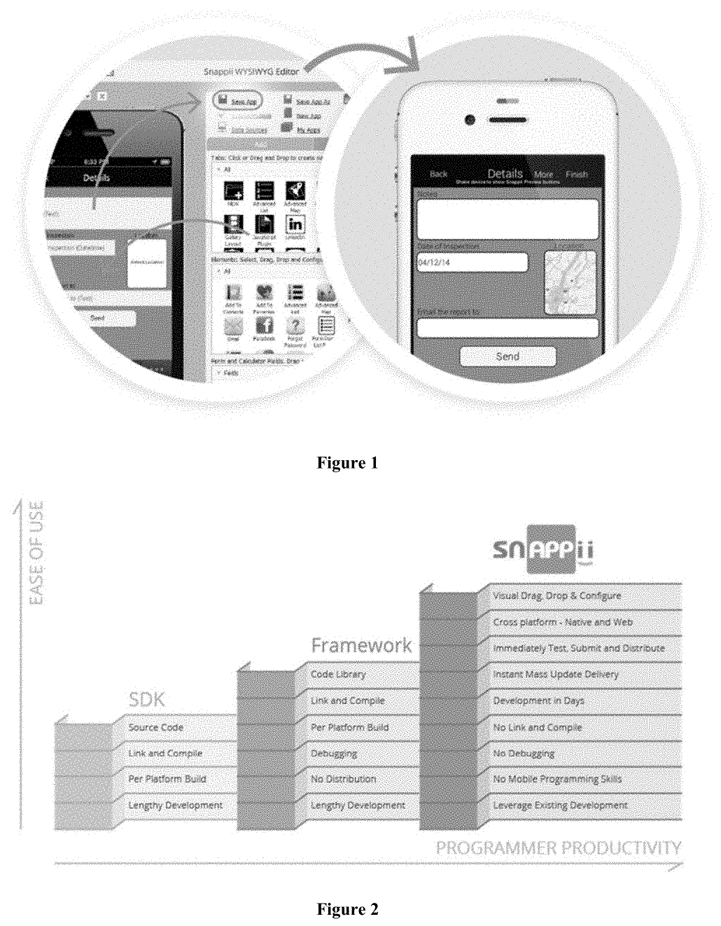

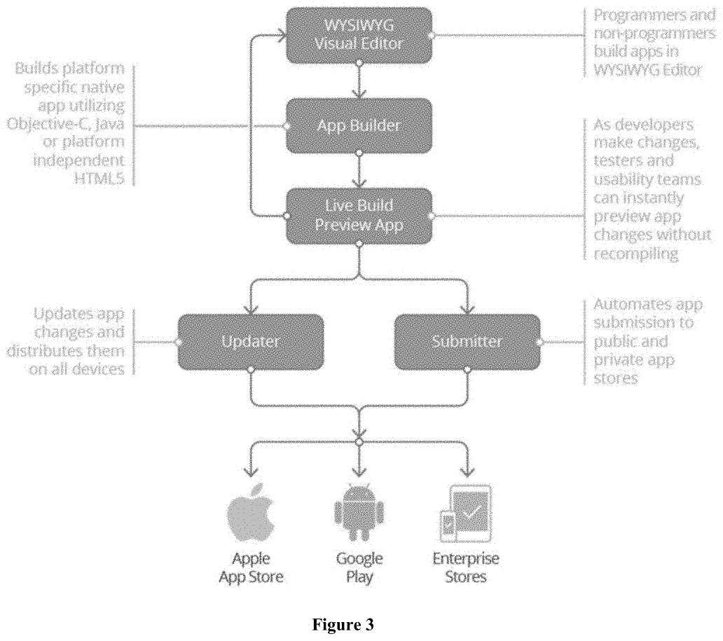

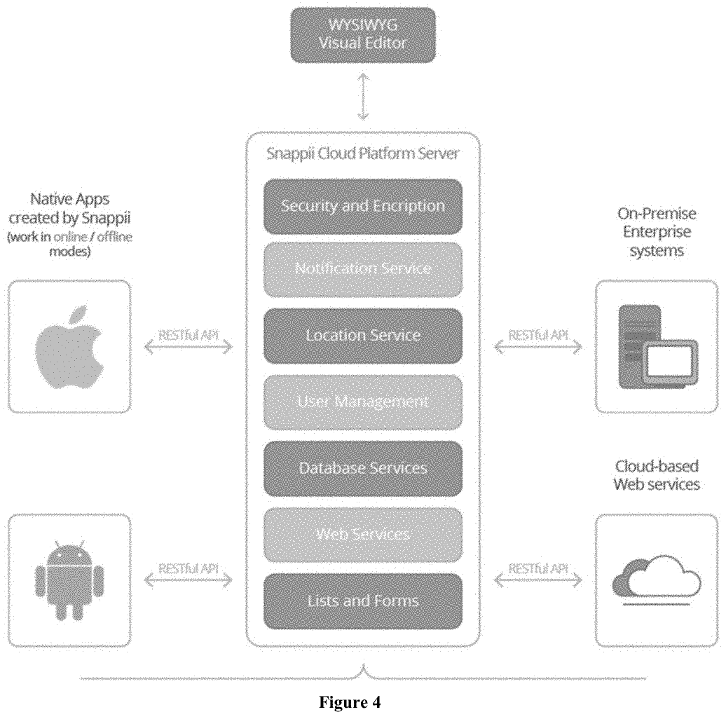

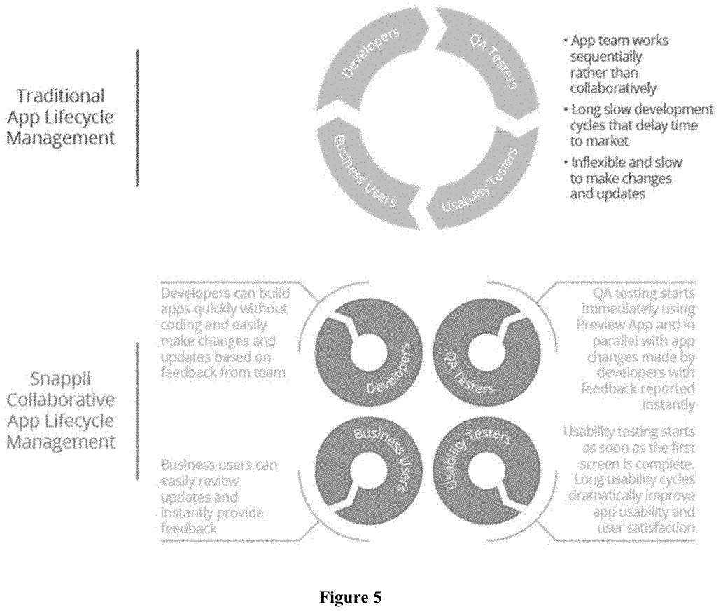

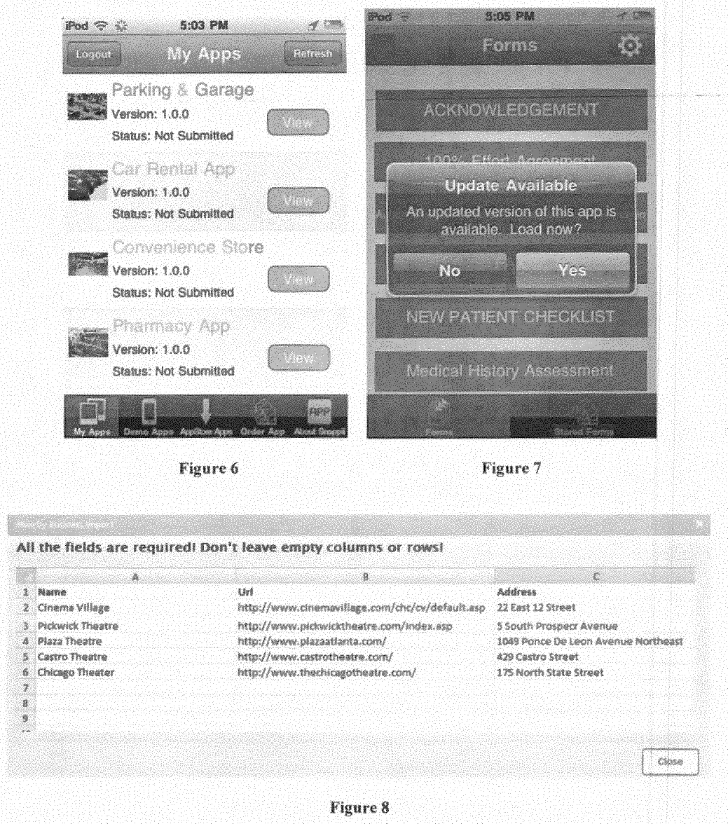

FIGS. 1-5 provide illustrative representations of exemplary embodiments of the disclosure including a WYSIWYG editor exemplary features (FIGS. 1 and 2), a process flow from visual editor to app builder to live build preview app, which can be repeated as needed, to updater and submitter and then delivery to app distribution platforms such as an Apple™ app store, Google Play™, or an enterprise store (FIG. 3), a cloud platform server (FIG. 4), and app lifecycle management (FIG. 5).

Exemplary embodiments of the disclosure provide Mobile Development on Snappii Platform which facilitates creation of apps on a DIY (Do It Yourself) platform, or via a Custom Development. Exemplary implementations include the following:

Snappii Platform Support

Testing and Submitting Apps
Snappii Preview app
Web2phone Copy
Apps submissions

App Updates and Distribution of Changes
Resubmit versus Publish
Snappii CMS benefits

Tabs and Buttons Usage
Nearby
Map
Advanced Map
Get Directions
List
Advanced List
Product List
PayPal
Custom
Favorites
Add to Favorites
Select Contact
Search
Discussion
Home
Universal Form
Notifications
RSS
Sign/Draw
Calculator
Calculator Button
Calculated Formulas
JS Plugin
Share
Image Gallery
Facebook
LinkedIn
Twitter
YouTube
Web
QR code
QR code Scanner
Bar code Scanner
SignUp Form
Login Form
Form Report List
PDF Form
In App Purchase Button
Navigation Button
Remove Account
Audio player
Video Player
Charts
Reminder
Radio Buttons

QR codes
Benefits of using QR codes

PayPal Integration
Why PayPal payments
mCommerce apps

Social Channels Integration
Why add Social Media channels

Collecting Data Apps
Types of supported data
Creating forms

Data Sources. What It Is and What For
How to use DataSource dialog?
How to add data to DataSource?
Shared Data Sources

Web Services and Cloud Storages
What is a web service and how it is used?
How to connect Twitter to my app?
Cloud Storages
   Share Form Report
   Form Report List button

Widgets
Adding Widgets

Levels of InApp Access
Predefined users
InApp memberships

White Label and Dashboard
White label
Dashboard
Push Notifications

Ads and In App Purchases
In app purchase
Ad removals for iOS
Ad removals for Android
In App Purchase Button
Android purchases license key
Interstitial and Banner ads in iOS and Android apps

An exemplary embodiment of the disclosure, reference herein as Snappii, provides an online mobile app building platform that allows individuals and companies of any size to easily and quickly make custom apps for their business without requiring any mobile programming skills.

The Snappii platform gives you the ability for rapidly building apps for Android and iOS platforms without writing any code and without having to recreate the app for each platform. Using a visual drag, drop and configure methodology and our Snappii Preview App, you have the ability to create, test and submit your apps quickly and easily.

With the robust nature and flexibility of the Snappii platform, App creation is exponentially faster than traditional platforms, taking months of development time and compressing it to days. You can build cross-platform native apps that can run on all key mobile app platforms without having to rebuild for each platform and with no mobile programming skills.

App updates are as easy as clicking “publish” to distribute changes to thousands of mobile devices at once. The cost of development and maintenance significantly less so you can build and release apps faster and more cost effectively.

According to exemplary implementations, embodiments of the present invention can support native iPhone, iPad and Android (phone and tablet) platforms.

Exemplary embodiments of the disclosure facilitate Mobile Development on Snappii Platform described with reference to exemplary implementations as follows

How to Create Apps with Snappii

No coding is required to build apps with Snappii's online platform. Fully functional apps for iOS and Android can be built rapidly and submitted to the app stores. Experienced programmers can further extend the platform capabilities through JS/HTML for additional features and functionality.

Snappii offers 2 ways to develop mobile apps: Do-It-Yourself and Custom Development.

1. DIY Platform

Snappii has WYSIWYG (What You See Is What You Get) editor which allows to create native iOS and Android without programming skills. You can build your app from scratch or using Demo apps as templates. In the second case you will have a ready-made app you can rapidly modify by replacing our content with yours and adding new elements and branding.

In the editor you will see an emulator where you can just drag and drop tabs and buttons on the screen and then configure them with your information to make an app. You can add content to the tabs/buttons you chose, upload spreadsheets for nearby and display lists (including interactive components inside the list like call, email, text, etc), change color themes, predefined app themes, fonts, pictures and many other changes to customize your app using Snappii platform.

In the App Settings section you can also input the App name, display icon, splash screen, enter tags and description to be found in the Apple app store and Google Play, update an application, copy it and finally submit to stores. The editor allows you to easily modify all your apps and push out changes to all devices with the click of a button.

Along with this manual, the Snappii website is equipped with many video tutorials that provide instructions on how to build your app. These are your resources to assist you with understanding the platform and how to build your app. Please note that our Live Chat team is available to address potential bug issues, but is not meant for “how to” questions.

Should you wish to take advantage of training to help you learn how to build your app, Snappii's professional services team can provide you with training on an hourly basis. This allows you to take advantage of as little or as much training as you would like to learn how to use the platform and build your app(s). Please note that once you select a paid subscription, you will be able to utilize whatever training and support options are available with that subscription.

App development using the DIY platform, as well as testing with the Snappii preview app, is entirely free. You can confirm all functionality and add all finishing touches prior to public release. You select a paid subscription only after you are confident your app is ready to be released.

2. Custom Development

Snappii's full service mobile app development is ideal for companies that are short on time and development resources or just aren't sure exactly how to go about creating a robust, user friendly app for their business. Our Custom Development options include the following:
1. Full development from scratch: We take your ideas and mock ups and create a fully functional app from the ground up.
2. Template Customization: Select from one of our many Ready Made apps and we will add all your branding (logos, photos, etc) based on the Ready Made template. Additional functionality can be added to the app on an hourly or per project basis.
3. App additions: The Snappii team can augment your development team by providing custom development services to apps you are building on our platform. We can take as much or as little of the development piece as you need including custom development for functionality you need that is not yet available.

Exemplary embodiments of the disclosure provide a Platform Support for creating apps.

Snappii specializes in creating native iOS and Android apps. Native apps are robust, stable and work on all iOS and Android devices and tablets. After these apps are made they are submitted to the App Store and Google Play and it takes some time before they are accepted and get live. But after they are approved they become searchable among enormous amount of other mobile apps. You can charge for your app downloads or even resell apps to clients. Each app can be downloaded and installed on devices to check them out. Snappii focuses on adding other widely spread mobile platforms such as Blackberry and Windows mobile.

Exemplary Embodiments of the Disclosure Provide for Testing and Submitting of Apps

Snappii has a convenient app testing process. While you are working on your app in Editor, you can control how the app looks and functions on your devices. You can see your App working on your smartphone immediately.

1. Snappii Preview App

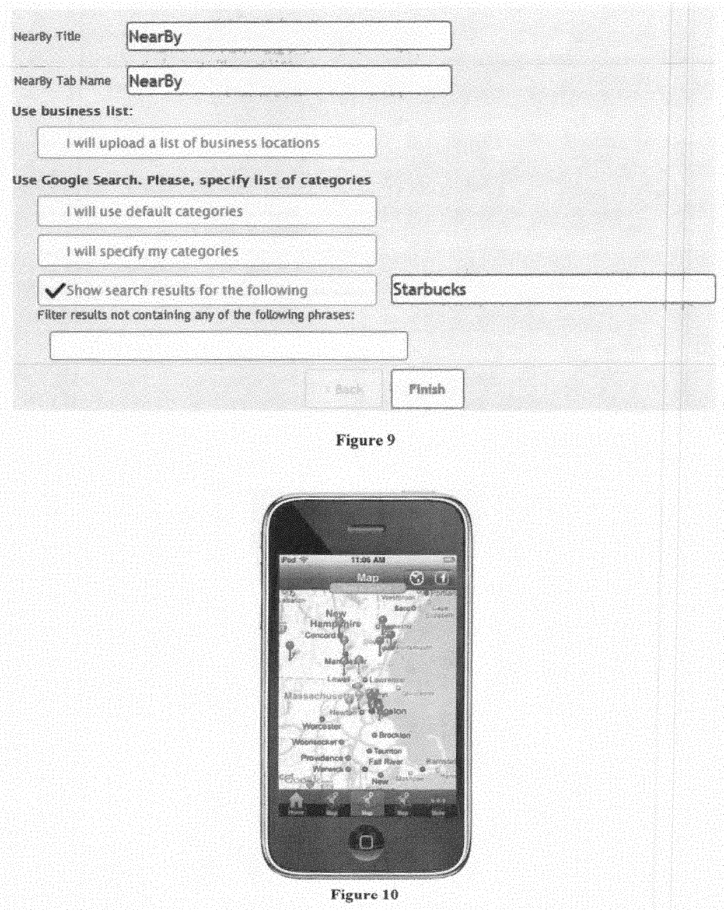

Download Snappii Preview App from the AppStore or Google Play. Then log in under your Snappii account credentials and check your apps out. Snappii Preview app allows to see Demo apps and the live apps in the Appstore and Google Play as well. When you add changes to your app, just press “Back to Snappii” and then click on “View” in app list. All the updates will be available then. (See example of FIG. 6.)

2. Web2Phone Copy

Web2Phone copy allows you to see how your app looks as if it were downloaded from the Apple App Store or the Google Play. In this case it will show the app icon, the splash screen and remove Powered By (if you White Labeled the app). Here are some steps how to create a web2phone copy for iOS:
1. Join Apple Developer program here https://developer.apple.com/programs/ios/
2. Complete apple developer profile here http://developer.apple.com/devcenter/ios/index.action
3. Add at least one device ID to your Apple developer profile here https://developer.apple.com/account/ios/device/deviceList.action
4. Go back to Snappii and click My apps-->at your app click web2phone copy
5. You will receive an installation link to view the app on your device in about 10-20 minutes.

If you added another device after you made a web2phone copy, it will not work until you do the following: You need to change your existing provisioning profiles so that they included the newly added device id.

Here's an example of a link to do it
https://developer.apple.com/account/ios/profile/profileList.action

Find the Ad Hoc profile you wish to modify, click on it, then click Edit button and put a check at the device IDs you wish to have the web2phone copy work for. Click Generate.

After that you need to rebuild your app using web2phone copy. The web2phone copy will show you the pop-up message asking you to update the app—don't worry, this message will not be shown in the live apps. (See example of FIG. 7.)

Notice! After saving any changes to your app within the “app settings” portion of the Snappii platform, you will need to request a new web2phone copy. When the new link is received, delete the old Web2phone copy from your device, install the new copy and your changes will appear.

In case you need a test build for your Android device simply go to Snappii and click My apps-->at your app click Web2phone Copy and select Android web2phone copy. You will get an email with the installation link in about 10-15 minutes (sometimes it may take more time depending on the number of test builds standing in a line).

Exemplary Implementations Provide Capability to Revoke Certificate

To test your app using a web2phone feature you should do the following: Upload your certificate in p12 format and enter a valid password

### OR

Revoke your distribution certificate and we will make you a new one when you click on Web2phone copy.*
You can revoke it here https://developer.apple.com/account/ios/certificate/certificateList.action Please choose the one that has iOS Distribution type
Go to Snappii editor and click Web2phone copy again. In this case, you don't need to upload anything to us. *If you don't have active apps subscribed under this certificate you′d better choose the second way.

3. Apps Submissions

After testing your app thoroughly you can submit it to Apple and/or Google. You must have Apple and Google developer accounts to be able to do so.

1. Apple Developer Account.

You can sign up to Apple Developer Program here. Apple charges a $99 annual fee to join their Developer program. You can add up to 100 device IDs to your account. You will receive messages about the status of your app review from Apple. You'll use this account to upload your app screenshots, to charge for your app, to track app download stats, etc.
It usually takes Apple 2 weeks to review the app. Study the App Store Review Guidelines to be sure which apps they accept and which they reject.

2. Google Developer Account.

To sign up to Android Developer Program you need to go to https://market.android.com/publish/signup.

In difference to Apple, there's no review process on Google, and your app will go live right after submission. You will need Google Developer Account to add screenshots to your apps, charge for them, etc.

Please keep in mind that after signing up with Apple or Android Developer programs, it can take up to a couple days for your account to get approved. During this time you'll not be able to submit your apps.

Exemplary Implementations Provide for App Updates and Distribution of Changes.

There are 2 ways to update your app content after the app is already live in the Apple app store or Google Play.

1. Resubmit.

Resubmit is needed if you want to change:
Splash screen, icon;
Name of the app, description, keywords, category, app website and the language.

If you add new elements (tabs/buttons) which are not supported by current submitted app version you will get the message telling you to Resubmit your app. In this case your app will go to Apple for approval. It will take a few days.

2. Publish.

You need to click on Publish button when you want to make the following changes:
App color theme;
Content of the tabs and elements (phone number, email, text, Url etc. . . . ) and their order in the app;
The name of tabs and elements, its icons.

The changes will get visible the next time your app users run the app. If you still are not sure which to choose—click Publish, if it's not enough to get the updates, you will get the Resubmit option.

Examples of Snappii CMS Benefits

Using a Mobile CMS like Snappii has the following advantages over hiring a programmer for every app:
You can get the app built and out much faster on Snappii. Days vs Months
You can develop apps at a fraction of the cost of outsourcing to even offshore programmers.
$250/mo fee plus app maintenance, new features and support vs many thousands of dollars per app
Apps built with Snappii mobile CMS are cheaper to maintain. You don't have to wait for programmers to make changes
Apps built with Snappii mobile CMS are faster to update and keep current
Apps built with Snappii mobile CMS are great when requirements are not known and or will change often
Apps built with Snappii mobile CMS are faster to update. Click “publish” and updates are distributed to many thousands of mobile devices at once.

The only advantage of hiring programmers is that they will create apps for you that Snappii is not flexible enough to handle.

Exemplary implementations provide for Tabs and Buttons Usage

1. Nearby Tab/Button.

Nearby Tab perfectly suits businesses with multiple locations. All you need to do is enter the name of your business, and it will show up in Nearby wherever user happens to be. Just imagine how convenient it is! You can always drive user to your nearest location. When you modify the Nearby button, you will see several options to specify the locations. For example,
you can upload a list of your business locations. If you want to show a list of your business locations, simply upload Excel file which contains:
   the name of needed location (for example AMC Cardian Lodge);
   it's Url (http://www.outdoors.org);
   address (774 Shem Valley Road);
   city (Alexandria);
   region (NH);
   country (if it's not located in USA);
   postal code (3222);
   phone numbers;
   emails addresses;
   logo link (http://www.yvts.co.uk/images/bibicon/casestudy.pgn);
   notes (if you want to show more details);
   description of that business.
      (See example of FIG. 8.)
use default categories;
specify your own categories;
show search results for a specific keyword.
   (See example of FIG. 9.)

You can even Filter results that don't contain any of the particular phrases.

2. Map Tab/Button

With the Map Tab you have the ability to display your business locations on a map, and give users directions how to get there. This will help users of your app to visually see how to get to your business locations. To add this tab to your apps, log in, go to My Apps, click Edit your app, click Add Tab and choose Map tab. Simply upload a list of your locations, and see them all on the map in Preview app. You can upload as many locations as you want. If you have more than 50, you will see the Show more button. You can also change your current location by clicking the globe icon. (See example of FIG. 10.)

3. Advanced Map tab/button

The Advanced Map allows users to show all items from the list on a map. You must add latitude/longitude location column to the list. You have total control over the Map view now. Choose to:
1. Text for each pin on a map
2. Information your app users will see once the pin detail view is clicked
3. Show all locations via list deciding what information your app users will see

The Advanced map feature works the same way as Advanced Lists—you need to upload a spreadsheet into the datasource dialog, then add Advanced Map tab or button, specify the views:
Annotation View—info that appears when user taps the pin
Detail View—info that appears when user taps Annotation View
Cell View—info that appears when user taps to view all locations as a list.

(See example of FIG. 11.)

Use case. Chamber of commerce can show a list of businesses with locations, descriptions, contact information and details. Allow app user to find a business of interest and contact it right from the app. Advanced Map vs. Simple Map has the following benefits:
Total control over the map layout
Choose the information to show to the app user
Decide the call-to-action buttons
View locations as map and as list
Offline work

3.1 Get Directions Button

This button is added to all advanced controls including: Advanced Map, Advanced Gallery, and Advanced List.

When the button is tapped in the app, the data from the specified location field will be used as the destination.

The starting location in most cases will be the user's current location. However, on advanced map if the user has changed the starting location shown on the map to some manually entered location, then this should be used as the starting location.

(See example of FIG. 12.)

4. List Tab/Button

Use List button when you want to show a list of items. When an item is selected a detailed view is shown. You can upload different lists to show info you wish. Drag and drop the List tab/button, download sample spreadsheet and modify it exactly how it looks in sample. You can't use spaces in the headers, you can't use formatting like Bold, Italic or Underline. Your file must be Excel 2003 and higher. You will see the List view template—it means how your app users see the list. You can choose any of the 4 templates and move to the Detail view template and choose 4 variants of the detail view.

(See example of FIG. 13.)

Choose the icon you want the list to have. You can choose from Snappii gallery, or upload your own. Keep in mind it must be black-and-white with appropriate alpha transparency. This is an example of how the List view looks like: as illustrated in FIG. 14.

5. Advanced List

How to Create Advanced Lists?
Add Data Source
Drag and drop Advanced List tab or element on an iPhone canvas in the Snappii WYSIWYG editor. You will see the dialog. (In our example the uploaded Data Source is called “Job Estimator”)

(See example of FIG. 15.)
1. Name the tab, then choose if you wish the list items to be emailed. In this case put a check at “Show email button” and fill out the fields with the email address, subject, message, etc.
2. Now select the Data Source you have added and wish to output.
3. Below you will see the options to allow or forbid your app users to add/edit/delete data from the list. (See User Management F.A.Q. for more information)
4. Now choose the List view template. You can manually customize it in the Editor. You can add any elements you wish from the Editor, including new elements such as: Post to Facebook/Twitter, Send SMS/Email, Location, Add to Contacts.

Moreover you can select any of the available templates (the image shown in example of FIG. 16)
5. Once the Cell view is set up choose the Detail view template. You can manually customize it in Editor using all the Editor's elements as well.
6. Search/Sort Filters:

The Search/Sort filter allows you to to specify search and sort options in the advanced list properties of your app(s).

Search filter allows to specify the search criteria that will Always apply for users, or be overridden when a user selects search or sort from the app. For example, by default I want to show only the BMW cars, so I specify it in the search filter, see the image shown in example of FIG. 17.

In the app, user will only see the BMW cars, but with the filter “be overridden when a user selects search or sort from the app” users can search for other cars.

You can use parameters specific to the user or device in the search filter:

<user.userName>,
<user.emailAddress>, <user.memberId>, <user.userType>, <user.location>,
<user.location.latitude>,
<user.location.longitude>, <device.version>, <device.model>, <device.language>.

This allows the app creator to specify specific ways the information will show up in the app and/or also allow the user to override these parameters to search/sort as they wish.

Some use cases for testing—a list of:
destinations sorted by distance from the app user
destinations where field named location is within x miles of the user's location
businesses in alphabetical order
items sorted by price lowest to highest
items on sale where field named isOnSale=true
comments entered by users where the field dateEntered is less than 1 week old
items shown only for the logged in user (where <userEmail>=<user.emailAddress>: userEmail is the name of a field in the data source, user.emailAddress will be replaced by the app with the currently logged in user's email address)

In the Search function (“where” clause) the user can enter the SQL for the “where” clause. The filer options are as follows:
always apply to list selection
be overridden when a user selects search or sort options from the app

### Example

You have uploaded a list of cars: they are different makes, styles, reviews and price. Snappii allows you to organize the search feature for your app users to easily access this data. Search and sort by car make, reviews and price.

In Snappii Editor you, as an app owner, choose the sort filter. (See example of FIG. 18.)

In my example, I allow app user to sort cars by Model, review and price—ascending/descending order. That's what they will see in the app: see example of FIG. 19. And the result will be: see example of FIG. 20. When your app users do a search, that's what they see on their devices: see example of FIG. 21. And view any of the results: see example of FIG. 22.

Search Filter

Search filter allows to specify the search criteria that will Always apply for users, or be overridden when a user selects search or sort from the app. For example, by default I want to show only the BMW cars, so I specify it in the search filter, see the image below: shown in example of FIG. 23.

In the app, user will only see the BMW cars, but with the filter “be overridden when a user selects search or sort from the app” users can search for other cars. There are more searching options available:

Simple search (search bar)

search operation: =, not=, contains, does not contain (default contains)

search scope: entire data source, already loaded items only (default entire data source)

select fields that should be included in simple search: all or list of fields (default all fields selected as searchable in the data source)

Advanced search button checkbox

App owner can decide only to have the search bar and not to show advanced search button ever.
1. <inputFieldName>−use value from input field on current form.

Example:<destinationAddress>
2. <current.fieldId>—use field value from current data item. Example: <current.address>
3. <parent.fieldId>—use field value from parent data item (actual for second (and more deep) level of advanced controls). Example: <parent.id>

With the new search options, the simple search should work according the options the app owner selected in the editor.

For example, let's say we have an app that helps users track delivery of packages that they order. There's a data source Packages: packageId, userId, description, status with all four fields marked searchable and sortable.

A couple use cases:
a. The app owner wants the search to show only the package that matches the complete packageId entered by the user in the search bar. Simple search options would be: search operation=, search scope entire data source, selected fields packageId.
b. The app owner only wants the search bar to only do a local search on items already shown in the list. Search scope should be already loaded items only.

7. Click OK.

This makes your Advanced List tab settings complete. Now you can customize your layout. A double click on the tab opens the following window: as shown in example of FIG. 24.

Cell View is greyed out that means that we already selected one of the available templates in the settings while for our Detail view we chose Custom view.

A click on the “Edit Detail View” button opens an empty page you can customize using elements from Snappii editor.

Drag and drop the elements you want to put data in to your cell and details views. The images below show a customized detail view (from the Editor and on iOS device) which consists of text elements. The elements on the left are used to name (describe) the information which will appear in the app (from your Data Source). You can customize text colors, size, and alignment. Don't forget to select “Constant” source for naming elements in the text element settings. Only then the required text will show up. If you choose “Data Source” source the data from your Data Source will appear. (See examples of FIGS. 25 and 26.)

You specify the text length by leaving as much text as needed in the box. The more text will show up in your app the more space should be left. You can place the elements as you wish, bind them with the fields from your Data Source, change their form and size, and play with the color schemes to fully customize it. After adding all the elements and binding them with Data Source, you can preview your app using the Preview app.

Use Case: You are a car dealership owner and you have a list of all cars in the app. Recently you had to upload a new spreadsheet each time you had a new car or needed to remove the sold cars, change price, etc., and now all you need to do is to add/remove to the existing list right from the app. Your customers can sort the list by models of cars, year, vehicles type, etc.—any field that you used in the spreadsheet will be searchable.

How to Share Data from Advanced List?

Once user submits data from any form to a data source, it can be shared from Advanced List. App creator can specify the data to be shared from Advanced list. By default, reports include all available fields. App creator can specify the fields he would like to share. In order to specify shared data, click Advanced List settings, “Share” settings, “Data in report” button. Click this button to see the list of all available fields from your data source and un-check the ones you don't want to be shared. See the screenshots below. You can even select if you want the data from related data sources to be shared or not. By default, the related data sources will be always shared.

(See examples of FIGS. 27 and 28.)

How to Create Multilevel Data Lists?

Relationships project allows Snappii users to create multilevel lists using advanced lists and advanced forms tabs and buttons. There are 3 types: One to One, One to Many and Many to Many relationships types.

I. One to One.

Use Case: list Authors and their books.

Create a spreadsheet with Authors and their Books. ID field indicates what book belongs to what author.

(See examples of FIGS. 29 and 30.)

When you upload the spreadsheets set the ID field type as “text” instead of “numeric”.

Save the data sources.

Click Authors data source, then Manage relationships. Choose Relationship type “One to One”->choose related data source as Books->ID fields must match the id columns from the spreadsheets. Click Add and you'll see the relationship. Click Close.

(See example of FIG. 31.)

Drag and Drop Advanced List tab and choose the Authors datasource. In the settings of Advanced Lists you can specify the following:
Tab/button titles
Tab/button icons
List/Detail View titles
List/Detail views
   Button
   Framed View
   Full Screen View
Enable sending emails
Email format
Select datasource
Modify operation permissions
Select a Template or Custom view to display the data from the spreadsheet.

When you drag and drop elements you must match them with the corresponding datasource columns. For example, to show a book name, I will choose “book”. See example of FIG. 33. Click save the app, on preview you'll see the following as illustrated in the example of FIG. 34.

II. One to Many.

Use case. A Publishing house wants to list the publishers, authors and books with descriptions. Earlier, Snappii user had to create custom buttons and populate it with texts and images. Today it is easy to create the 3 spreadsheets with the information on publisher, authors and their books, and bind these spreadsheets inside Snappii Editor. App user will see the list of publishers, click on one, see the list of authors, click on any author and see the books.

I. Create 3 spreadsheets:
1. PublisherID (see example of FIG. 35.)
2. Authors (see example of FIG. 36.)
3. Books (see example of FIG. 37.)

II. Upload the spreadsheets into the DataSource dialog in the Editor. Keep in mind that you need to choose “text” type instead of “number” for ID and publisherID. Save them. (See example of FIG. 38.)

III. Click Publisher datasource and Manage Relations button below illustrated in example of FIG. 39. Choose One To Many relationship type->Related Data Source will be “Authors List”->ID fields must contain IDs. Click Add button and you will see the newly added relationship. (See example of FIG. 40.) Click Close button.

IV. Click “Authors List” data source and then manage Relationship button illustrated in the example of FIG. 41. Choose One to Many->Books will be related Data source->publisherID will be as ID fields in both cases. Click Add as illustrated in the example of FIG. 42. This is how the two One to Many relationship types will be visible. Close the Data Source dialog.

V. Drag and Drop Advanced List tab. Choose the Publishers List and specify the List view and detail view by either using a template, or customizing in Editor. We will need Custom detail view to have the ability to add another Advanced list button on it. (See example of FIG. 43.) Close this window and double click Cell view to specify what data to show from the Publishers spreadsheet. Double click Detail view to add another Advanced List button. (See example of FIG. 44.) And specify its layout. Here you can see the settings that will allow to show the list of Authors.

In the settings of Advanced Lists you can specify the following:
Tab/button titles
Tab/button icons
List/Detail View titles
List/Detail views
   Button
   Framed View
   Full Screen View
Enable sending emails
Email format
Select datasource
Modify operation permissions
Select a Template or Custom view to display the data from the spreadsheet.

See the screenshot illustrated in the example of FIG. 45.

Click OK. Drag and drop the new Advanced List button on the Detailed view of this second level. This time I choose template view for the Cell—will show Books names as and Template view to show Books Price. See example of FIGS. 46 and 47.

Save the app. This is what you get as a result. See example of FIGS. 48 and 49.

III. Many-to-Many
1. Create 2 spreadsheets with the data you want to show in your app. I have made the following, as illustrated in the example of FIGS. 50 and 51.
2. Please ensure you added the required id column to each of your spreadsheets
3. For Many-To-Many Relationships type make a junction spreadsheet which will bind the both spreadsheets above. My junction spreadsheet looks this way as illustrated in example of FIG. 52.
   Bind the items you need in it. For instance my junction spreadsheet shows that:
1st artist created albums #1 and 3, 5th artist made 9th and 10th albums etc.
4. Upload the first two spreadsheets in the DataSource dialog in the Editor (see example of FIG. 53).

Make sure you chose “Text” ColType for IDs in the uploaded spreadsheets. Once you uploaded and saved everything, select “Albums” and hit “Manage Relationships.” (See example of FIG. 54.)

Select ManyToMany type and choose the related data source from the list. Related ID and Current ID Fields must contain IDs only. Click on “Upload bindings” button. The details will appear below as illustrated in example of FIG. 55.

Hit “Save” to save all the changes in the DataSources

Add Advanced List tab or button on a Custom tab (see example of FIG. 56).
In the settings of Advanced Lists you can specify the following:
Tab/button titles
Tab/button icons
List/Detail View titles
List/Detail views
   Button
   Framed View
   Full Screen View
Enable sending emails
Email format
Select datasource
Modify operation permissions
Select a Template or Custom view to display the data from the spreadsheet

I selected Custom detail view to be able to drag and drop another Advanced List control on it (see example of FIG. 57). This time I choose the second list I have and select the required views. On the new Detail view I again drag and drop another Advanced List button (see example of FIG. 58). This time I choose “Albums” and specify my views. When you select any Template view don't forget to choose the information you want to show (see example of FIG. 59).

In case you are using Custom View add the required controls right on the screen like text, hyperlink, call, email etc and bind them with the items from the uploaded data source. After “Save” we can take a look at the app on a device. (See example of FIG. 60.)

6. Product List Tab/Button & Shopping Cart

Product List works pretty much the same way as usual List tab/button does. There is a sample spreadsheet which can be downloaded and modified according to your needs. In difference with List controls Product List contains pricing details which are visible then in the app. As well the Details page shows up a Shopping Cart button after clicking on it, a chosen item goes directly to the Shopping Cart to be purchased. (See example of FIG. 61.)

7. PayPal Button

PayPal is an online service that allows customers to make purchases online from your devices or PC. By implementing it to your app, you will enable users to make payments inside the app. PayPal can be used to allow users to purchase physical goods or organization membership that gives users benefits outside the app.

Using PayPal for the following types of purchases is not allowed (from Apple review guidelines):
11.1 Apps that unlock or enable additional features or functionality with mechanisms other than the App Store will be rejected
11.2 Apps utilizing a system other than the In App Purchase API (IAP) to purchase content, functionality, or services in an app will be rejected.
   (See example of FIG. 62.)

Go to Snappii Editor, add PayPal button on a Custom tab/button. Keep in mind you can only add one PayPal button. If your app already contains Shopping Cart, the PayPal button won't be added. In the left menu find the PayPal Settings section. Here you can enable PayPal functionality and enter some necessary parameters like Sandbox merchant PayPal ID to test your app and Live App ID to submit your app.

How to Get a Sandbox Merchant PayPal ID?
Please make the following steps:
Go to https://developer.paypal.com/cgi-bin/devscr?cmd=home/main#
Click on “Create a preconfigured account”
Select account type, either buyer or seller, fill in names, the sum needed for testing (max. $9999)
Click on “Create Account”
Copy the received Sandbox Merchant PayPal ID and paste it into the PayPal settings in your app
Create a test build to check how PayPal works in your app

How to Get Live App Id?

Before submitting your app to Apple, you need to submit your app to PayPal to receive a PayPal Live App Id. Please make sure that you enabled PayPal settings in your app and entered a Sandbox Merchant PayPal ID. Otherwise you will not be able to test PayPal functionality.

1. From www.Snappii.com, click on the button to submit your app. Select Apple. You'll get a message saying you need to submit to PayPal first. Click test build. Click ok.
2. In a while, you will receive an email with links to two files. Download them onto your computer.
3. Go to www.x.com and sign in using your PayPal credentials.

In the section, “App Information”, make sure you select platform iOS. For the description, just give an overview of how people will use your app to make purchases.

In the section “Services used by App”, click on “Adaptive Payments” and select “Mobile Express Checkout Library”. In the “Testing Information” subsection, once again give an overview of how people will use your app to make purchases. In the “Supply Test Account Name and Password field, enter:
account name: appreview@Snappii.com password: appreview
Upload both the ipa and mobile provisioning files that you received in #2.

8. Custom Tab/Button

Use a Custom Tab to create a totally customized page where you can drag and drop text, images, email button, call button, social media buttons, hyperlink button and YouTube button, etc. This enables you to have total freedom and control over layout of buttons and screen elements. You can build really customized apps for many industries and uses. (See example of FIG. 63.) For example, you can create image galleries.
1. Drag and drop Custom Tab.
2. Drag and drop Custom element on the Custom Tab.
3. Specify the icon in Custom element settings. Upload the image you want your users to see.
4. Drag and drop Image element on a Custom button and upload the same image you used for Custom element icon. Play with the size of the image, e.g. make it larger. Then when the icon is clicked a large image will show up.
5. Do the same to add more images to your gallery.

9. Favorites Tab

When you have your app, keep in mind that users would want to add important information and save it for quick access.

Use Favorite button and be sure that your customers would be glad to use it. Life becomes easier when you can find important phone number in Favorites. Go to Editor, drag and drop the Favorites tab and it will enable your app users to add the info to Favorites. The information like Phone numbers or locations can be added to Favorites via the Map and/or NearBy elements.

9.1 Add to Favorites

This element allows to add any item to Favorites. Let's consider a use case. There is a list of doctors in the app, any doctor can be added to Favorites. Create a datasource of doctors. Upload it and save. Add Advanced list to display the doctors. The Cell view must be “custom” mode in order to add “add to favorites” button to it. Now go to Datasource dialog. Click to Add new datasource.

A separate datasource type called “Favorites” is available in the Datasource dialog. See example of FIG. 64

Once chosen, name it. The very first value that you see there is “Name”. This field will be shown in a pop-up window when the item is added to Favorites. You can insert any value that is appropriate. Then click the Plus button to add the fields to it. We will add Doctor's name, Picture and Specialty. Basically, all the fields we want to be added to Favorites. Save the datasource. Now go back to the Doctors Advanced list, drag and drop “Add to favorites” button to the Cell view, click its settings: Select Data Source □ Favorites, Favorites fields mapping □ Change □ Map the Favorites datasource field with the Doctors datasource field; Favorites mode: “Reference” means that the Favorites datasource will only add the data the User will enter when adding the doctor to the reference, “Copy”—means that all the information on the doctors will be copied from the Doctors datasource to the Favorites datasource once added to favorites.

Now drag and drop the Advanced list where all the Favorites will be displayed. Select the Favorites datasource. Set up the list view and save.

Here's what you will have, as illustrated in the example of FIG. 65.

10. Select Contact Button

This control allows to autofill form fields with the contact information from Address Book on users' devices. The following information can be retrieved from Address Books:
Company name
Full name of a contact
Web site
Home and Mobile Phone numbers
Fax number
Address including country, city and street names

To create it you need to use Universal Form tab/button, drag and drop text/number fields on it. Ensure you have entered name and placeholder for each element. Then add Select Contact control to your app. See example of FIG. 66.

Now we need to specify some settings of Select Contact button. In Inputs Mapping section you can select any of the fields of the form you created and match them with the required types in the second box as shown below in the example of FIG. 67.

To add the next field use “+”, to remove the current one—use “−”

Once all the fields are matched tap “OK” button and save the app. Let's preview the changes on the Preview app. Here is what we got, as illustrated in example of FIG. 68. By clicking on the Select Contact button we are opening our Address Book (see example of FIG. 69). Tap any contact you need and you will be automatically driven to the form you created with all the Contact info filled out (see example of FIG. 70). You can also add some wording/comments into each field in Inputs Mapping section (see example of FIG. 71). And on Preview app we see an output as illustrated in example of FIG. 72. Then the autofilled form can be submitted via email and/or web/post modes depending on your requirements.

11. Search Tab/Button

Search allows you to either browse a specific site you enter, or internet for a specific keyword (see example of FIG. 73). When you choose to browse site, you enter a keyword in a search string, it will show all the related info to the search term. When you choose to browse the Internet on a particular keyword, it will show all the results as if you were browsing Google.

12. Discussion

Adding a Discussion tab to your app helps you open a dialog with your customers. Use this tab to help customers interact with each other and with you. Your customers can ask questions and other customers or you can answer them. To participate in discussion forum, a user needs to log in, so this is one of the obvious benefits of signing up. You will never lose any question or answer, because you will have push notifications about new discussions, as well as red badges with numbers of unread threads. You will also receive emails with new discussions, questions and answers. It is very convenient for users to keep in touch with other people on forum. Forum can help you get feedback from users, and assist them. (See example of FIG. 75.)

13. Home Tab

Home Tab is like a face of your app. You can place your logo for users to see, and write a short message either about what the app is about, or what your company does, or a logo, etc. What it is meant for is adding your contact info, so that your customers could reach out to you easily. Fill in your email address and your phone number—make it easy for users to connect you. Another good thing about this tab, it allows users to Sign up and then Log in. Being a registered member of your app allows users to participate in discussion forum, rate places, write reviews and track unread discussions. And you will collect your own database of users to send messages to them, and get their feedback. (See example of FIG. 76.)

14. Universal Form

Use “Universal Form” to create input fields which can collect information from users. Examples: registration fields, schedule appointment, fill out application, submit request, etc. Form fields allow you to make calculations, collect feedback from users, get copies of sent out forms, etc. The data can be received in PDF file, Excel spreadsheet or in email body. The form can go to several email addresses that you specify. If you receive a report in Excel file, you can specify the Column width for each form field. It can be:
Auto Fill
Wrap text
Fixed

How to Change Standard PDF Template

In the editor go to App settings->Miscellaneous->PDF report templates button. You can specify:
First page header
First page footer
Other pages header
Other pages footer
Page number with necessary font size and color
Font size and color for report title
Color for the separator (line after report title and between submissions in one report). See example of FIG. 77.

Fill out the information you want to show and click Save. For Header and Footer you need to upload images. The recommended image size is 1305*150 and higher. Once saved, the new template will appear to the left in the Templates list. If you want to change it, select it from the list, make the changes and click Save.

To select this template for your form, open the form settings->Report common settings->PDF report template->choose the template you need. A Defaulted one is the report made by Snappii. Moreover, you can choose if you want to include automatic date and time stamp to the report, or show the information about the app user. (See example of FIG. 78.)

To make the changes to the template, go back to the dialog, select it from the list, make the changes and click Save. To add a new template, click Add button. (See example of FIG. 79.)

How to Create Custom PDF

You can create custom PDF reports. First, create PDF templates using online tools like http://www.pdfescape.com or http://www.pdfamigo.com/. Take any PDF form you already have and import it into Snappii Editor when creating a Universal form.

Simply create your PDF file and name the form fields according to your fields in the Datasource. Save the PDF. Create an Excel spreadsheet with the corresponding form fields' names. Save this spreadsheet and upload to the Datasource dialog. Save it.

Drag and drop the Universal Form element, after you set it up, i.e. select the saved datasource, choose the layout, open the settings for the Universal Form—click Submit by Email, select the PDF format and put a check next to Use PDF template. See example of FIG. 80.

Click Upload, select your saved PDF template, you will see the fields mapping will open, map the fields of your PDF template with the fields from the datasource. Save and close. Now just add form elements like you would normally do for your form.

If you are using tables in your form, these PDF fields should start with “table.” Instead of inserting the whole picture in your PDF report, you can substitute it for a link to this image. Simply put a check “Show URL instead of image”. Web post mode supports Get and Post methods. Choose method, response type and enter web server URL to take data from. For example, you can enter zip code and find out the weather, or retrieve any data from server. If you need to use datasource, then open “Submit by Datasource” dropdown and put a check next to “Use Data Sources”.
1. Add Data Source (see How to use Data Source dialog? question)
2. Drag and drop Universal Form tab or element on an iPhone canvas in the Snappii WYSIWYG editor. You will see the dialog. (In our example the uploaded Data Source is called “Drill” as illustrated in the example of FIG. 81.)
3. Specify the following settings:
   Universal Form name
   Tab icon
   select a required Data Source (if you have only one Data Source it will appear automatically)
   Check the required options if you need them: Multiple Adding, Auto fill data, and Show Clear/Submit buttons.
   Activate Email mode if you want to send the Universal Form data to any email address/es once it is filled out and submitted
   configure Universal Form by changing its size and view
   adjust Time Zone settings
4. You can customize the Universal Form page by adding text elements and form fields (see example of FIG. 82) available in the Editor.

Editor's view is illustrated in the example of FIG. 83.

Binding fields is illustrated in the example of FIG. 84.

Use Case: You are a medical institution and you need to fill out lots of forms about your patients. Paper work is eliminated and the reports can be stored on device and sent via email as PDF file whenever the doctor decides to do so. If you have no Internet connection, you can still fill in the forms and click Submit button. Once the Internet connection is reached, the forms will be sent out. The Advanced Form feature will be especially useful for those who work in fields and don't have constant access to PCs.

Table Selection Input

The table selection control is used to allow users to create relationships between the data entered/edited on the form, and the data selected on the table selection control.

Table selection allows to:
fill table element with data from data source.
replace table element with a more user friendly element.
fill form fields with data from data source.

Use Case 1: App creator has a data source with pictures and wants his users add these pictures into table element on form. User clicks table selection element, chooses needed photos with a check box, clicks Save button and photos will be automatically added into table. Use Case 2: In the app there might be a form for getting some company information like name, address, email, website, etc. App user would fill out the form and the company information would be saved to a datasource. Now there might be multiple other forms in the app where this company information needs to be filled into multiple input controls on the form so the user doesn't need to re-type the company info every time.

Custom PDF Reports Binding

App owners will need to make names for PDF fields that are related to fields inside TableSelection inputs using the following rules (rules are similar to table input bindings):

These PDF fields should start with “tableSelection_”

These PDF fields should end with number of row (>=1).

Save Input History option that can be found in a universal form element. Snappii has added the ability to memorize the information user has entered before, and appear like a hint the next time app user starts typing.

Use Case:

App creator has added Login Form. App user starts filling out the login fields: email address and password. Next time when the app user will have to login, there is no need to enter full email address and password. The Save Input History option will show the email address and password entered before.

How to Create a Custom Excel Report

If the default Excel format does not work for you, you can always create a custom format meeting your needs. The custom Excel report can be laid out and formatted any way you want. You can also use different fonts and colors, add logos and leverage other tools to make it look professional.

When the report is finished, you will need to upload it into the app.

Universal Form Settings->Report Common Settings Section->make sure “Use custom Excel template” is selected->click the “Upload” button;

As soon as the report is uploaded, you will need to connect input fields in your Universal form to the correct cells in your custom Excel report. There are two ways you can do it:

1. Using Cell Address

In Excel each cell has its address, which is a combination of a letter and a number that specifies the column and row in which a cell is located on a spreadsheet (A1, B2, C3 etc.). You can use cell addresses to connect your Excel report to your mobile form. In order to do that:

1. Upload your custom Excel report
2. As soon as it is uploaded, you will see the window as shown in FIG. 85:
Enter the address of the cell in the left-hand column;
Select the corresponding input field from the right-hand column
Click the “+” (plus) button to add a new line
Use the “−” (minus) button to remove the incorrect line/the lines you don't need anymore

Notice! You can use different tabs (sheets) in your Excel Report for collecting data. If you use tabs, the cell address should look as follows: “Sheet name”! “Cell address”, e.g. Sheet1!A1. (See example of FIG. 86).

2. Using “Cell Names”

As soon as you define which cell the data from your Universal form will go to, you can “name” this field and use this name for connecting your Excel to your Form. When “naming” the cells, please stick to the following format: <cellName>

Example of FIG. 87 illustrates some examples of the cell names (column B) and the labels (column A).

Notice! A spreadsheet cannot contain duplicate cell names.

When you are done with the spreadsheet and the cell names, save it and upload it. As soon as it's uploaded, you will see a window, as illustrated in the example of FIG. 88.
You will see all the cell names you have in your Excel form in the left-hand column;
You will only need to select the corresponding input fields from the right-hand column to connect them one to another;
You can still utilize cell address for connecting some “extra-fields”

As a result, you will receive a report with the output in the Excel format similar to example illustrated in FIG. 89.

Embedded Forms

Forms can be embedded on advanced list, gallery and map detail views and also on custom tabs/button views. In this way, multiple forms could be added on one page. You can choose if this form is displayed as a button, or as framed view, specify the element height and width.

The embedded form is used to Add/Update information that was previously filled in from the Universal Form and is stored in Advanced list. Simply add the new universal form on the Advanced list cell or detail view, select the same Datasource as you use for the Advanced list and the original Universal form. Now select if you want to Add or Update information in the Saved Advanced List. Choose an option and click OK. Now drag and drop the form fields to this embedded form, you can select only those fields you want users to actually change. Once your app users click to Update the saved data and fill out the embedded form, the data will be changed right away. No need to close the app and open it again. (See example of FIG. 90.)

If you choose Add, then the new data will be added to the Saved Advanced List. Just like it works with the default Add/Edit/Delete buttons at the top right corner of the Advanced List. The main benefit of adding embedded form on the Advanced list, is to control what information can be changed. In order not to get confused, you can uncheck the Security permissions of the Advanced List settings. You will see that in this case, your app users will be able to Update/Add data you allow them to. (See example of FIG. 91.)

Enable Autofill Form with Predefined Data

App creator can choose to show a form filled with predefined data from the datasource.

Use case: You have a list of Companies in one datasource called “companies” and a list of documentation in another datasource called “documents”. You add Universal form with companies datasource and set up Auto-fill option to load the documents for this particular company from the documents datasource. Once user selects a company of interest, the fields will be auto-filled with the data from “documents” datasource. To make this work, you need to set up “Fields mapping”. Select the “documents” datasource for the Fields Mapping and map the datasource fields with the form fields.

Auto-Fill Options

You can have the form field show default value. For example, you can enter a value manually, or have it be prepopulated from the datasource, or use Formula. (See example of FIG. 92.)

Scheduled Reporting

Snappii users can manage the reports coming from their apps. In the editor open datasource dialog, select the datasource of interest and click Manage Auto-Reporting button. Click Add new. You will see the dialog, as illustrated in the example of FIG. 93.

You can specify report name, schedule recurrence (daily/weekly/monthly), time, email address the reports will be sent to, subject line, message, report file name, data you want to receive from report. Click Change button to specify the data you want to receive from report. (See example of FIG. 94.)

You can set up searching filter to send the reports based on a specified selection. For example, specify dates you want the reports to be received from.

Use Case. Construction manager receives many reports on a daily basis from the construction workers. Instead of receiving reports on a daily basis, he can schedule reports to be sent on a weekly basis in one file.

14.1 Universal Form Wizard

Fields Wizard allows to create a form that can be saved as a template form. Click on a field you want to add to your form, click Add, name it and it will appear in your form. (See example of FIG. 95.)

You can save the form fields as a template and use in your other forms by clicking “Select form fields from template” and choosing your saved template. The added form fields look, as illustrated in the example of FIG. 96.

14.2 Pagination.

Pagination makes it possible to split long digital forms into several pages for an easier and more convenient access. Each page can be submitted separately if all required fields are filled out properly. Percents at the bottom right corner show how much of the form is already completed.

To enable paging go to Universal Form settings->Paging->check the box next to Paging (see example of FIG. 97. There is also an opportunity to show percentage of the form completed and have Submit button on each page. To add/delete/edit pages tap Manage button. You will get the following a pop-up window, as illustrated in example of FIG. 98. Here you can specify Form Pages names and edit the pages.
“+”—use it to add a new page
“−”—use it to delete the selected page
“Edit”—use it to change a page name
“Up” “Down”—use them to change the order of pages
“Clear”—use it to delete all pages at once

Please keep in mind the title of the Universal form will be used as the name of the first page!

In the editor you will see all the pages after a click on the Universal Form. (See example of FIG. 99.) You can tap any of the pages to drag and drop any inputs you will want right on them. On a device it will look the following way: as illustrated in the example of FIG. 100. Slide right to see the rest of pages or left if you aren't at least on the first page. You will not be able to submit your form if some required fields are left empty.

Pagination will make your digital forms look professional and more user-friendly. Please keep in mind that Pagination will not divide the already existing forms into several parts. It will just place all your form inputs onto the first page of your form. You will have to copy or make those inputs for other pages from scratch.

14.3 how to Use Relationships in Universal Forms

In our example we wanted to let users add as many photos and comments to their forms as needed. You can play with it to suit your own case.
Create two Excel spreadsheets. One of them will be a parent Data Source and another a child Data Source.

Parent Data Source contains all fields which are covered in the form. To be able to add multiple photos and comments (in our case 8 photos and messages) we add Photo1, Comments1, Photo2, Comments2 and so on up to Photo8, Comments8 in our parent Data Source spreadsheet.
Child Data Source contains only two fields: Photo and Comments
To bind Parent and Child spreadsheets you need to add common Id field in both.
(See example of FIG. 101)
Open Data Source dialog and upload both spreadsheets using Upload Data button
Important! Select Text type for Ids. (See example of FIG. 102)
Open Parent Data Source and click Manage Relationships button
Select Relationship Type needed for you and a Child Data Source
Important! Related Id Field and Current Id Field must be Ids
Once fields are specified click on Add. Later you will be able to delete that relationship and set up a new one. Know more about types of relationships in the same chapter below (see example of FIG. 103).
Drag and drop Advanced Form, select Parent Data Source, add Form inputs you need and bind them with Data Source data (Parent)
Drag and drop Table input and bind it with Child Data Source. Actually the required Data Source will be selected automatically as these settings were already specified when you were managing relationships
Bind the inputs inside Table with the fields from Child Data Source
Add Advanced List and bind it with Parent Data Source
Choose Custom Detail View in the tab settings
Drag and drop another Advanced List button right on Detail View
In the second Advanced List settings choose Child Data Source. It should appear automatically if you set up relationships correctly

15. Notifications

Notifications are a great way to gain more people into your business. When you have an announcement, send it as a push notification, and all users will see it. Please, keep in mind that Apple rejects apps that send promotional messages. According to point 5.5 of App Store Review Guidelines

“Apps that use Push Notifications to send unsolicited messages, or for the purpose of phishing or spamming will be rejected”

For example, “We have added a new job board”—this will help users stay aware of your activity. You can create notifications in two ways, from the platform and from within the App itself. To create a notification, go to Dashboard.
1. Choose an application you wish to send a notification from
2. Go to Notifications tab
3. Name the notification, specify date
4. Write a message, insert images or/and URL, and schedule the notification

As a registered (non-subscribed user), you are able to access the Snappii dashboard features 5 times to test functionality. Once you become a subscribed customer you have unlimited access to the Dashboard.

Sending Notifications from an APP

Snappii users can send notifications right from the app. In order to do so, simply click “Communicate” dropdown to find the following tabs/buttons, as illustrated in the example of FIG. 104.

One Time Notification

This tab allows to create and send Push Notification right away to all or predefined groups of users from devices

Ongoing Notification

This tab allows to create and send Push Notifications to all or predefined groups of users from devices. Users can send Push Notifications on daily/weekly and monthly basis. If weekly Notifications are selected then monthly fields should be skipped and vice versa.

Scheduled Notification

This tab allows to create, schedule and send Push Notifications to all or predefined groups of users from devices.

Please ensure that only you or some predefined users have access to this tab in your app.

RSS Tab/Button

RSS looks like a news feed when added to an app. User can read news right from your site, and recurrently visit it. If your site doesn't have an RSS, then you could add an RSS about the topic around your app.

Some Snappii users get an RSS from their Twitter, it's also a good way to get people's interest.

Anyway, it won't hurt to add something useful for your users to read. Simply add RSS tab/button and you'll see a dialog asking you to load the feed. (See example of FIG. 105.)

Sign/Draw Tab/Button

With the help of this tab it is possible to create and share digital signatures or draw pictures and send them to your friends and etc. Just add this element and draw anything you would like to share. (See example of FIG. 106.)

Calculator

Drag and drop text or datetime fields onto Calculator tab/button. Choose the “Number” in the Data type of your text field and date, time or datetime format in your datetime field. To make calculations, use the Datetime or Number formula fields. Enter the formula to get needed calculation result.

How to create formulas:

Arithmetic operations: +, −, *, /, % (modulo), &, |, \hat{ }(exclusive or), <<, >>

Place input control names in < >. For example, <StartDate>

Date/time operations: A date/time may be subtracted from another date/time. A time interval may be added or subtracted from a date/time. Time intervals include: YEARS, MONTHS, WEEKS, DAYS, HOURS, MINUTES.

Example:

<Date1>+26 WEEKS

Date constants: TODAY (today's date) and NOW (Current date/time)

To use conditional expressions (may be nested):

(comparison ? expression1:expression2)

Comparison operators: >, <, >=, <=, (equal), !=(not equal).

Examples:

(<Operator>“Double” && <Number1>=0<Number1>*2:0) (<Date1>==TODAY ? 1:0)

To sum a column in a table input:

SUM(<TableName.FieldName>)

(See example of FIG. 107.)

18.1 Calculator Button

This element is added to the Universal Form. It is added on the Universal Form element together with the formula fields. When you click it, it performs calculations. Once you add it, you will see the list of available formulas. You can specify which one you want to be calculated automatically and which only after Calculate button is pressed. (See example of FIG. 108.)

Calculated/Formula Fields

Calculated/Formula fields allow making calculations, showing user's personal information, location data and more. Formula fields can be added to such controls as Form, Advanced Form, Universal Form, Advanced List and Gallery Layout and can be found in the Elements Panel—Form and Calculator Fields. They are:

Datetime Formula

Number Formula

Text formula

(See example of FIG. 109.)

Datetime Formula Field

Datetime Formula allows making calculations with date/time/datetime data types.

Datetime may be subtracted from another datetime formula/input. A time interval may be added or subtracted from a date/time. Time intervals include: YEARS, MONTHS, WEEKS, DAYS, HOURS, MINUTES.

Example:

<Date1>+26 WEEKS

Date constants that can be used: TODAY (shows today's date) and NOW (shows current date/time)

Datetime Formula settings:

(if adding the field to Advanced/Universal form)

Field for entering formula

In contrast to ordinary fields, formula fields allow changing the field height, font size (#4) as well as the font color (#5)

(See example of FIG. 110.)

If you want data from the field to be submitted to the data source (and advanced list), you need to specify the field the data will go to.

Notice, the column in the data source you want to submit data to should be of the corresponding data-type—datetime/date/time

Please, see #2

Please, see #2

You can specify if the field is visible or not when you look at the app from device.

E.g. your today's day to be submitted to the data source/email report, but you don't want an app user to enter it manually. In this case invisible option of the Datetime Formula field will work for you. Put TODAY in the Formula field, make Visible unchecked and that's it.

You can specify if you want the field to be framed or not.

There's also an opportunity to drag and drop the all Formula controls to the cell or detail views of Advanced list and Gallery Layout. The settings of the formula controls in this case will be almost the same with the only difference—there won't be Select field option (#3).

Number Formula Field

Number Formula allows making calculations with numeric (number) data type. Besides simple arithmetic operations of addition, subtraction, multiplication etc. the field supports more sophisticated formulas like ability to calculate distance based on two GPS locations.

For example:

Calculates distance between two certain locations (coordinates are entered), as illustrated in the example of FIG. 111.

Calculates distance between user's current location and some certain point, as illustrated in the example of FIG. 112.

How it looks in the app on device is illustrated in the example of FIG. 113: Text Formula Field

Text formula allows showing text as a result of some calculations. There're several examples it can be used for:

It can replace device/app specific variables with text: Device/app specific variables are:

<user.userName>

<user.emailAddress>

<user.memberId>

<user.userType>

<user.location>

<user.location.latitude>

<user.location.longitude>

<user.location.textAddress>

<device.version>

<device.model>

<device.language>

For example:

Shows the name of the user when he/she is logged in (will show anonymous if a user is not logged in), as illustrated in the example of FIG. 114.

Shows current user's location as a text address, as illustrated in the example of FIG. 115.

Will show that a user stays in his/her current location as illustrated in the example of FIG. 116.

How it looks in the app on device is illustrated in the example of FIG. 117:

DATE_OPERATION( . . . )—calculates data/time operations in Text Formula Example: DATE_OPERATION(NOW)

TOTAL—Number Formula function that calculates total rows in datasource

IN_DAYS( . . . )—Number Formula function that converts data/time operation to days Example: IN_DAYS(<saleEndingDate>-NOW)

IN_TEXT( . . . )—Text Formula function that converts numerical calculation Example: IN_TEXT(<value1>+<value2>)

.replace(searchvalue,newvalue)—Text Formula function that searches a string for a specified value and returns a new string where the specified values are replaced.

Parameters:

searchvalue—The value, that will be replaced by the new value

newvalue—The value to replace the searchvalue with

Example: (“OldValue”).replace(“Old”,“New”). Result is “NewValue”

.toUpperCase( )—Text Formula function that converts a string to uppercase letters.

Example: (“Value”).toUpperCase( ). Result is “VALUE”

.toLowerCase( )—Text Formula function that converts a string to lowercase letters. Example: (“VAlue”).toLowerCase( ). Result is “value”

.sub string (from, to)—Text Formula function that extracts the characters from a string, between two specified indices, and returns the new sub string.

Parametrs:

from—The index where to start the extraction. First character is at index 0

to—The index where to stop the extraction. If omitted, it extracts the rest of the stringExample: (“Hello world!”).substring(3,7). Result is “lo world!”

.indexOf(searchvalue,start)—Text Formula function that returns the position of the first occurrence of a specified value in a string.

Parameters:

searchvalue—The string to search for

start—Default 0. At which position to start the search

Example: (‘Hello world, welcome to the universe.’).indexOf(‘e’,5). Result is ‘14’

Default Value for text/number input and datetime input controls on forms

When users use Text input field on form, they can specify ‘Default value’. That means that if user opens the app on device, Text input field will already be pre-filled with default value, specified by app creator.

(See example of FIG. 118.)

Text address field

Allows to display not entire user's address, but capture only city, region, zip code or country. Add additional variables to extract parts of textAddress for user location result:

<user.location.textAddress.address>

<user.location.textAddress.city>

<user.location.textAddress.region>

<user.location.textAddress.country>

<user.location.textAddress.zip>

Using formulas in Advanced List and Gallery Layout.

As it has been already mentioned above, all Formula controls can be added to the cell or detail views of Advanced list and Gallery Layout. Input controls when added to the cell and detail views must have names different from data source columns if used in formulas. The name of the data source columns you want to show data from should be written in Formula field like <name> where ‘name’ is a data source colName.

For example:

(See example of FIG. 119.)

That's how it should look like in the setting of Txt formula control.

(See example of FIG. 120.)

Here's one more example: you can show distance from any locations specified in the data source to the user's current location. The function can be used in Number Formula control as follows:

DISTANCE(<Location>, <userlocation>)—where Location is a field in the data source;

Thus, the way how formula controls work inside advanced lists is similar to the way simple Text element functions—they both display data from data sources with the only difference: when using Test element, you need to choose the necessary data source filed from the drop down list in the elements settings, but when using Formula control, you need to specify the data source field name like this:

<fieldname> inside the formula filed in the control settings.

Datasource formula field

Allows app creator to select a scalar value from the data source. For example:

first(fieldName)—returns first record in column with specified name;

last(fieldName)—returns last record in column with specified name;

count( )—returns items count in specified datasource;

sum(fieldName)—returns sum of records in columns with specified name. Note: column must be numeric value;

avg(fieldName)—returns average value of records in columns with specified name. Note: column must be numeric value;

max(fieldName)—returns maximum element in column with specified name. Note: column must be numeric value;

min(fieldName)—returns minimum element in column with specified name. Note: column must be numeric value;

Searching and Sorting filters can be applied to set the order of items in the data source.

Use case: manager can now choose dates range, name of a person and in a field below he will see revenue this sales person made in chosen date range.

Viewing Formulas Option

Viewing Formulas option allows you to enable/disable input fields for Form and Calculator controls (Datetime, Location, Multichoice, Photo, Sign/Draw, Table and Text/Number fields) depending on the condition (formula) you'll specify.

When any of the input controls is dragged and dropped to Calculator, Form, Advanced Form, Universal Form, Advanced list, Gallery Layout, there will be an option to use formula to determine whether the control is disabled or enabled. Here's how it looks like in the editor:

(See example of FIG. 121.)

We have added two Text/Number fields into the Universal form, named the first one ‘t1’ and used Viewing Formulas option for the second one.

If you open the Viewing Formulas menu, you will see the following:

Use formula to enable/disable input field on form—allows to ‘switch on/off’ the option

Dropdown menu allowing to specify if the field is going to be enabled or disabled depending on some condition.

(We set ‘enable’ option, which means that if a user fulfills the condition, the field will be enabled).

Formula—that is where the necessary condition should be specified.

(We entered the following formula: <t1>.length >0 where ‘t1’ is the name of the first field and if the length of this field is more than zero (i.e. if a user fills any data in there) the second field will be enabled).

As you can see on device, the second field is disabled (inactive) at the beginning, but as soon as you fill the first one in, the second one becomes enabled and active, so you can enter anything in it.

(See example of FIGS. 122 and 123.)

Thus, you can specify a condition that involves any of the input controls you have inside the form. The formulas format should be similar to the one of Number Formula and Datetime Formula controls.

Here are some formula examples you can use in Viewing Formula Field:

<FieldName>.length >0—will enable/disable the field if the other field (standing for ‘FieldName’) is filled out;

DISTANCE(44.123456, 54.123456, <userlocation>) >200—will enable/disable the field if a user is located further than in 200 mi/km from a certain point (the coordinates of which are specified in the formula);

DISTANCE(<Location1>, <userlocation>)<DISTANCE(<Location1>, <Location2>)—will enable/disable the field if the first distance (from a certain location to a user) is smaller than the second distance (from one location to the other);

(<date1>-<date2>)<3—will enable/disable the field if the difference between the two dates is less than 3;

<user.userName>length >100—will enable/disable the field if the user name has more than 100 characters in it;

SUM(<TableName.FieldName>)<=<NumberField1>+<NumberField2>—will enable/disable the field if the sum of all the data from the table is less or equal to the sum of the two number fields (‘NumberField1’ and ‘NumberField2’);

<FieldName>“YES”—will enable/disable the field if the value of the other field is equal to ‘Yes’;

<date1>><date2>—will enable/disable the field if the date in one field (called ‘date1’) is greater than the date in the other field (called ‘date2’);

<date1>==TODAY—will enable/disable the field if the date entered in one field (called ‘date1’) is the today's date;

<user.userType>=“LoggedIn”—will enable/disable the field if the user who sees it is logged in.

Enable/Disable and View/Hide formulas. All controls in the “Elements” section and the “Form and Calculator Fields” section have the viewing formulas.

There are four options for viewing formulas:

use formula to disable field

use formula to enable field

use formula to hide field

use formula to show field

Automatically move other controls up to fill space when this control is hidden

Viewing formula for tabs

You can include the following variables into a formula to show/hide the tab:

<user.userName>

<user.emailAddress>

<user.memberId>

<user.userType>

<user.location>

<user.location.latitude>

<user.location.longitude>

<user.location.textAddress>

<user.location.textAddress.address>

<user.location.textAddress.city>

<user.location.textAddress.region>

<user.location.textAddress.country>

<user.location.textAddress.zip>

<device.version>

<device.model>

<device.language>

Use cases:

Example 1: Show new questions to user depending on his answer on forms.

Example 2: Display different pictures to users depending on what you have in data source. If a pilot is unavailable, we can highlight him with red color. If he is available—with green.

Example 3: App creator can give some users access to a form (or any other button) with a password—the form will not be visible or accessible until the user enters a valid password.

Example 4: Display different background pictures for users depending on what country they are from.

20. JS Plugin Tab/Button

Extend you app with HTML, CSS, JAVA Script code to do anything you want. For example use in-app HTML to create custom database query, registrations, integration with other systems, etc. You can re-use existing code from your website.

Presently, you cannot call back into native code from the JS/HTML code. The resulting mobile apps:

Have better performance, scalability and security

Enable better migration from web apps to native mobile apps

Give customers protection against well know HTML5 failures

Allow customers to leverage existing Web Apps

JavaScript plug-in capability for in depth app customization including:

Code Reuse. Snappii app builders can reuse existing code from their websites and other apps and drop it in the JS PLUGIN control bringing the same features to their mobile app.

JavaScript library use. JavaScript is the most popular programming language in the world. It has become common in both game development and the creation of desktop applications, and it is now possible to use it in mobile apps development as well.

Extensibility. Further extend the Snappii platform features by enabling JavaScript plugins to create fully customized, enterprise mobile apps. For example use in-app HTML to create custom database query, registrations, integration with other systems, etc. It is also possible to add many more features such as image galleries, graphics, animations, etc. by way of different existing JS/jQuery plugins.

Even simple games are available for adding into Snappii mobile apps.

Enable Javascript extensions to work in Offline mode when internet access is not present.

Read more about the JS Plugin here.

Let's see using a gallery example:

You can use “Photo Swipe” plugin (http://www.photoswipe.com/) for a gallery. On its site you can see that this plugin is mobile-oriented. That's why it works and looks fine for all devices.

A Zip file with the HTML code was uploaded. It contains only one html file (index.html), js (JavaScript) and css (styles) files and also images files. The js and css files are connected to the .html file and all links must be relative (not absolute):

<link href=“photoswipe.css” type=“text/css” rel=“stylesheet”/>

<script type=“text/javascript” src=“klass.min.js”></script>

The links for images are relative too (e.g., <img src=“images/01.jpg” . . . ).

Using the JS/HTML control all paths must be relative for the offline mode to work properly.

(See example of FIG. 124.)

Share Button

This control allows to share data by posting via Facebook, Twitter, Weibo, sending via Email, SMS, assigning to Contacts, copying to Board, printing out and saving to Camera Roll.

To share images user needs to enable sharing in the image settings, as shown in the image below

(See example of FIG. 125.)

Then drag and drop Share control on the canvas. The control can be added to Custom tab/buttons as well as to cell/detail views of Advanced List. Specify the share options available by holding CTRL button and selecting the required options with Left Mouse Key. If all options are necessary use CTRL+A command that will select all items in the list. (See example of FIG. 126.)

You can specify a message recipients will receive/see together with your shared items. The whole process is below:

(See example of FIGS. 127 and 128.)

Or if Twitter is chosen:

(See example of FIG. 129.)

It's easier to share your app with others. Simply fill out the Message you want to share and put a check next to “Share predefined message only”. See the image below

(See example of FIG. 130.)

Image Gallery

Allows to create image galleries by taking images from uploaded DataSources. The following image galleries types are available:

Grid

Horizontal view

Split View

Any of the types can be specified when you drag and drop Gallery Layout controls on the canvas. You will see this window: (See example of FIG. 131.)

In the settings you need to choose the DataSource you will take the data from. Read more about creating data sources in Data Sources Chapter.

Here you can also enter Cell/Detail views titles and specify if they will have a custom or templetized look.

Columns count will define the number of images to be shown in a row. Below are some examples for each gallery type:

Grid view shows all images in several rows based on column counts and the image size specified in the settings. Users can scroll down to see all the images. (See example of FIG. 132.)

Horizontal view allows to show all images in a row. Users can slide right and left to see all of them.

(See example of FIG. 133.)

Split view includes horizontal view as well as the picture specified for the detailed view. When users click on any picture at the top they see another one taken from DataSource or the same but bigger depending on the settings. (See example of FIG. 134.)

23. Facebook Tab/Button

Use this tab to show Facebook pages to users. Use a mobile version of a URL which begins with letter “m”. To figure out the full url go to http://m.facebook.com site. Navigate to particular page of interest. Then copy the URL and paste it in to the url field.

Now you can share your Facebook page with your app users. Add Facebook Tab to drive your app users to your Facebook page.

To link Facebook with your app you need to follow the steps below to create a Facebook app:

Go to http://developers.facebook.com/apps>.

Login to Facebook if not logged in already.

Click the “Create New App” button.

Enter app name and continue until app is created.

From Settings->Basic, copy the Facebook App ID, and enter it in the Snappii WYSIWYG editor.

(See example of FIG. 135.)

LinkedIn Tab/Button

Use this button to show LinkedIn pages to users. Navigate to particular LinkedIn page of interest using mobile browser. Then copy the URL and paste it in to the url field of LinkedIn control.

Now your app users will find you on LinkedIn.

(See example of FIG. 136.)

Twitter Tab/Button

Use Twitter tab to show your tweets to the users. Simply enter your username on Twitter. Now your app users can see your Twitter updates. (See example of FIG. 137.)

YouTube Tab/Button

You can add a link to your YouTube videos, simply copy it and paste in the YouTube tab/button.

Web Tab/Button

This button allows you to add links to websites. The links will open inside the app or in browser.

QR Code Tab/Button

To start making QR code click on “QR codes” at the right top corner. Fill in the form with data depending on the type of QR code you want to create. The required fields are marked with red. In a drop-down menu choose the type you would like to be coded.

Specify the size of QR code image to be displayed. After all the necessary information is inputted click on Save button. Now you can select readymade QR code in Tabs and Buttons settings.

To make another QR code go to QR codes again and press Add at the left corner. All the created QR codes will be listed on the left menu.

(See example of FIG. 138.)

You can use QR code as coupon.

A QR code coupon is a special type of QR code that you can use in your app to give your customers special discounts or rewards. The QR code coupon is only scannable from your app.

Your app will track the number of times a user scans the coupon, and unlock after a specified number of scans to give the user a reward. You can also require users to register and login to your app to be able to use the coupon.

A QR code coupon is a great way to reward customer loyalty.

(See example of FIG. 139.)

Let's take a closer look at how you can easily and quickly create your own QR code coupon in a matter of minutes. After registering on our site, reading and watching all the useful stuff you visit WYSIWYG editor and press QR code button at the top right corner. Here we go . . . .

In front of you there is a window showing all the necessary information for creating QR code coupons. The fields marked red are required to be filled out. They will vary depending on the type of the QR code you create. All of them can be seen in a dropdown menu. The following types are required:

Contact info (MECARD or vCARD)

Email address

Geo location

Phone number

Text

URL

YouTube

-Calendar Event

You may ask what is the difference between vCards and MECARDs? A vCard or Versitcard is the standardized file format for electronic business cards. This is a file format developed by the Versit group in 1995 which, at that time consisted of members from Apple, IBM and Siemens. This is a universal format understood by most devices and software that handle things like contact information and email. MECARDs are used for the same purpose, but have been developed to be slightly more portable. This makes them better suited for distributing as a QR code. So the difference is slight and you can choose any of the variants which suits you best.

After choosing a definite type of a QR code you will get some fields to be filled out below. It can be only one field like in case with email address type or even seven fields if Contact Info is chosen. Specify the size of a QR code. Three variants are given. Once data is entered there is the very time for a significant moment which makes a QR code coupon out of a usual QR code. It is the settings at the bottom of the window. Check “Use as coupon” and specify the settings. Checking Active will make the coupon function. The number of scans needed for redeeming the coupon can be specified by you as well. It will help you track the usage of your QR code coupons. If you offer a discount after 3 scans for instance you will be able to let customers take part in rewarding by checking Restart the scan count after a coupon is redeemed. In opposite case your coupon won't count the number of scans to be redeemed. Hardly ever you will allow your QR code coupon to be visible if you use it for rewarding clients' loyalty. If it is so don't check it. One more limitation is to let users scan the coupon only after they are logged in. Keep in mind —only the users of your app will be able to scan QR codes you offer them for discounts or any other cases. Once all is done, click on Save button and your QR code coupon will become available to the left. Need more coupons, press on Add button and go on making them.

QR Code Scanner Tab/Button

The QR Code Scanner allows your app users to scan QR codes using this tab/button. Simply add this element to your app, and you'll be able to scan QR codes from any surface.

Bar Code Scanner

To scan bar codes drag and drop Universal Form tab/button and add Bar Code input from Fields section. You can change the size of the input. Save the app. When previewing the app on a device tap on the bar code sign and scan the bar code you need. Once scanned it will allow you to submit the form with the bar code image in the email/pdf or spreadsheet mode depending on your choice.

To see characters/value of the scanned Bar Code you may add a Text/Number input from Field Section and specify the name of your Bar Code element in the Formula as shown in the example below. (See example of FIGS. 139 and 140.)

In the meantime we are supporting the following formats for scanning:

UPC-A

EAN-8 and EAN-13

Code 39

Code 128

ITF

QR Code

SignUp Form

Apart from default SignUp form that we offer you can use your own SignUp form. To create one, please add the SignUp form element on a Custom/New Tab and populate it with your fields. Add fields just the same you do for Universal forms, and match them with the Sign Up Fields placed at the bottom of the field settings. See the screenshot below. You can choose “not to use” if you have a field that is not listed in the settings. This data can be submitted to the email address, via web post mode and can be received as PDF, Excel file or in the Email body. This data can also be stored in the Snappii cloud database.

(See example of FIGS. 141 and 142.)

Login Form

Adding this element allows you to control the login fields and customize the login view you with your app to have and your users to see. Drag and drop this element on the Custom/New tab, then add form fields to it. Match each field with the login field offered at the bottom of each form field you are adding. See the screenshot below.

(See example of FIG. 143.)

Navigation Button

The Navigation button can be placed anywhere in the app and allows app creators easily open access to the destination element inside the app. The main benefit of using the Navigation button is to help the app user easily find the most relevant information inside the app without having to look for it.

Remove Account

Remove Account Button allows the user to remove his account from app.

PDF Form button

With the help of this button app creator can upload his own PDF form to be used in the app. App creator can allow app users to upload their own PDF forms that can be filled out, saved, edited and shared with others. There are 2 ways to upload a PDF file:

From Cloud storage (Dropbox, Google drive, etc)

From local storage (on Android device)

Once forms are uploaded they can be instantly:

Used to enter information

Filled out and shared with co-workers via email or cloud drives

Stored locally on device or on cloud drives such as Dropbox, Box, Google Drive and MS One Drive;

Printed

What's more is that users can add additional capabilities (fields) to forms they have imported. The additional capabilities include:

Signature capture fields

photo capture fields

time and date stamp fields

additional fields to capture text and numbers

show GPS location om the map,

add bar code QR code scanners

add radio buttons, multiple choice buttons, checkbox

Use Case. Fire inspector needs to inspect a fire extinguisher. The inspector opens the Fire Inspection app created by Snappii, clicks “Upload Form” button and loads a fire extinguisher inspection form that is used in the office. The form opens on the inspector's device, and the inspector can easily fill out the data on inspection. The inspector can not only fill out the necessary details, but also add such data as location, date, signature, text, radio buttons and more.

(See example of FIG. 144.)

Audio Button

You can play audio files in your apps. In order to do so, please drag and drop audio player button, and specify a link to the audio file you want to play. You can also upload a file from your computer. Only mp4a files are supported.

Video Button

You can play video files in your apps. In order to do so, please drag and drop video player button, and specify a link to the video file you want to play. You can also upload a file from your computer. Only mp4 files are supported.

Charts

Data can be displayed as charts. Chart types:

(See example of FIG. 145.)

Data that is arranged in columns of single DataSource can be plotted in a pie chart. Pie charts show the size of items in one data series, proportional to the sum of the items. The data points in a pie chart are displayed as a percentage of the whole pie.

Single sources of data.

Sorting for this chart is not used.

Name only “text”.

Value only “numeric”.

Example: field_value—data (type—only “numeric”), field—legend items (type —only “text”)

(See example of FIG. 146.)

or Example: counting the number identical elements in field (type—only “text”)

(See example of FIG. 147.)

Column charts

Data that is arranged in single column of single DataSource can be plotted in a column chart. Column charts are useful for illustrating comparisons among items. In column charts, categories are typically organized along the horizontal axis and values along the vertical axis.

Single sources of data.

Sorting for this chart is used. App creator will be able to sort data by X-axis value or by Y-axis value.

Name only “text”.

(See example of FIG. 148.)

Line charts

Data that is arranged in columns of DataSources can be plotted in a line chart. Line charts can display continuous data over time, set against a common scale, and are therefore ideal for showing trends in data at equal intervals. In a line chart, category data is distributed evenly along the horizontal axis, and all value data is distributed evenly along the vertical axis.

Because the horizontal axis of a line chart is a category axis, it can be a text axis, a numeric axis or a date (time) axis. A text axis displays text only at evenly spaced intervals. A date or time axis displays dates or times in chronological order at specific intervals or base units, even if the dates on the DataSource are not in order or in the same base units.

Example: horizontal axis—“date” (type—only “date”, “time”, “datatime”, “text”, “numeric”), vertical axis—“numeric” (type—only “numeric”)

(See example of FIG. 149.)

or Example: horizontal axis—“text”

(See example of FIG. 150.)

or Example: multiple DataSources

(See example of FIG. 151.)

Sorting for this chart is used only in case if we have “text” data type on X-axis.

when “text” type is chosen in Axis accordion for X axis, only one data source should be available for choice in DS accordion. So, in case of “text” type, the logic on DS accordion should be like in Bar charts (take a look at screen shot below):

(See example of FIG. 152.)

Bar charts

Bar charts illustrate comparisons among individual items.

(See example of FIG. 153.)

Sorting for this chart is used only in case if we have “text” data type on X-axis.

Clustered bar charts

Clustered bar charts compare values across categories.

(See example of FIG. 154.)

Scatter charts

Scatter charts show the relationships among the numeric values in several data series, or plots two groups of numbers as one series of xy coordinates. A scatter chart has two value axes, showing one set of numeric data along the horizontal axis (x-axis) and another along the vertical axis (y-axis). It combines these values into single data points and displays them in irregular intervals, or clusters.

Because the horizontal axis of a scatter chart is always a value axis, it can display numeric values or date (time) values that are represented as numerical values. To display the numeric values along the horizontal axis with greater flexibility, you can change the scaling options on this axis the same way that you can change the scaling options of a vertical axis.

Can be many sources of data.

Sorting for this chart is used only in case if we have “text” data type on X-axis.

Horizontal axis type only “date”, “time”, “datatime”, “numeric”.

Vertical axis type only “numeric”.

Add custom marker.

when “text” type is chosen in Axis accordion for X axis, only one data source should be available for choice in DS accordion. So, in case of “text” type, the logic on DS accordion should be like in Bar charts (take a look at screen shot below):

(See example of FIG. 155.)

DataSource 1.

(See example of FIG. 156.)

DataSource 2.

(See example of FIG. 157.)

Example: horizontal axis—“numeric” (type—only “date”, “time”, “datatime”, “numeric”), vertical axis

“numeric” (type—only “numeric”)

(See example of FIG. 158.)

Use Case. You want to collect feedback about your website logo. You are considering changing the color of your logo. You have color choices: blue, green, pink, yellow, none. Create a datasource with these colors, select data type “boolean” next to each choice in the datasource dialog (we will have them as checkboxes) and the field to send colors to (name it choices). Data for the chart will be taken from that text field (choices).

You can view the results on the chart right below the question, or add it on a separate tab.

(See example of FIGS. 159-161.)

Reminder

Snappii platform users can add reminders. To add a reminder, drag and drop Reminder tab or button on desired space. Save the app. Open the app from Snappii preview app on your device, and click Add to add a reminder. You can specify title, location, start and end date, time, and alert, repeat, add links and notes. Once the pop-up notification arrives, you can choose to view or snooze.

(See example of FIG. 162.)

Radio Button

You can use radio buttons in your apps. Let's consider an example that describes how to enable radio buttons.

A restaurant inspector plans to make an audit. In the Snappii editor, drag and drop universal form tab. Drag and drop text element with the inspection statement “Staff is friendly and smiling”. The options to this statement will be Yes or No. So we will need two radio buttons: one of them states for YES, the other one for NO. Drag and drop a radio button next to the statement. You will see its settings dialog.

Value: Type in Yes.

Group name: click Manage button to add radio groups. You will have as many groups as there are statements for this inspection. Click Add to add radio groups. Group names can have any name. In our case we have 1, 2 and 3. Choose if the data goes as text or as number. In our case it is text. Click Add New Group and Close. See screenshot below.

(See example of FIG. 163-166.)

Checked. Select this element if you want the Positive value to always show as defaulted. By default, a negative image always shows. In our example, we have this field unchecked.

Height/Width Stands for the Radio Button Height and Width

Positive Image and Negative Image can be used with defaulted images that are there in the Snappii editor, or you can upload your own images. We have uploaded a positive image if the answer Yes is selected as a green radio button, and negative (the defaulted one) is grey. For the second radio button that stands for No option, we have a red radio button image for the positive image, i.e. if the “No” radio button is selected, and a grey radio button image for the negative image (the defaulted one). See screenshot below for the Yes radio button and for the No radio button.

Please make sure that both radio buttons belong to the same radio group. So, when the Inspector selects the answer to the statement “Staff is friendly and smiling”, if he or she chooses Yes radio button, it will be highlighted with a green color, if he or she chooses No, then the button will be highlighted with red color. See the two screenshots below. Screenshot #1 reflects the situation where inspector has just opened the form and sees only the defaulted grey radio buttons, Screenshot #2 shows the audit process in progress.

Chapter 6. QR codes

Benefits from Using QR Codes in Business

They say that if you have a perfect service and a qualitative product it will steadily attract new customers and keep existing ones with you. However new interesting ideas won't disturb your marketing strategy and will even assist you to obtain new clients. One of such modern and successful ideas is the usage of QR code coupons. The time of paper coupons people needed to cut out is gradually going to the past. Remember all these pieces of paper you had to collect to get discounts, you kept them somewhere in the pockets or in your bag and it happened frequently that when it was the time to use them you found them torn and useless or lost them at all. QR code coupons are much more convenient. All that your customers will have to do is to scan QR code with their camera-enabled smartphone. Then instantly they will see a message on their screens saying they get a discount or any other special offer or are notified that they need to get QR code scanned for a particular number of times more to receive a reward. Next time they go to your shop/cafe etc. they can easily retrieve the code stored in smartphone memory and while purchasing get one more scan of your coupon.

(See example of FIG. 167.)

All the necessary info will be available to you: how many times clients scanned a coupon, what time they did it and etc. It is especially important for tracking usage of your service.

Using QR code coupons is cheaper than printing out usual coupons, besides it will eliminate the usage of paper and save our forests.

It seems to be amazing and no doubt will attract new clients both children and adults as it is one more thing people can do with their smartphones and they are hot today.

Having a mobile app with the ability to scan and count the number of QR code coupon scans is becoming a great tool in promoting products and services. On Snappii site you will be able to create a mobile app with implemented QR code scanner and coupons. The content of coupons can be simply modified according to your business offers and sales. The role of QR codes and coupons themselves is growing all the time and really crucial. Don't lose time, go to our site to make a mobile app and find out more about QR code coupons usage and profit.

Input any data type in QR codes to show clients your locations, allow them to add you to contacts, watch videos, access your website and the most important option is to reward customers' loyalty using them. The process is simple:

you create a QR code coupon on our site (it will take a couple of minutes)

add QR code scanner into your app to enable users to scan the coupons you create

print out QR code coupons to allow your customers to scan them

QR code coupons loyalty programs are a great tool for promoting your products and services and attracting new clients. The majority of people have iPhone/iPads and devices on Android platform. They will obviously prefer using mobile apps to carrying plastic cards in their wallets with them. All the info they need will be stored in the app including the scan date, number of scans and the scans left to redeem coupons.

List of Businesses where QR codes are most popular:

Car dealerships

Marketing agencies

Professional services

Banking

Trade association

Ski Resorts

Retail services

Insurance agencies

Law offices

Hospital

Golf courses

Art Gallery

Conference

Credit union

Forum app

Fitness

Night clubs & Pubs

Parking & Garage

Pharmacy

Post office

Music & Radio

Religion

Towing

Shoe store

Restaurants

Hotels

Travel agencies

Newspapers

Real estates

Medical practice

Law offices

City guides

University

Spa & Beauty Salon

Boutique store

Chamber of Commerce

Convenience store

Gas station

Government agency

Leasing agency

Car rental

Movies

Pizzeria

Police station

Political party

Sports

Theatre

Financial app

Chapter 7. PayPal Integration

Why PayPal payments

There are actually plenty of reasons why you should allow people to pay with PayPal in your app. Many people will trust paying through PayPal because that's what they normally use. As PayPal is becoming more important people are also starting to hold money in their account. By offering PayPal you will have access to all of these people.

Even large businesses are opening up to the idea of PayPal because it helps to attract more customers.

Pay pal is also helpful for your cash flow. This is because you can transfer the money whenever you want to rather than needing to wait until the end of the month.

mCommerce apps

First of all come to Snappii WYSIWYG editor and start creating your app. You can add PayPal button to Custom tab, then specify the settings. To fit your app perfectly play with its size, there are three dimensions available. Keep in mind that you need to enable PayPal functionality in PayPal settings, otherwise you won't find the button when previewing your app. The following fields need to be filled out: Description, Item ID, Product name, Item Price. Due to the last changes now it is possible to enter any amount for purchasing products, just check the appropriate box. As well tax and shipping can be added to the starting price, check the boxes if you need this. Later you will upload the spreadsheets for them in PayPal settings in the menu on the left. Sample spreadsheets are available in the settings and will help you create your own ones following the patterns. To use PayPal functionality everyone needs to input his Live App Id. To get it you will have to go thru the whole process of approval specified in “Tabs and Buttons usage chapter”. PayPal button will perfectly suit you in case the main idea of your app is to purchase a definite product or e.g. membership in the app.

To perform multiple purchases there is a Product List (upload a spreadsheet with needed parameters and data). App users will see the list of products with images and price. Tapping on any product will move it to a Shopping Cart you need to add to your app in advance. For your convenience you can use both tabs and buttons and instead of separate tabs add buttons to Custom tab. Once products are in the Shopping Cart they can be purchased. As you see the whole process is really simple and can be done in minutes—the single exception is awaiting for Live App Id approval.

Social Channels Integration

In Chapter 5 we already discussed the Facebook/Twitter/LinkedIn social media channels usage, YouTube and Web site.

Today almost anyone has social media profiles. It's easy for your app users to browse Facebook, LinkedIn or Twitter and visit your website to get all info about your business, as well as see some videos of your company.

Chapter 9. Collecting Data Apps

Types of supported data

It is possible to collect various data from your app users. You can collect the following info:

Name

Email address

Contact info

Date

Time

Details

Locations

Pictures

Creating Forms

Forms are more easily created with the help of the form wizard. App creators can select various form fields, fill in placeholders and even save each form as a template for quick access and reuse. Once built in the wizard, users can further modify the form for additional text and customized field placement in the editor.

Just drag and drop the inputs above on the Form tab/button. To specify what your app users should enter in those fields, use text areas. The data you collect can be set up as required and/or optional. Your app user can get the copy of the form he/she sends to you. In this case you need to drag and drop text field, choose “email address” data type and put a check on “Send data copy to the email”.

Two modes to collect data are available:

Email

Web/Post

Email mode supports the following formats: email body, spreadsheet, PDF. Web post mode supports Get and Post methods. Choose method, response type and enter web server URL to take data from.

You get the data in convenient reports: in Excel, PDF or in the email body sent to you over email. You can specify several email addresses you wish to receive info to. If you receive a report in Excel file, you can specify the Column width for each form field. It can be:

Auto Fill

Wrap text

Fixed

If you choose to receive a report in PDF you can either use our standard PDF, or upload your own PDF file. You will need to bind the PDF fields with the form fields appropriately. See more in 14. Universal Form

Let's see an example how you can get the data from server using Web/Post mode.

Drag and drop form tab/button □ put check by the “web/post mode” □ GET □ HTML □

http://www.wtsp.com/weather/local-weather.aspx? (keep the “?” at the end of the link) □ OK

Drag and drop text field □ enter the word “location” in the Web Parameter name □ Data type
-number.

Now save the app. When you enter a zip code and click Submit, you'll get the weather in that area.

(See example of FIG. 168.)

Form buttons:

Clear—clears the whole form

Reset—resets all fields and populates default/auto-filled values

Submit—substitutes the default system button and allows to email the form or submit it via web post mode

The following form fields are available:

Bar code—allows to scan bar codes

Boolean/Checkbox—allows to choose between 2 options

Calculate—add this element to calculate the formulas

Clear—clear all the data entered with one button click

Reset—reset the entered field values to defaulted values

Datetime—specifies the added data type: date, time or datetime

Datetime Formula—allows to input a formula to get specific calculations in the form

Location—shows user's current location on a map, can be changed

Multi-choice—allows choosing among specified options, adding users' own options

Number Formula—allows to input a formula to get specific calculations in the form

Photo—ability to upload and take pictures and add them to the form, also allows to draw on images

QR Code—allows to scan qr codes

Radio Button—allows to select data

Sign/Draw—collects signatures and/or drawings

Table—allows adding multiple entries. You can customize the Table Cell view

Table selection—use it to autofill data from datasource

Text Formula—allows to input a formula to get specific calculations in the form

Text/Number—a field that collects any text/numeric data, email, password

Audio—record and play audio files

Video—record and play video files

Document upload—select source to upload your PDF

Data upload—add data from Excel

Submit—sends the form

List of choices for multi-choice control can be pre-loaded from any data source of the app.

Example 1: if you creator have a list of choices, that dynamically changes, you don't have to change editor settings. Multi-choice will always have actual data.

Example 2: User selects a country in 1st multi-choice. In 2nd multi-choice list of regions for this country is automatically loaded. User chooses region and in the 3rd multi-choice list of airports for this region is loaded.

Example 3: User selects any record in Multi-choice and several fields on form become filled in with data depending of user's choice.

(See example of FIG. 169.)

Data Sources—what it is and what for?

Data Source enables apps to work with data that is located in Database created on Snappii server or the data coming from external web services.

Users can use Data Sources to store and retrieve data inside apps. The data from Database can be populated from the Advanced list and users can update these lists right in the apps. Another way to update a Data Source is by using an Advanced Form. The information in the Data Sources can be sorted, searched, edited, updated, and deleted, it is stored on devices, uploaded from computer and can be sent via email. Everyone can use data from Data Source practically in all standard elements (YouTube button, Map, RSS, Twitter, etc.) to increase the app functionality.

Please find more details about each option below.

There are 2 scopes of Data Source: Global and Local. Global scope allows data to be available for all users on all devices; Local scope only shows the data entered on one device for one person meaning it stores data locally.

How to use Data Source dialog?

For managing Data Sources in your app you need to use Data Source dialog (click the Data Source button in the Editor right panel to view it).

To create Data Source do the following:

Open Data Source dialog. When you open it, you will be in the creation of a new Data Source mode.

Existing Data Sources are shown under “My Data Sources” table.

Name the Data Source.

Choose Database scope. Global—data from Data Source seen on all devices, Local—data from Data Source is only visible on the device it was added from.

Choose time zone (optional), it will be shown in reports when you submit info via email.

(See example of FIGS. 170-175.)

Click Upload Data. When you upload the Excel spreadsheet, keep in mind that the headers must not contain a space or any symbols. Use one word or a phrase without spaces and/or symbols.

When it is uploaded, match the Columns: Id, Name and Type. “Id” is the column names taken from your spreadsheet. See the picture below. “Name” is how you want to call it. Type denotes item content and is meant to show how the particular field in the app is used. So, it is extremely important to choose the right type for each cell in the Data Source. When you upload a spreadsheet, the Snappii Editor tries to match type and upload content automatically.

Text—any textual information, please keep in mind that YouTube videos as well as Social Channels and URLs will also use this type.

Numeric—numbers that you use like price, ID, order number, phone numbers etc.

Location—coordinates of a particular place on the world map. Use the following format: “xx.xxxxx,yy.yyyyy” (where x—is latitude, y—longitude. Both values are in angles from 90.00000 to −90.0000. Field with such type can be used in Map, location elements. In this field users will be able to upload coordinates to the Location Input.

Address—is a field with textual information about a specific Location. It can be used together with Location to describe the place more detailed, or apart from Location.

Datetime, Date, Time—fields to store date in different formats.

Image—field with the URL to the picture. Do not try to upload the picture into the spreadsheet, you must only add a link to it. Your app users will be able to upload their pictures or signatures into this field.

ATTENTION: If you don't match the Type and Name correctly, the Data Source will not work.

If you want to be able to search and/or sort data inside your app put a check next to required fields.

Later in the app itself you will see an Advanced Search and Sort button you will use to search/sort data.

In our example we are searching for all hygienists working in a clinic. We click on Advanced Search button and enter the keyword in the Header2 field which reflects names of the team and their specialty. As shown in the second picture the search returned only 4 people who are hygienists. This feature will help you quicker handle large lists of items.

Sorting is another helpful feature which provides ascending or descending views of your items. The image below is showing a descending view. Alphabetical order will help you to faster and more conveniently handle large volumes of data in your mobile app.

Click Save.

After you click Save, you will have your Data Source. If you don't save it, the Data Source will not appear. After you save the Data Source, you will see it in the table of Data Sources to the left. Then you can start using it in your app with the new elements: Advanced List, Advanced Form (see the description below).

How to add data to Data Source?

Data to your Data Sources can be added in three different ways.

Using Data Source dialog

Using Advanced List

Using Advanced Form

Using Data Source dialog

Open Data Source dialog in the WYSIWYG Snappii editor.

(See example of FIG. 176.)

When you are in a making and/or testing mode of your app you can use the following options:

Upload Data button: Upload data from a spreadsheet into Data Table located on Snappii cloud server. Supported format is Excel file .xlsx. The cells of the first row in the spreadsheet will be used as columns' names for the data table. The titles must not contain spaces or any special characters.

Append Data: Use Append Data button to add data to an already existing Data Table. The set of fields should match the fields of originally uploaded Data Source. New data will be added to the end of Data Table.

Download Data: Use this to download and export the current test data to a spreadsheet.

Once you publish your app all the uploaded Data Tables changes status to “published”. You will not be able to change or add any new data fields. Snappii separately stores data for published apps in production and apps in development so that further app development can proceed without effecting data in published apps in production. Snappii developer can continue to test apps using Preview app and perform Web2Phone copy builds. It will not damage the data in the published application in any way.

When it comes about Data Source data changes in live apps use Production Development buttons

Download Data: Use it to download and export data currently stored in production Data Table

Transfer Development Data: Use it to replace production data table with data from development data table.

Attention! If you don't want the production app data to be lost you need to download it using Download Data and add it to the development data (Append Data or Upload Data). Only after this you transfer from Development environment to Production.

Using Advanced List

Once you upload your spreadsheet to the Data Source dialog you can add Advanced List and display data from uploaded Data Sources in the app. Moreover Advanced List allows to add/edit/delete and email information from Data Sources.

In the pictures below you can see the whole process of adding new items into Advanced List. The same data will go to the upload Data Source, to see these changes you can download development data using Download Data option. Using User Management an access to add/edit/delete operation can be limited. (See User Management F.A.Q. for more information)

(See example of FIG. 177.)

Using Universal Form

Universal Forms are connected with Data Sources and store entered data in an Excel spreadsheet users can always download from Data Source dialog.

Filled out data via Universal Form cannot only be submitted via emails and saved in Data Sources but also be stored right in the app.

Here are some steps on how to add data from Universal Forms into Advanced Lists:

Upload a Data Source

Add Universal Form, bind it with the uploaded Data Source

Drag and drop text elements (to name fields) and form fields to enter data into them, bind each field with a corresponding value from the Data Source uploaded.

Add Advanced List and bind it with the same Data Source as you did in Advanced Form

Select Custom Detail View for your Advanced List

Drag and drop as many text elements as required to show fields names and display information received via Advanced Form. Bind each element with a corresponding field from Data Source. If you have images

(See example of FIGS. 178-180.)

Don't forget to select “Constant” source for naming elements in the text element settings. Only then the required text will show up. If you choose “Data Source” source the data from your Data Source will appear.

How to make forms inside forms?

To be able to create forms inside forms you need to use Table input available in the Form inputs section in the Snappii editor.

Once added on a canvas it will look as a usual field with a green plus sign next to it. A double click on the

“Plus” will open another blank page where you can place more Form fields and create a whole form inside.

When it is filled out users can save it and again open another form by clicking on “Plus” (see image below).

They can also delete and edit filled out forms.

Shared Data Sources

With the help of the Shared Datasources feature Snappii users can create native mobile role-based apps that use shared datasources and hence will be able to provide the same data to a series of apps. Let's review a possible use case.

You want to create a work management app that will be of high value both for supervisors and employees. Using one app can be confusing and sometimes inconvenient. Due to the shared datasources option you can now create two different apps: one for supervisors and another for employees. Both apps will use the same datasource that will enable supervisors to assign tasks and check job statuses while employees will be able to review assigned tasks and edit them when tasks are completed. That clearly divides responsibilities and makes the whole work process easier and more intuitive.

Similar scenarios can be utilized for a majority of apps that have assignment features such as apps for logistics, dispatchers, drivers etc.

To enable this feature, open the Datasource dialog, click the datasource you want to share and put a check next to Share. Then save the settings. Now this datasource will appear in the Shared Data sources dialog like in the image below.

Runtime Datasources

Runtime datasources is a great option to use inside big companies. This feature will allow to share data sources among some specific users but not all app users. On the app registration form, app users will enter the company identifier when they register. If users work in the same company they should enter the same value for this identifier. It will allow them to work with the same set of data.

Use Case. Ask your employees to fill out the questionnaire form. Only logged in employees will have access to the form.

Use Case: how users from single company can register in the app and share companyId. Anonymous user fills in a registration form:

(See example of FIGS. 182-184.)

When a user logs in, he gets to the main tab. He has button Share, by clicking it he can send companyId to other users:

A user with another companyId will have separate version of data:

Chapter 11. Web Services

What is a web service and how it is used?

A Web service is a universal mechanism that connects apps with on premise data sources inside organizations as well as with websites on the Internet. There are literally hundreds of thousands of really useful data sources available for anything from weather, file storage, videos, pictures, marketing services, etc. Apps can retrieve data, show it and if needed update updated it.

For databases you have to upload data. With Web Services it is different. To make it work you need to create a “connector” that will describe how to retrieve data and possible update it. The “connector” is an XML file. For example of a connector please download several samples from “data source” dialogue.

Snappii staff has created many connectors that can readily be used in your applications. This list of connectors will continue to grow. In brackets there are some URLs with examples.

Please ensure you have chosen a corresponding OAuth Consumer type after connectors upload in the DataSource dialog.

Twitter (https://www.Snappii.com/static/tmp/Twitter.xml)

Salesforce (https://www.Snappii.com/static/tmp/salesforce leads full doc.xml)

Google API (https://www.Snappii.com/static/tmpBlogger_APLxml)

Vimeo (https://www.Snappii.com/static/tmp/Vimeo.xml)

LinkedIn

Instagram

Facebook

etc

Please review an example of SalesForce connectors with detailed description using the link below. https://www.Snappii.com/static/tmp/salesforce_leads_full_doc.xml

OAuth.

OAuth is an open standard for authorization. OAuth provides a method for clients to access server resources on behalf of a resource owner (such as a different client or an end-user). It also provides a process for end-users to authorize third-party access to their server resources without sharing their credentials (typically, a username and password pair), using user-agent redirections.

You can get more info about oAuth here: http://oauth.net/

To create an app using SalesForce connectors please do the following:

open DataSource dialog in the editor

select Web services

OAuth Mode: My account or User's account. Using “My Account” option customers will not need to enter credentials as they will get data by using app creator's account

In the “User's Account” case they will have an access to data only after entering their own credentials.

OAuth Consumer: choose SalesForce from the list (the list will be constantly growing)

upload the connector in the DataSource menu using “Upload XML Connector” button

click on “Generate New Token” button, it will redirect you to SalesForce website to sign in to complete the authentication process.

test Select operations to know exactly if your connector was correctly created or not

if the operation is successful, add Advanced List/Form and bind fields in the tab/button settings the same as you do with simple Excel spreadsheets (if no rows of data returned then make sure your connector is properly made)

for each connector use a separate Advanced List/Form tab/button

Please ensure you have chosen a proper mode for the authentication (My or User's Account)

You can categorize your data using data sources or other web services as categories. The following variants are possible in category mode: Web Service+Spreadsheet, Spreadsheet+Web Service, Web Service+Web Service.

To know how the web service works and looks in the app please take a look at the demo app we created here http://MobileOnlineApps.com/demo_31734

It includes SalesForce leads, users, twitter, message board, cases, contacts, events and etc. Using the SalesForce connector as the pattern you can create your own connectors. Also find even more useful web services for your apps on www.apigee.com

For more details contact Snappii support team.

How to connect Twitter to my app?

To be able to connect your app to any web service you need to get a full documentation on the web service you are planning to use. Creating a “connector” for your web service is a necessary condition. Some of the widely spread web services documentations are available on apigee.com/providers. As well such web services as Vimeo or SalesForce and others provide this information on their websites. The example we are checking can be downloaded here: https://www.Snappii.com/static/tmp/Twitter.xml Let's create Twitter connector together using apigee service.

Go to apigee.com/providers and choose Twitter from the list

Select the data you wish to pull (depends on the data you want to be retrieved from the web service such as: users' timelines, tweets, retweets etc. We will try to pull users' timelines. (statuses/user timeline). To proceed click on the chosen parameter.

To be able to use the web service, you need to be logged in. For this choose OUath1 mode in the dropdown menu of Authentication setting at the top

Now sign in with your twitter account login info

Authorize the app

Go to “Template” and choose the responseType parameter. We support XML and Json formats.

Select your variant in the “Value”

Go to Query. Scroll down the menu and find the mandatory fields. They are user ID and Screen Name. However you can fill in just either of them. Please ensure you enter correct screen name or ID

Click “Send” on the right

You will get a Response containing all the necessary data needed for your connector

Now we start creating the connector itself. Download any of Snappii examples, change parameters there and use them as your own. No need to create connectors from scratch. The structure of connectors is always the same

As we are using Select operation for our twitter account, there are the following parameters:

The opening tag is <settings>. We use <select> operation.

Timeout—timeout for cache in minutes. For Select operation during this period of time the data will be taken from cache instead of a regular request to the web service. If cache is not found, regular request to the web service will be performed and cache will be written down again. If timeout=0, then each time the data will be downloaded from web services. So we get:

<cache timeout=“0”> then we close the tag </cache>

<uri>—is the Request URL you get on apigee. In our case it is https://api.twitter.com/1/statuses/user timeline.xml

Closing tag is </uri>

<dataXPath>—Path to data array in XPath format. Mandatory field. Statuses/status is our case. Closing tag is </dataXPath>

<countXPath>—Path to the value with general data quantity. Optional field, can be left blank. And close it</countXPath>

The following settings are mandatory:

requestType—request type. Available values: GET|POST|PUT|DELETE. If request type=GET, then the valid type forrequestContentType=application/x-www-form-urlencoded and in requestTemplate you should write only parameters (par1=1&par2=2 etc.). When we use Select operation only Get type can be used.

responseType—type of data from web services response. Available values: XML|JSON.

requestContentType—Type of data for web services request. Available values: application/x-www-form-urlencoded|application/json|text/xml

<requestParams requestType=“GET” responseType=“XML” requestContentType=“application/x-www-form-urlencoded”>

Is what we will use.

<requestTemplate> Template to send data to the web service depending on requestContentType, list of parameters needed here JSON or XML.

In Select Operation only one parameter can be used for now—[categoryId]. When this data source is used as “categorised”, then instead of [categoryId] the id of the category, that is being requested, will be used.

If you need to set a default value (when the Data source is used by itself, without categories), then you need to put [categoryId?12345]. In this case for regular requests the value after “?” will be set. In my example it is 12345.

If there's nothing you′d like to put in the request, this field must be left blank. Close the tag </requestTemplate>

After closing tags the rest of the tags </requestTemplate>
</requestParams>
</select>

we define the fields for our connector (they will show up in the app). Please keep in mind you should have all the syntax correct otherwise it will not work.

<fields> can contain the following:

field name—just name the field

field ID—must be unique among the fields. must not contain spaces and symbols like/. $ etc.

Sortable/Searchable—two types are available: True and False. In case you choose True the fields will be chosen as marked after you upload the connector to Snappii DataSource dialog. False—the fields will not be checked as sortable or searchable.

primaryKey—means that this field is used as data record identifier. It means that among all the fields there can't be fields with equal data. This field is used during adding, deleting and editing data.

There can only be one field with primaryKey=True. It's possible to change it in Data Source dialog. Values: True/False.

fieldType—text, numeric, datetime, image, location, address, date, time. Type of the field. If you don't know which one suits your data best then select Text type.

xPath—a path to the data within the record taken from <dataXPath> from the section <select>.

In our case we already wrote Statuses/Status as the dataXPath that's why we won't define it as xPath. The whole line looks this way:

<field name=“id” id=“id” sortable=“True” searchable=“True” primaryKey=“True” fieldType=“text” xPath=“id”/>

Closing tags are <fields>

</settings>

The connector is completed and ready to be uploaded to Snappii DataSource dialog. Some final touches:

open DataSource dialog in the editor

select Web services

OAuth Mode: My account or User's account. Using “My Account” option customers will not need to enter credentials as they will get data by using app creator's account

In the “User's Account” case they will have an access to data only after entering their own credentials.

OAuth Consumer: choose Twitter from the list (the list will be constantly growing)

upload the connector in the DataSource menu using “Upload XML Connector” button

click on “Generate New Token” button, it will redirect you to Twitter website to sign in to complete the authentication process.

test Select operations to know exactly if your connector was correctly created or not

if the operation is successful, add Advanced List/Form and bind fields in the tab/button settings the same as you do with simple Excel spreadsheets (if no rows of data returned then make sure your connector is properly made)

for each connector use a separate Advanced List/Form tab/button

Please ensure you have chosen a proper mode for the authentication (My or User's Account).

3. Cloud Storages

In the Snappii editor to the left from the iPhone canvas just under PayPal you will find Cloud Storage settings. Click the Plus sign to add new Cloud Storage. You will see a window. Select from the 4 Storages we offer:

Dropbox

Box

Google Drive

MS One Drive

If you put a check next to “Provide key and secret for my own app folder in my cloud storage choice” it will ask you to enter key and secret. This feature allows you to specify the exact folder on Dropbox where the data will be stored. Only Dropbox offers this feature. Box, Google drive and MS one drive do not offer this. You can leave this option unchecked and the data from your app will go to the root of the Cloud Storage selected. Just click Save and Create token. Once you click that button, you will be redirected to the login page of the selected Storage. Login and you will see the message “Successfully authorized!” Go back to Snappii Editor—you will see more buttons appeared. You can close the window now.

(See example of FIGS. 185-186.)

Use Case. We have the app that allows its users to fill out the Daily report and send it. Once the report is filled out, app user clicks Submit like it normally works with Universal Forms. Take a look at the Universal form settings. You will see that there is a “Submit to Cloud Storage” setting. Click it to choose your added Cloud Storage and specify the report format: Excel and/or PDF.

Another setting in the Universal form is called Report Common Settings. Here you can specify a file name for PDF and/or Excel reports. You can insert NUMBER, TIMESTAMP and USERNAME variables to add a sequence number and a timestamp to the file name. Examples of what you can use as a report file name:

Report NUMBER

Your reports will look like: Report 1, Report 2, Report 3, . . . .

Report TIMESTAMP

Your reports will look like: Report 04.05.14, 02:43:55 AM, Report 04.05.14, 02:43:53 AM . . . .

USERNAME Report NUMBER

Your reports will look like: John Smith Report 1, John Smith Report 2, John Smith Report 3

You can specify if you want to allow user to choose format of report (PDF, XLSX or both), use your own PDF template □ upload your PDF template. Read more here—Universal Form

Share Form Report

This setting allows you to specify what you want users to do with the submitted report:

View and Save

Just Save

By the user's choice

By the boolean's input choice

(See example of FIG. 187.)

Form Report List button

This button stores all the submitted reports in one place as a PDF or Excel file. It's a great substitution for Advanced List element in case you just want to display the report as it is. The settings of the Form report List button allow to select the button view—Button, Framed view or Full screen view just like it works for Advanced List. The List view template can be set with 3 different templates.

(See example of FIG. 188.)

Chapter 12. Widgets

Widgets are tabs and elements from the Editor created by Snappii users with predefined content. Users have the ability to save their tabs and elements with content as widgets that they can later use in their other apps.

Users can suggest adding widgets they treat as extremely useful for every Snappii user to access and utilize in their apps.

Users can create as many widgets as they wish.

For example, you can create a tab with elements as call, email, contact form that you later wish to use in other apps. Save this tab as widget and insert it in another app! Another example, you are using database in your app, have multilevel lists that you′d like to use in your other apps. Save this as a widget and add to your next app, no need to recreate that functionality from scratch anymore!

Creating widgets allows to save time and development work, speeds up app making process significantly. Widgets are saved under Widgets tab in the Snappii Editor.

(See example of FIGS. 189 and 190.)

You can add any element as widget and save it under “My Widgets”.

You can suggest your widget to be added as a “Community widget” for all Snappii users to have access to. If you believe your widget is very useful for all users, you can send it to the Snappii team for review.

Levels of InApp Access

Predefined users

User management option will help you specify the groups of users who will be able to use your app, e.g. setting various levels of access to an app. Find this button in the left part of editor menu. By default, there are the following types of users: anonymous, logged in and app reviewer. You can add more types, click on “Add new type” button and enter the needed types. In case you want to remove the types you entered, click on red cross to the right from type title. UM provides 3 registration modes:

General mode—it allows anyone to register in the app and use default users' types.

Predefined users—Upload a speadsheet containing the following fields:

userName

emailAddress

password

memberId (optional)

userType (will default to LoggedInUser if not specified)

expiration date (required)

Sample spreadsheet is available for your convenience. (click on Question mark and download it). Predefined users are likely friends or employeers who don't have to register in the app, they get access to apps just by logging in. If the user was previously entered, then the password will not be updated (user can change their password in the app). Any users already entered, but no longer in the spreadsheet will be disabled and will not be able to log in.

InApp memberships

Member—App creator specifies member ids by entering the spreadsheet with the following fields:

memberId (requried)

userType (will default to LoggedInUser if not specified)

itemId (required)—itemId from PayPal element or product list

Either:

expirationDate (required) or

membershipLength (required)

membershipLengthUnits (required)—days, weeks, months, years

Users may purchase their membership for the app and get assigned manually or automatically (specify it by choosing one of the options). Manually assigned members—After purchasing, app creator sends users their member ID, they can use to register in the app. If the user was already registered as a general user, he will be able to update his profile and enter his member ID. Auto assigned members—The user purchases membership then immediately register in the app, and will be assigned a member id and expiration date. When a user is assigned a member id, the app creator will receive an email specifying member id, user information, and PayPal transaction id for the app creator's records. As well as manually assigned members, auto assigned members can also update their profile and enter member ID in case they were registered as general users. (See example of FIG. 191.)

Chapter 14. White Label and Dashboard

White label

White label is the ability to use your own company/brand instead of Snappii. White label allows you to show your Splash screen, remove Snappii ads and Snappii powered by button.

Dashboard

Dashboard helps you track your app usage. Go to dashboard from Snappii site, choose an app you wish to analyze. As a registered (non-subscribed user), you are able to access the Snappii dashboard features 5 times to test functionality.

Once you become a subscribed customer you have unlimited access to the Dashboard.

You can see there are many reports. You can choose to see users over a specific period of time.

First Time Users—shows users who use your app for the 1str time

Usage Frequency—shows the number of times your app has been run by users

Active Users—shows users' activity over time

Registered Users—shows when and how many users have registered.

(See example of FIG. 192.)

Push Notifications

Notifications are a great way to gain more people into your business. When you have an announcement, send it as a push notification, and all users will see it. Read more in Chapter 5.

Chapter 15. Ads and In App Purchases.

To the left from the Emulator there are Ads and In App Purchase settings.

These features allow you to show banner and interstitial ads in your apps. Banner ads are shown at the top or at the bottom of the screen, interstitial ads are full screen ads that can be closed by app user.

In App Purchase

To set up IAP for iOS you need to do the following:

Open your app in Snappii editor

Go to Ads and In App Purchases settings that is placed to the left from device canvas

Click Subscription Products □ Enable □ Monthly/Yearly or both

Save the app and create a web2phone copy (learn more here) Select iOS web2phone copy, check “Add this app to iTunes connect” and click OK

(See example of FIGS. 193-195.)

After your iOS web2phone is generated, you can find your app in your iTunes account. Login to itunesconnect.apple.com □ click My Apps □ select your app

Select In App Purchases and click Create New.

Select Auto-Renewable Subscriptions to set up monthly and annual subscriptions

Click Select and enter Reference Name (Subscription, for example)

Set up duration and pricing (see screenshot below). Please note that Product ID should not contain spaces, special characters and must be all lower-cases.

Click Save.

Important: If you want to create both annual and monthly subscriptions, do not create a new Auto-Renewable Subscription. Instead, please click Add Duration in the created subscription.

Same points work for annual subscription.

Click Add Language. See screenshot below

Now Upload screenshots that show you have IAP in your app. Click Choose File and upload the screenshot. It should contain information about app subscriptions you offer.

Save. A pop up window will ask you to enter Privacy policy URL.

Click Save.

Go back to the Snappii editor and enter the created unique IDs into iTunes Product ID for both monthly and annual subscriptions.

Scroll down to Free form submission limits and insert the number of free submissions you allow per ever/month/day.

Use Case. If you allow users to make 2 free form submissions per day, the app will ask them to purchase subscriptions after they exceed 2 submissions. The counter will be reset in 24 hours.

Put a check next to Enforce registration if you want to collect users' contact info.

Save the app.

Now your app is ready to be submitted to the Apple App Store.

For Google Play:

In difference to iOS setup you don't need to create web2phone copies. IAP can be created right after the first

app submit.

Open your app in Snappii editor

Go to Ads and In App Purchases settings that is placed to the left from device canvas

Click Subscription Products □ Enable □ Monthly/Yearly or both

Create unique Google Play Product ID in the Editor before you submit your app. Save your app.

Submit your app to the Google Play.

After the apk file was uploaded to Google Play developer console, you can set up subscriptions.

Login to your Google Play developer account. Find your app and select In-app Products in the menu to the left.

Click Add New Product button->Subscription.

Fill in the unique ID you created in the Snappii editor, and click Continue. Fill out the information, see screenshot below:

Important: Keep in mind that once the info is saved, you can't make changes to the pricing.

Save it. And click Activate button on top.

Create annual subscription the same way, if you need it. Save it. And click Activate button on top.

Go back to Snappii and click Resubmit your app to Google Play to enable your IAP changes.

Ad Removals on iOS

To set up ad removals in iOS you need the following information:

iTunes Product Id—to get it you should have a valid Apple Developer Account. To add an app to it you at first should click to create a web2phone copy. You will see a message with a checkbox:

“This app will be added into your iTunes connect account. You will be able to configure “In App Purchase” settings for this app in iTunes connect and test it before app is submitted into Apple App store.”

Put a check and proceed. The app will be then added to your account and you can continue setting it up. (See example of FIGS. 196 and 197.)

Go to https://itunesconnect.apple.com/WebObjects/iTunesConnect.woa and login

Manage your Apps->Click on your app icon->Select Manage In-App Purchases on the right>tap Create New□ Select Non-Consumable type.

Non-consumable In-App Purchases only need to be purchased once by users. Services that do not expire or decrease with use are usually implemented as non-consumables, such as new race tracks for a game app.

Non-consumable settings:

Enter Reference Name

Product Id—It should be a unique id for your app. Example: For Construction Manager App we will use: ad_removal_for_construction_manager

You will then need to copy and paste this id into a corresponding section in the Snappii Editor.

Select the Price Tier

Add language. It is some short information about your product.

Upload a screenshot, it should be 640/920 pixels

Add your iTunes Product id in the editor and save the changes. Be sure to enable add removals in your app in the editor.

To set up ad removals in Android you need the following information:

Google Play Product Id. You should have a valid Google Developer Account. Before setting up ad removals in your app you should submit it to Google Play without in app purchases settings enabled.

Once submitted you can login to Google Developer Portal http://www.google.com/accounts/Logout?continue=https://play.google.com/apps/publish

Find the app you want to enable ads into Open it and go to In-App Products in the menu on the left

Click Add New Product

Choose Managed Product category and enter your product id. It should be a unique id for your app.

Example: For Construction Manager App we will use: ad_removal_for_construction_manager

Add a title and some description about your app

Enter the price (you can auto-convert it)

Click Activate at the top and Publish your app changes

Copy your Product Id and paste it in the corresponding section in the Snappii editor

Add your iTunes Product id in the editor and save the changes. Be sure to enable add removals in your app in the editor.

How to set up In App Purchase Button?

To be able to disable your ads your app users can purchase a one-time payment. To allow them to do it, drag and drop In App Purchase Button to a desired place in your app.

In a live app users will click it and be able to pay a fee to turn ads off

(See example of FIG. 198.)

How to get Android purchases license key?

You should have a valid Google Developer Account. Before setting up ad removals in your app you should submit it to Google Play without in app purchases settings enabled.

Once submitted you can login to Google Developer Portal http://www.google.com/accounts/Logout?continue=https://play.google.com/apps/publish

Open an app and go to Services & APIs, copy your base 64 encoded PSA public key

Paste it in the corresponding section in the Snappii editor.

How to set up interstitial and banner ads in iOS and Android apps?

Register at https://apps.admob.com

Monetize your App

Find an existing app or add a new one manually

Enter your App Name (if manual) and choose the required platform, Add App

Select a required format

Once saved you will see an Ad Unit Id. Be sure to copy it and paste in the corresponding section in the Snappii editor.

Ad Unit Ids for Banner Ads should be specified for each tab/element separately while Interstitial Ads are set up just once in Ads and In App Purchase settings.

There is a special Ads section for it in all Tabs/Elements in the editor. You can either place Banner Ads at the top or at the bottom.

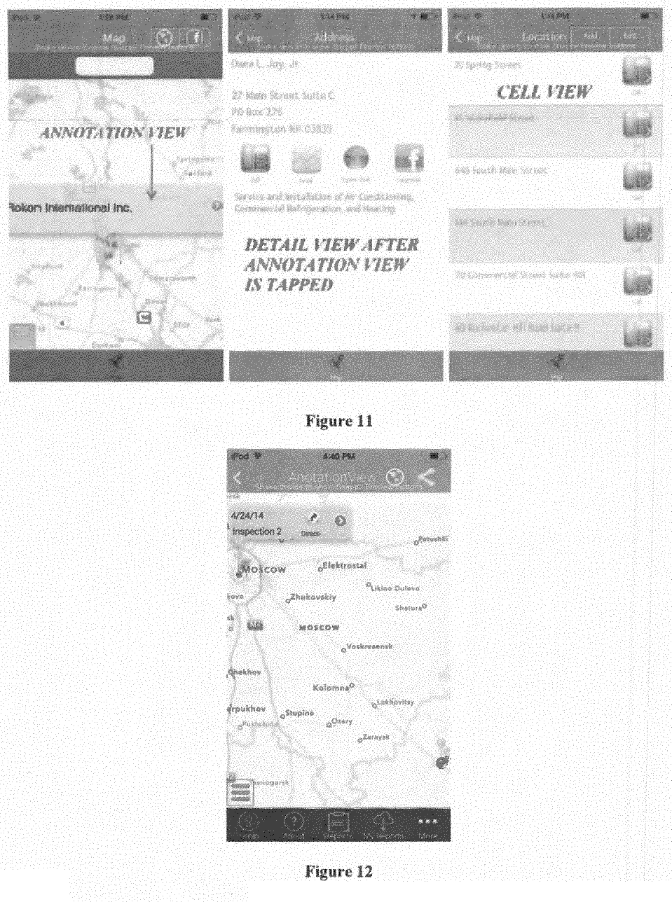

(See example of FIG. 199.)

You can track and control a number of app user's clicks before showing him your interstitial ad. Just enter a number and specify the places that will count users' clicks.

Besides IAP and Ad removal, you—as the app creator—can filter out the content you want your app users to see. For example, if you want to show a tab for a paying customer, use the formula: <currentSubscription.status>==“purchased”

Chapter 16. Partnership

Our Partner list is growing rapidly, because you don't have to be a programmer to create Mobile Apps. Sales people, Marketing people, IT support people, literally anybody who can use the web can now make Mobile Apps for Clients. Thousands are starting new companies, or expanding existing companies to offer building Mobile Apps for Small Business Clients.

For every App our Partners get:

FREE: 100% white label solution (so it looks like you made the app)

FREE: Analytics Dashboard

FREE: Push Notifications messages

If you are a web developer why outsource app building? Build apps with Snappii, keep the client happy and keep the profit! You can even re-use your HTML code.

Epilogue

By the end of 2017, market demand for mobile app development service will grow at least five times faster

than internal IT organizations' capacity to deliver them, according to Gartner.

According to Gartner, now half of business processes require near-real-time responses, which can be enabled by mobile business apps. Not surprisingly, the mobile enterprise business application market is expected to double by 2018.

According to the Comscore report, US population now is spending 52% of its “digital time” on mobile apps.

IDC's Mobile Enterprise Software survey from April 2014 showed that 40% of businesses with more than 1,000 employees developed and deployed all their apps themselves within the previous 12 to 18 months. 15% of the respondents deployed all apps using a third party and 43% mixed third-party firms and internal development.

In a recent Forrester's survey, 75% of decision makers admitted that deploying mobile apps had increased worker productivity, while 65% acknowledged that mobile apps had increased employee responsiveness and decision-making speed.

By 2017, mobile apps will have been downloaded more than 268 billion times, generating more than $77 billion in revenue, according to Gartner.

A digital solutions provider Xcube Labs notes that 67% of CIOs and IT professionals believe mobility will impact their business as much as or more than the Internet in the 1990s. In addition, Visage Mobile report states that the global enterprise mobility market will rake in $140 billion a year by 2020. Snappii team keeps working hard and adding more functionality to its ever growing to-do-list. All the features are customer oriented and made on latest demands. We respect and welcome customers' ideas, thoughts and are always happy to take them into account when releasing new features. In the nearest future we plan to support such platforms as BlackBerry and Windows Mobile.

“We are adding talented, hardworking and customer focused people to our team,” says Alex Bakman,—“our goal is to supply as many businesses as possible with a native app and/or mobile friendly website.

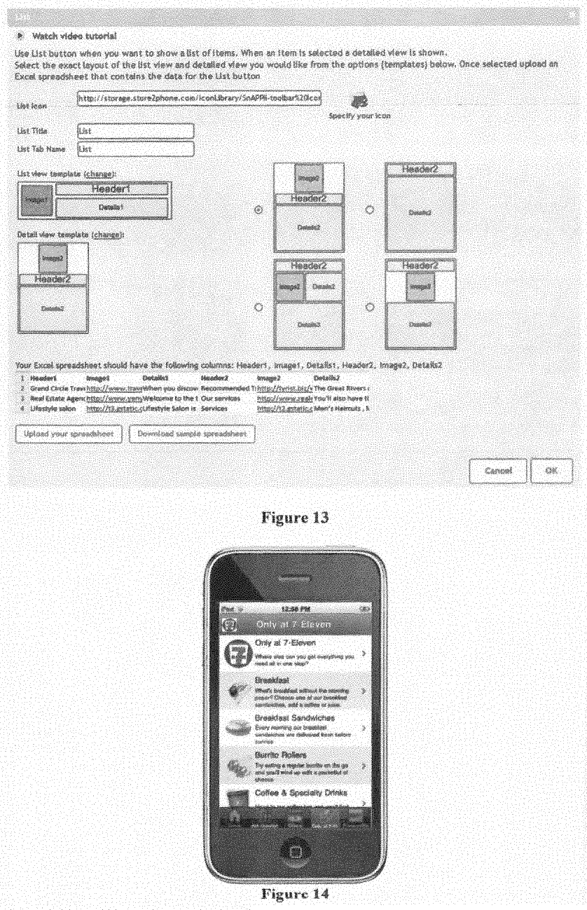

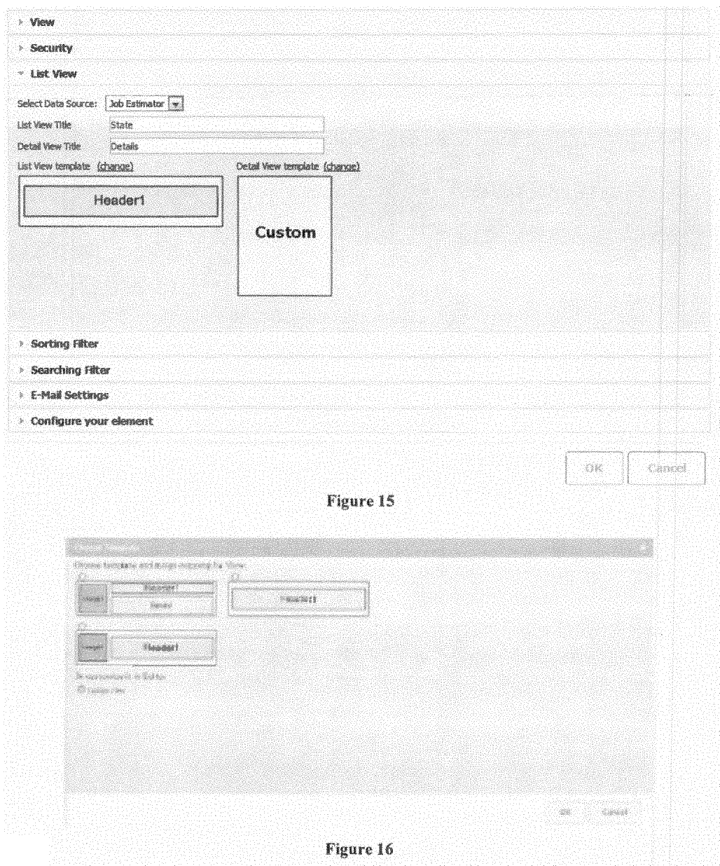

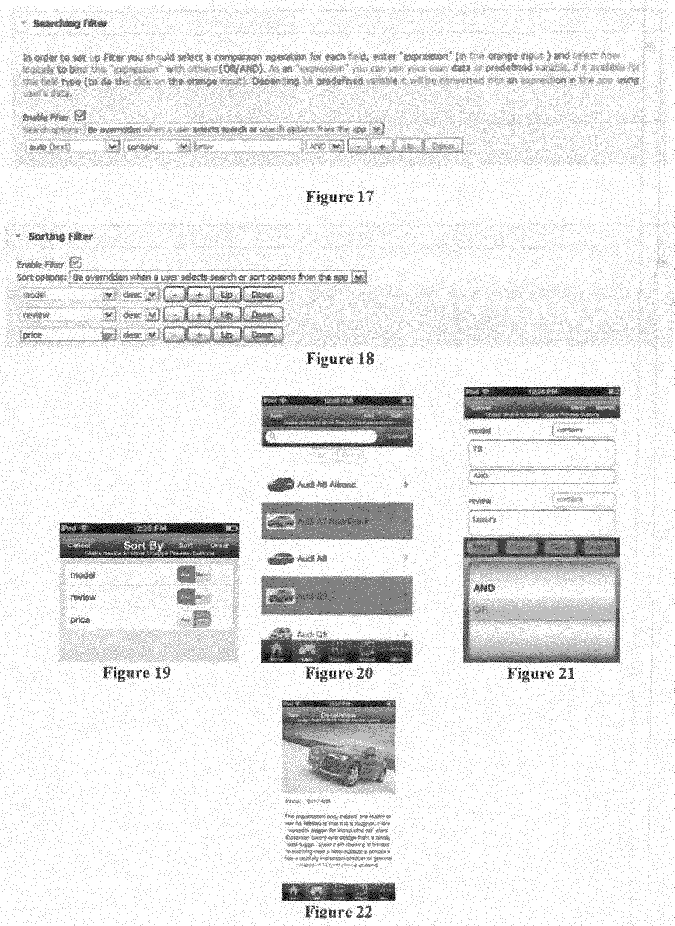

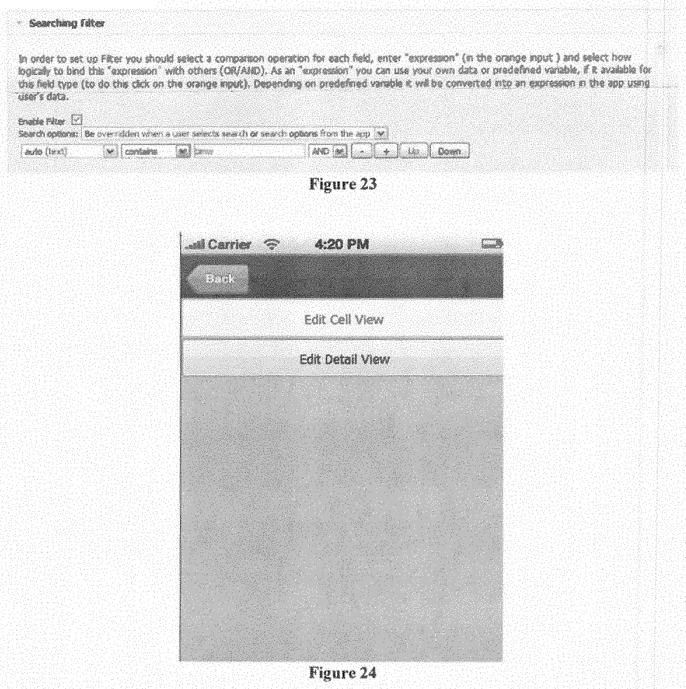

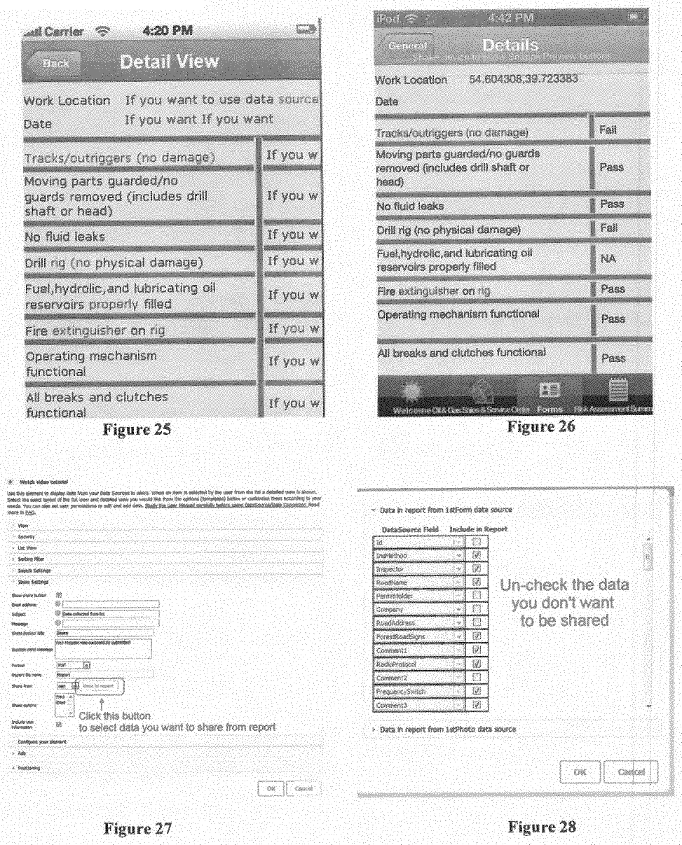

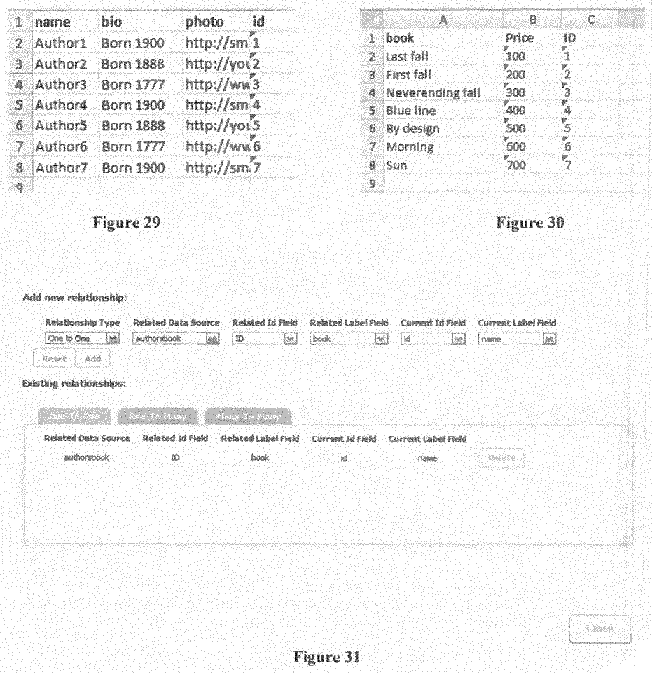

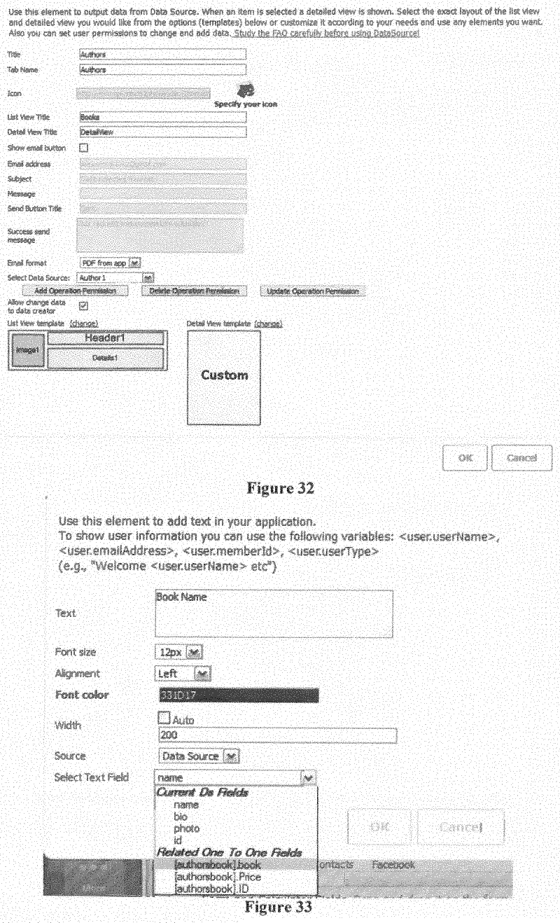

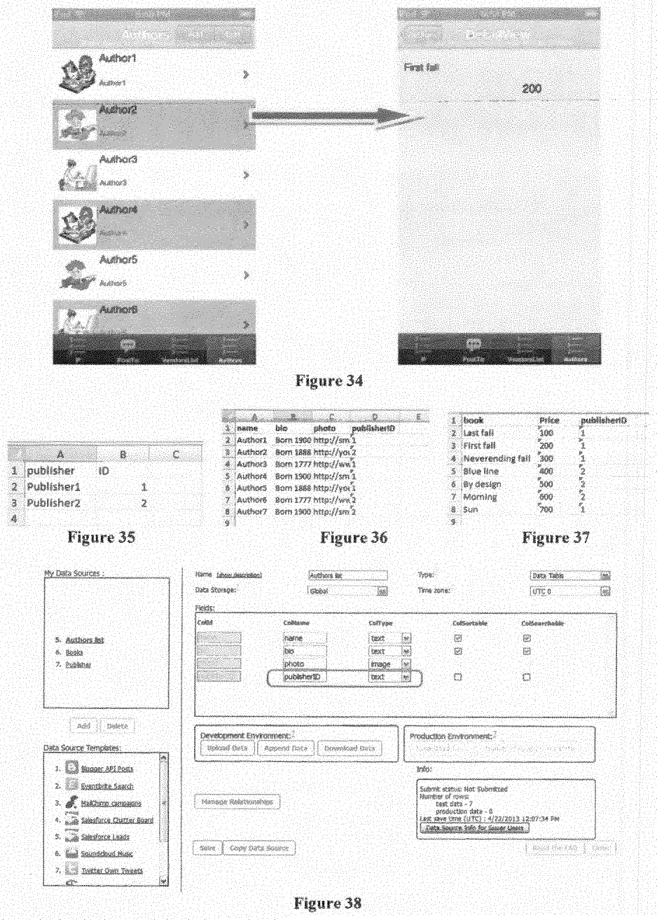

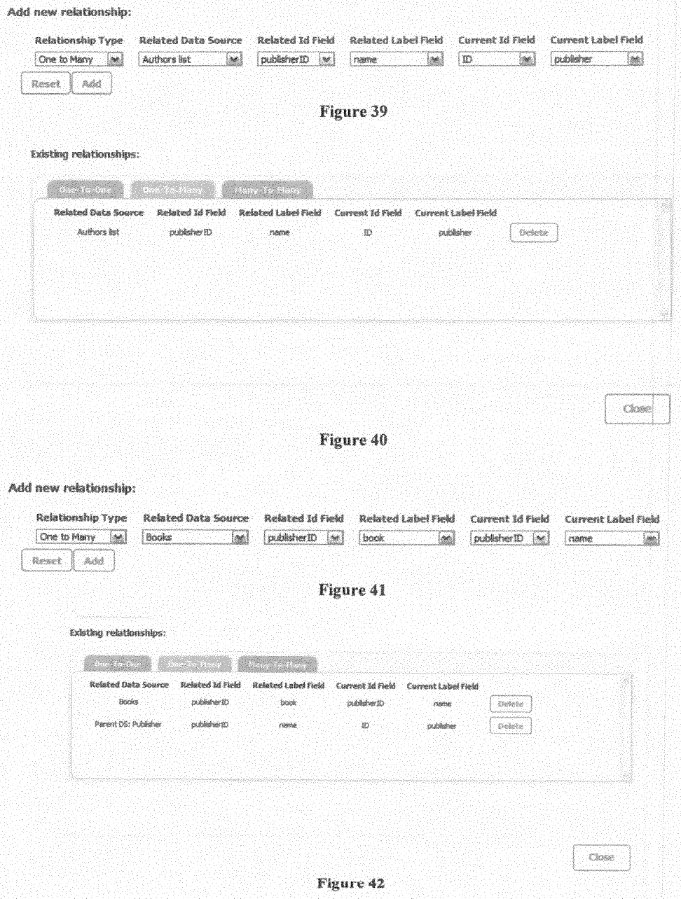

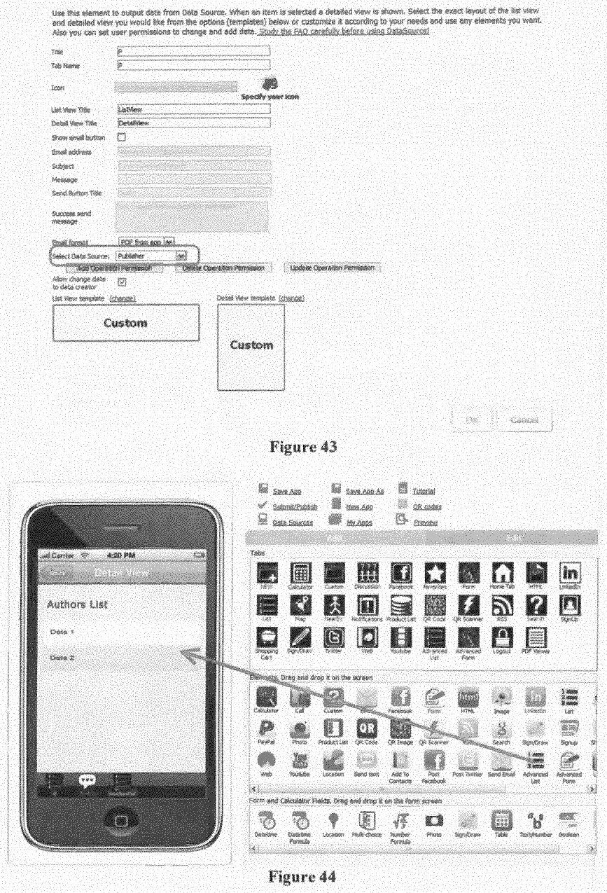

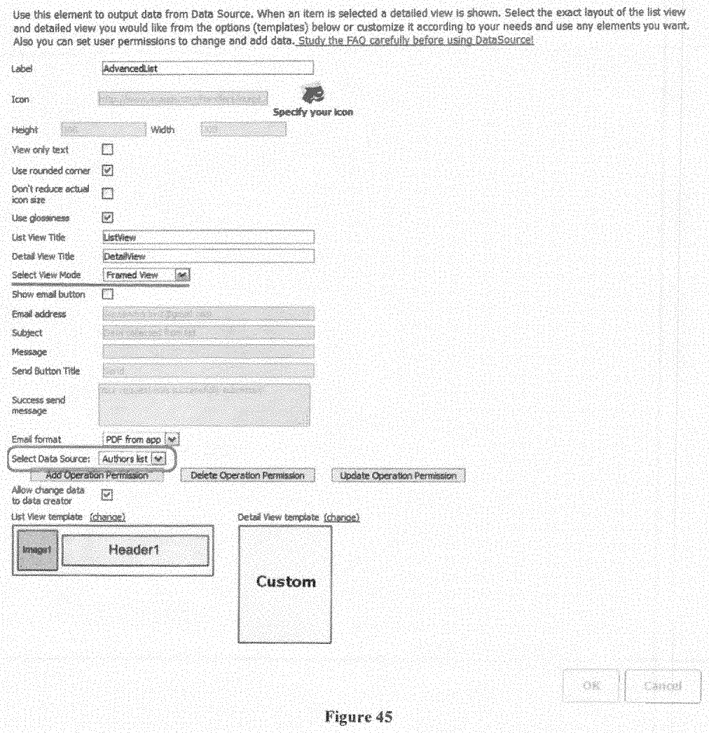

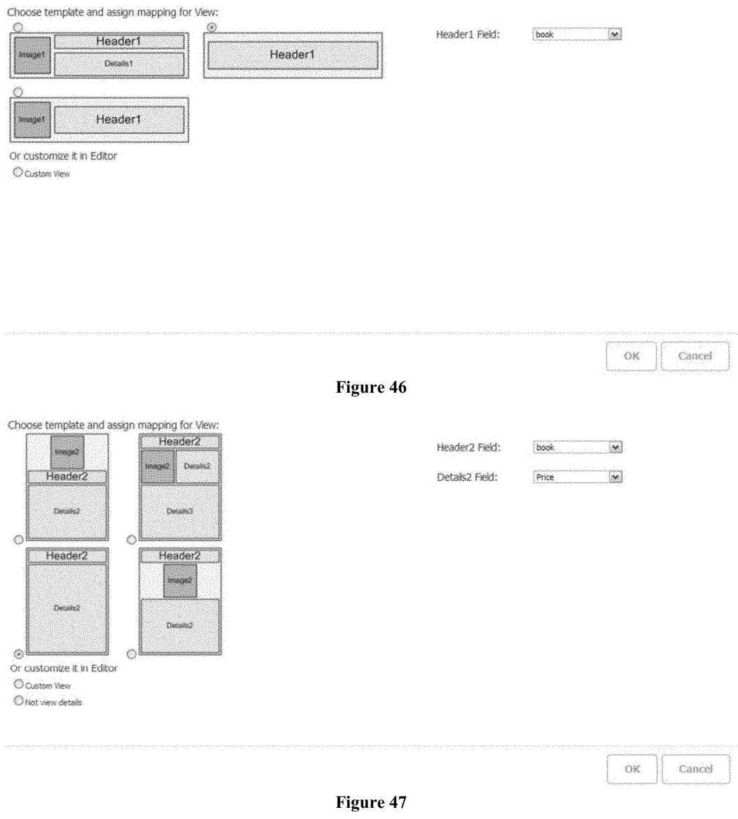

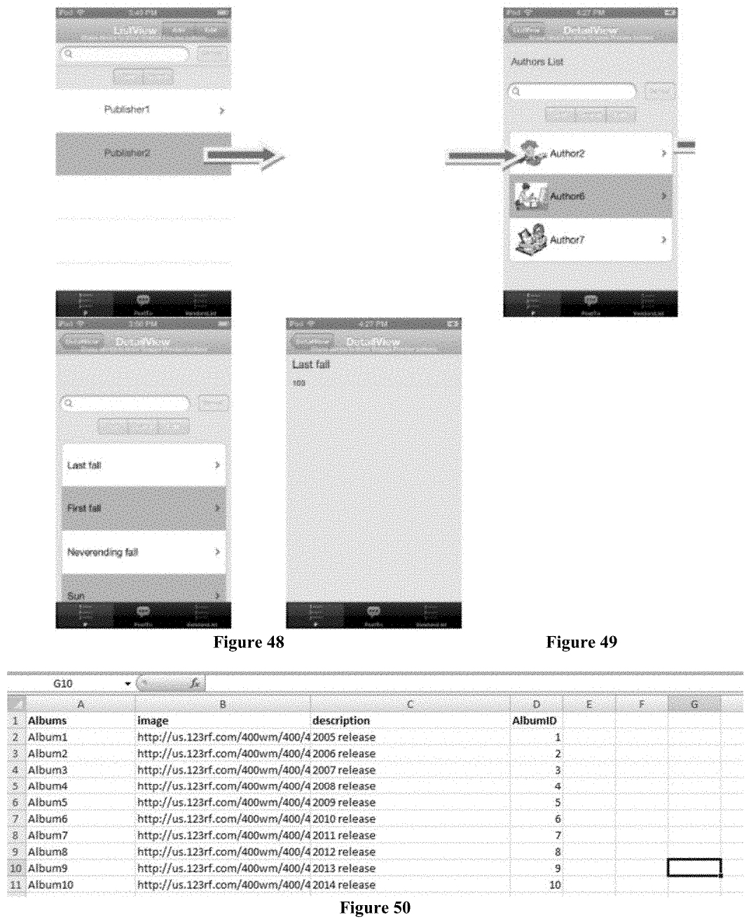

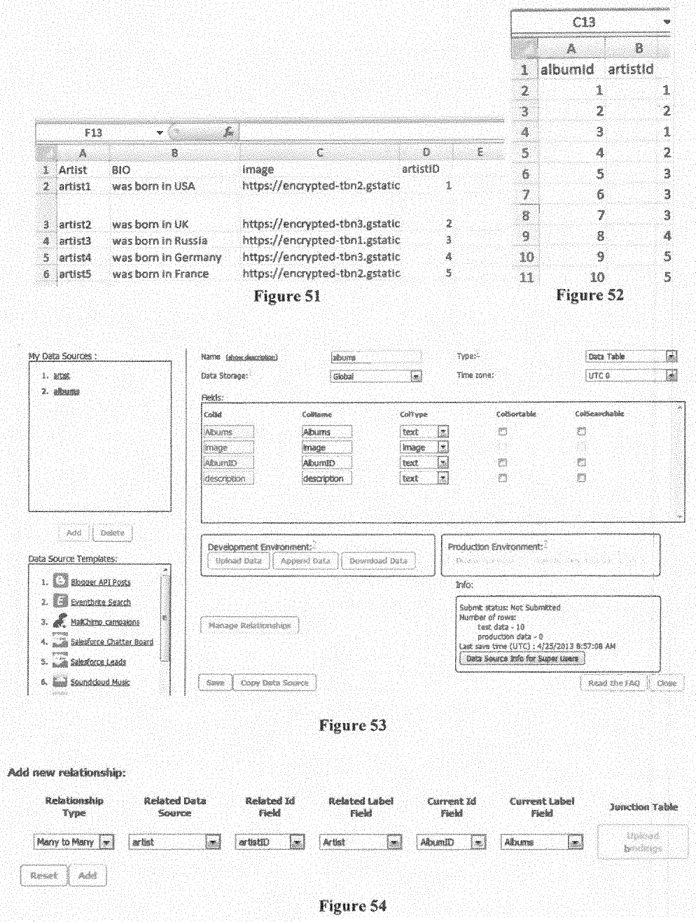

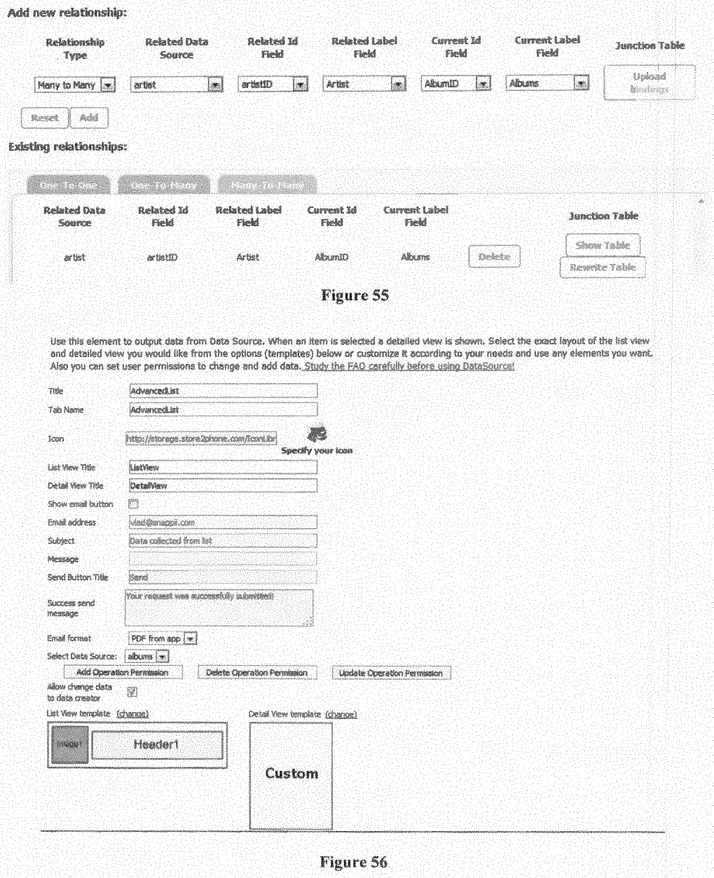

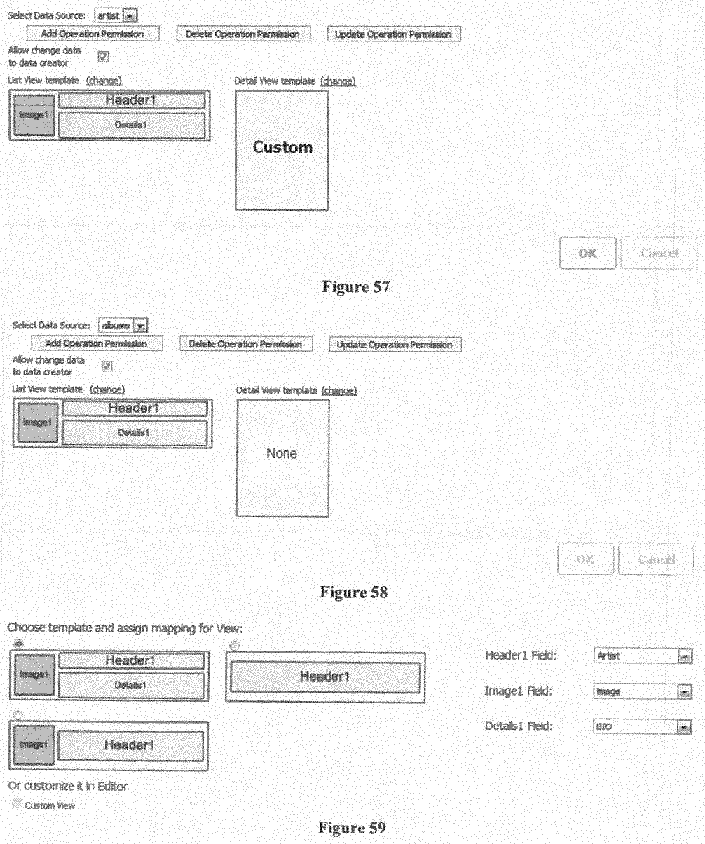

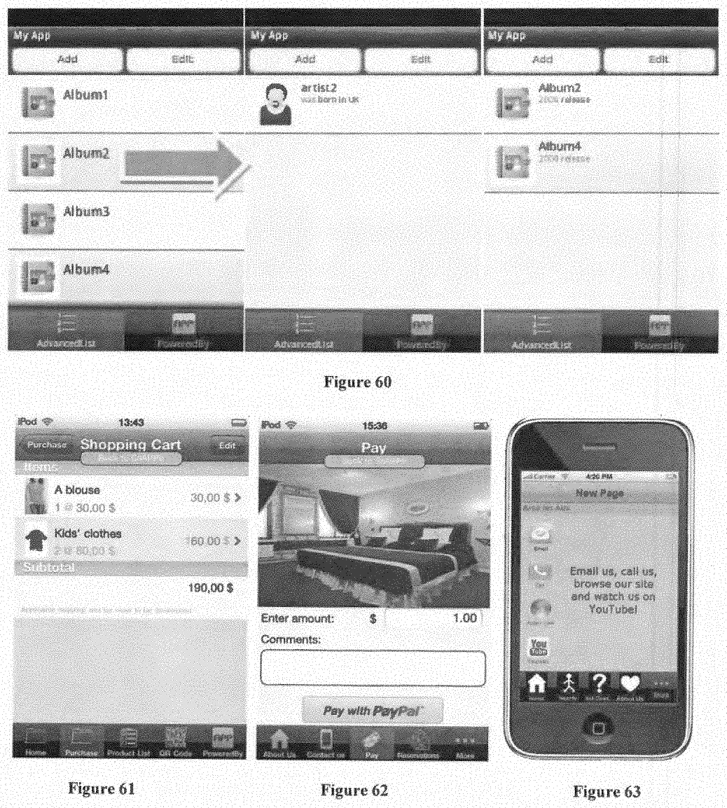

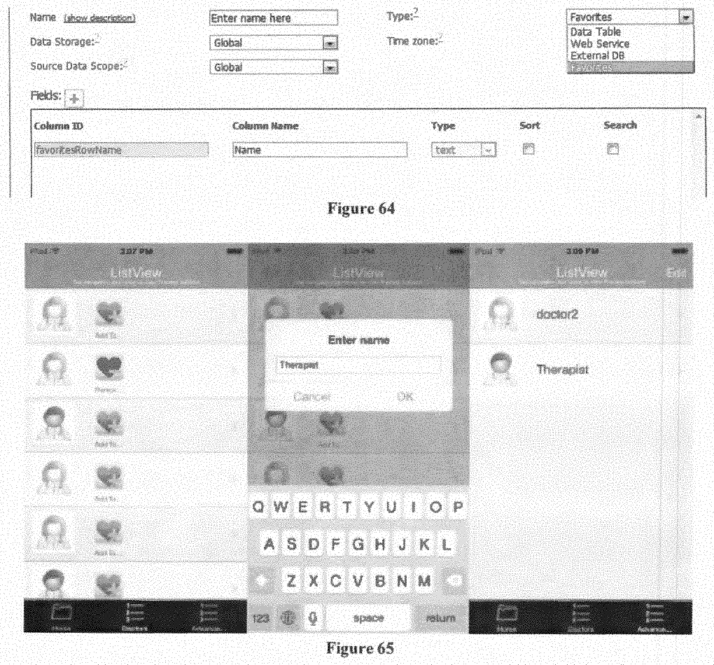

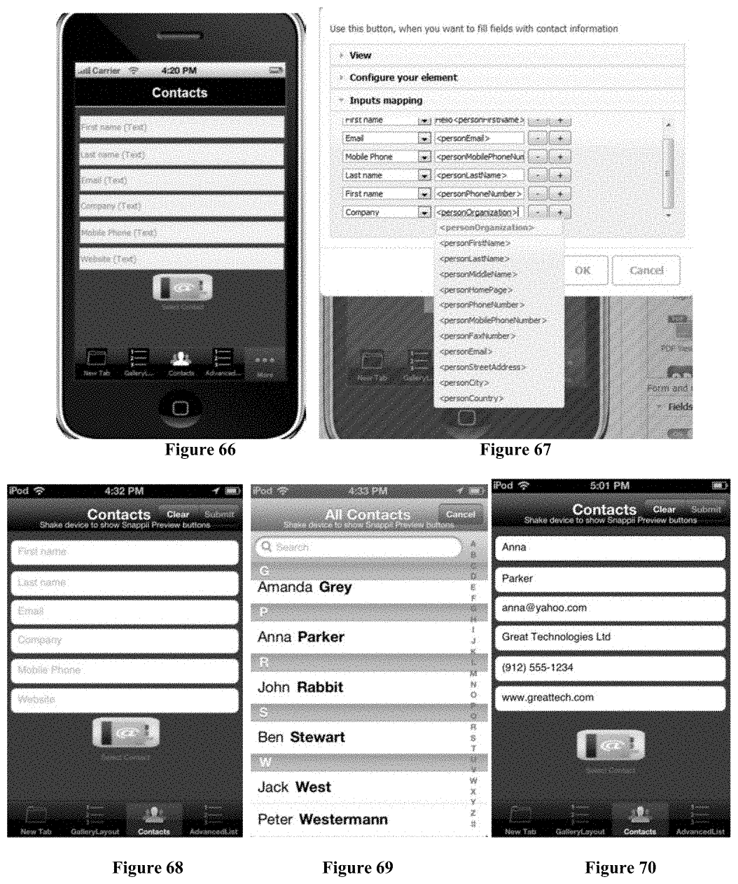

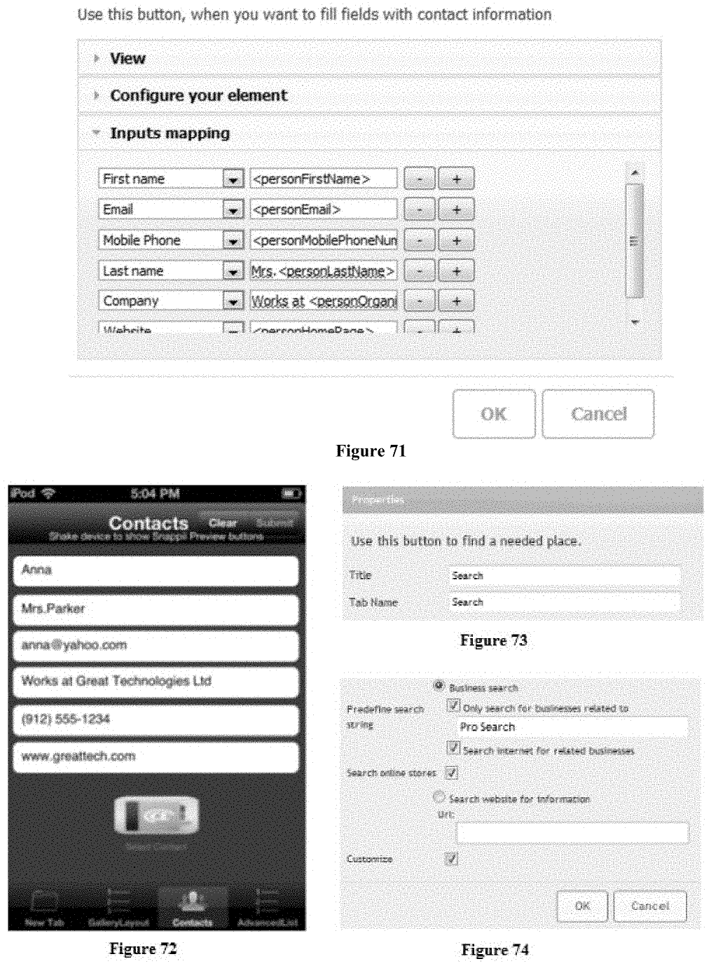

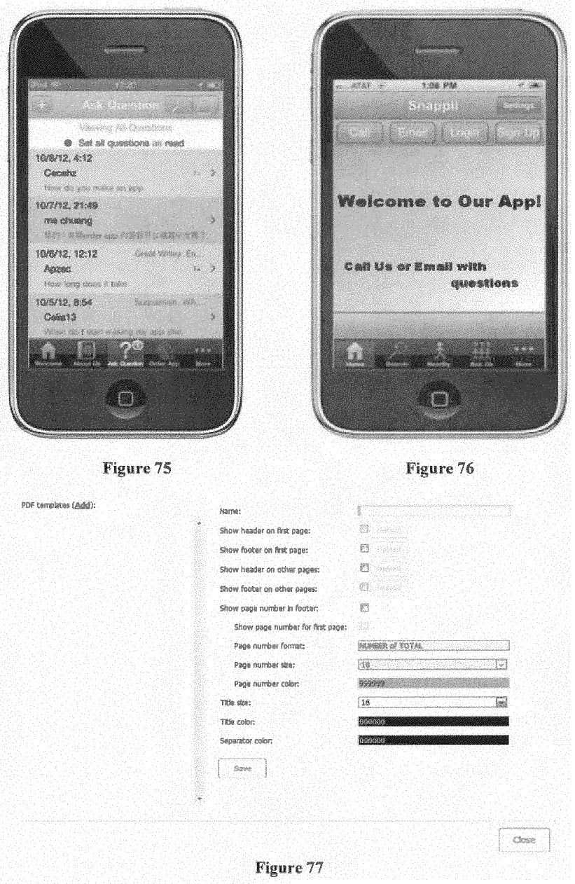

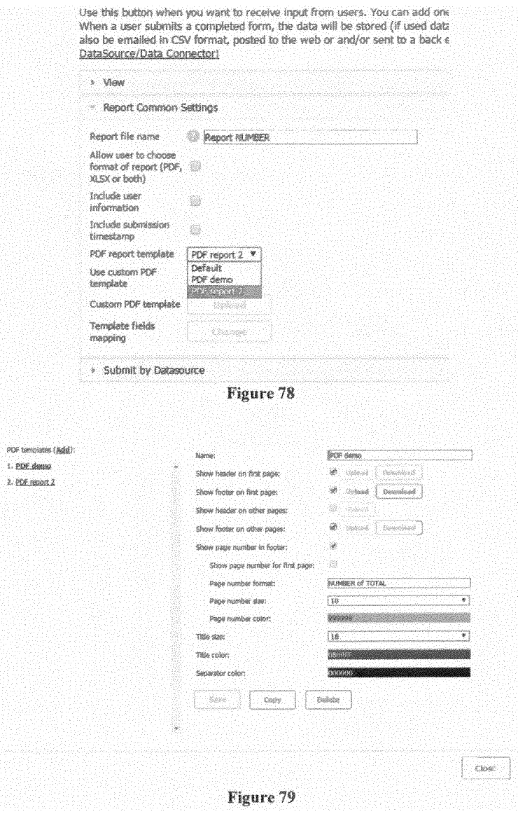

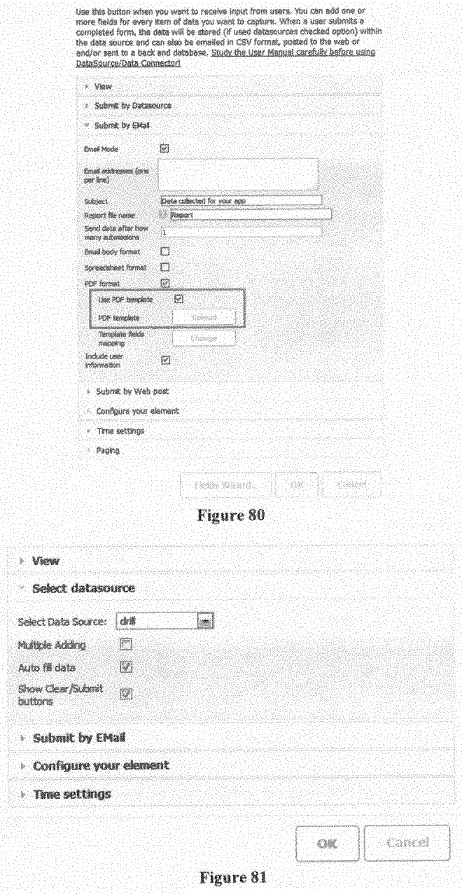

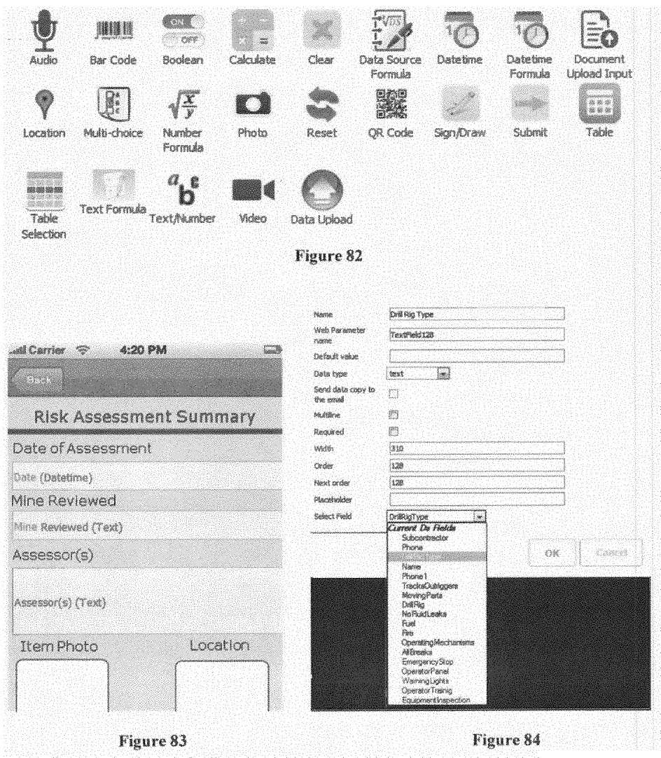

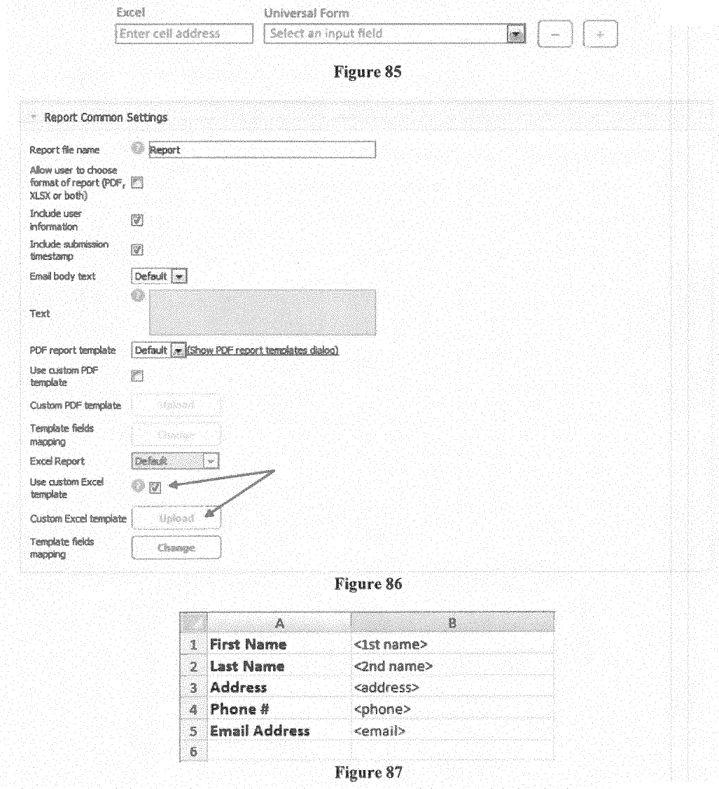

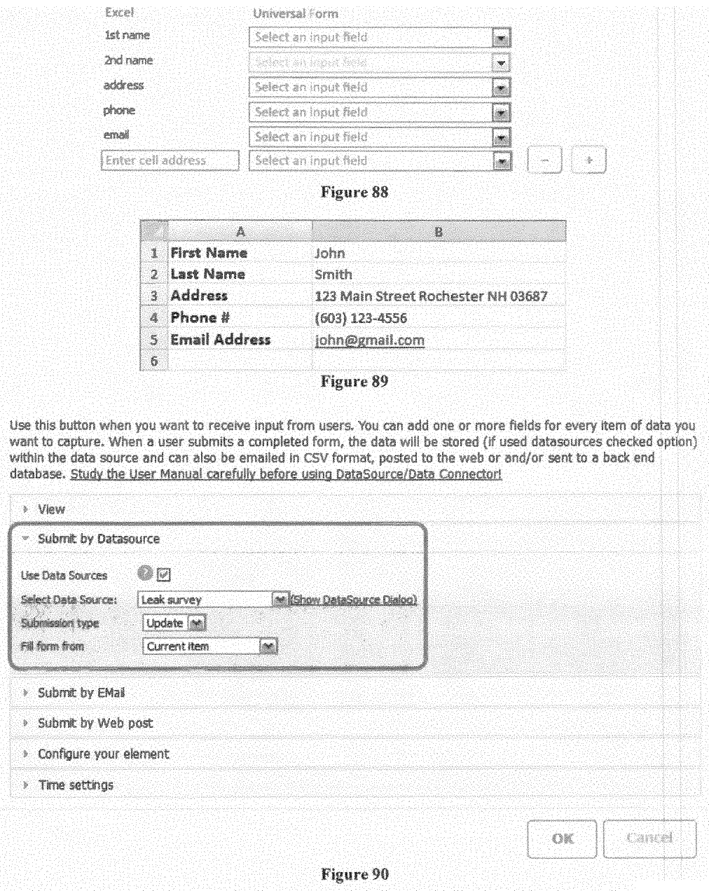

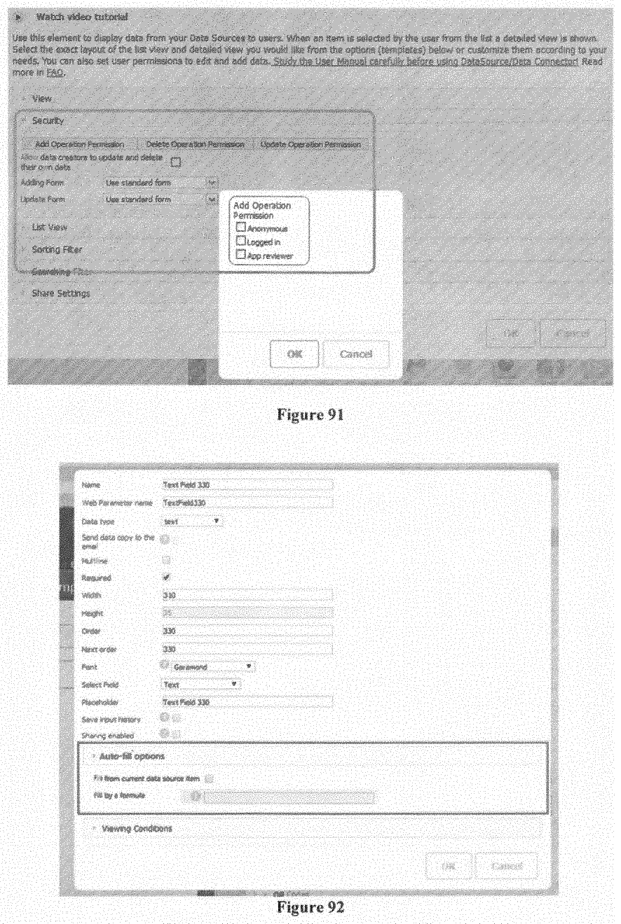

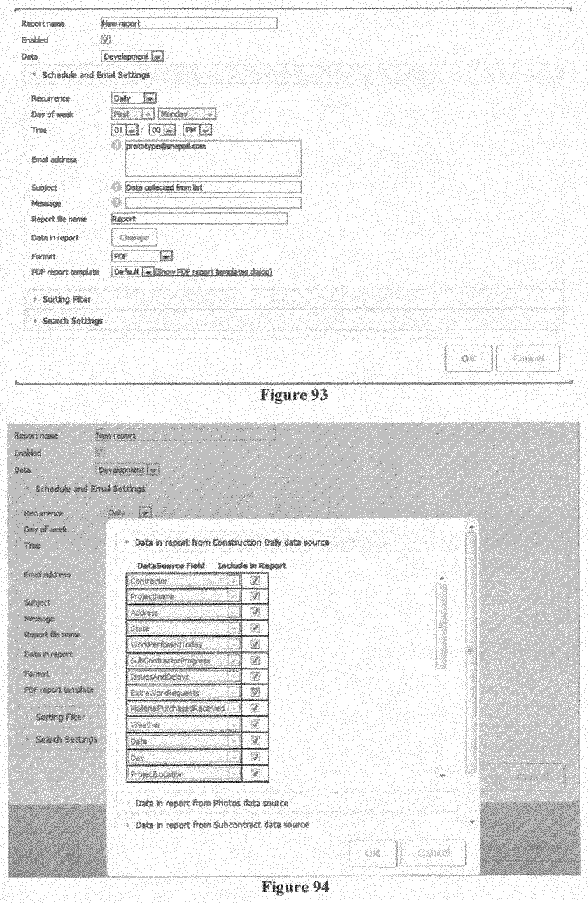

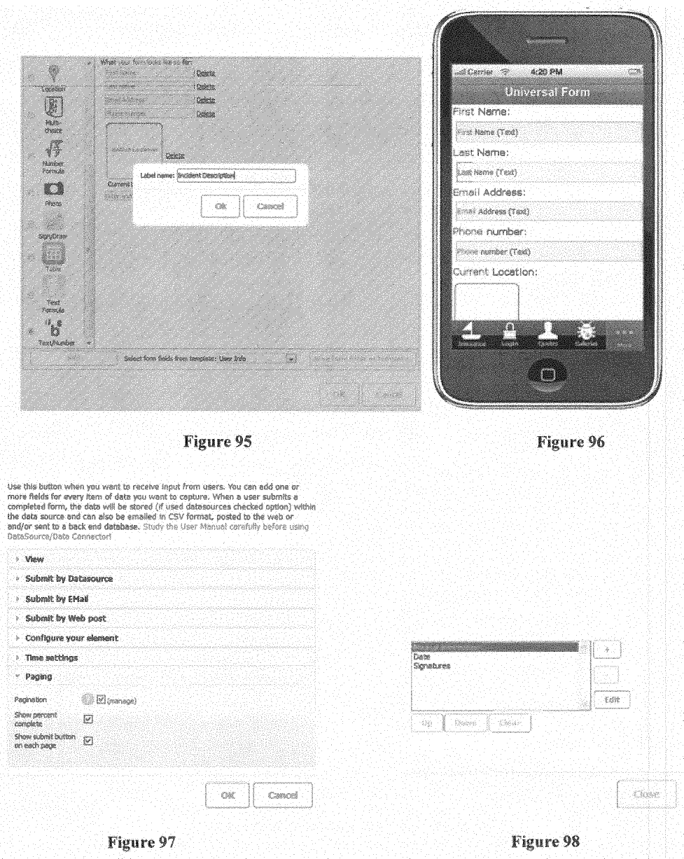

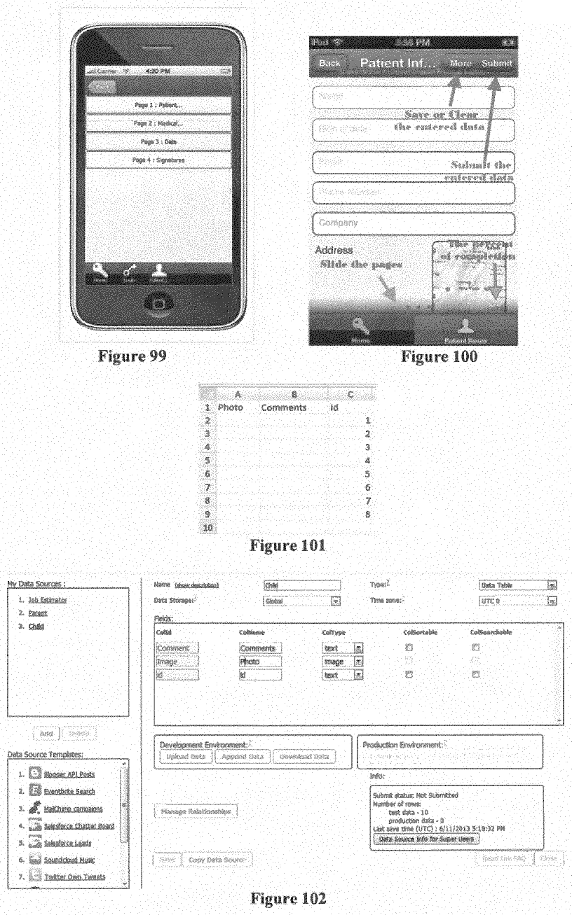

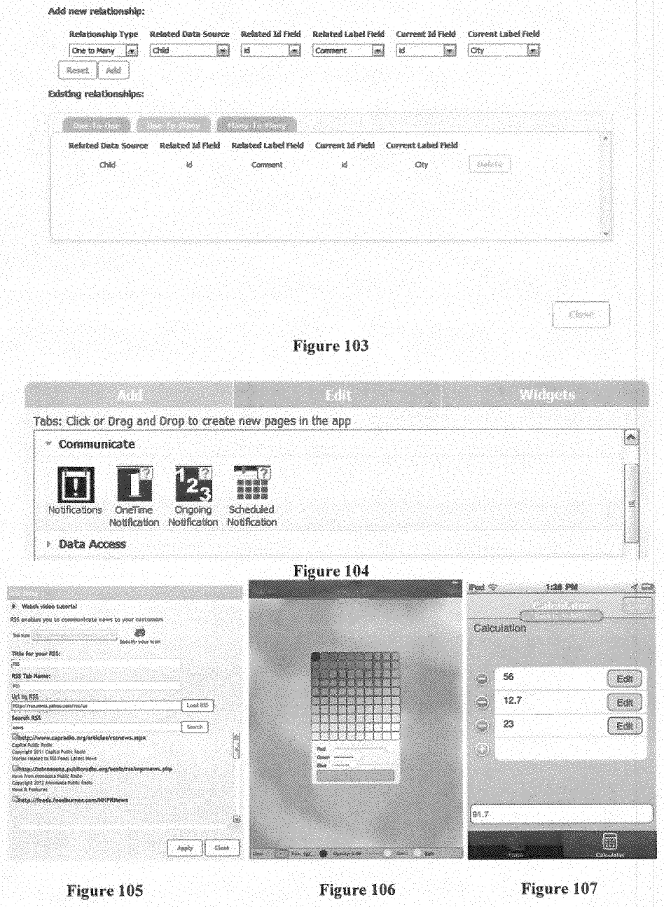

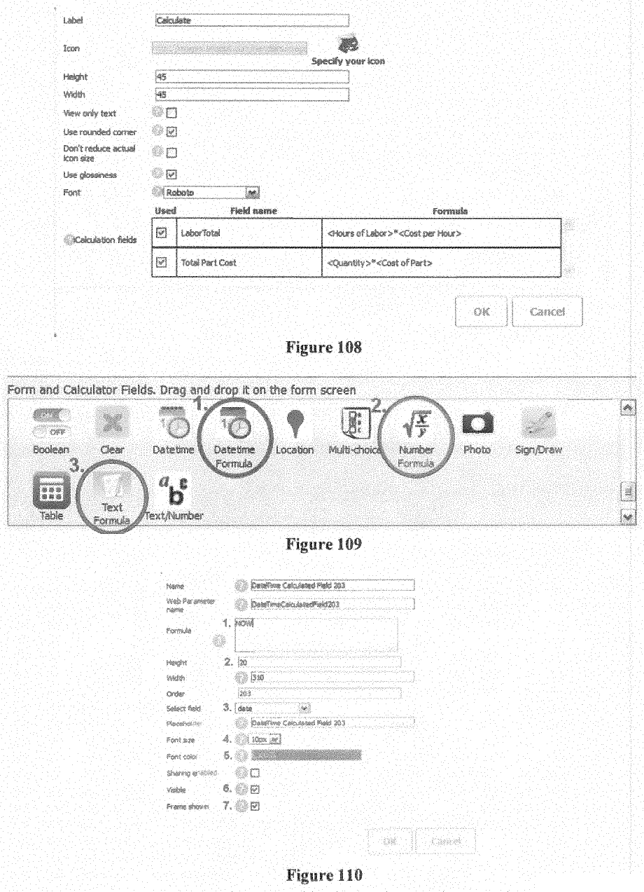

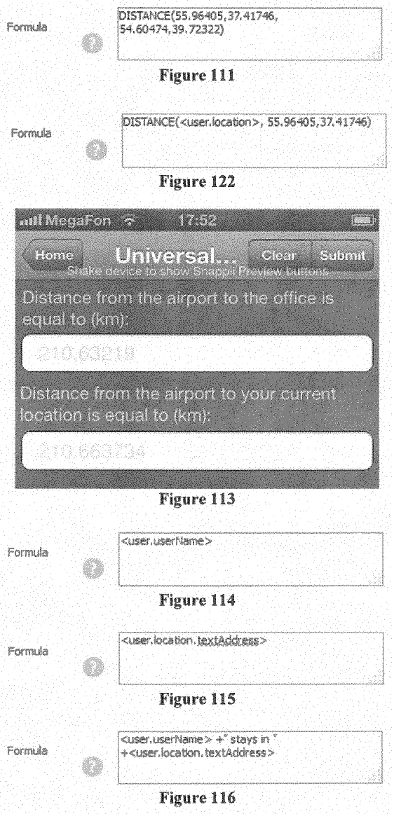

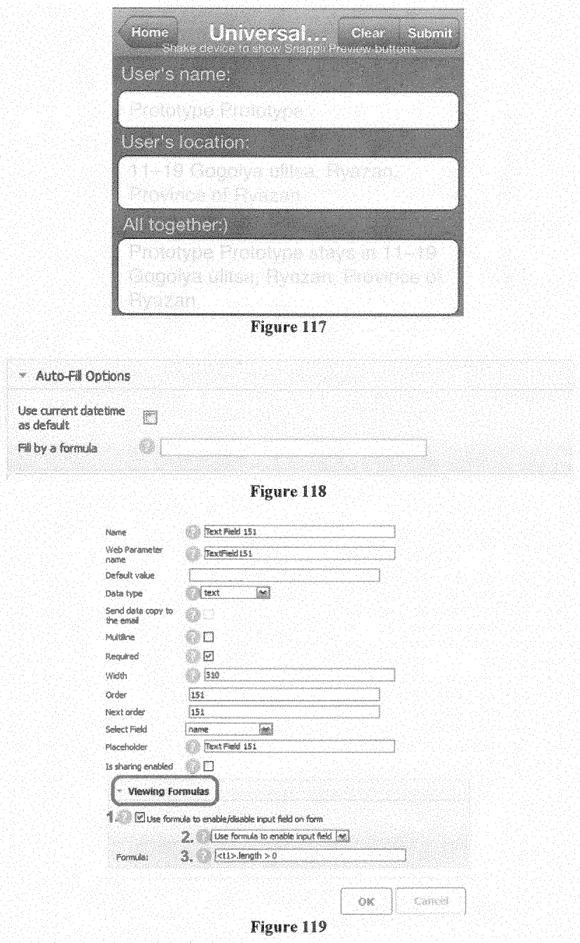

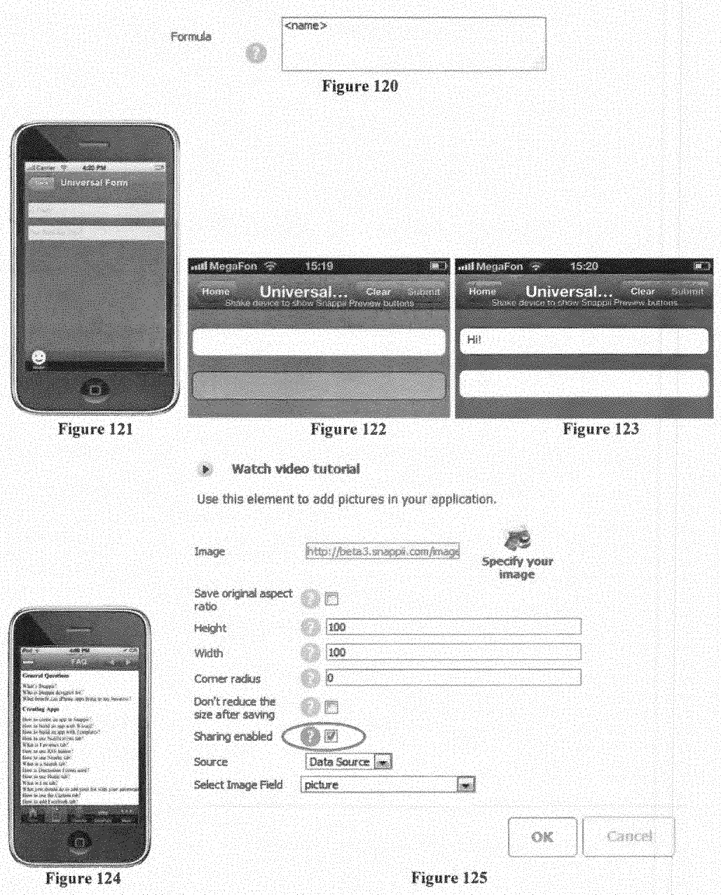

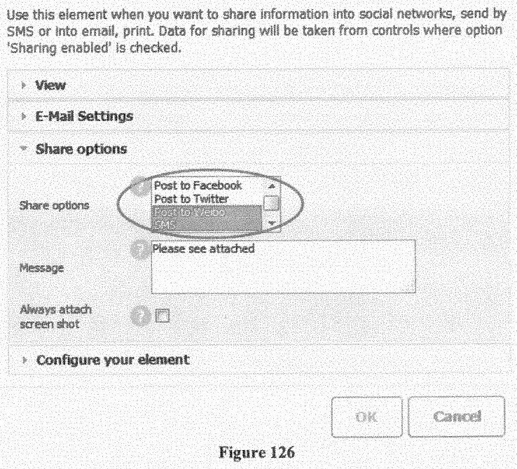

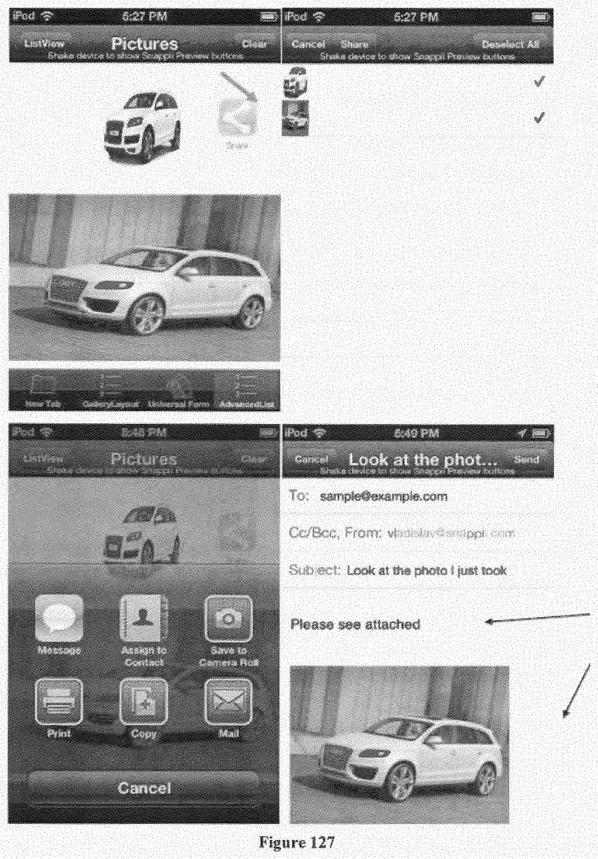

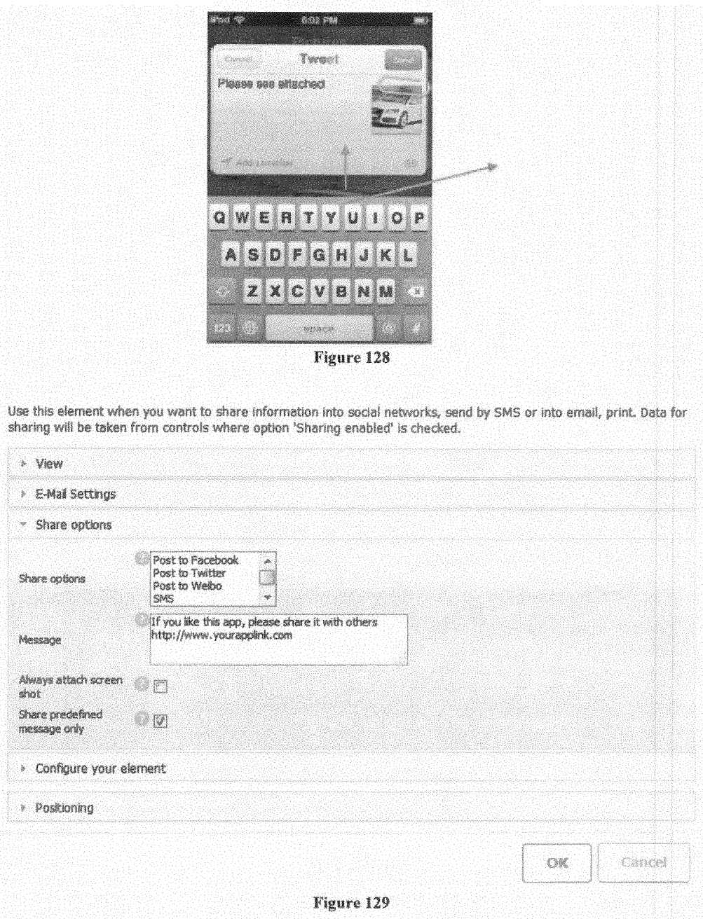

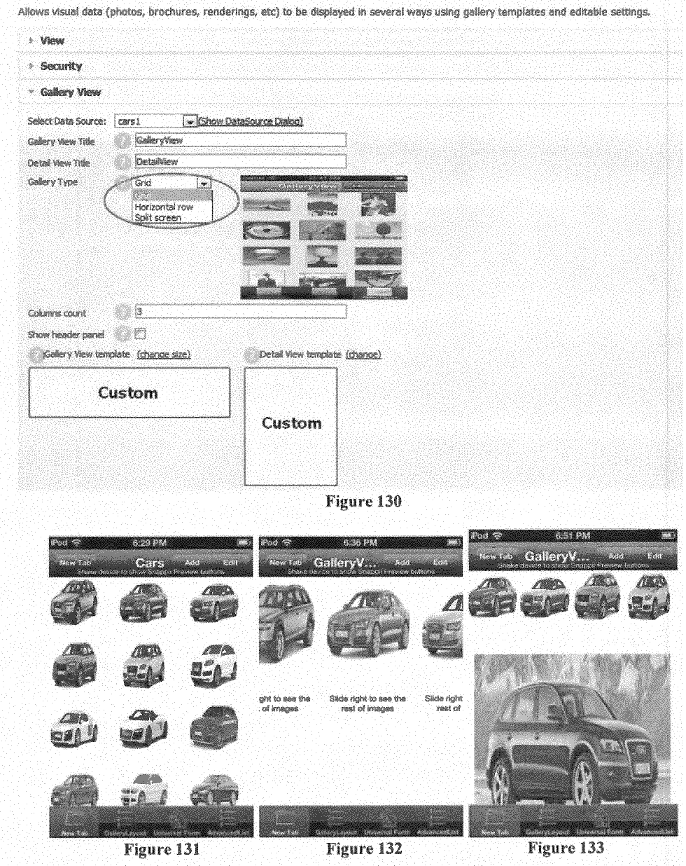

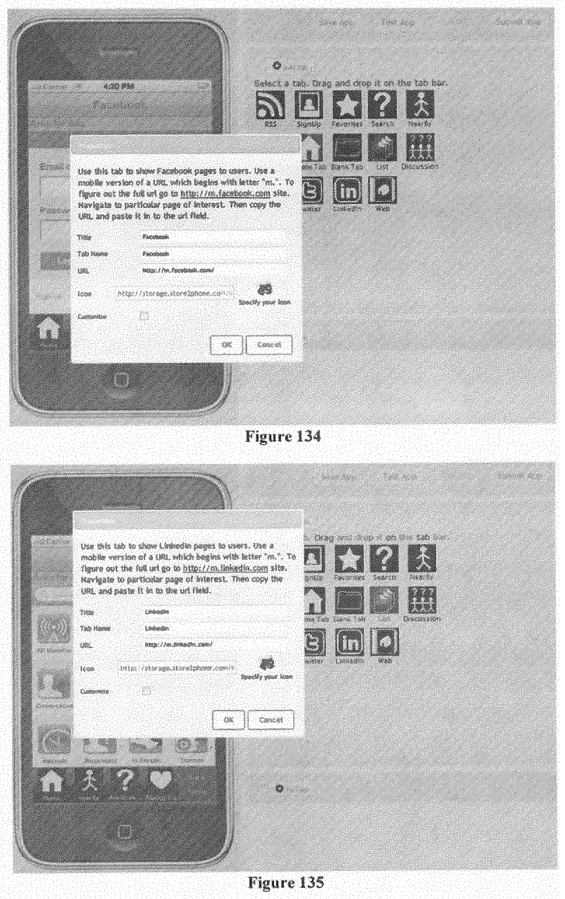

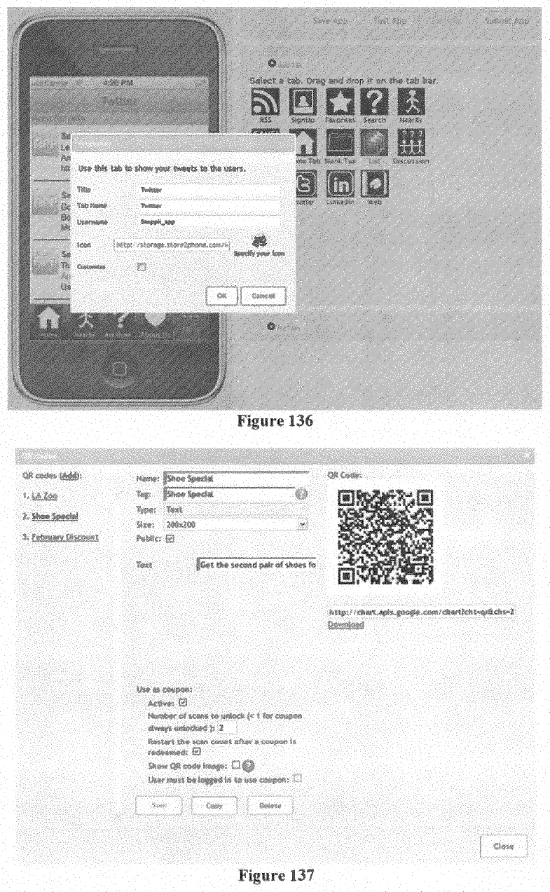

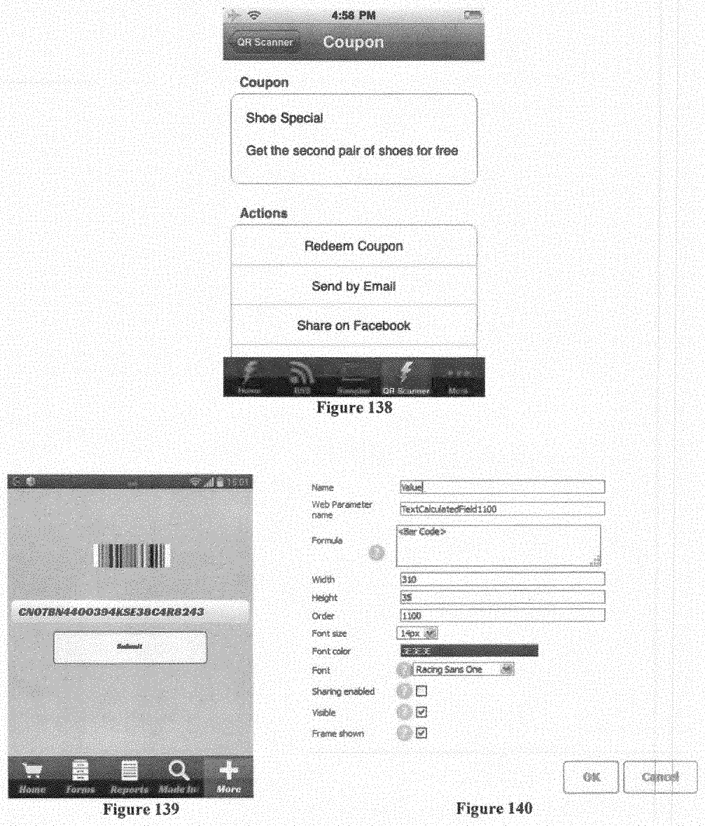

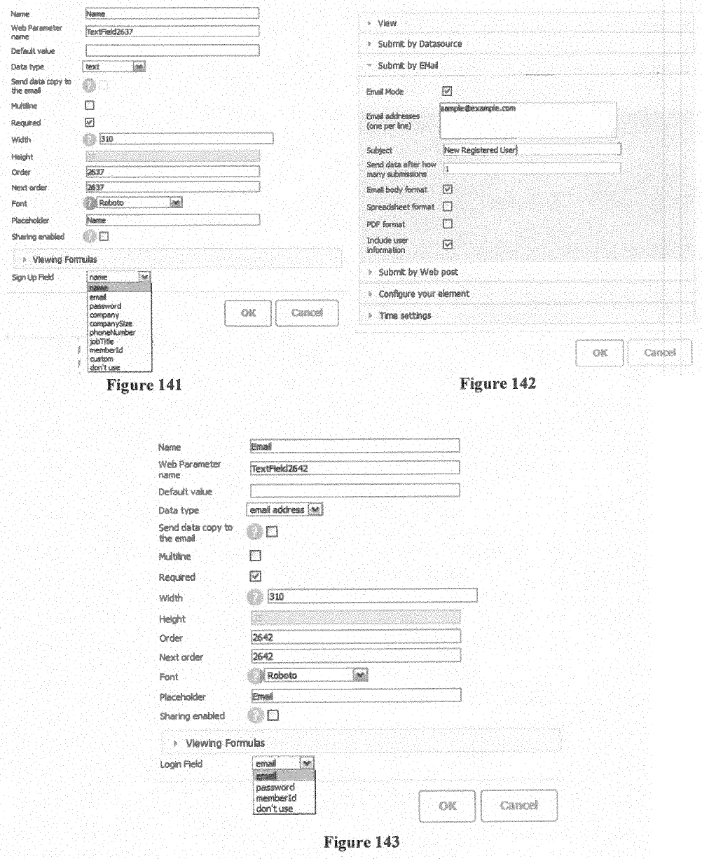

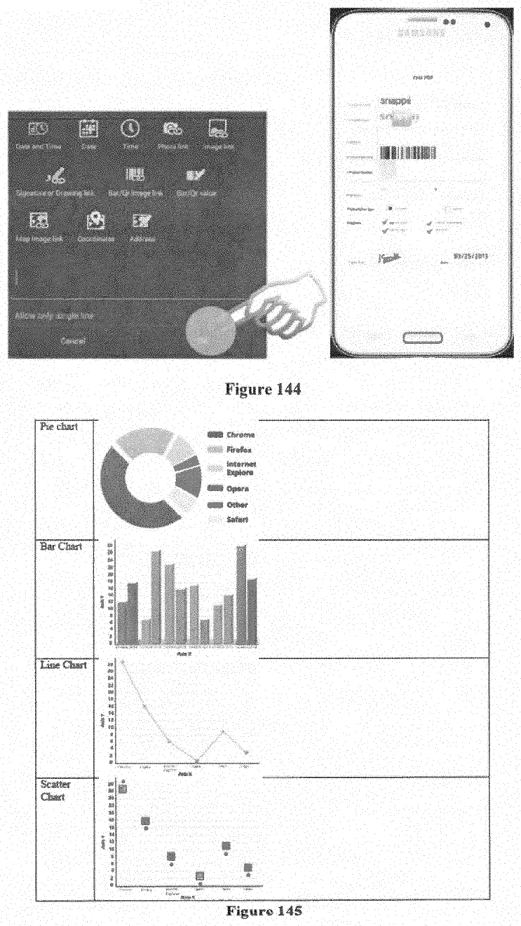

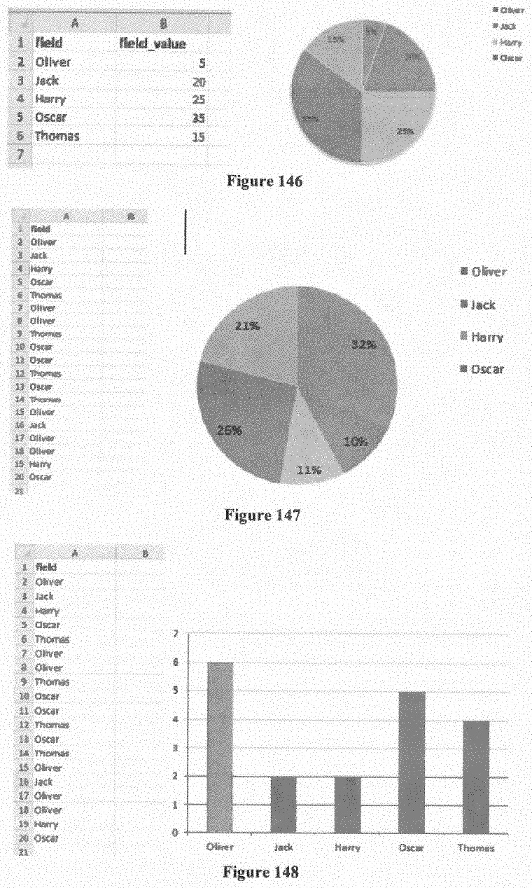

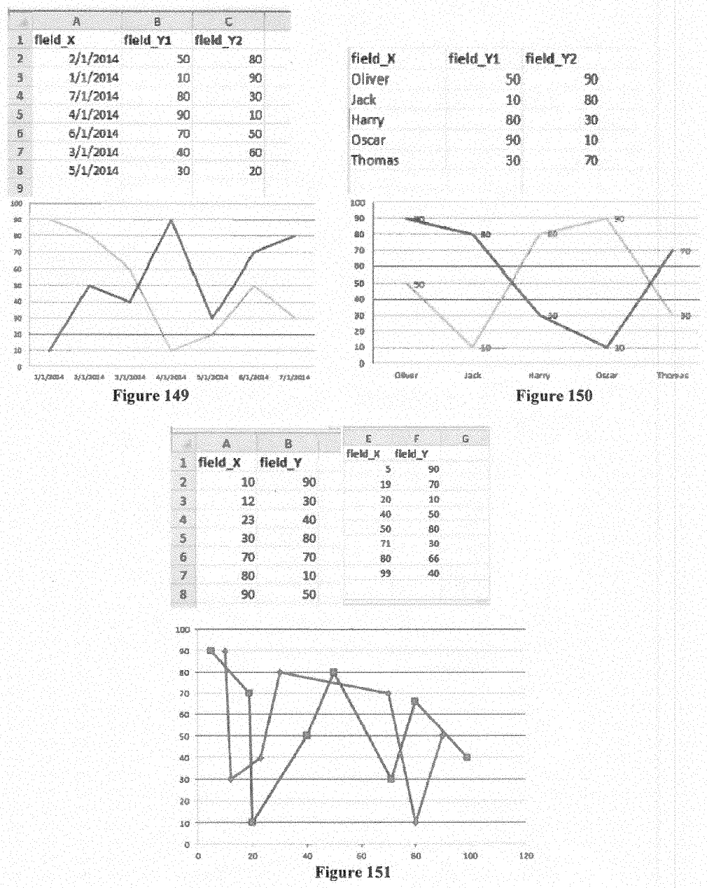

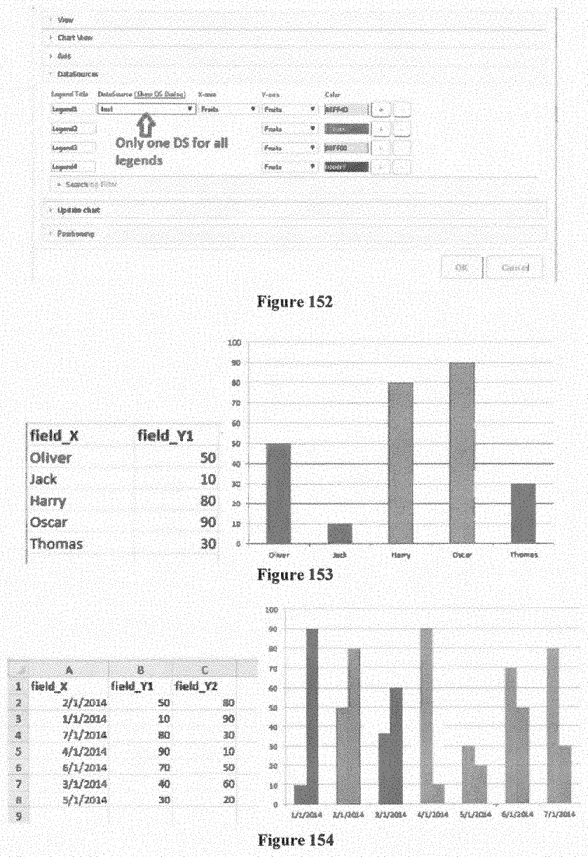

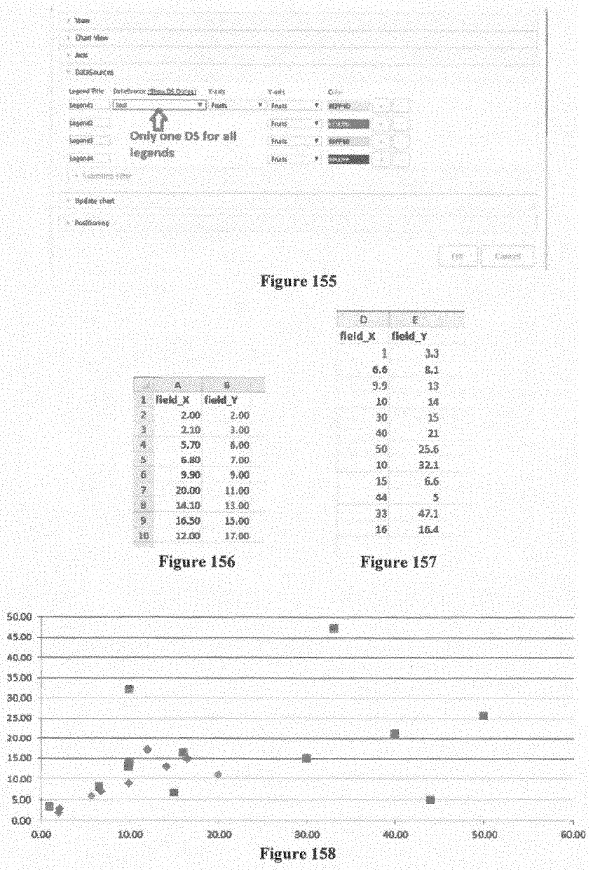

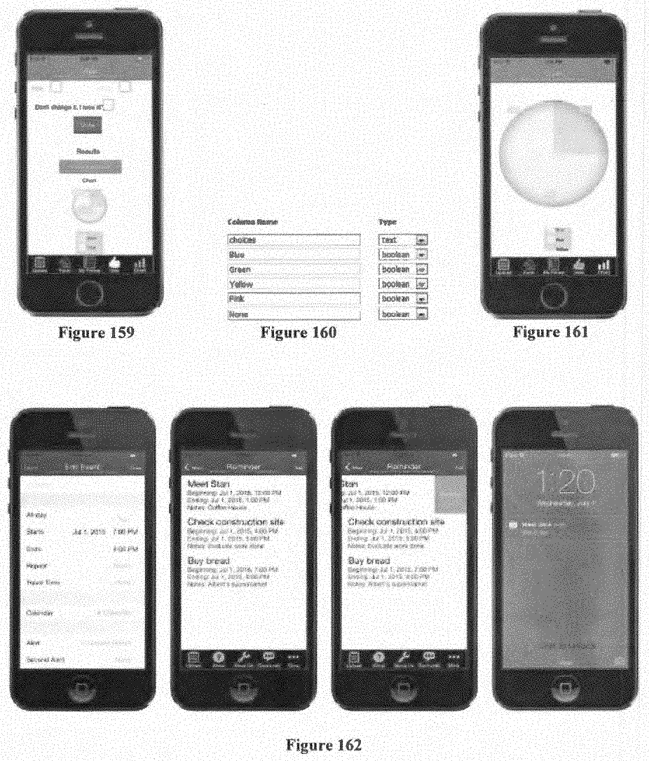

Referring to examples of FIGS. 200-248, an exemplary implementation of embodiments of the disclosure provides a New Form Editor

Form Editor

The general flow of a user coming into the form editor should be as follows

Authentication

Wires here https://moqups.com/ddodge/98rEWfVv

UI overview

Spec:

Form Editor window mode

Form Editor main screen

Form Editor pre built functions example

Form Editor field settings view example

Form Editor form settings view

Adding fields: Custom fields include

Single text box with definable name tag

Number text box that accepts digits

Paragraph text box to accept multi line input

check boxes

Multi choice radio buttons

Drop downs

Section breaks to break up sections of a form

New Page

Table

pre built fields include:

Name

Address

Date

File upload

Email

Time stamp

Phone number

Website

Price

Opinion taking assessment

Star rating

Credit card payment

Take a photo

Barcode scan

Sign & draw

Maps/gps

Social Security Number

Gender Select

Audio input

Video input

QR code scan

Stand alone text editor like this

Limited formula support

IP Address Maybe

settings for each control/field

Other ideas for V2

Form Editor

We need to build a system with good UI/UX that is intuitive and easy to use.

The general flow of a user coming into the form editor should be as follows
from expert mode:
user opens form editor from expert mode
user edits form in form editor
user saves form in editor user returns to expert mode

From Novice mode:
users can select new form from the search results of “new tab/form dialog” and this will add a form tab to the project. Users can select setting of that form tab and see some basic settings of the form, there will be a button in settings to launch the form editor.
for existing form when users click on form settings button the user can launch the form editor.
user edits form in form editor
user saves form in editor
user returns to Novice mode

Accessing the form Editor

As discussed earlier, the Form Editor should be identical whether it was invoked from within Expert or Novice mode. From the Novice mode the path would look like this:

Click ‘New Tab’

The list of tabs and forms has a ‘sticky’ entry that sits at the top of the list regardless of category/industry dropdown selection and/or search field terms/keyword—“Custom Form”. The end user selects it and clicks ‘Add Tab’. In light of the recently discussed changes to the ‘New Tab’ dialog (growing it sideway for having extra column with Tab's/Form's description and configuration overview) there should be some appropriate heads up info about Form Editor, full control over fields and other feature highlights.

The newly added Form tab has no content yet and thus its preview should either show some placeholder text/image about Form Editor or have the ‘Start The Form Editor’ button sitting right in the center of the canvas.

Clicking on Tab's settings (gear) icon would open a Tab/Form setting modal dialog. It's unclear at this point whether we should expose all Form's global settings or just some of them or any at all. Since all Tabs Form-Tabs are isolated—meaning that there are no conditional logic where the content or visibility of one Tab/Form would depend on settings/content of the other Tab/Form—we can do either of the two extremes: all or none. Regardless of that, there should be a button to send the Form into the Form Editor.

If the Form Editor opens up in a new page we have to figure out how to prevent the app changes (adding/deleting tabs etc.) while the user is in the Form Editor. Putting the App Editor window into a hibernation/suspension mode that would prevent any activity until the Form Editor page is closed/expired/timed out is logical. It may be very unreliable and confusing. In this case it is better for the Form Editor to take over the existing viewport completely.

All changes coming from the Form Editor (after clicking Save and returning to the App Editor) should be directed into ‘Soft’ (a.k.a Auto) save branch and could be lost as any other unsaved changes until you click ‘Save’ within the App Editor. Since the Form Editor is not available as a standalone editor and can only be invoked by new/existing Forms, it is very important to use proper button captions representing the closing/exiting action. Otherwise people may think they'll loose their progress in the Form Editor. ‘Save & Return to Editor’ sounds like a self-explanatory and non-threatening alternative to ‘Close’ or ‘Exit’.

The form tab now has some content (fields, checkmarks, radios, buttons etc) and thus should be visible in a preview.

The path from within Expert Mode would be very similar:

Click ‘Universal Form’ under ‘Add’/‘Tabs’

Blank ‘Form Tab’ added. The Configuration dialog may self-invoke as it currently does in the App Editor

Depending on the decision whether to show any Form settings or not to, we may either send the user right away into the Form Editor (within modal window) or show the settings+‘Form Editor’ button

The form is edited and saved. The end user returns back to the App Editor. The App Editor should be reinstated in the exact same state it was prior to invoking the Form Editor. To ensure the existence of the ‘return point’ we probably should force-trigger on the background either Hard or Soft save before going into the Form Editor.

Now comes the trickiest part. Since the current expert-mode App Editor allows configuration of the individual form elements (fields, checkmarks, radios, buttons etc.) we probably need to restrict any direct editing by the App Editor. Shouldn't all changes be made only through the Form Editor?

Authentication

The authentication via UAC list is a standard feature for App Editor where the creator needs to provide a list of people (emails) that can use the app (or access specific tabs only). Not sure how the pricing model ties into this approach, but allowing the users to authenticate via FB, Twitter, OpenID and alike may create some additional problems and technical difficulties with:

App pricing

Form fields validation/conditional logic

Pre-populating form fields with FB/Twitter profile information

Wires here https://moqups.com/ddodge/98rEWfVv

UI overview

The color of the form (background color and font/text color) will be the same as the template color pallet a user selects in the novice mode step 3 color schemes.

some fields in old forms are placed two into one line, They will be vertical when converted into the new form editor.

The form editor will work with existing forms but they will be converted to be vertical like the form editor is speced to do. Any fields that are horizontal will need to be converted when loaded to the new editor. existing forms for tabs will be converted at the stage when app builders create templates.

We are not supporting background images in the new editor for Rev 1.

How do we need to handle forms that are not tabs but buttons in Novice mode? “Open form in Editor” button for every form button that is placed on tab.

The form editor will load from novice mode and expert mode in a full screen module window.

Form settings will be available in 2 places. in the form editor and in the novice setting dialog for the form. Only basic form settings. no field settings will be available.

we will have a additional setting called form title for the navigation bar. If you don't want a form title then just leave it blank. If the form title is blank then the navigation bar title is blank. The footer and header are nonremovable fields in the form editor.

Alignment: users are able to align the logos. Fields do not have alignment options.

Language setting for forms: After talking with Debby and Victor we have decided we will not support this in the form editor in Rev 1. If a user requires a different language they will type it in the label of the field.

Field Visibility: After discussing this with victor and Debby we have decided we will extend the user authorization that we use for tabs to work with forms and check if a user has authorized access to this form.

Submit and clear buttons: We will have separate footer that has clear, submit buttons. This is part of the config setting in the footer. We show the same buttons that were selected for footer in the navigation bar under more. The submit and clear buttons are shown at the bottom/footer of the form. To see this footer on the user's device they need to scroll down to the footer.

Form User Instructions: This simply shows up as text above the field with the beginning of the instructions starting with “instructions: text of the instructions”. Description text is shown below the field. It should have smaller font size then the main font, the color of the text can be gray to show the difference. We will add placeholder setting for this also.

Formulas: Formulas are simply written or pasted into the formula field. they act the same as formulas do now. We will leave the current expert mode behavior (default value) Formula is supported only for Super Users. We will use 1 setting for this instead of default value and formula value.

Changing field types of existing fields: Users can change any field type easily this way without having to delete and add a new field. When a field type is changed the settings all revert to default for the new field type if a user changes it. type means the field such as email, text, phone number. This type can be changed when editing a form to any other type. This is for ease of use while creating a form. Any field can be changed to any other field type ex. photo input field to text field.

Duplicating and deleting fields: Any field can be changed to a different field type, added or removed. form settings are saved when a user clicks the save button. This is for ease of use while a user is creating a form. The user can duplicate a field and then change the duplicated field below to a different type. delete allows a user to simply delete a field.

Saving forms: we will have the same soft save and hard save states that we are using for novice mode. Hard save will work by clicking the save button and saving the current state of the form. Soft save works on interval such as every 5 minutes. The soft save also triggers as soon as you open the form editor, This give us better version support of a form.

Field types: SN is not a field type for example. It's a preset text field with formatting logic. Same with IP. predefined field bundles are just a collection of preset up fields. This applies to many fields with the same logic.

If form created in new editor is opened in old editor we should warn users that “the form you are attempting to edit was created with a different version of the form editor, you may lose formatting for x, y, z, if you don't want to do this click the cancel button.” Novice to Expert form editor and vise versa: There's no need to create copies of the form save file every time the form is edited by a different Form Editor (Old or New). The form editor (Old or New) is selected implicitly—by switching from Novice Mode (New form editor) to Expert Mode

(Old form editor) or vice versa. The information about last editor should be saved inside the form's save file (XML ?). Every time the form is opened by the editor different from the one that was used last time, there should be a message about:

Conversion into Old/New form format Expected gain/loss of features

Suggestion to switch into an opposite app editor mode and use the original form editor in order to avoid the conversion [OK] [Cancel]

Add static image: users size images based on absolute value, alignment center always. aspect ratio is locked and x axis changes y axis proportionally. we suggest 8:1 ratio 800 px×100 px

By Default (when no input selected) the right-side bar shows Form Settings:

On mouse over, the input highlights and shows contextual buttons (upper right corner):

Clicking the input (same action as selecting edit/pencil icon) the elements becomes ‘selected’ and its settings show up in the right-side panel:

(Form Header is non-removable element. Showing Delete button just for demonstration purposes).

Menu is made up of 3 collapsing (expanded by default) sections: Basic Fields, Pre-Built Fields and Extras. (Pre-Built Fields section shows just a subset of all fields outlined in the spec):

Basic toolset for form editing Clear, Undo, Redo, Preview and Save:

Undo should undo any user action that has been completed in order. It should revery any change made such as change in position, setting, new field, removed field etc.

Same logic goes for Redo.

Clear should clear the form entirely.

Preview should just show the way the form will look to the user in a module window. If there are multiple pages you should be able to click left or right and step through the pages.

Adding pages to forms by clicking the +page icon

Spec:

Users can get to this screen 2 ways.

from novice mode—users can select new form from the search results of “new tab/form dialog” and this will add a form tab to the project. Users can select setting of that form tab and see some basic settings of the form, there will be a button in settings to launch the form editor.

from expert mode—takes spot of old form wizard and form editor. (full screen module window)

Form Editor window mode

Some more point why we should use full-page mode instead of modal dialogs which at a glance look like a more logical choice: Full-page mode provides more onscreen space

Scrollable modal dialogs are only good for reference info/one-time-use content. Using them as IDE canvas would be tiresome. Constant confusion over which scroll bar to use—dialog's or window's

Form Editor main screen

https://moqups.com/ddodge/98rEWfVv/p:a6baaeaf7 change the terminology:

Custom Fields-->Basic Fields

Pre-built Fields-->Advanced Fields and Groups

The button in the upper right corner—‘Pre-built Forms’—assumes that you can load one of the existing templates from the form library into the editor and customize it for your needs. If we'll have any Form Tab settings (accessible from within App Editor level) like form field mapping, data sources etc—they may come into a conflict with the form. For example you start from a scratch, create a new form, save it and go back to App Editor. There you configure some settings like the ones I mentioned above and go back into Form Editor again and reload a new template into it, which actually completely replaces all form fields you had earlier. Now, by saving the form and returning back to App Editor you may cause a conflict of your higher-up settings with the ‘reloaded’ form.

Form Editor pre built functions example

https://moqups.com/ddodge/98rEWfVv/p:a01d67034 Pre-built Fields & Groups

Pre-built fields and groups should be nothing more than a simple shortcut—they should NOT have any functionality or settings that the end user wouldn't be able to re-create himself (spending a bit more time if course) by adding individual fields one by one and configuring them. Thus the standard operations you can perform over any given filed (delete, duplicate, configure) should NOT apply to the pre-built field groups as a whole! For example in the ‘Address’ field group, the end user should be able to manage individual fields—City or Address Line 2 etc.

Form Editor field settings view example

https://moqups.com/ddodge/98rEWfVv/p:a2777b6eb

Form Editor form settings view

https://moqups.com/ddodge/98rEWfVv/p:abffca24f

Looking at the mockup (https://moqups.com/ddodge/98rEWfVv/p:abffca24f) makes me think that Form Settings dialog should used for configuring how the form works (data sources/targets, filed mapping etc)—not how particular elements of it look. Form title, description, alignment, logo placement—all of that should be turned into a special form element—Form Header—that can not be removed from the form or duplicated or added another instance of it. ‘Language’, ‘Access Control’, ‘Confirmation Email’—those probably deserve to be a part of Form Settings. If we were to extend this idea even further, the special non-removable element—Form Footer—can control the form submission buttons, their alignment etc.

As for ‘Button Alignment’ (I think ‘Placement’ would be a more appropriate term here) with 3 choices—Top, Bottom, Both—it is a redundant setting. All mobile device keyboards (as well as tab order) drive you top to bottom. Having ‘Submit’ at the top of the form would make no sense.

Overall, the UI may look like this:

This approach mimics majority of textual/graphical/programming editors by having 3 visual columns: The toolbar on the left

The canvas—in the center

The tweaks/configurations on the right

The settings ‘column’ will display settings for the currently selected element. If selection is dropped (e.g. the form itself is selected)—it will show the form settings.

Adding fields:

there are custom and prebuilt fields to add to a form

Custom fields include

Single text box with definable name tag

ditch max char count and set text field 128 paragraph/multiline to 1024 do not show this char count on device

as long as you keep typing it should stop accepting input in the field when it hits max

if pasted into a field it will truncate the remaining text over the max.

we will show error messages for unfilled mandatory fields as module window message

https://moqups.com/ddodge/98rEWfVv/p:a3dd8e6d8

Not supported: Field Size (Min-Max number of Characters or Words)

Min/Max is not a big feature but nice to have. I would like to have it instead of letting the user to change the size (dimensions) of the element is a bad idea. Ultimately it would create more problems than provide benefits. We simply have to use a ‘responsive’ layout approach. It all should depend on the application's canvas. For example compare the layout of ‘Address’ field group for phone canvas and tablet canvas:

The only case where sizing (by two presets—Small and Large) would make sense is for fields like Zip Code or filed where a short integer is expected. Having it stretched across the whole screen width (even on a small phone screen) doesn't look ideal.

Number text box that accepts digits

https://moqups.com/ddodge/98rEWfVv/p:a51d5976f

Min-Max fields can be set for how much data a field can take. This can be defined by the number of Digits or Value

Text Form field and Number field are one and the same. To enforce the content type, the settings for this filed type should have a basic data validation in place (text or digits or email or phone along with secondary check: for text—min/max char count 128 char; for number—less than/greater than; for phone or email—RegEx check). Google Forms is a very good example of this feature implementation. I know that we have ‘Formula’ functionality that can achieve the same results. What we need to implement is an ‘Error Message’ if the validation/formula check fails.

do not show this char count on device

Paragraph text box to accept multi line input

ditch max char count and set text paragraph/multiline to 1024 do not show this char count on device

as long as you keep typing it should stop accepting input in the field when it hits max

if pasted into a field it will truncate the remaining text over the max.

we will show error messages for unfilled mandatory fields as module window message

The Small/Large sizing of this element should control its vertical growth only—the width of it should always span the full container's width.

https://moqups.com/ddodge/98rEWfVv/p:a3ee07374

Not supported: Field Size (Min-Max number of Characters or Words)

Min/Max is not a big feature but nice to have. I would like to have it

check boxes

Checkboxes can be laid out in multiple different formats. One Column, Two Column, Three Column, Side by Side

The layout (1/2/3 columns or in-line) should depend on the canvas size, number of choices and responsively reflow depending on those two

https://moqups.com/ddodge/98rEWfVv/p:ac8d317de

Not supported: Field Layout (One Column, Two Column, Three Column, Side by Side)
At the moment, we can move it manually

We need to give users this option. I want multiple layout features out of the box with no manual moving.

Multi choice radio buttons

Checkboxes can be laid out in multiple different formats. One Column, Two Column, Three Column, Side by Side.

Same as above. In general it's good practice to avoid columns for regular radios—use either horizontal list or in-line placement (if number of choices and canvas size allows). The only exception—‘Grid’ or ‘Multi-Scale’. Google Forms have a very good implementation of those:

Import predefined choices allows upload of CSV file

https://moqups.com/ddodge/98rEWfVv/p:a967e5660

Not supported: Field Layout (One Column, Two Column, Three Column, Side by Side) *At the moment, we can move it manually

Question: Why do we need upload CSV file here? I think this function need for using such controls as table selection, when we need to to select some items from LARGE list.

Table selection (Also table selection control can be type—frame. With Input Mode—Multiple or Single)

Or you can use control—radio battons

We need this feature with the UI and UX as shown in the spec. CSV is a nice to have but not critical.

If users have a list of choices they have made then we should accept a xls upload of the options instead of making users enter this information manually. they may have many choices.

Drop Downs

Import predefined choices should allow CSV file upload and populate the choices fields.

If users have a list of choices they have made then we should accept a xls upload of the options instead of making users enter this information manually. they may have many choices.

https://moqups.com/ddodge/98rEWfVv/p:a07dca071 Not supported: upload of CSV file!
At the moment, there is an element “Multiple Choice Field” in editor. It allows you to download EXCEL file with any values. CSV is a nice to have but not critical.

Section breaks to break up sections of a form

https://moqups.com/ddodge/98rEWfVv/p:a5e05d667

A section break just puts a black line across the form and helps divide sections of the form. This can be used to separate sections of a form and fields from other sections. This section break has a padding above and below the black line to help separate.

New Page

A user can define what they want the next button to say.

By default it spawns a new page tab. A user can change this text. can be done with button or via page tabs

deleting pages in editor, ok to do, just bump next pages up. dynamically change page #'s. if last pages is deleted footer moves to bottom of previous page

user can delete 1st page in same way

form header only on 1st page not individual page headers and footer on the last page form header only on 1st page not individual page headers and footer on the last page

can not change the order of tabs/pages

Adding pages (represented in the UI as tabs) assumes that the end user should be able to assign the meaningful names to them—not just Page 1, Page 2 etc. Possible naming options include:

‘Page X’ IS the actual DEFAULT name that can be changed in the settings to whatever the end user wants. This new name would be shown in the tab's flap.

‘Page X’ is non-changeable part of the name. The name assigned by the end user would be appended: ‘Page X—My Cool Title’ and would be shown like this in the tab's flap.

‘Page X’ is non-changeable part of the name. The name assigned by the end user would be appended but would NOT be shown like this in the tab's flap. It would be used on mobile device's navigation bar only. In the editor it would keep showing up simply as ‘Page X’.

As soon as the new page is added, the non-removable footer element should jump to the bottom of that new page. As soon as the LAST page is deleted, the footer should be relocated to the bottom of the preceding page.

The pages' order should be non-changeable. Otherwise the developers would have to figure out the enforcement mechanism for those two special form elements—header & footer—so they would always be the very first element on the first page and the very last element on the last page.

Deleting pages may be a challenge in terms of UI implementation. The most logical way is to place a small [X] on the flap. But switching the active page or selecting them for configuration purposes, would definitely lead to accidental deletion of the page. Unless of course it is properly spaced (see mockups) and should always invoke the verification dialog—“Are you sure you want to delete this page?”

https://moqups.com/ddodge/98rEWfVv/p:a20948111

I'd add centered bullet indicators choice. The next button should be on a right side though. Everything is vertical in the editor. You add a page break where you want it. the bullet menu shows on the device when a user is using the form.

Not supported:

We support:

It's better to use current functionality, because it's more convenient and covers all requirements of our users. We need this feature with the UI and UX as shown in the spec.

Table

New UI of Table input

pre built fields include:

Name

Users can choose from 2 name formats. Normal and extended. both options are shown here

Required fields have a icon in red showing they are required—Do not support:

https://moqups.com/ddodge/98rEWfVv/p:a814ee40b

or extended name

Supported already

Address

Users can select a default country so users do not have to look in the dropdown and select a country. They can still select any country if the default is set. We may add the ability to have GPS auto fill out the address but I'm worried about the accuracy.

https://moqups.com/ddodge/98rEWfVv/p:a9ce93cf5

Supported already

Date

https://moqups.com/ddodge/98rEWfVv/p:a44e954af We do not support such date format!

We support date format in one combined field. It's better to use current functionality, because it's more convenient and covers all requirements of our users.

Some people may prefer a trickle-down (a.k.a Linux) date format: YYYY/MM/DD. There should be an option to pre-populate with current date by default (without invoking the calendar dialog).

OK we will use this time and Date format.

we will use the device setting for this

File upload

Users can upload/attach a file to a form.

there should be a upload UI that shows file progress similar to the UI on the right side here. Also a file explorer to select a file to upload

https://moqups.com/ddodge/98rEWfVv/p:a44e6a9f0

icon

We can not upload/attach a file to a form.

We can upload PDF/Excel forms.

I don't really understand why we need this feature in apps. We never had such use cases before.
May be an ability to attach word document will be useful

We need to be able to attach any file type and use a link to it for the report. We also need some upload UI so users know it was attached.

Email

https://moqups.com/ddodge/98rEWfVv/p:ad8b60259

Supported already

For email field should be “Send data copy to the email” option to allow user send report to needed address

Time stamp

https://moqups.com/ddodge/98rEWfVv/p:a9e8b62c0

or military time ex 0300 is 3 am

We do not support such time format!

We support date format in one combined field. It's better to use current functionality, because it's more convenient and covers all requirements of our users.

OK we will use this time format

Phone number

Users can select from different phone number formats. either Standard ### ### ####

OR International

international # ### ### ####

https://moqups.com/ddodge/98rEWfVv/p:a07c15ae0

or with a country code box in front

For 4.7 and 4.17

It will be able to develop a universal system that allows you to create masks. For example, after a certain number of characters to be automatically displayed (dash, dot, etc.)

OK sounds good

Website

https://moqups.com/ddodge/98rEWfVv/p:a3b17e971

Not supported. Maybe need to add more types (not only website) for validation.

Price

users can set the currency type from the following and have the correct labels applied to the currency fields. we will want to support as many currency types as we can.

https://moqups.com/ddodge/98rEWfVv/p:a00a56691

Supported already

Opinion taking assessment

WE WILL NOT SUPPORT THIS IN REV 1

Users can choose from two layouts, they can choose to allow or not allow NA answers. Both options are shown here. The NA option above the upload pre defined options button only shows if allow NA check box is checked

https://moqups.com/ddodge/98rEWfVv/p:ada80224e

This is the ‘Grid’ I was referring to in 3.5 (Radio Buttons)

or

Not supported.

I can't believe it can be useful because it's not flexible at all. To implement the same behaviour app creator can use radio buttons. Also if we will use a lot of variants for answer it can have very small size of text on device. It can be difficult for viewing.

This is not critical to the spec but is a very nice thing to have. I would like to have it in V1

Star rating

https://moqups.com/ddodge/98rEWfVv/p:a97081f1e

Not supported.

I think this feature will be useful This is much needed, we will build it

Credit card payment

WE WILL NOT SUPPORT THIS IN REV 1

https://moqups.com/ddodge/98rEWfVv/p:a362af817

Not supported.

Ok we will just use PayPal instead

Take a photo

Users can tap the camera icon and it should spawn the camera on the phone/device and allow them to take a photo.

https://moqups.com/ddodge/98rEWfVv/p:a657202d1

Supported already

Barcode scan

Users can tap the barcode icon and it should spawn the camera/barcode reader on the phone/device and allow them to scan a barcode

https://moqups.com/ddodge/98rEWfVv/p:adbd7433a

Supported already

Sign & draw

Users can tap the icon and sign/draw in a box that takes this type of input

https://moqups.com/ddodge/98rEWfVv/p:a5489d7b5

Supported already

Maps/gps

Users can tap the map icon and add a map point. the gps should auto detect the users location. A user can change the map point if they like

https://moqups.com/ddodge/98rEWfVv/p:a5f619b61

Supported already

Social Security Number

Users can enter their SSN

This is a regular Text/Number input filed with SSN validator selected—it doesn't need its own custom SSN′ type

https://moqups.com/ddodge/98rEWfVv/p:a2efc413c

Not critical to the spec but could be nice to have.

Gender Select

Users can select a gender Male or Female

Same here—doesn't need its own custom type—it a simple 2-option radio.

https://moqups.com/ddodge/98rEWfVv/p:a7af23eac

Supported already

Audio input

Users can tap the audio icon and it should spawn the audio record function on the phone/device and allow them to record audio.

https://moqups.com/ddodge/98rEWfVv/p:a8663079a

Supported already

Video input

Users can tap the video icon and it should spawn the camera/video camera on the phone/device and allow them to take a video. We then upload this video

https://moqups.com/ddodge/98rEWfVv/p:a9a50429e

Supported already

QR code scan

Users can tap the QR code icon and it should spawn the camera/QR code reader on the phone/device and allow them to scan a QR code

Since QR code can have different types of information encoded (URL, text, Vcard etc.), we need to figure out the behavior of the form when the supported type is scanned. Present it as a text field (or text area) . . . . Needs further discussion.

https://moqups.com/ddodge/98rEWfVv/p:a983c1698

Supported already

Stand alone text editor like this

WE WILL NOT SUPPORT THIS IN REV 1

https://moqups.com/ddodge/98rEWfVv/p:a15ed4019 should support all basic text editing and formatting. it would work like this

user clicks a text box to add text the editor pops up

user formats text in the editor clicks done

formatted text is shown in form builder text box Not supported.

I believe such a text editor will be very useful. Ifs necessary to analyze in more detailed way what certain settings should be released. Not critical to the spec but again nice to have and useful.

Limited formula support

IP Address Maybe

WE WILL NOT SUPPORT THIS IN REV 1

Same simple Text/Number input field with IP validator check applied to it—no need for custom type.

Why do we need to use IP address in form?

We will not do this part in V1

5. settings for each control/field

Supported Configuration Features:

Text/Numbers Input Field Title (above)

Description/Help (below) Placeholder (inside) Formula

Required/Not required

Data Type (HTML5/iOS/Android input types that control the keyboard character set): Text, Numbers, Email, Phone, URL

Max 128 character for single text line (implicit, not exposed for user configuration)

Dropdown/Select List

Title (above)

Default value/Placeholder (inside)

Description/Help (below)

Required/Not Required

Multiple selection

formula (Not in rev 1)

Text Area/Paragraph

Title (above)

Placeholder (inside)

Description/Help (below)

Required/Not Required

Max 1024 character for multi line (implicit, not exposed for user configuration)

formula

Checkbox

Title (above)

Description/Help (above, below Title) (Not in rev 1)

Required/Not required (Not in rev 1)

formula (Not in rev 1)

randomize (Not in rev 1)

Radio Group

Title (above)

Description/Help (above, below Title) (Not in rev 1)

Required/Not required (Not in rev 1)

formula (Not in rev 1)

randomize (Not in rev 1)

Photo

max size 10 MB (implicit)

required/not required

title

Video (record only—no upload)

max size 60 seconds of video (implicit) (expected filesize—130 MB) required/not required

title

Bar Code (presented barcode image+as text line with decoded data)

required/not required

title

See de-/encoded data (checkbox)

Sign/Draw

required/not required

title

Purpose dropdown: Sign/Draw (changes the size of the area)

Map

required/not required

(title

file upload

required/not required

max file size of 130 MB

Implicit file type screening on the background (reject harmful file types: EXE, COM, VBS etc)

Gender

required/not required

title (gender)

QR Code (presented as QR code image+text area with decoded data) required/not required

title

See de-/encoded data (checkbox)

(Figure out whether the decoded data will be unwrapped into a single line of text)

Audio (record only—no upload)

required/not required

title

max file size 130 MB

SSN

required/not required

placeholder

Table (not in rev 1)

required/not required

randomize

allow NA

instructions/description

title

Price (for rev 1 it's just number field with currency type)

required/not required

placeholder

formula

currency type

min/max value (not in rev 1)

title

Website

required/not required

formula

description

placeholder

title

Phone number

required/not required

placeholder

formula

description

title

Time

required/not required

formula

description

title

military time and AM/PM

display current time from device (user can change if needed)

Email

required/not required placeholder

formula title description

Date

required/not required

formula

title

uses device native setting (implicit, not configurable by the end user)

display current date from device (default, user can change if needed)

Address (not in rev 1)

required/not required

formula

title

Name (not in rev 1)

required/not required

formula

title

placeholder

page break (replaced by ‘New Page’ functionality)

Section break

description

Star rating (not in rev 1)

required/not required

formula

title

1-5 star only

Opinions (not in rev 1)

required/not required

formula

randomize

allow NA

upload pre defined options

description

title

Credit Card (not in rev 1)

required/not required

formula

description

title

Text editor (not in rev 1)

all function of standard text editor

6. Other ideas for V2

skipping logic, skip some fields based on prior user input Nested fields that show when radio or checkboxes are enabled formula support

upload custom form and edit it

add date/time combo option for field setting

use for moving back and forth from new and old form editor

Any form created with the new editor can be opened by the old editor

User creates form in new form editor

user saves form

user needs to add custom field next to another field

user goes into expert mode and selects form to edit (maybe add link to do this in new form editor)

user edits form

user saves form

new form is synced to app using email as ID

user can now use edited form

edit in app form in form editor

user clicks customize this form TBD location

app tells user to check their email

we send an email to users account with link to open that form in the form editor on a computer

user clicks hyperlink on desktop computer

User signs in to Snappii

form editor starts and loads form user edits form

user saves form

the new form is synced to the app using user email as identifier

user can now use edited form

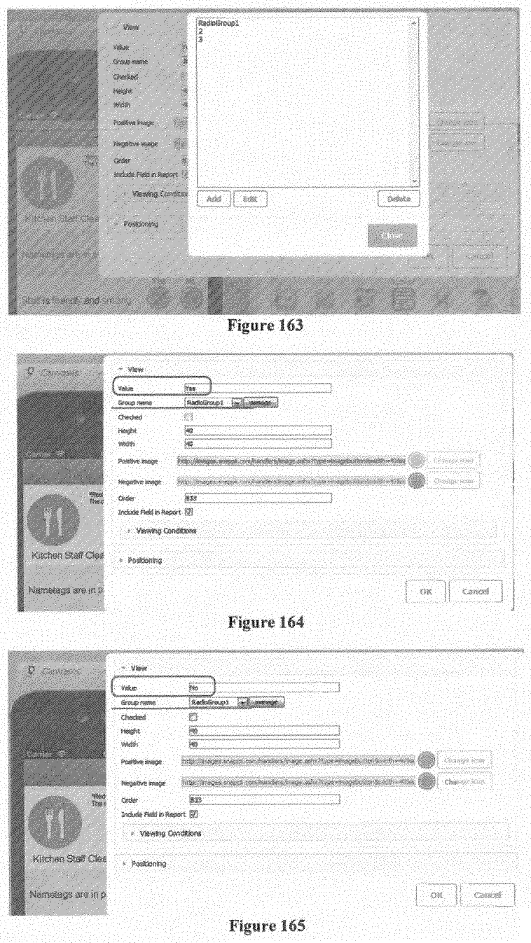

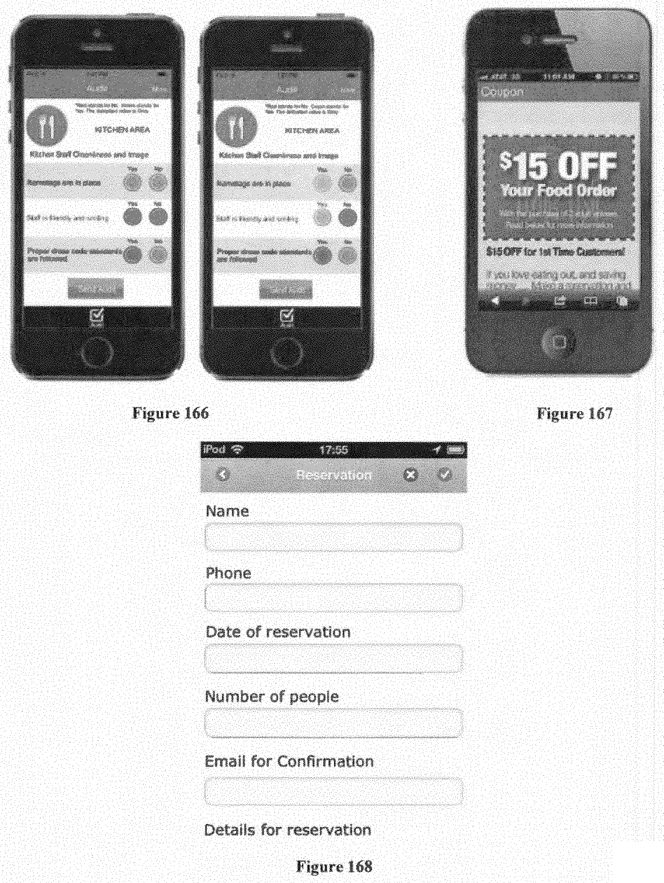

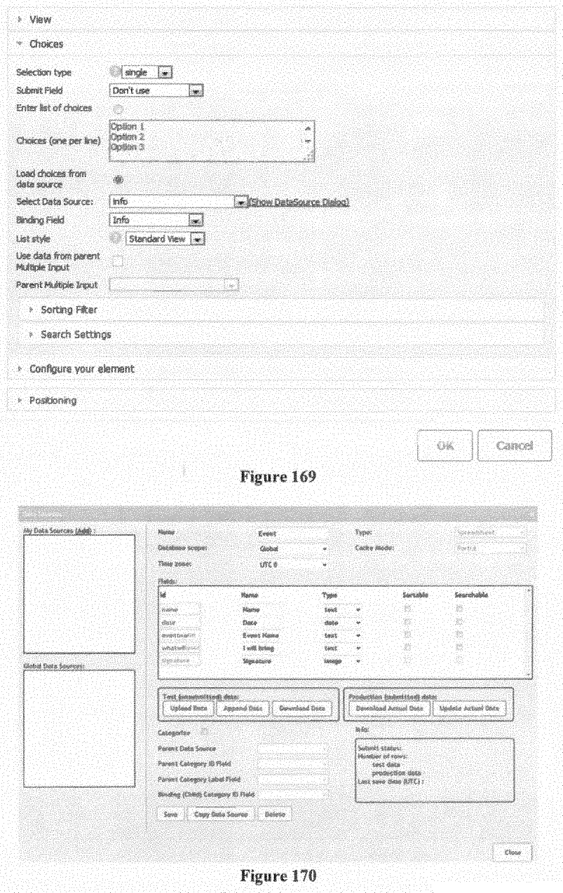

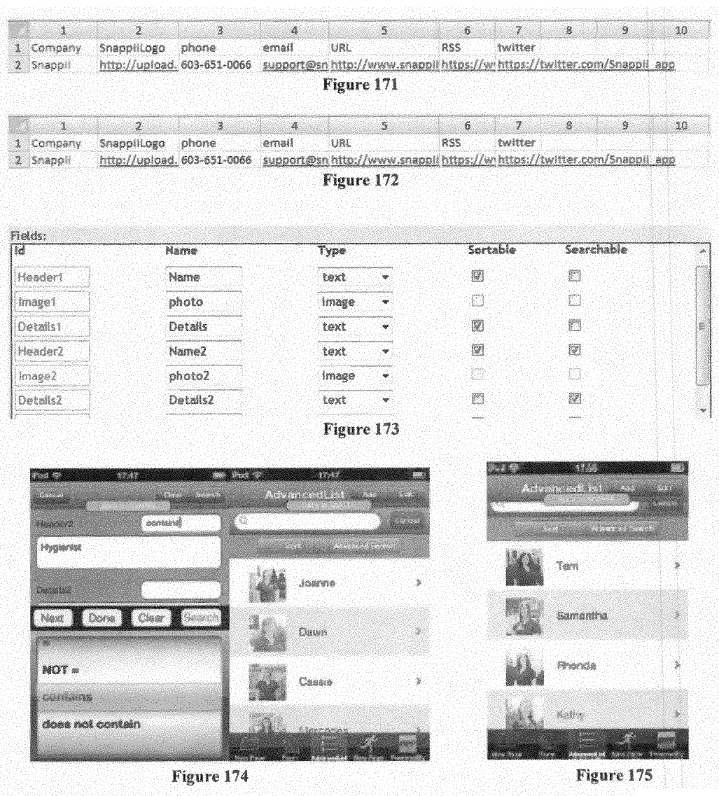

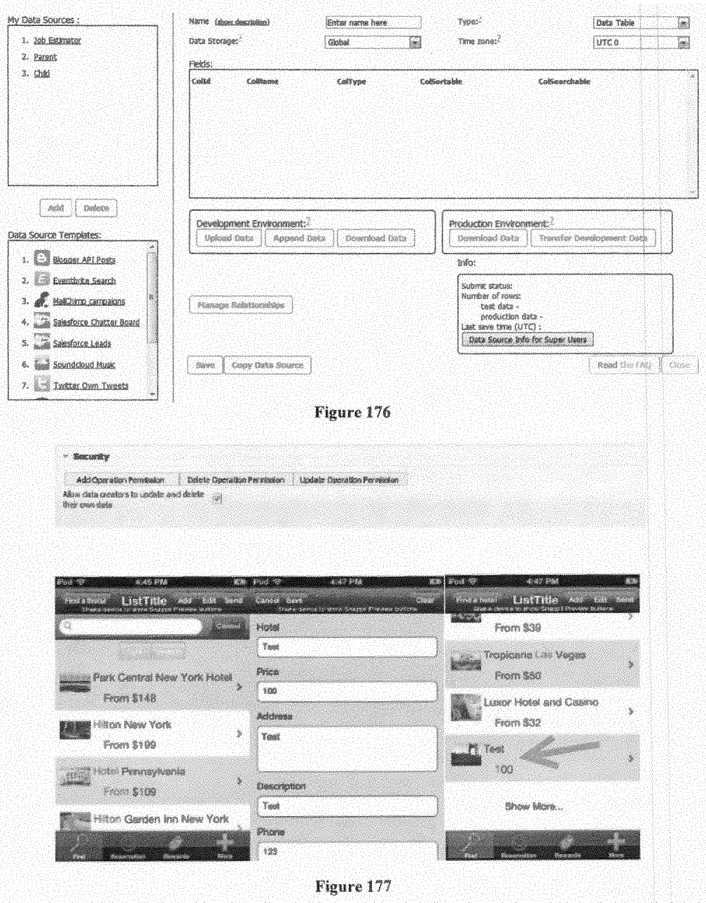

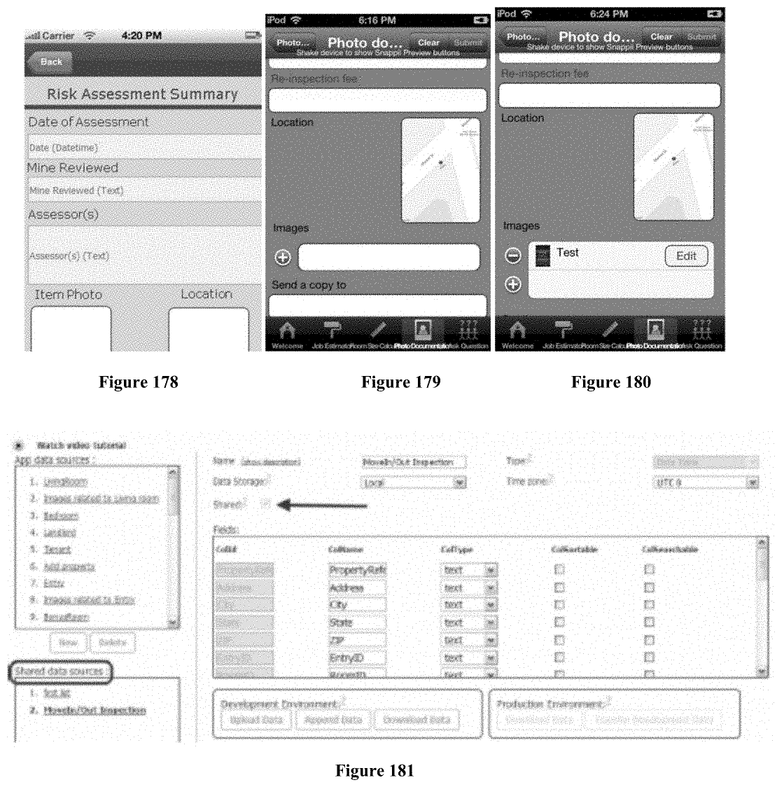

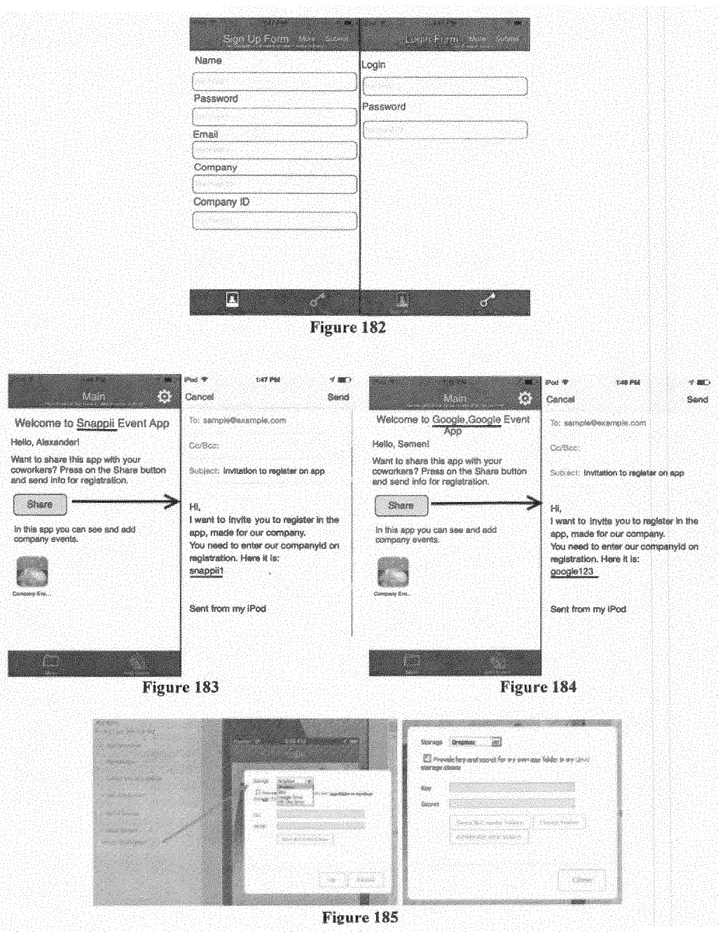

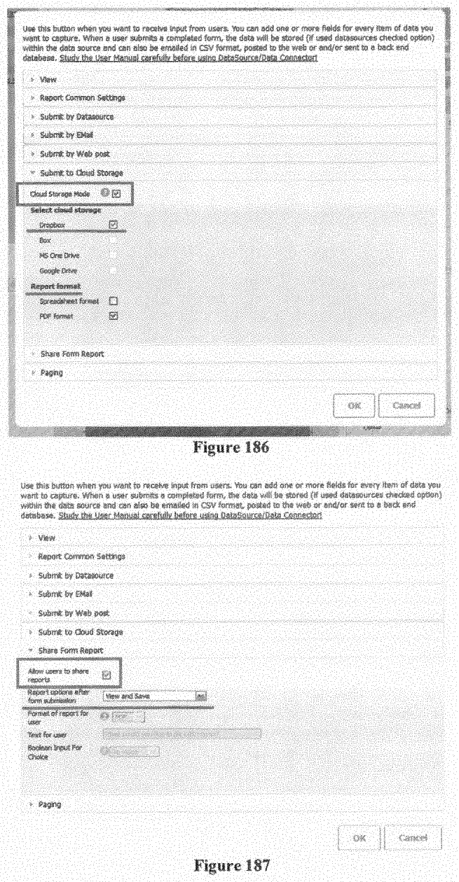

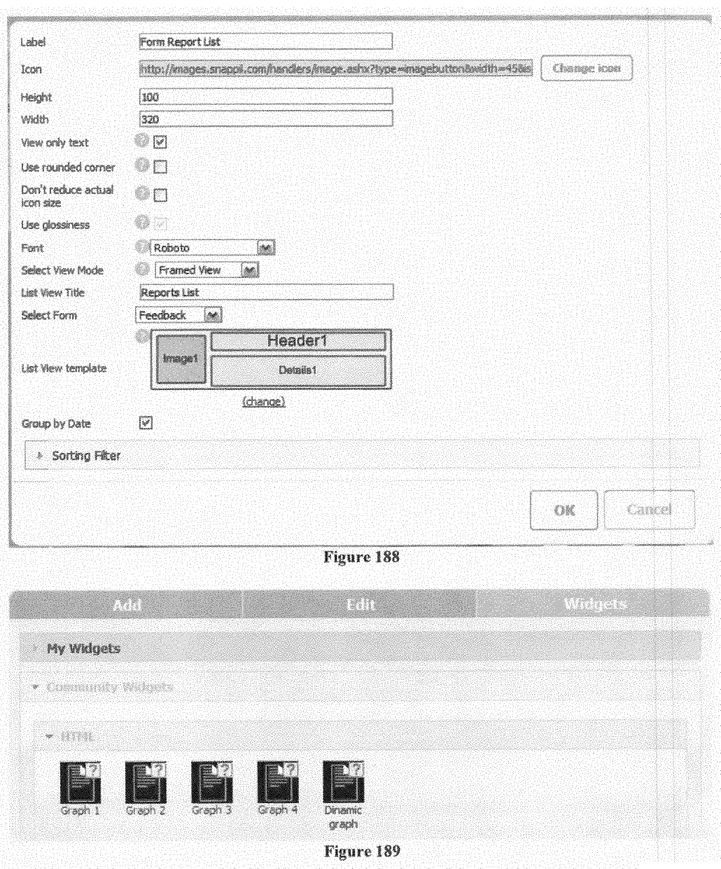

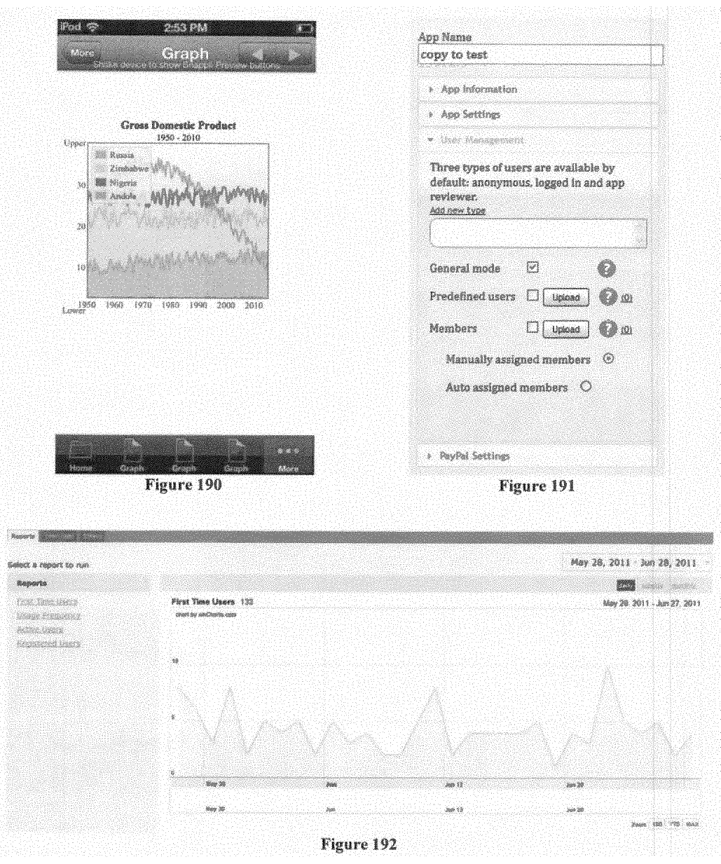

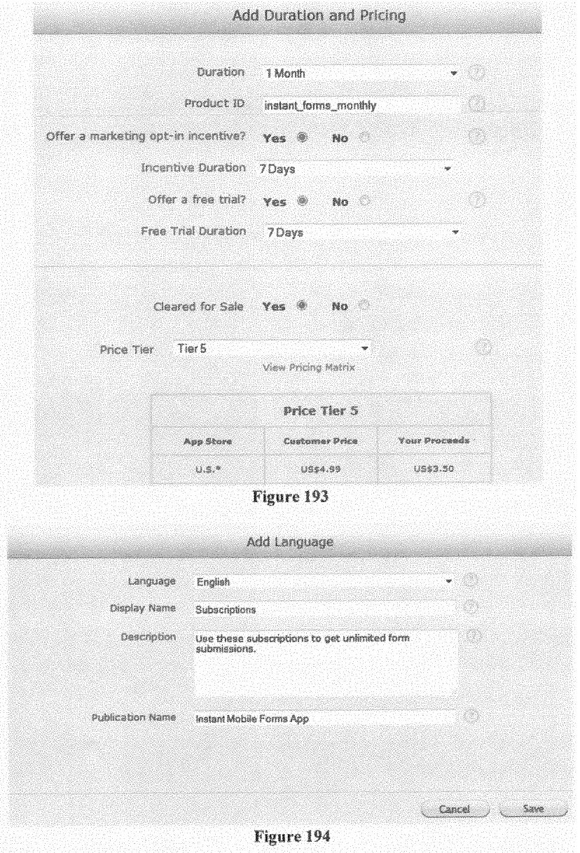

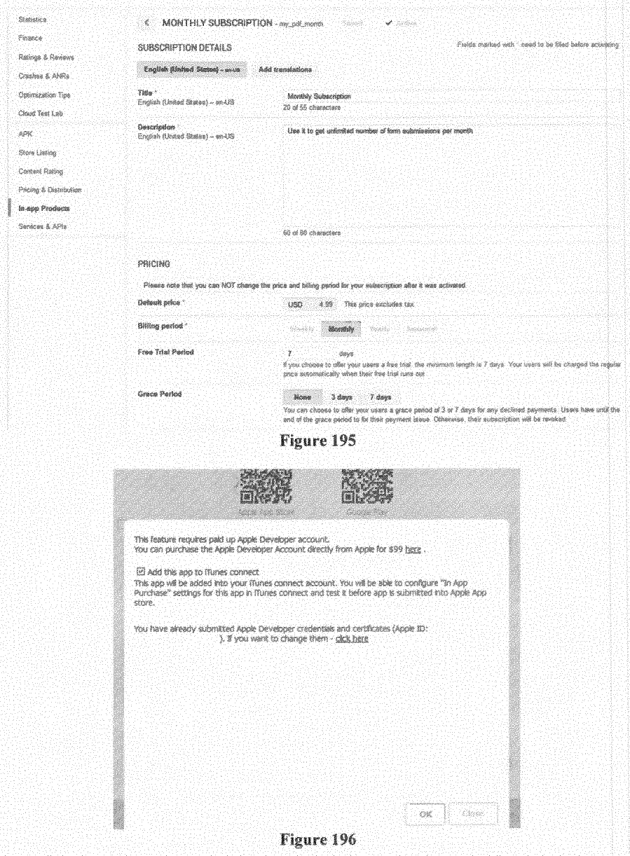

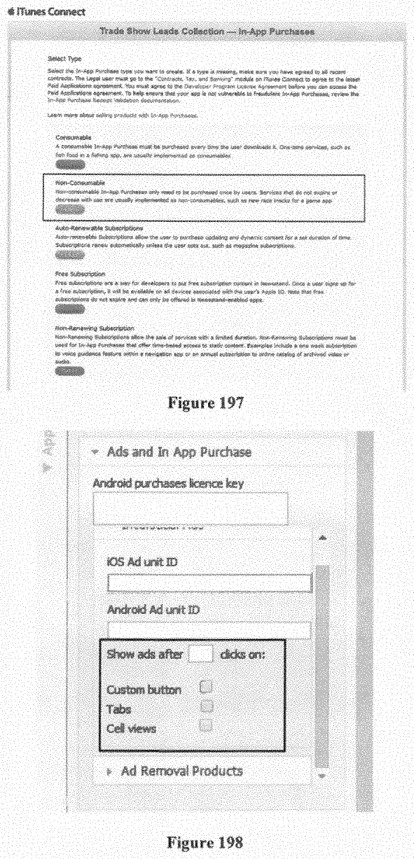

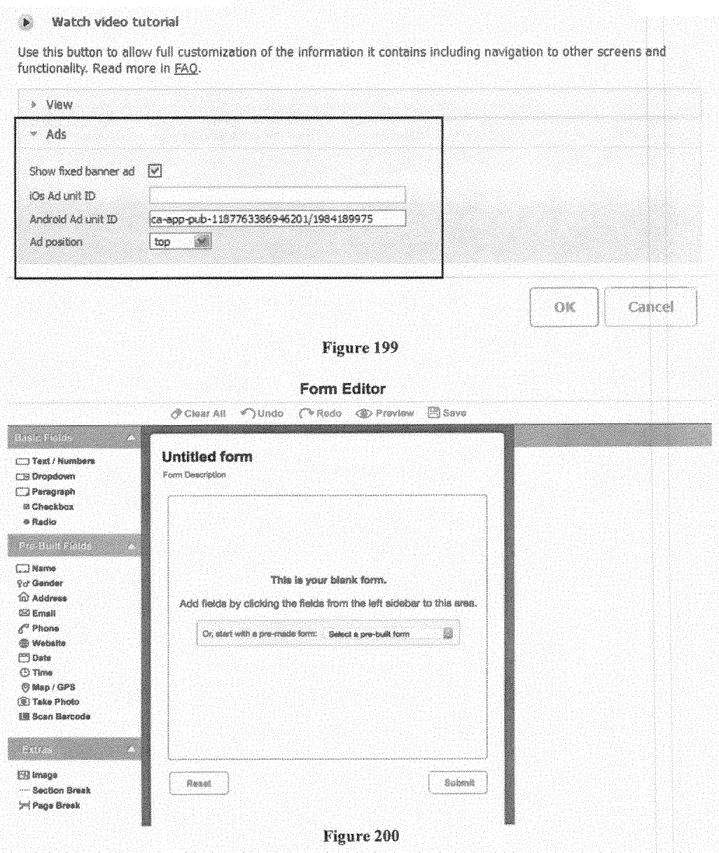

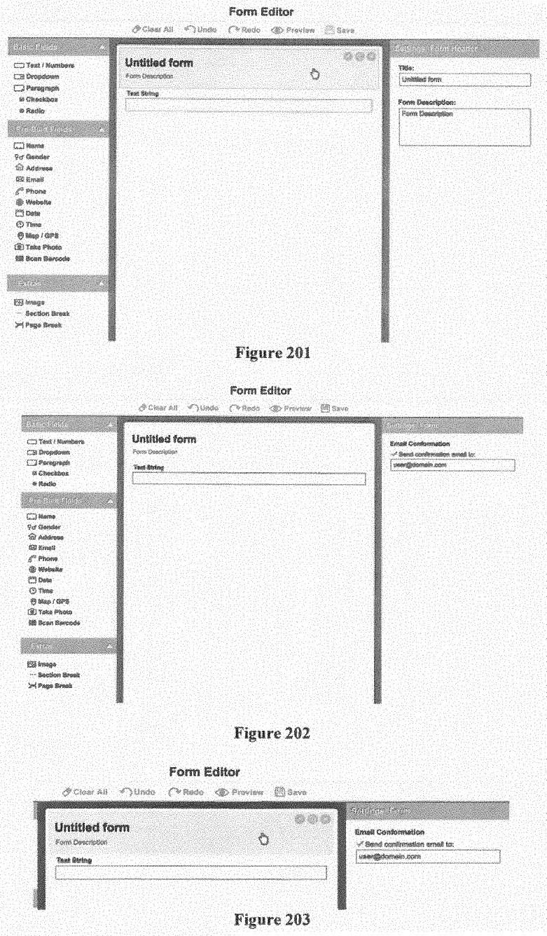

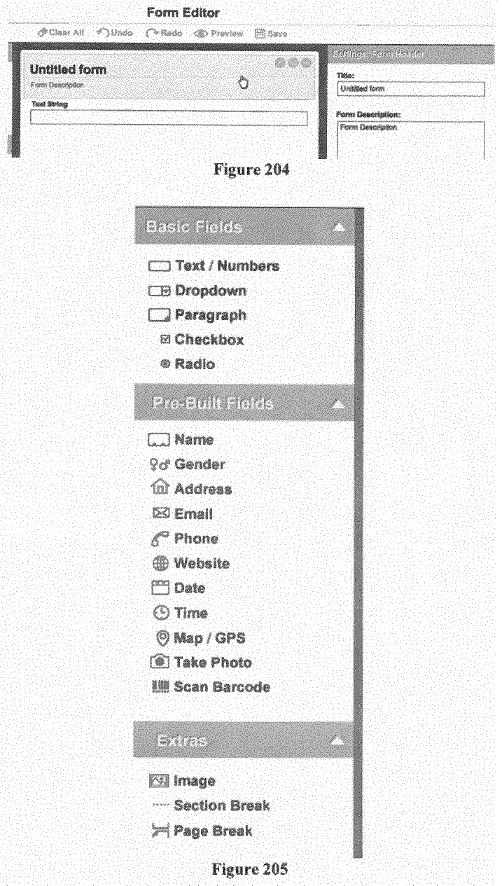

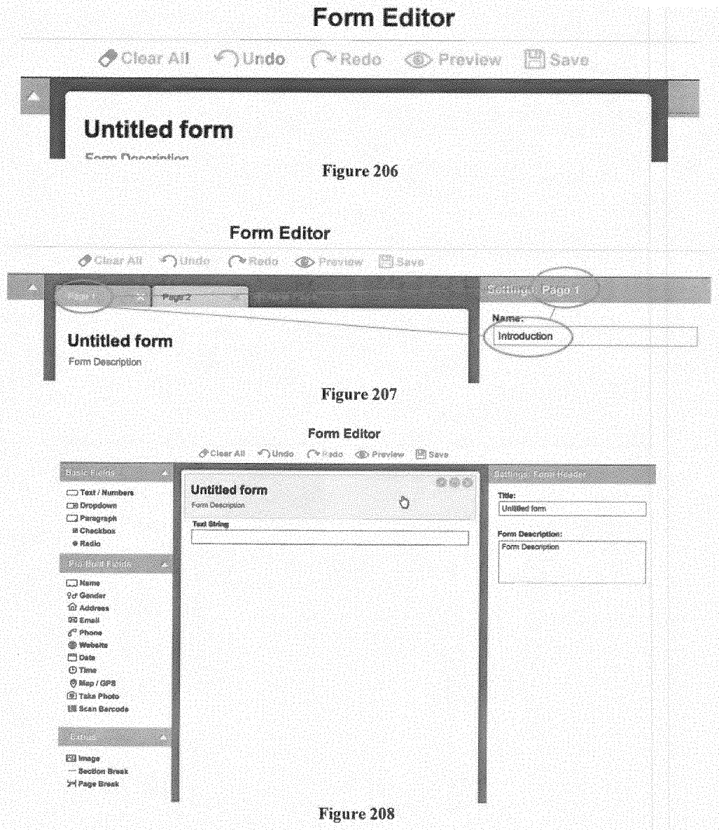

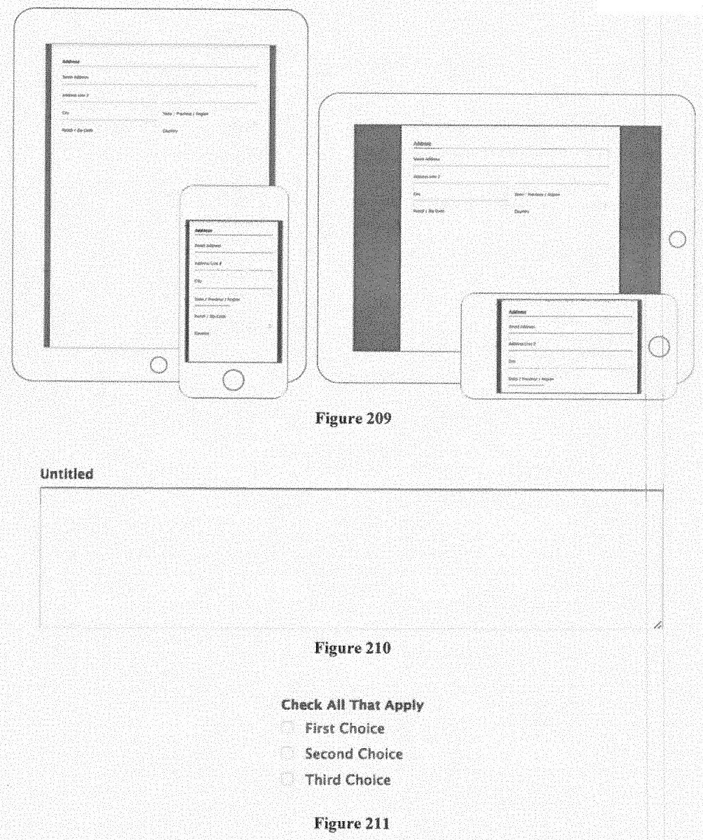

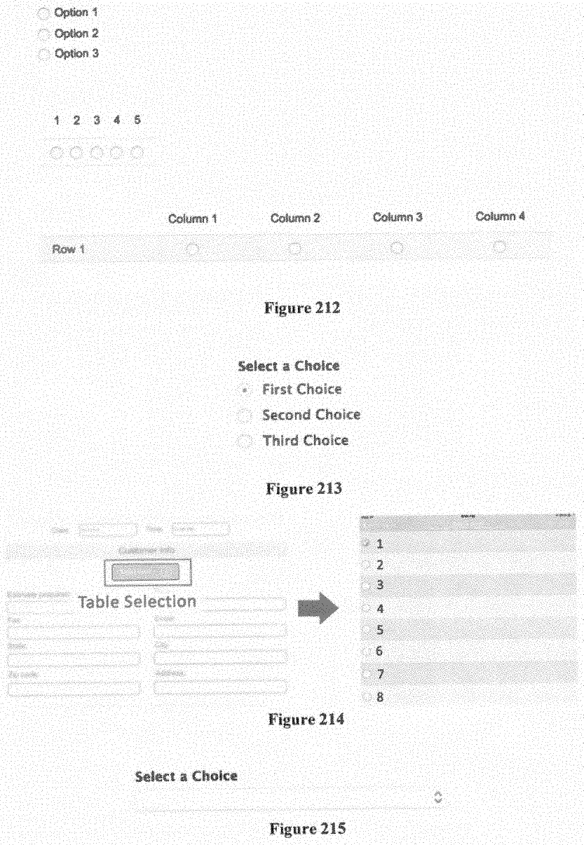

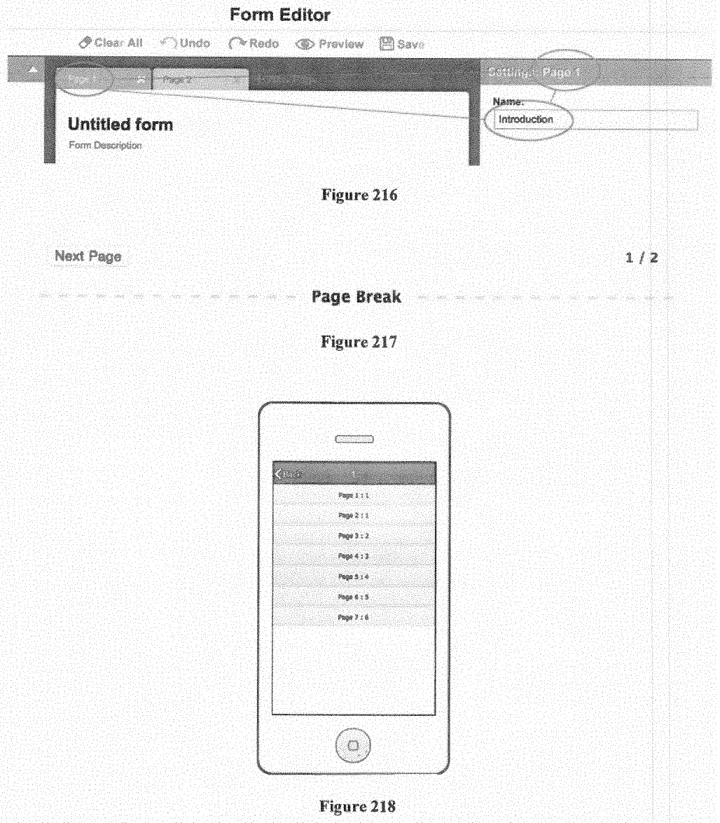

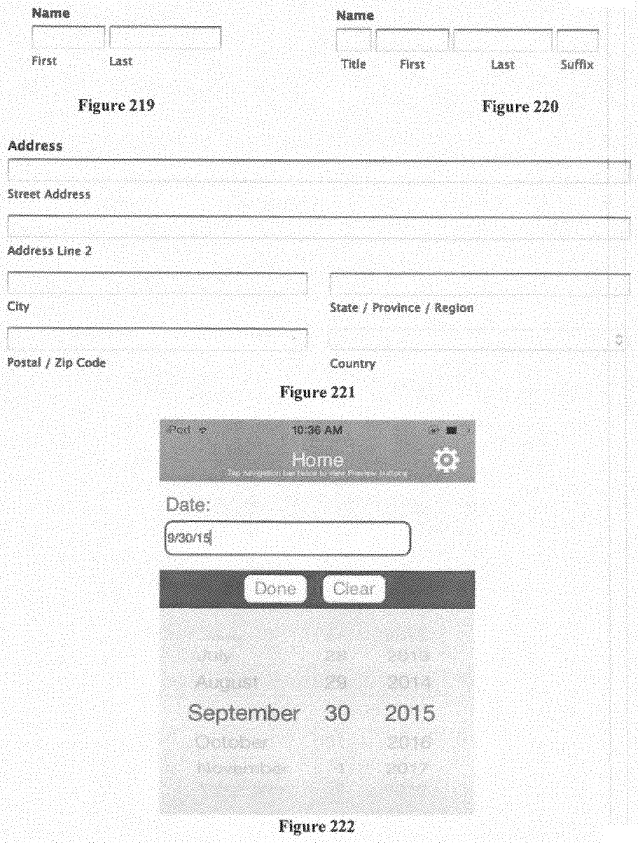

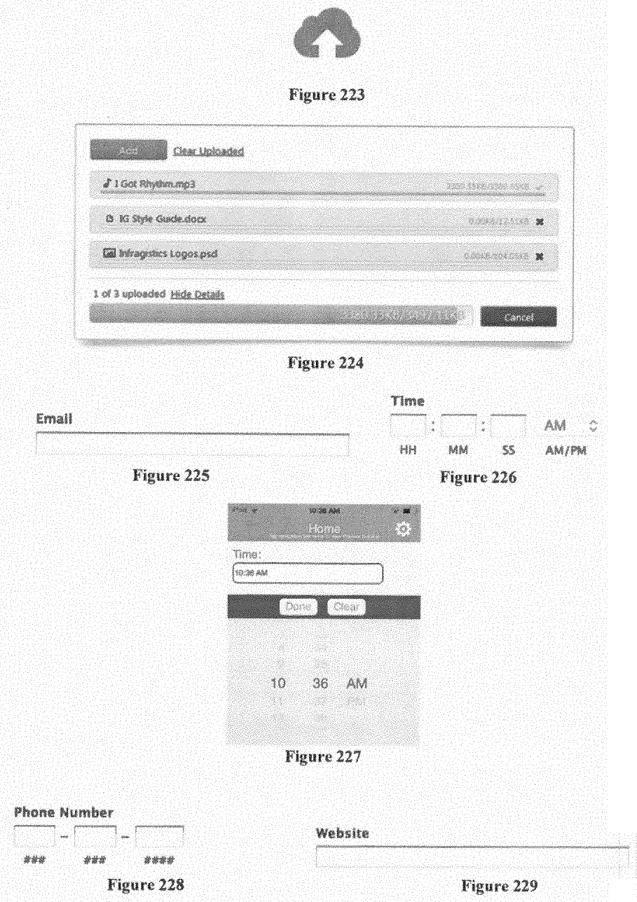

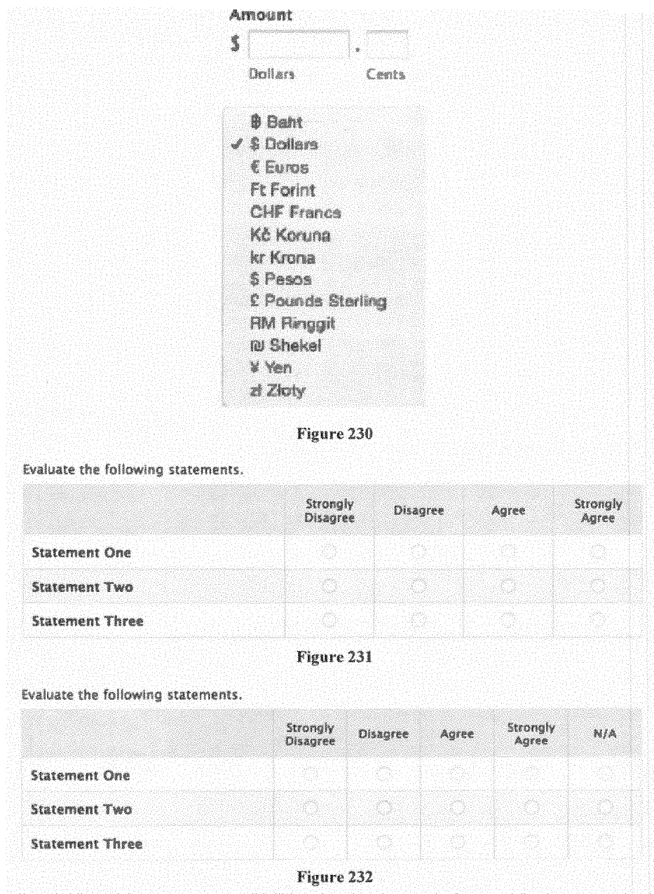

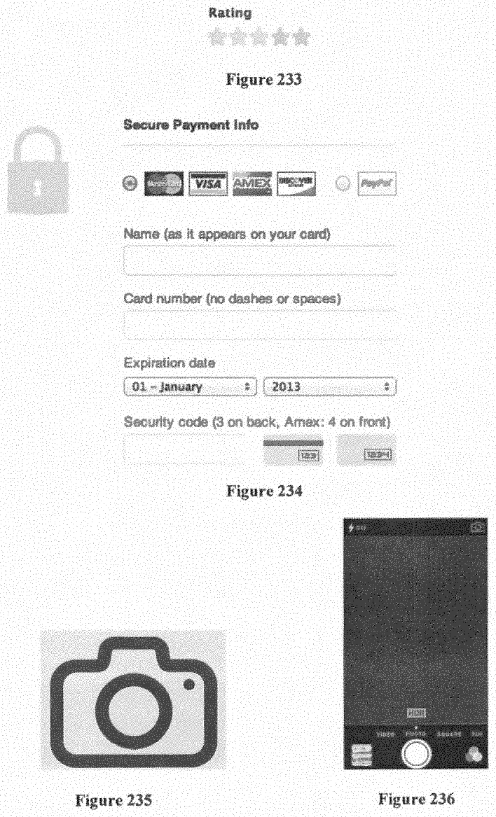

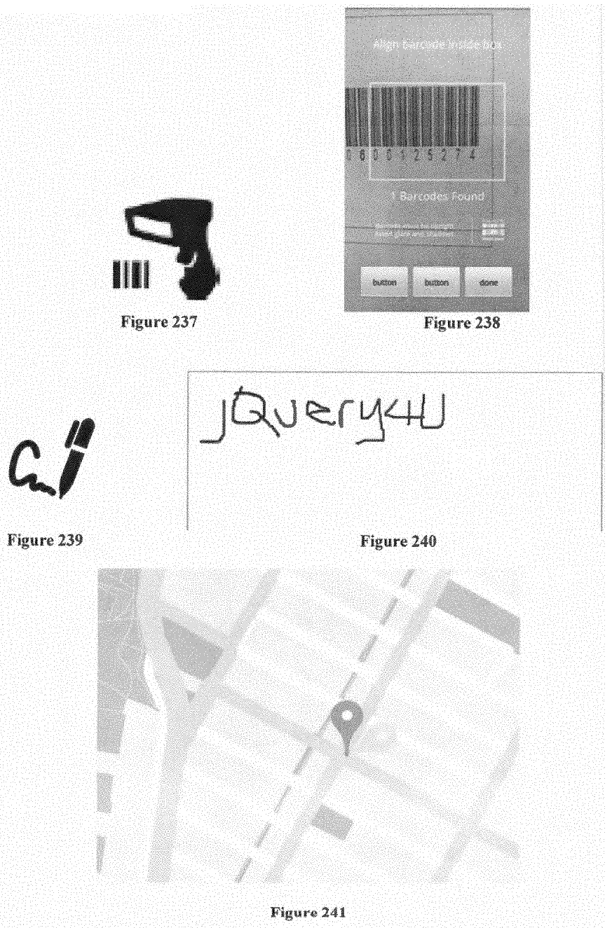

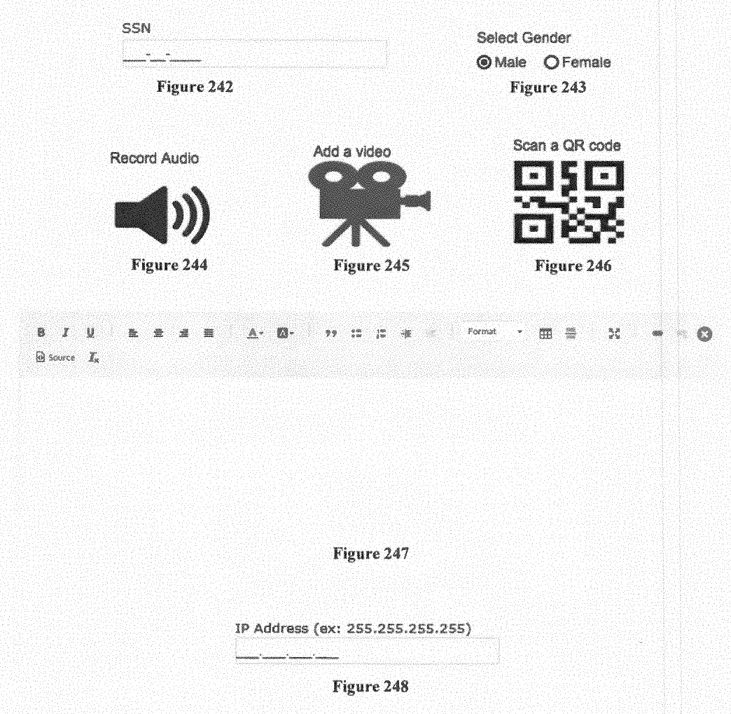

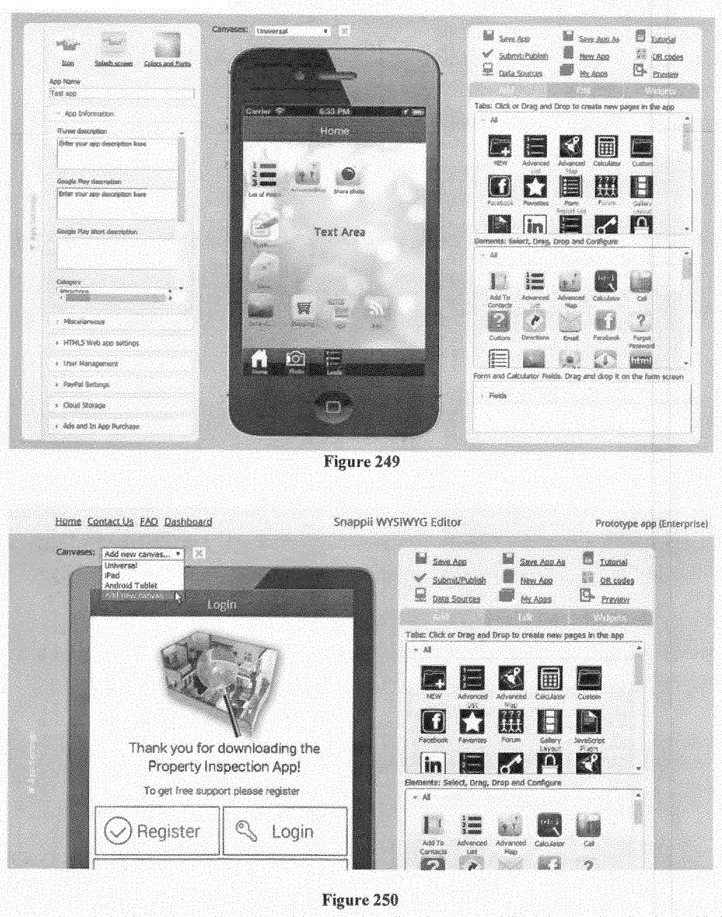

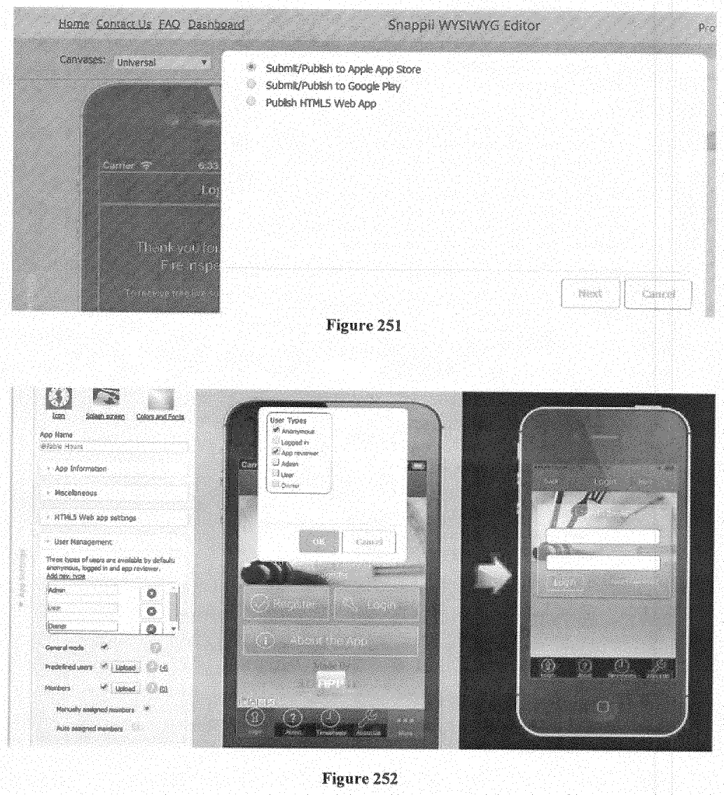

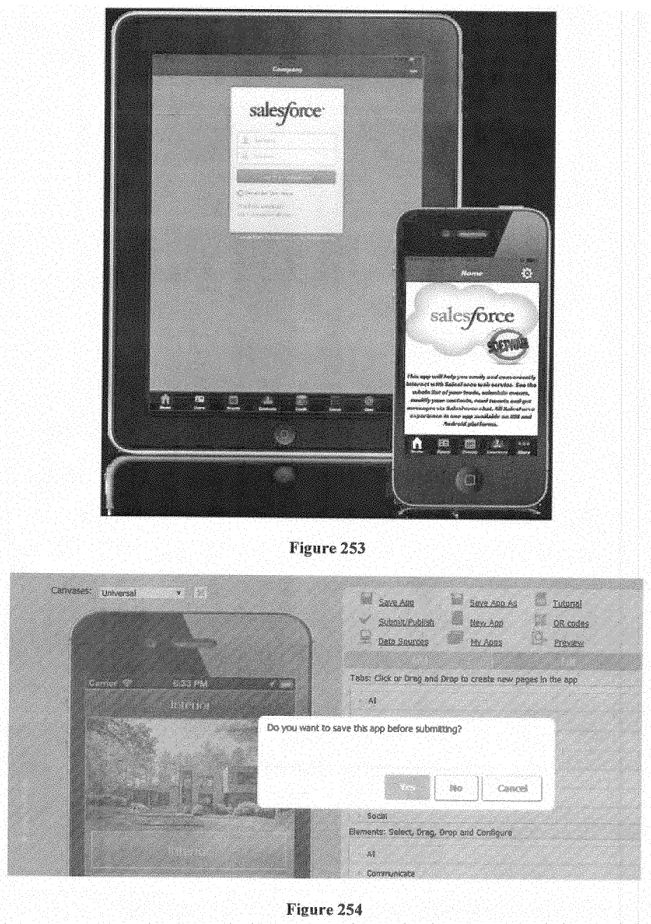

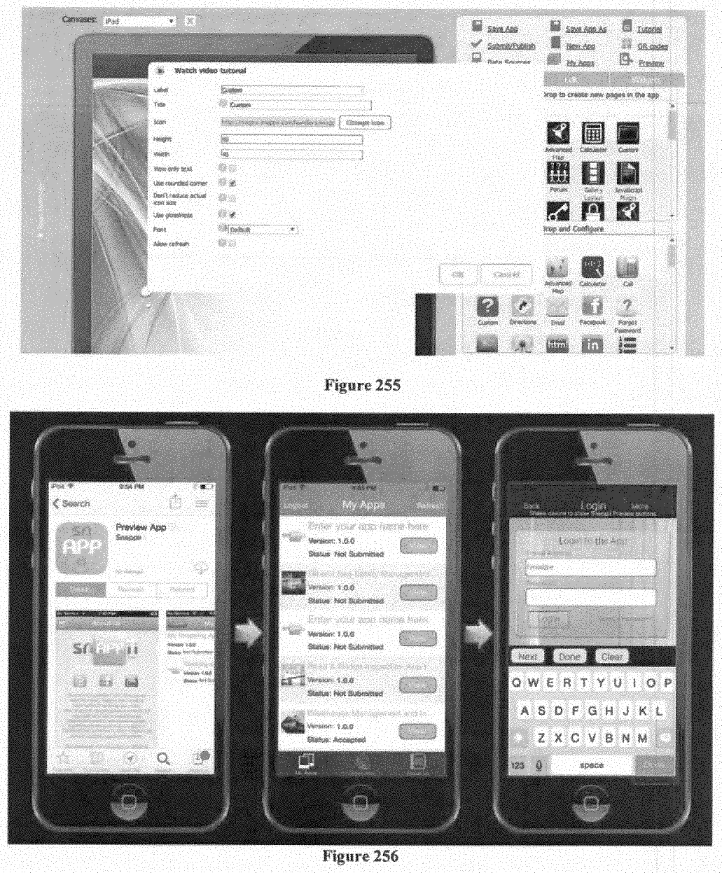

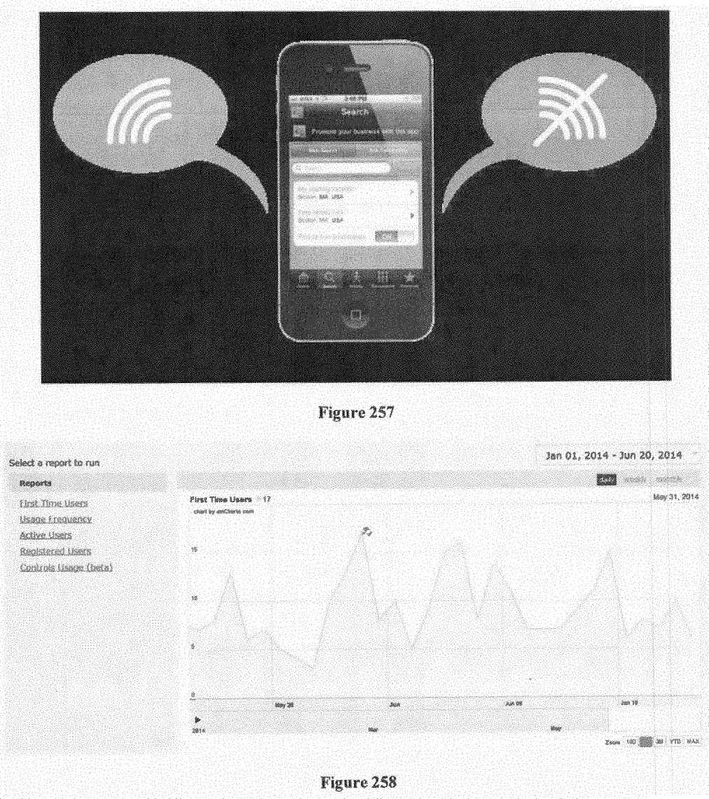

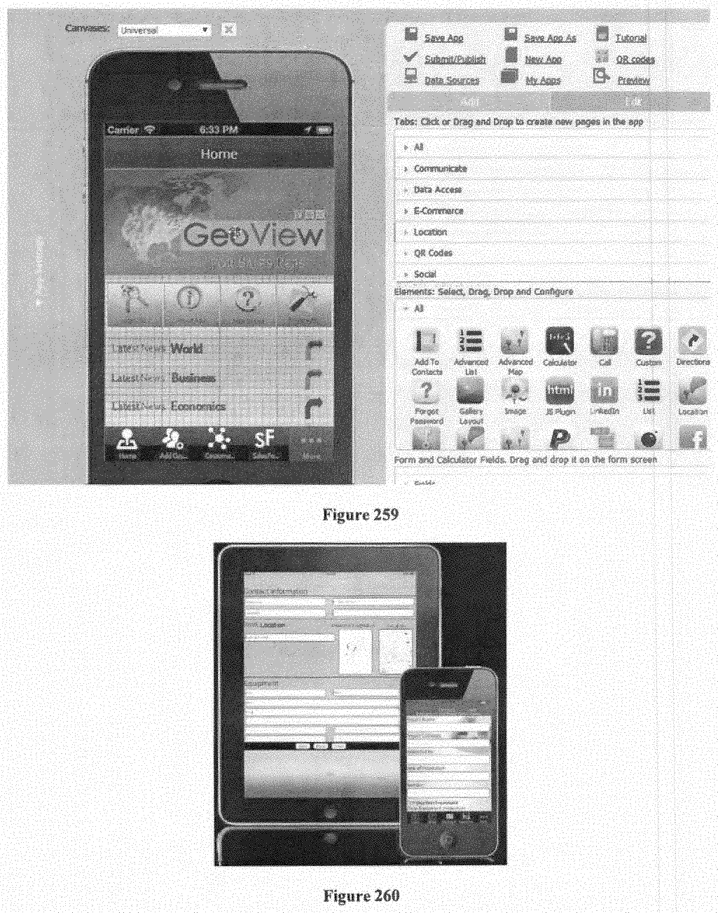

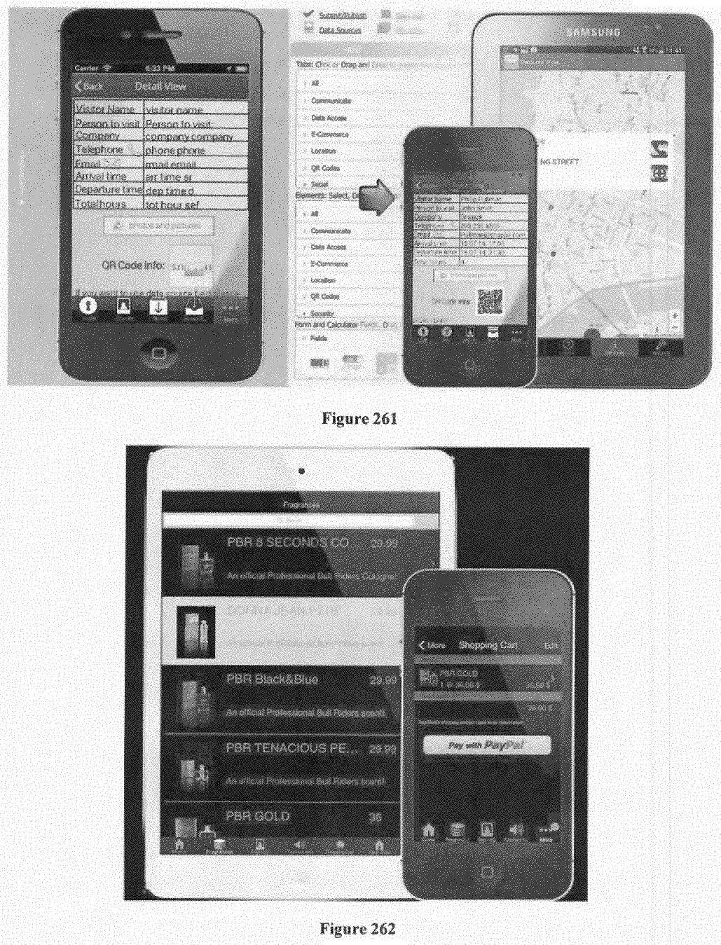

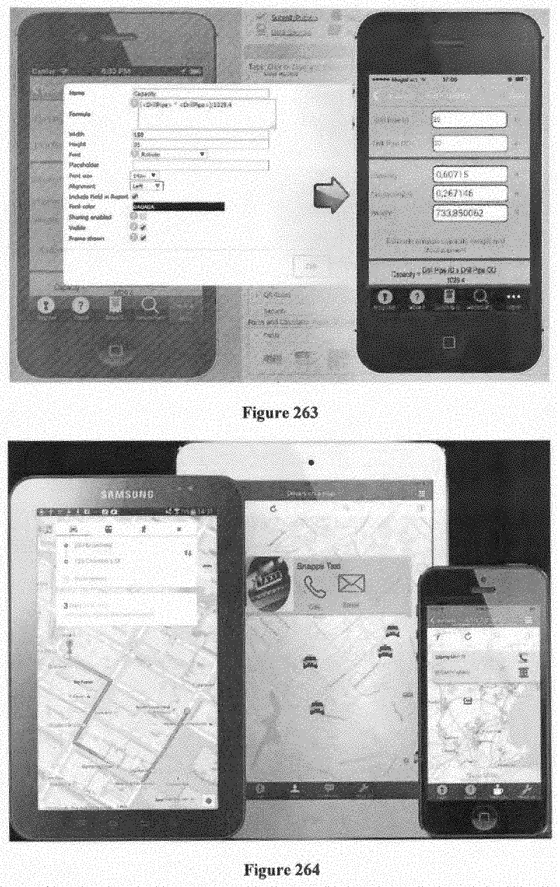

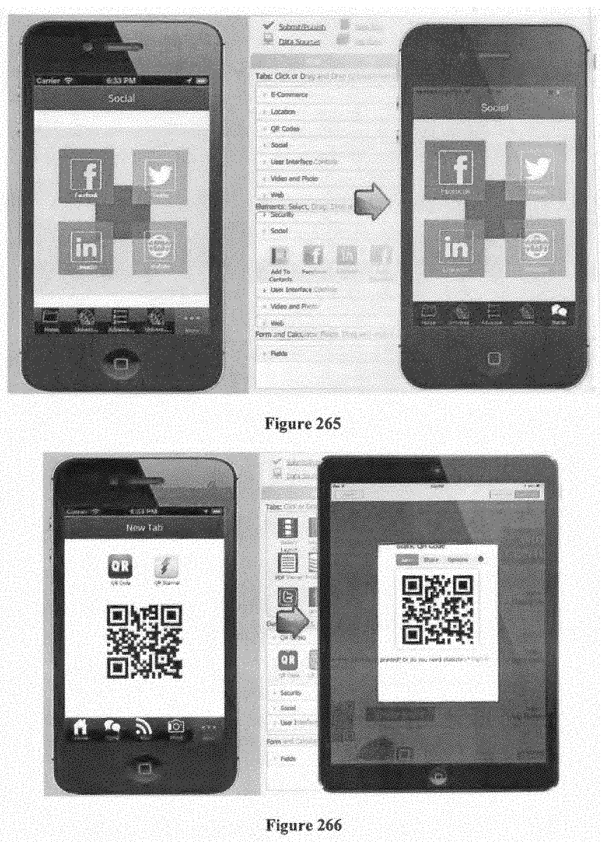

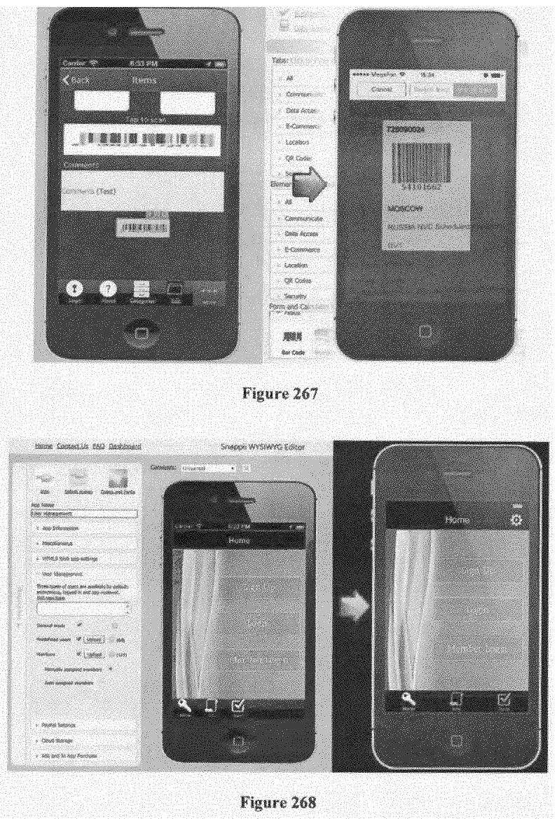

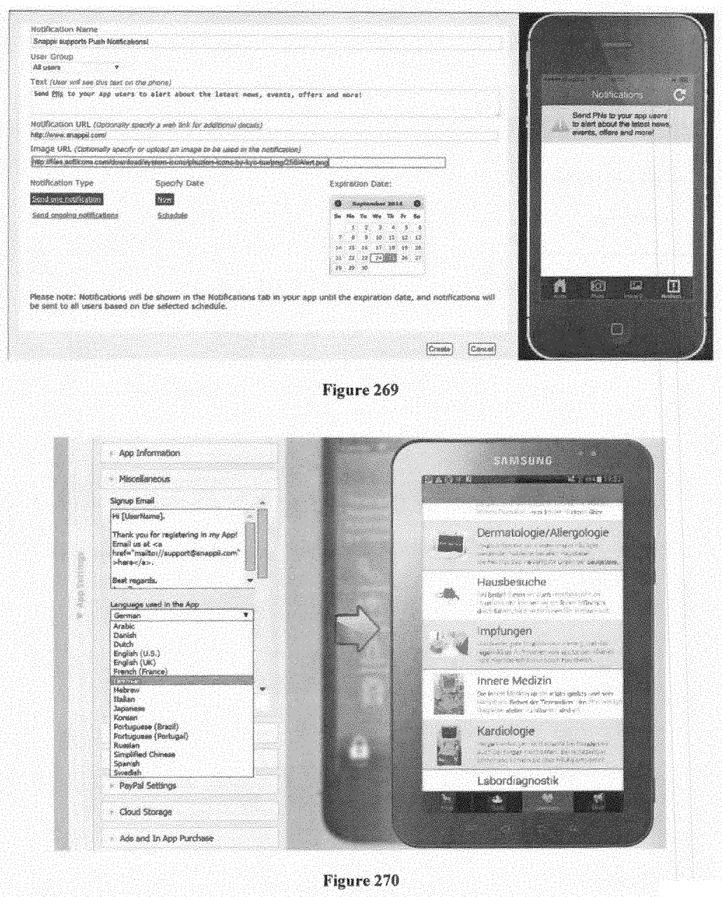

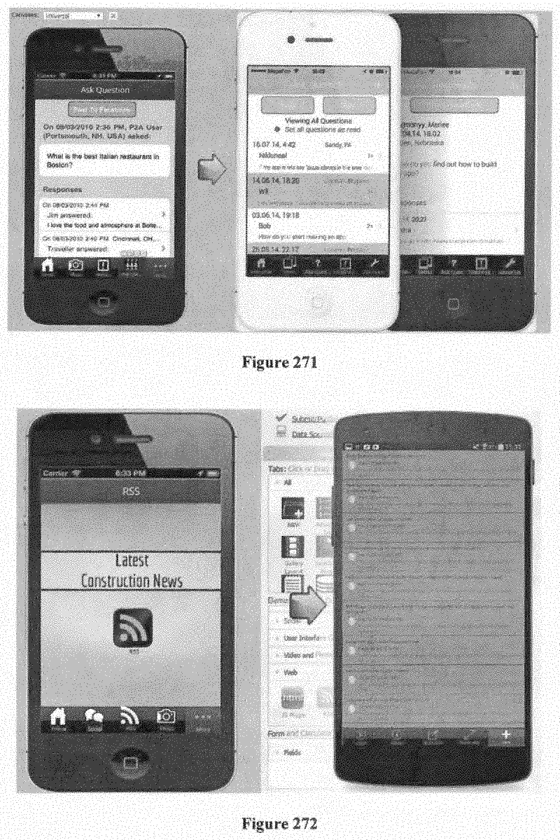

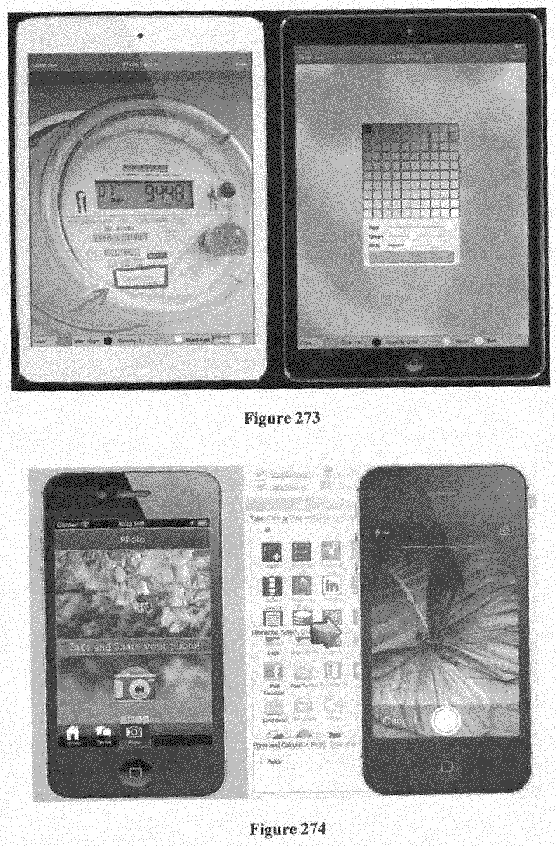

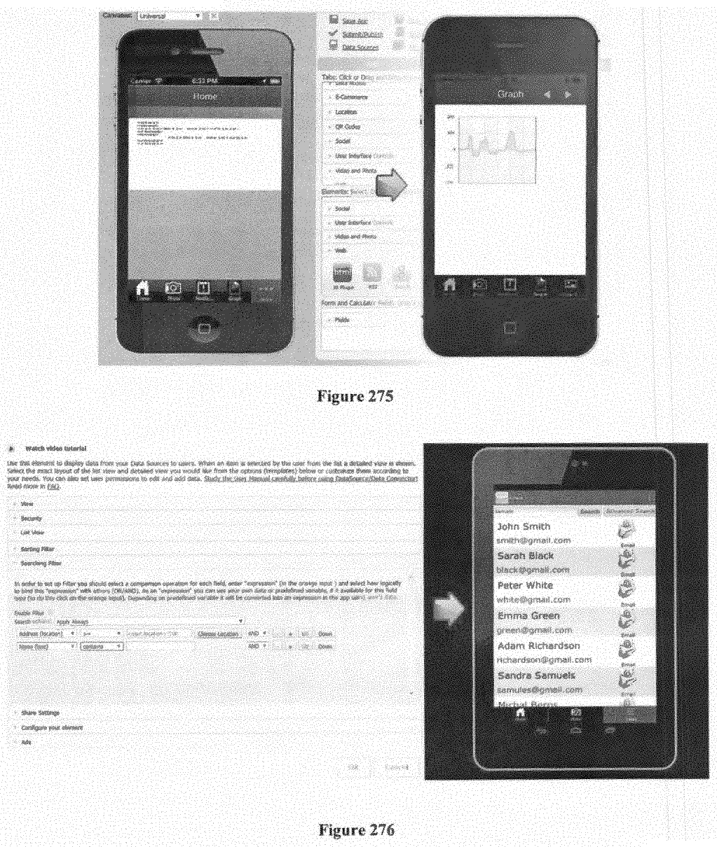

Referring to examples of FIGS. 249-288, exemplary implementations of embodiments of the present disclosure provide a CODELESS PLATFORM

(* Click on the screenshots to enlarge)

TABLE OF CONTENTS

Visually Develop Mobile Applications

Build Apps for Any Android or iOS Device and Any Screen Size

Build Once and Then Deploy Anywhere

Take Advantage of App Security & Authentication

Connect to Enterprise Systems & Cloud Applications

Make Changes and Updates Fast and with Ease

Build Apps 30 Times Faster

Test a New App with Ease

Work in Online/Offline Modes

Take Advantage of App Analytics

Have Total Control over the User Interface

Submit Data in Any Format

Create Custom Lists, Maps, and Image Galleries

Sell Products and Services via Paypal

Make Custom Calculations

Incorporate GPS and Maps

Integrate Social Networks

Take Advantage of the Built-in QR Code Scanner

Make Use of the Built-in Bar Code Scanner

Utilize Role-Based Access

Incorporate Notifications into Your App

Take Advantage of Multi-Language Support

Make Use of the Built-in Discussion Forum

Take Advantage of RSS Feeds

Make Use of the Sign and Draw Feature

Incorporate Photo Capture from within Your App

Enhance Functionality with the HTML Button

Take Advantage of the Search Feature

Enhance Functionality with JavaScript Plug-in

Incorporate Various Widgets into Your App

Take Advantage of the Data Collection and Reporting Options

Enrich Your App with Custom Lists, Galleries, and Maps

Take Advantage of the Advanced Search Feature

Share Content from Your App with Others

Print Completed Reports Using the Share Button

Store Data on Network Drives

Auto-Generate Custom PDF Reports

Take Advantage of Condition-Based Visibility

Save Time with the Data Selection Features

Make Use of Hundreds of Pre-Built, Easy to Use and Customize Business Apps

VISUALLY DEVELOP MOBILE APPLICATIONS

A rich WYSIWYG web-based visual development editor allows you to build applications with a simple drag and drop user interface. Have 100% control over the User Interface. Add or change functionality in seconds. Customize your screens and tabs with your own design, features and elements. Build your own apps when and where you want. All you need is Internet connection and a laptop/PC. Nothing to download, install, or configure. Just open your browser, find www.snappii.com, register on the platform for free and start making apps. Make custom and native apps in minutes! While you are making an app, you can also simultaneously test and see it running on your mobile device with free Snappii's Preview app.

Build Apps for any Android or IOS Device and any Screen Size

You can build an app specifically for a tablet, a smart phone or both. Create an app that will individually fit the screen sizes of iPads and Android tables, iPhone5 and Android smart phones. Device-specific apps can have the same functionality as well as different features for different canvases. This feature gives you a great number of opportunities for app design and functionality

Build Once and then Deploy Anywhere

Once you've built an app, Snappii will generate native iOS and Android mobile app versions. With Snappii, you can simply create an app on the universal canvas and then check off the operating systems for which you want your app to be generated.

Take Advantage of App Security & Authentication

Snappii's platform comes with many built-in security features. To protect your data, Snappii apps offer encryption, HTTPS communication, and Access Control Lists (ACls) to tabs and buttons, Login/Logout, and OAuth2 Authorization.

Connect to Enterprise Systems & Cloud Applications

Build sophisticated data driven native apps that leverage data from both internal enterprise systems and cloud based applications. Snappii has already prebuilt some data connectors to connect to various web services. You can take advantage of these or upload your own connectors to retrieve and post data from web services, databases and cloud based apps. For example, with the SalesForce connector, you can obtain all necessary information about your leads or clients. Upload their contact info from your device immediately after your meeting, and the data will be automatically updated under your SalesForce account.

Make Changes and Updates Fast and with Ease

Making changes in an app takes literally minutes and doesn't require any programming skills. Updating apps is possible with the click of a button. Simply click ‘Publish’, and your users will be immediately notified of a new version.

Build Apps 30 Times Faster

Building apps without coding is 30 times faster! Make apps by dragging and dropping. It's like drawing an app: add objects on the empty canvas, and Snappii will do the rest. No coding necessary for 99% of the apps. However, you can also add JavaScript and JS-plugin whenever necessary.

Test a New App with Ease

Develop an app with Snappii and instantly see it running on your smart phone or tablet. Create or change your app, save it and instantly see the changes on any iOS or Android mobile device with the free Snappii Preview App. The Web2Phone copy feature allows an active test version of the app to run on any mobile device before it goes live. This lets you showcase your app to potential clients to make the initial sale or before the final product is released.

Work in Online/Offline Modes

Unlike simple HTML5 apps, Snappii-generated native applications can use databases to store information locally on your device while you are offline. Once the internet connection is re-established, the data can be forwarded to the central database, network drives or ERP and CRM backend systems.

Take Advantage of App Analytics

Use the dashboard to measure user analytics and improve your app performance. Leverage continued feature and functionality updates to enhance user experience. With the Snappii dashboard, you can:

Track the total number of app downloads

Track active users

Track registered users

Track first time users

Send and track push notifications

Track usage frequency

Check reports on daily, weekly and monthly bases

More

Have Total Control Over the User Interface

You have total control over the user interface down to pixel level. Unlike the template-based approach, you have complete control over each element—texts, images, multiple buttons, etc—exactly how and where you want. Change icons, add graphics—the design opportunities are limitless.

Submit Data in any Format

Submit data 24×7 in any format in both online and offline modes. Collect, store and send information from customers, partners, clients, and employees. Different types of data can be captured—texts, dates, digital values, calculations, photos, GPS locations, signatures, etc. Store submitted forms as PDF or Excel files in Dropbox, Box or Google Drive, or simply email them as PDF and Excel documents. Save completed forms in the cloud for future access and sharing.

Create Custom Lists, Maps, and Image Galleries

Create custom lists, maps and image galleries with any data you need and edit it on demand. You can create complex multi-level scroll down lists or connect your database with any form in the app. This feature allows you to collect different data from your app users such as feedback, reports, orders and more!

Sell Products and Services Via Paypal

Create product and service lists and sell them via Paypal.

Make Custom Calculations

Create custom formulas of any complexity to calculate orders, measure project specifications, and develop productivity tools. You can disable or enable calculator fields depending on the conditions specified in the formulas.

Incorporate GPS and Maps

Create lists of custom locations and show them on the map. Display the branches of your company, restaurant networks, shop departments etc. Literary anything that can be defined geographically (employees, locations, products, equipment, etc.) can be tracked and reflected here. You can also specify the visibility radius to show places on the map closest to your current location.

Integrate Social Networks

Your app can be fully integrated with Facebook, Twitter, LinkedIn, YouTube, RSS feeds, etc. Stay connected with business associates, employees and customers through LinkedIn, Facebook and Twitter. You can also upload RSS feeds to company news (blog feeds)

or any blog, magazine, newspaper or other outlet where an RSS feed can be used.

Take Advantage of the Built-in QR Code Scanner

Add QR codes and scanner capabilities to your apps for different purposes. With the help of the web QR code generator, you can create various QR codes that will show your business locations, add an appointment or event to your mobile calendar, redirect to a website, run a YouTube video, send an email, show text and share contact information. You can also reward your clients by offering them special deals and discounts by using QR code coupons that get decoded only after a certain number of scans.

Make Use of the Built-in Bar Code Scanner

Leverage the build-in bar code scanner and decoder capabilities in your apps. Capture and collect data, store it within the app and send it to your email as PDF or Excel reports. The feature can be really useful for such industries as logistics, warehouse, delivery, transportation and others.

Make inventories, track packages, parts and any other items for business purposes or personal use.

Utilize Role-Based Access

Use Sign up and Login features to capture user information and control access rights to certain screens and tabs. Create multiple levels of the in-app access to make some content available only to specific users and/or user groups. Add predefined groups of users or establish paid membership for your app. Our platform also supports O-Auth protocol for user validation, providing the ability to log users in to a variety of web based systems for authentication via LinkedIn, Twitter, Facebook, etc.

Incorporate Notifications into Your APP

Schedule and send push notifications to users and/or certain user groups to promote news, events, appointments, special deals and offers. You can send notifications from the app or the Snappii Dashboard.

Take Advantage of Multi-Language Support

Select any of the 17 languages available in the Snappii WYSIWYG editor to build an app in. Snappii supports the following languages: English (U.S.), English (UK), French (France), German, Simplified Chinese, Italian, Spanish, Portuguese (Brazil), Portuguese (Portugal), Swedish, Korean, Japanese, Russian, Arabic, Hebrew, Danish and Dutch.

Make Use of the Built-in Discussion Forum

Use the discussion forum to enable app users to interact with each other. Moreover, here your customers can ask questions and receive answers from you and other users.

Take Advantage of RSS Feeds

RSS feeds allow you and other app users to get news right from your website or any other source. Use any newsfeed, your twitter feed or even weather forecasts to keep your app users informed of the latest events.

Make Use of the Sign and Draw Feature

Sign e-documents, sketch out product designs, and supplement images with notes right in your app.

Incorporate Photo Capture from within Your App

Take photos and instantly share them with others via email and other sharing options available on your mobile device.

Enhance Functionality with the HTML Button

You can enhance your app with HTML coding. For example, use in-app HTML to create custom database queries and registrations and integrate the app with other systems. You can even re-use the existing HTML code from your website. Anything you can do in HTML can be encapsulated in this control with limitless functionality.

Take Advantage of the Search Feature

Help your customers browse your website, the Internet and physical stores for information about your products right from within your app

Enhance Functionality with Javascript Plug-in

Further extend the Snappii platform features by enabling JavaScript plug-ins to create fully customized, enterprise mobile apps. For example, use in-app JavaScript to create custom database queries and registrations and integrate the app with other systems. It is also possible to add such features as image galleries, graphics, and animations with the existing JS/j Query plug-ins. Even simple games are available for adding into our mobile apps.

Incorporate Various Widgets into Your App

[Speed up app development by using widgets. Simply save pieces of your app and then re-use them in other apps. In addition, in the Snappii editor, you can find and use dozens of great widgets created by our team.

Take Advantage of the Data Collection and Reporting Options

Build apps to collect any type of data including text, numbers, dates, locations, images and more into a database. Access and modify information on demand. Share the stored data via social channels and network drives, email it or print it. Create ad-hoc queries for flexible reporting.

Enrich Your App with Custom Lists, Galleries, and Maps

Visualize data with custom lists, galleries and maps. Let users easily switch between the three viewing options.

Take Advantage of the Advanced Search Feature

Build 100% searchable apps where users can search for data with simple key words or complex Boolean logic based on multiple conditions and formulas. (if product=TV and price <500)

Share Content from Your App with Others

Share content from your app via social networks, email, text messages, Dropbox, Google Drive and print it out if needed.

Print Completed Reports Using the Share Button

There is no need to be at home or in the office to print your reports. Just complete a report, email it, and then print it.

Store Data on Network Drives

Collect data and store it on such network drives as Dropbox, Box or Google Drive and MS OneDrive.

Auto-Generate Custom PDF Reports

Simply upload any existing PDF template or create it from scratch, and your app will automatically generate the PDF reports you need.

Take Advantage of Condition-Based Visibility

Show and hide, enable and disable elements, buttons and pages in your app when needed. Here are the questions you will need to answer to do so.

Would you like some additional fields appear on a form if a question is answered correctly?

Do you want a button to be only available for this specific user?

Do you need a page to be Green for Yes and Red for No?

Save Time with the Data Selection Features

Enhanced data selection features allow you to pre-fill and auto-populate forms in your app. Select information you need from the database, and the selected fields will be instantly auto-populated. Create relationships between fields and enable convenient multiple-choice options.

Make Use of Hundreds of Pre-Built, Easy to Use and Customize Business Apps

We have created over 80 business apps on Snappii's codeless platform. You can modify any of them yourself in the Snappii WYSIWYG Editor or have us customize it for you.

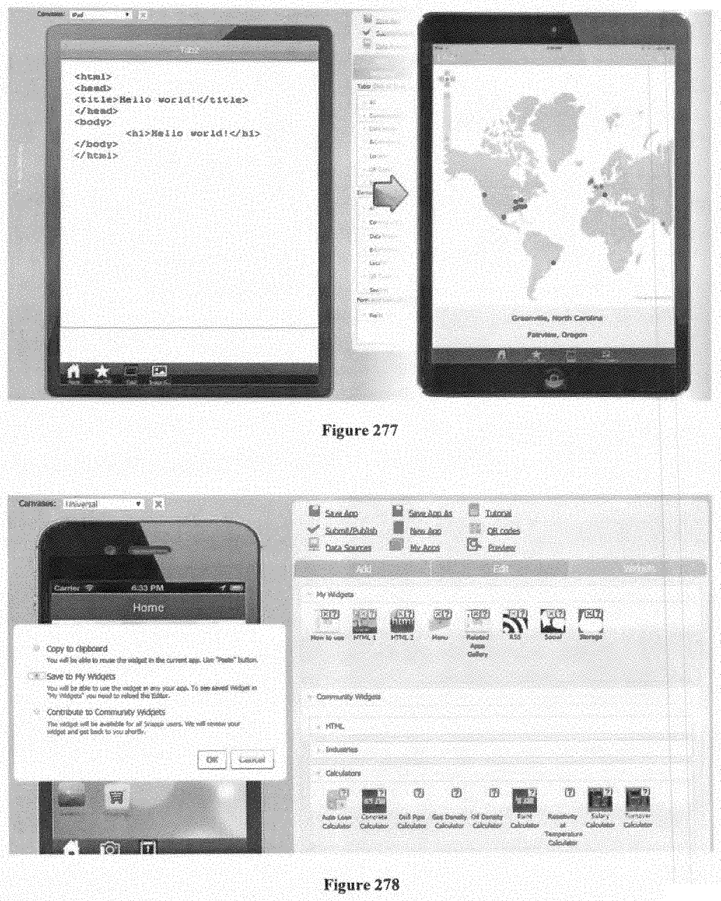

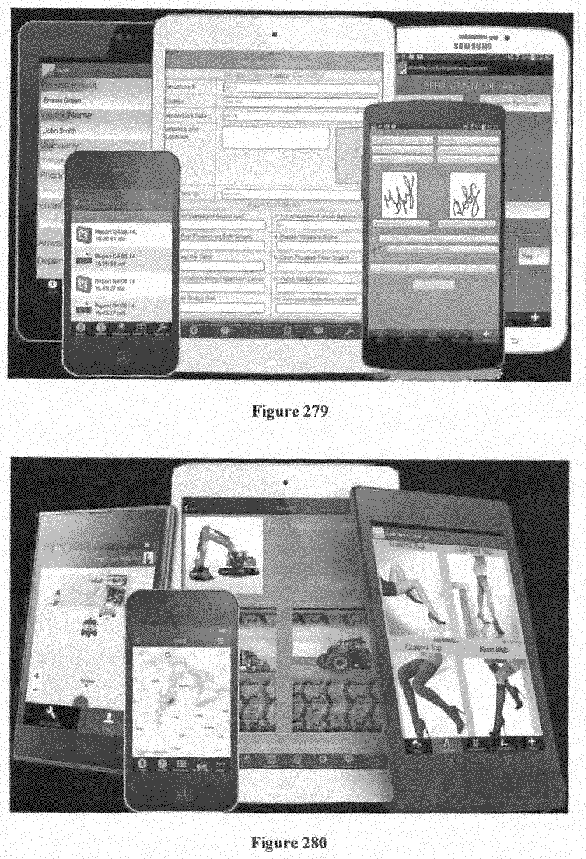

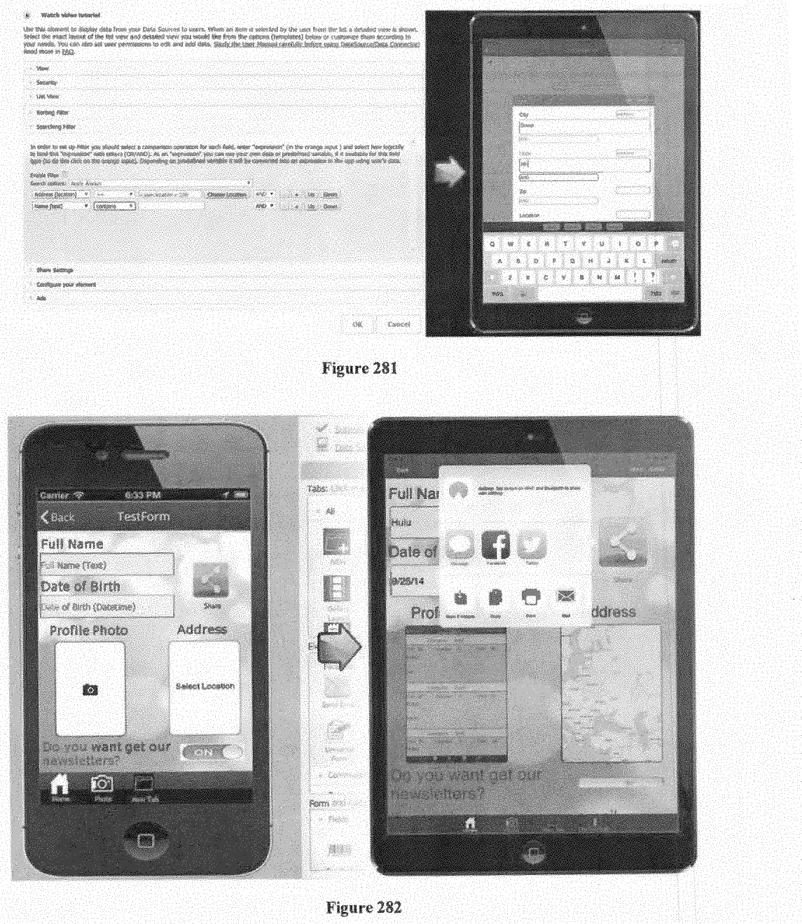

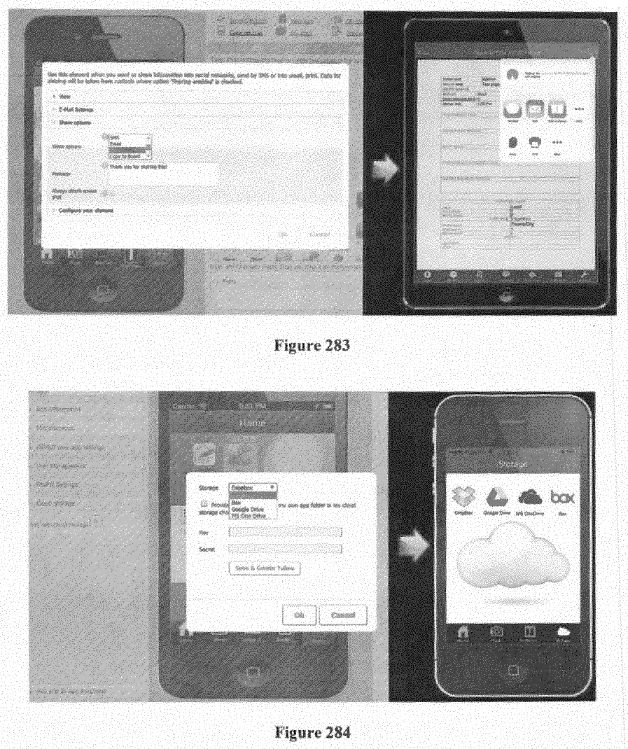

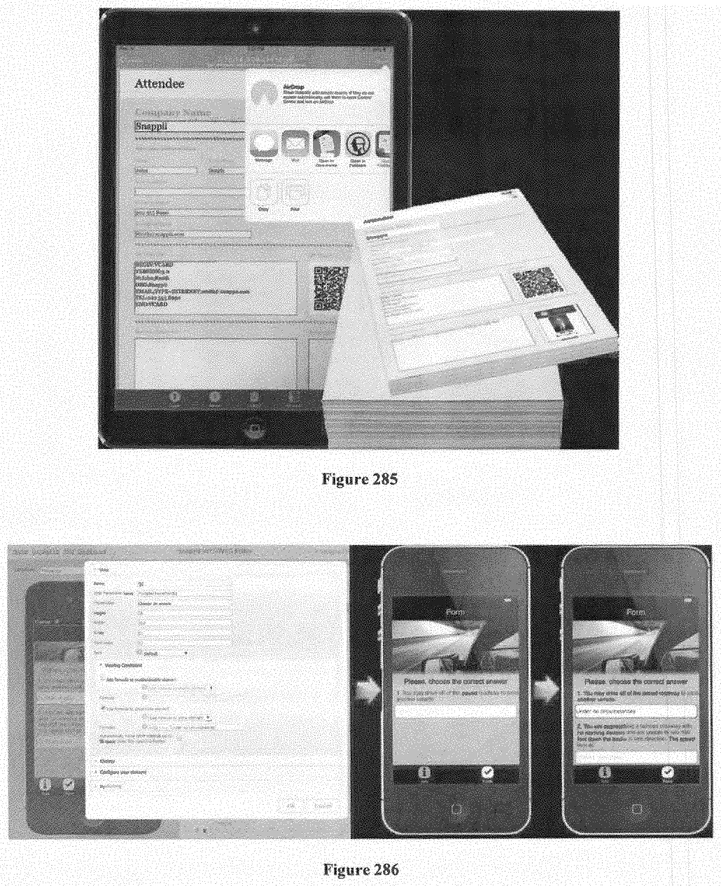

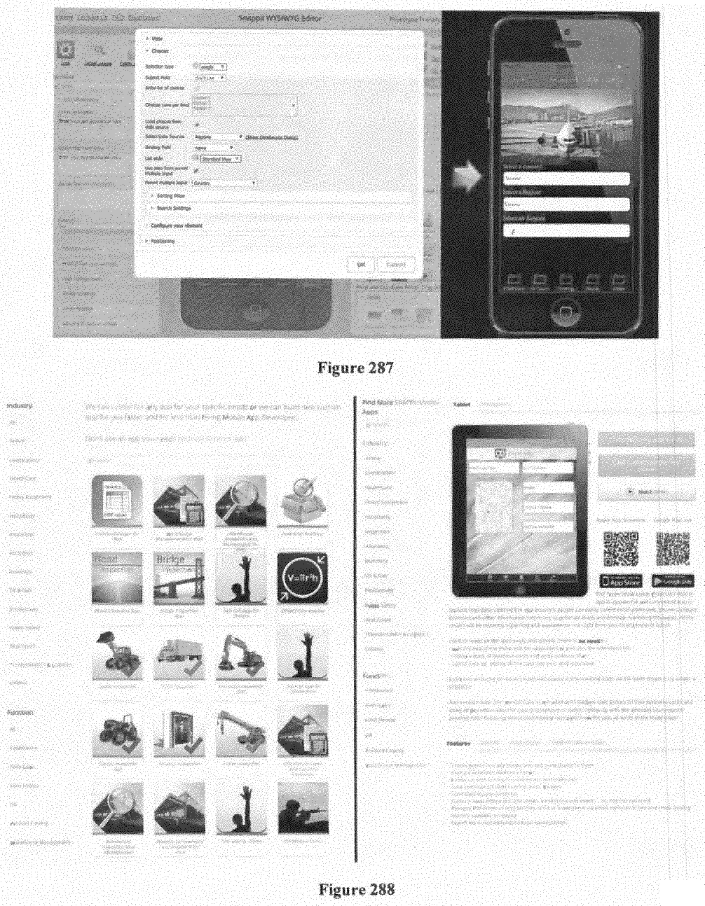

Referring to examples of FIGS. 289-294, exemplary implementations of embodiments of the present disclosure provide additional features as follows.

This screen shows hoe users can search over 250+ premade app templates

This is the main screen of App Editor. From here you can “edit” any pp. This mean s configure any tab and add new tabs to add new functionality.

The next screen shows how user can add over 200 premade and configurable tabs to extend app functionality.

The next screen shows how to configure each tab.

The next screen shows Express Form Editor used to create and edit forms.

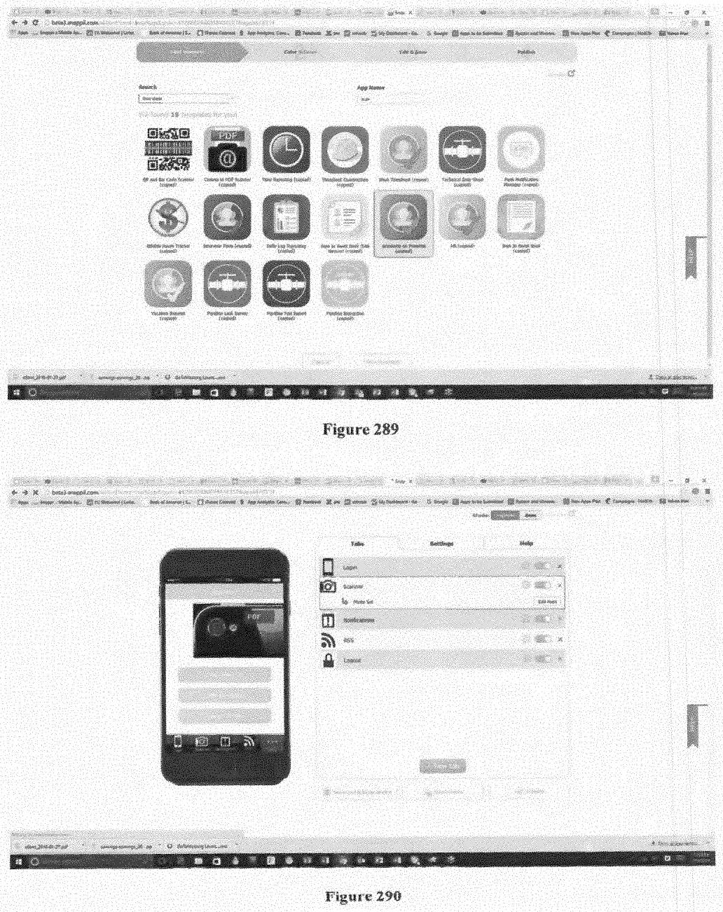

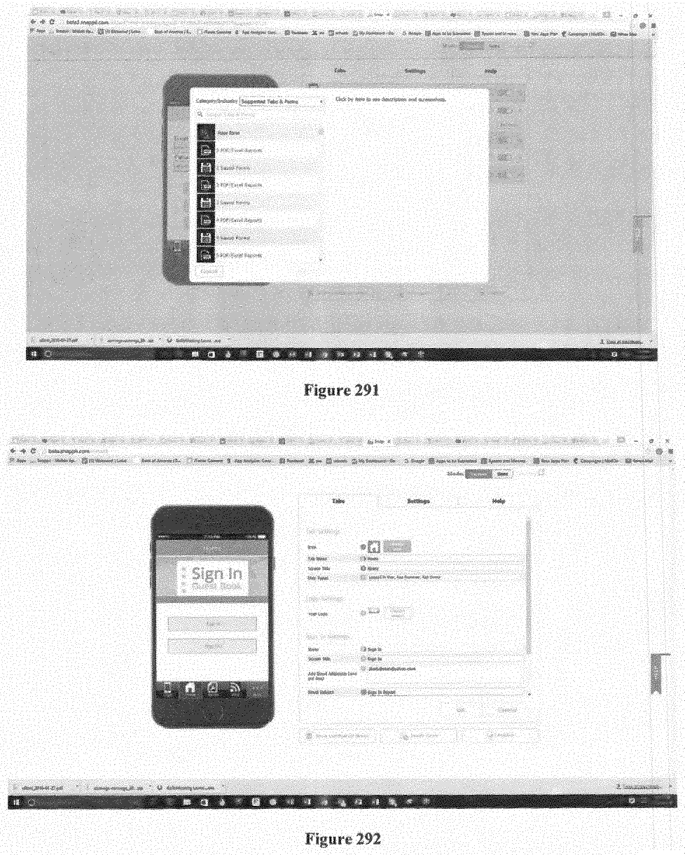

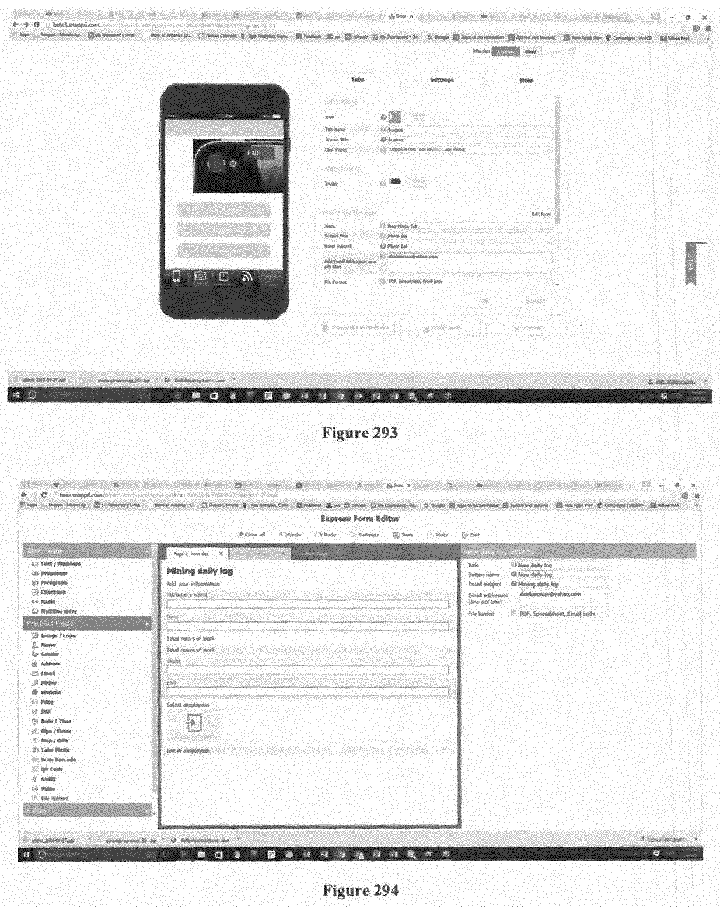

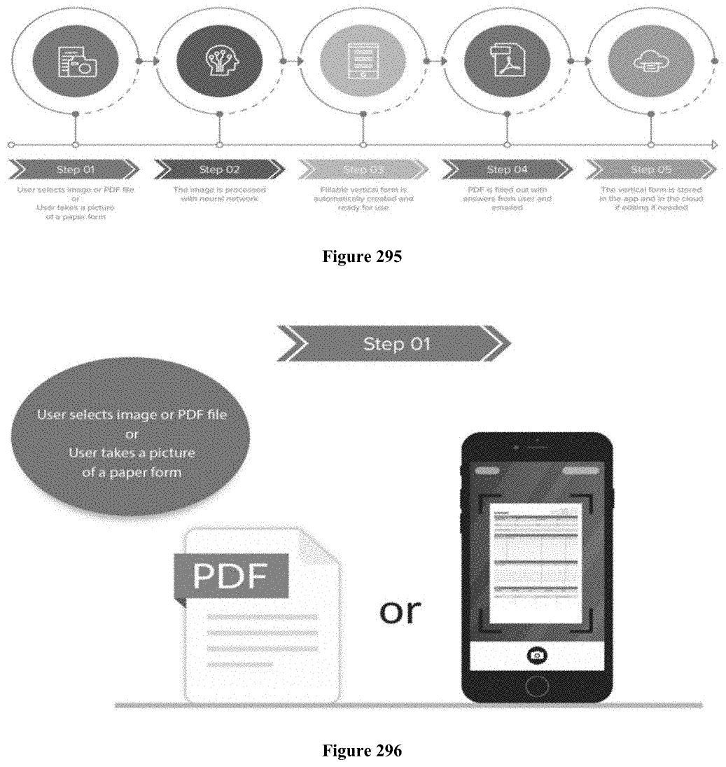

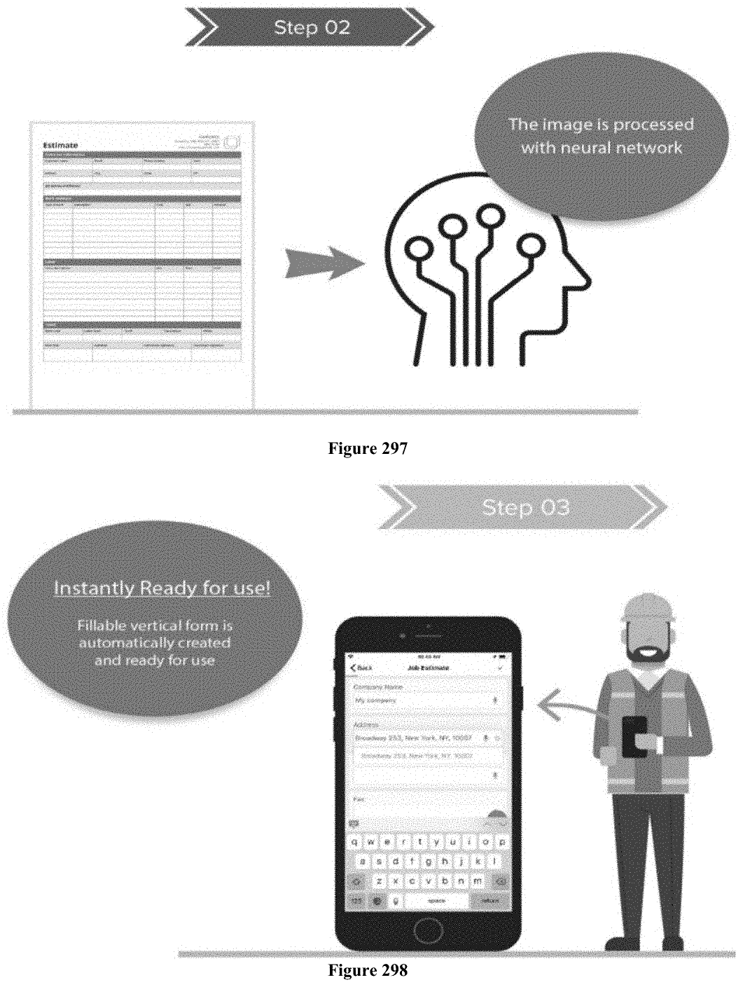

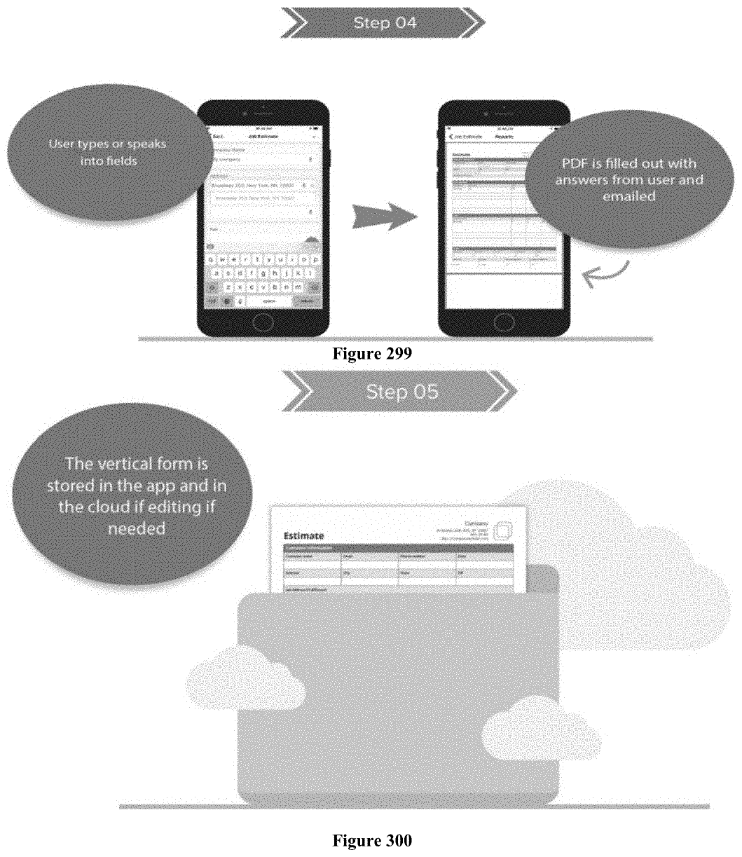

Referring to FIGS. 295-300, yet another exemplary implementation of the disclosed exemplary embodiments provides digital document processing to facilitate conversion from paper to app according to exemplary steps 1 through 5 as shown. Still further exemplary implementation can also employ and/or provide tools such as OCR to facilitate app creation from written documents and/or forms and/or digital images thereof. As shown in in FIGS. 295-300, a deep learning approach can be applied automate form conversion process and enable instant digital conversion. According to exemplary implementations, forms can be automatically converted into IOS and Android Apps, Apps can be extended without coding, and platform for DIY and professional services can thereby be provided.

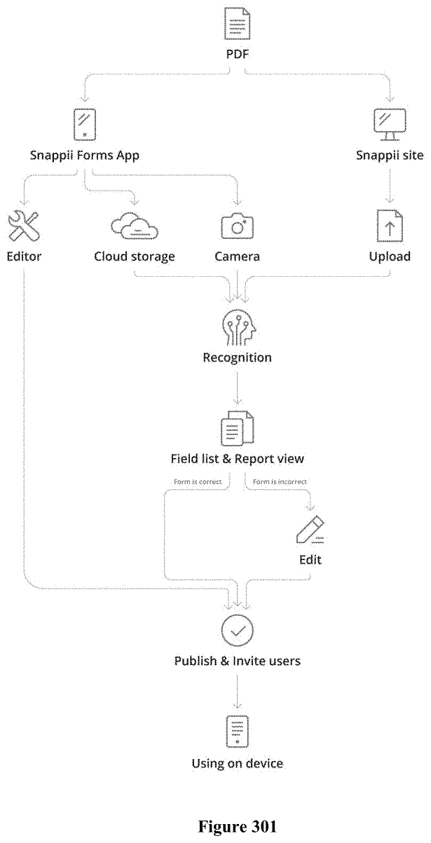

Referring to FIG. 301, an exemplary methodology according to embodiments of the disclosure provides various options and scenarios that are can be followed when using optical field recognition technology according to the disclosure.

Website Upload

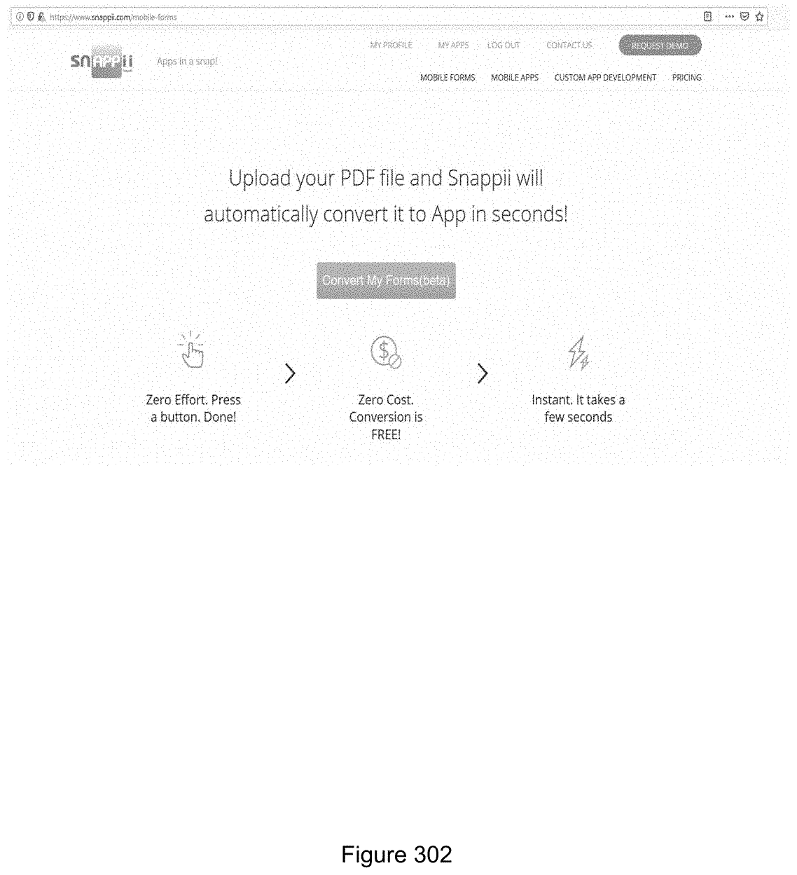

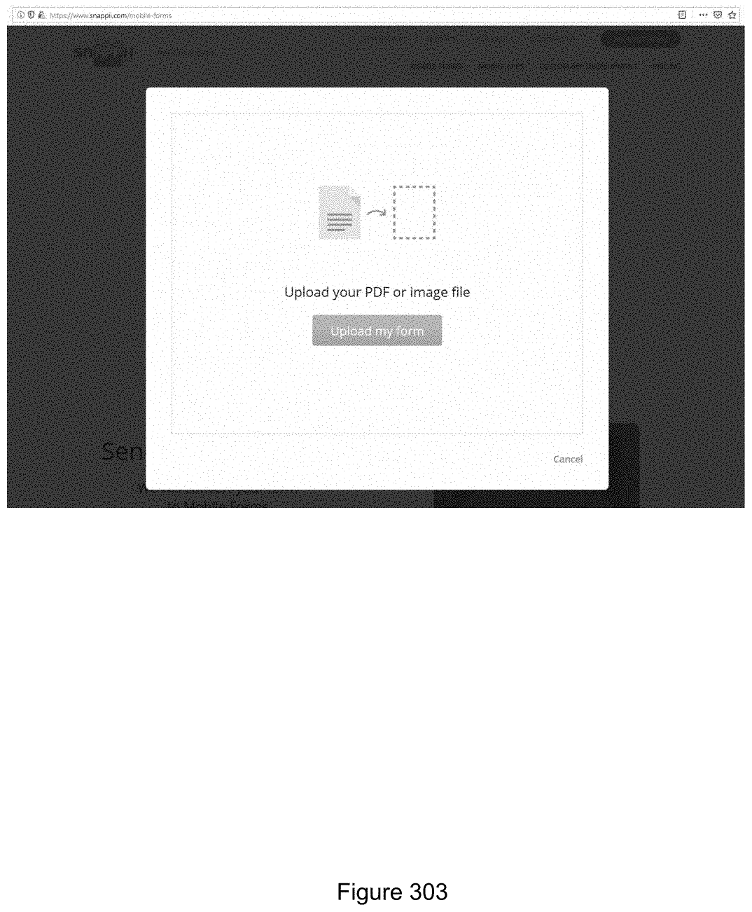

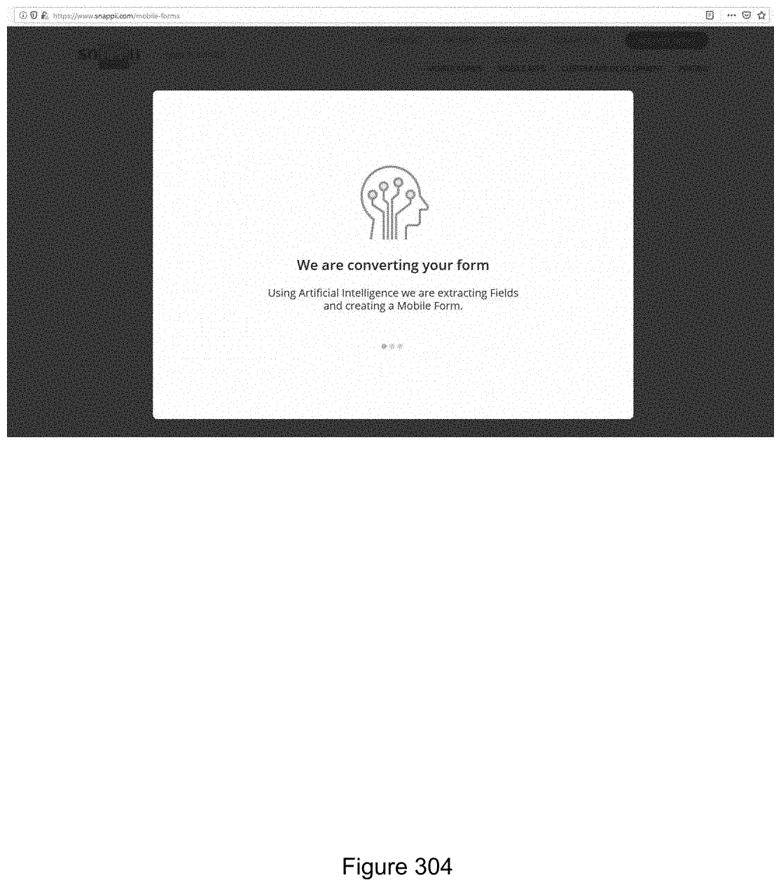

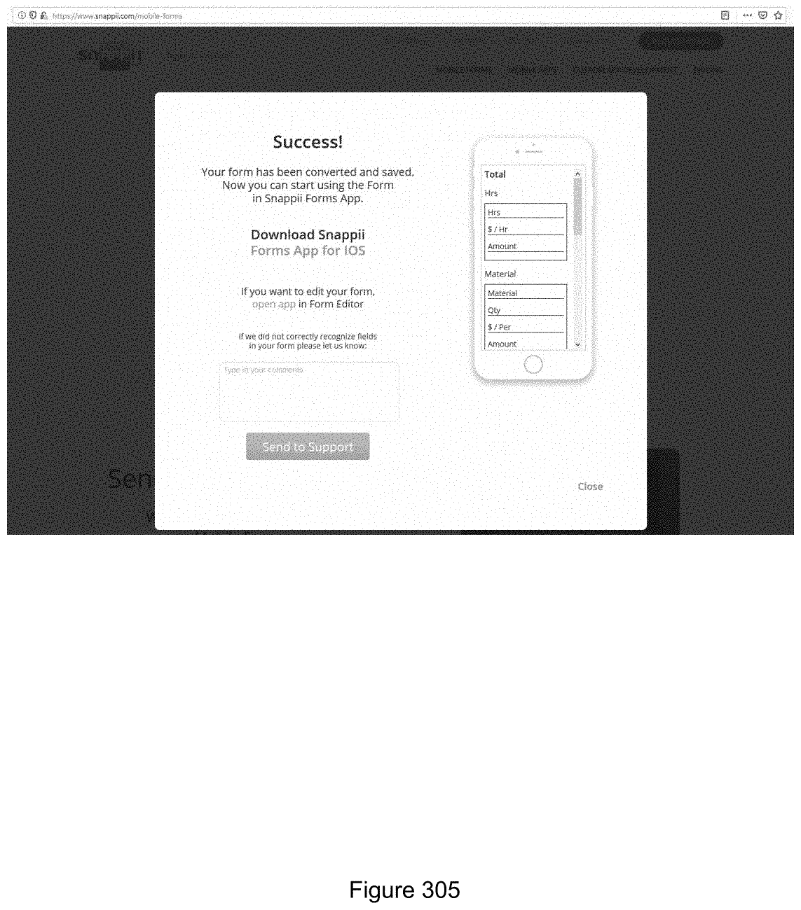

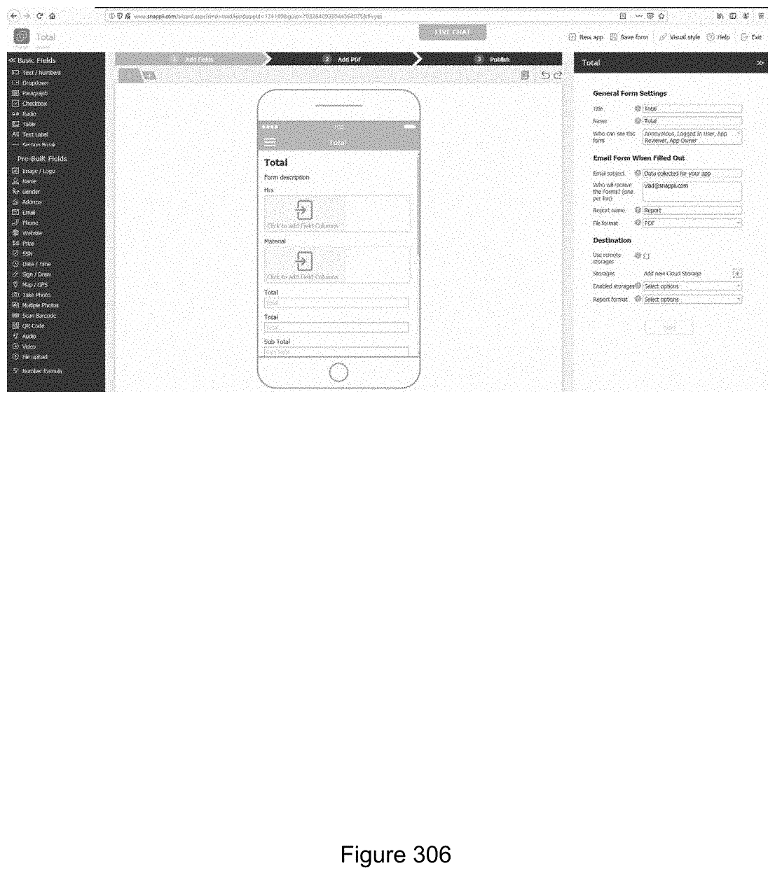

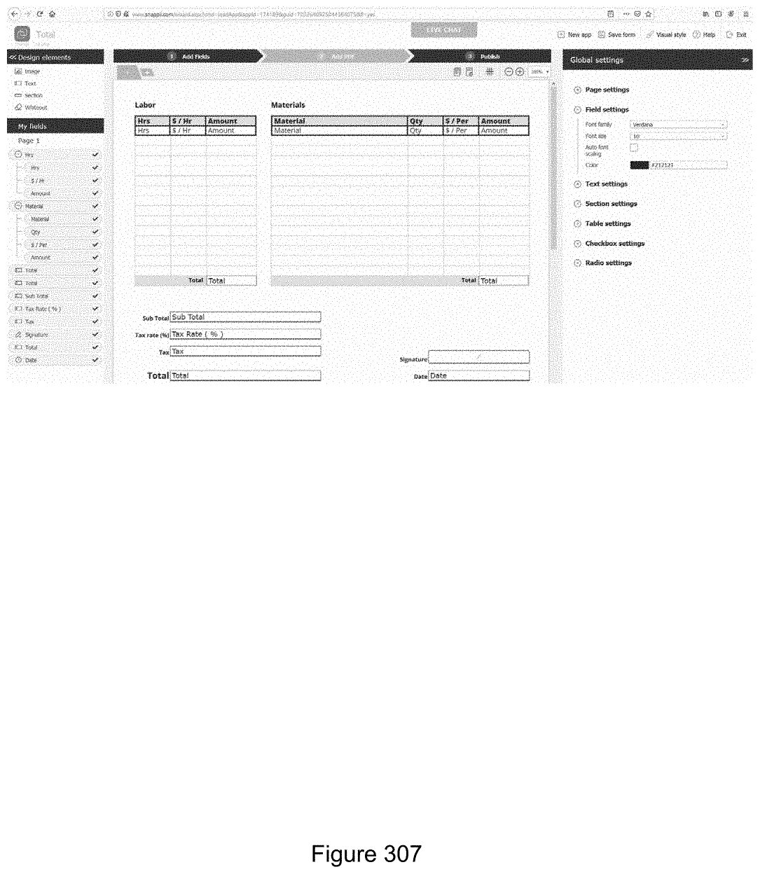

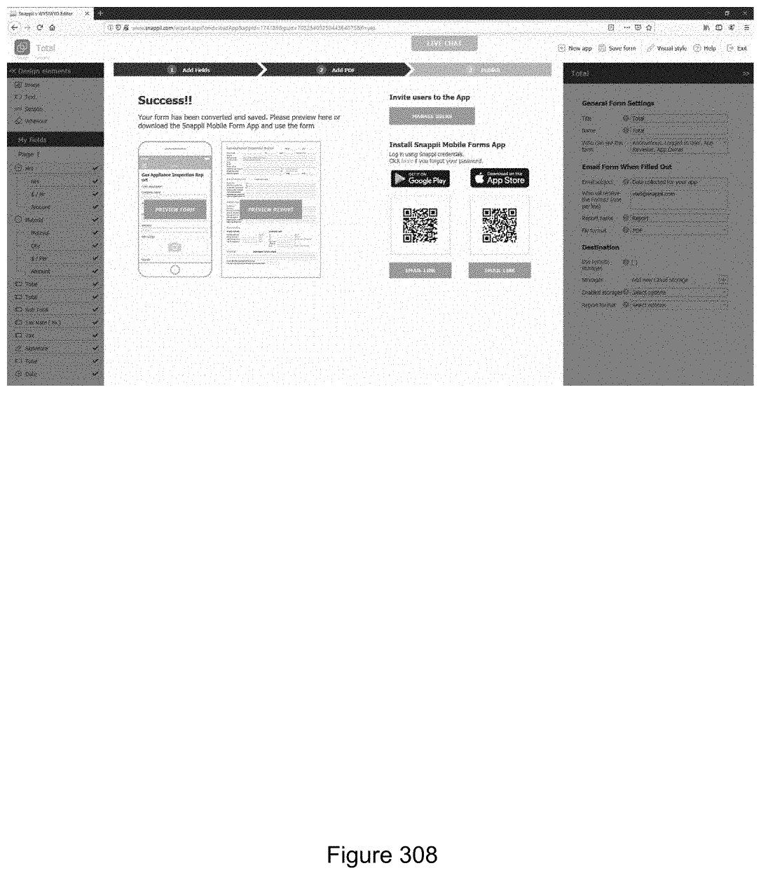

For example, referring to FIGS. 302-308, a user can select and upload any PDF or image form file from a desktop. OFR will complete the form recognition in a few seconds and show a quick preview of the form. At this point user can download the Snappii Mobile Forms app from Google Play Store or Apple Appstore to view and use same form from a mobile device right away or open it in the Snappii Form Converter on the website for further modifications.

In the Form Converter user can go thru 3 steps:

1. Add/Edit and Delete Fields

In the menu on the left there is a list of various field types including:
Text/number
Dropdown
Paragraph
Checkbox
Radio
Table
Text label
Section break
Image/Logo
Name
Gender
Address
Email
Phone
Website
Price
SSN
Date/Time
Sign/Draw
Map/GPS
Take Photo
Multiple Photos
Scan Barcode
QR code
Audio
Video
File Upload
Formulas
   Any of the fields above can be quickly and easily added to the existing mobile form with a click of a button. Existing fields can be deleted or edited on demand. User can copy existing fields and reorder them.

2. Modify PDF Output

Here user can make PDF output corrections/adjustments and place new fields to any desired position in the screen.
As extra design tools user can choose from:
Text
Whiteout
Image
Section

3. Publish and Share the Form

Here user can preview the complete form and PDF output as well as invite users to see that form by installing same Snappii Mobile Forms app

Device Upload

A scenario similar to the Website upload is applicable from a mobile device in the Snappii Mobile Forms app.

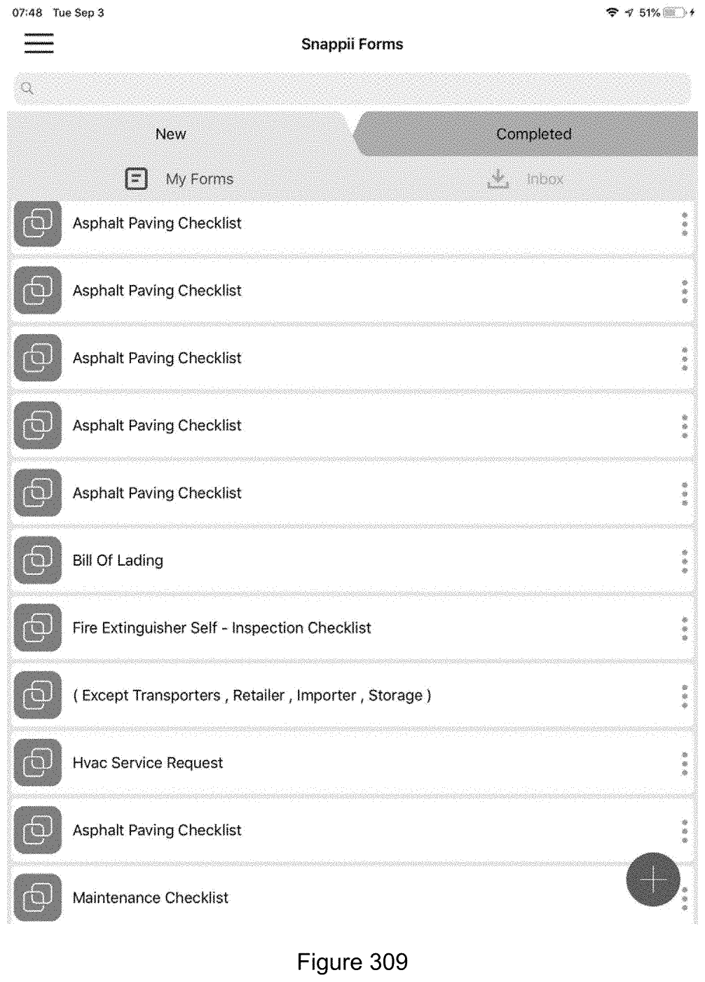

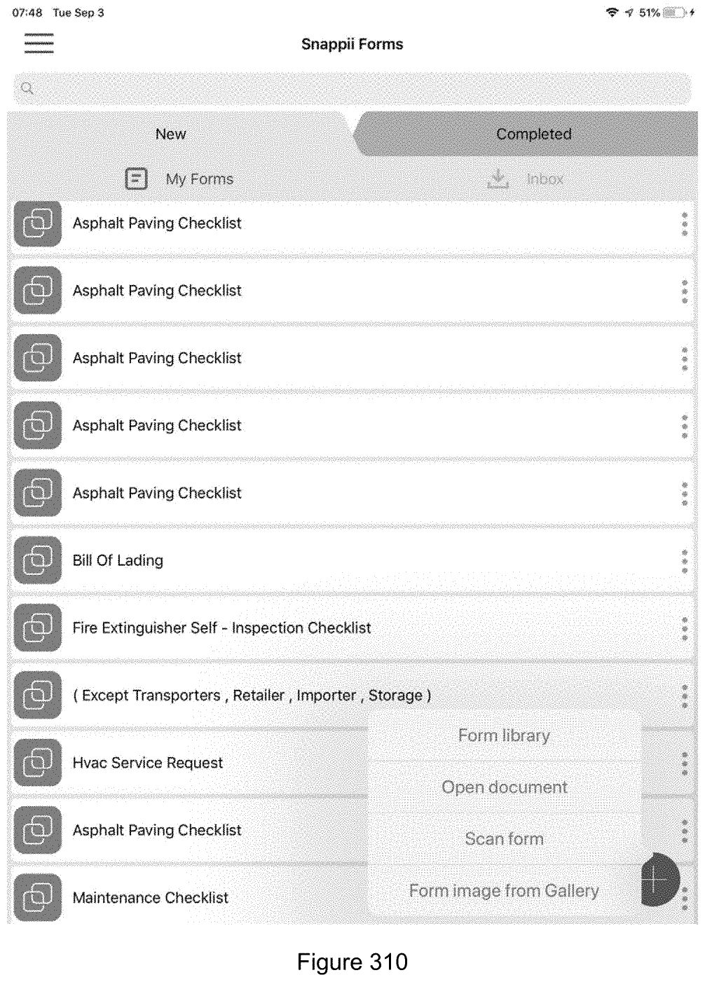

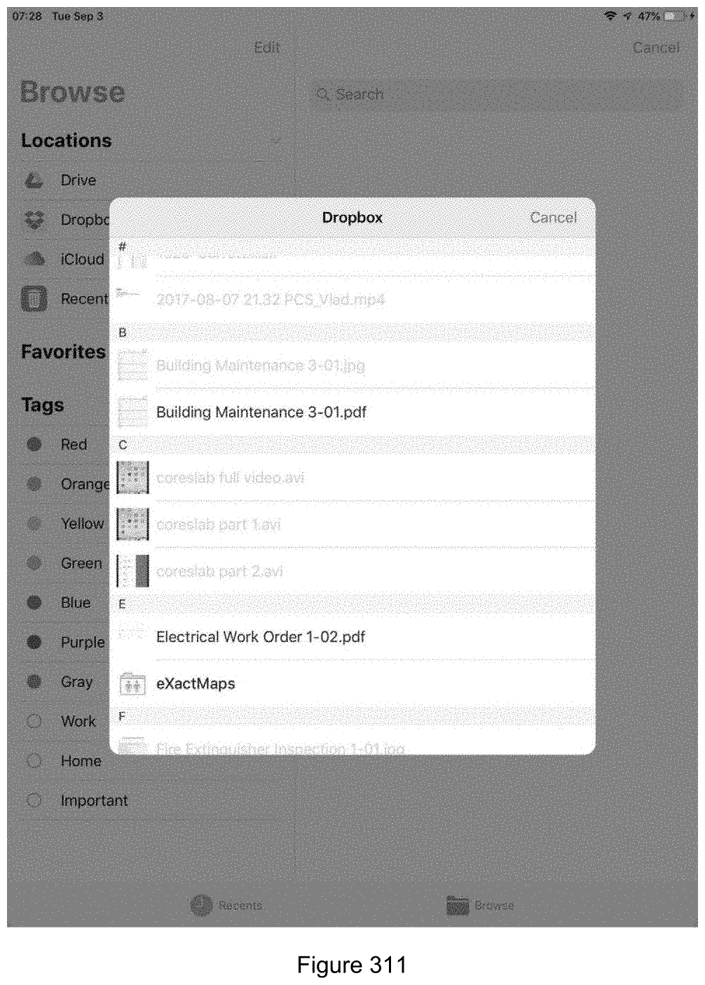

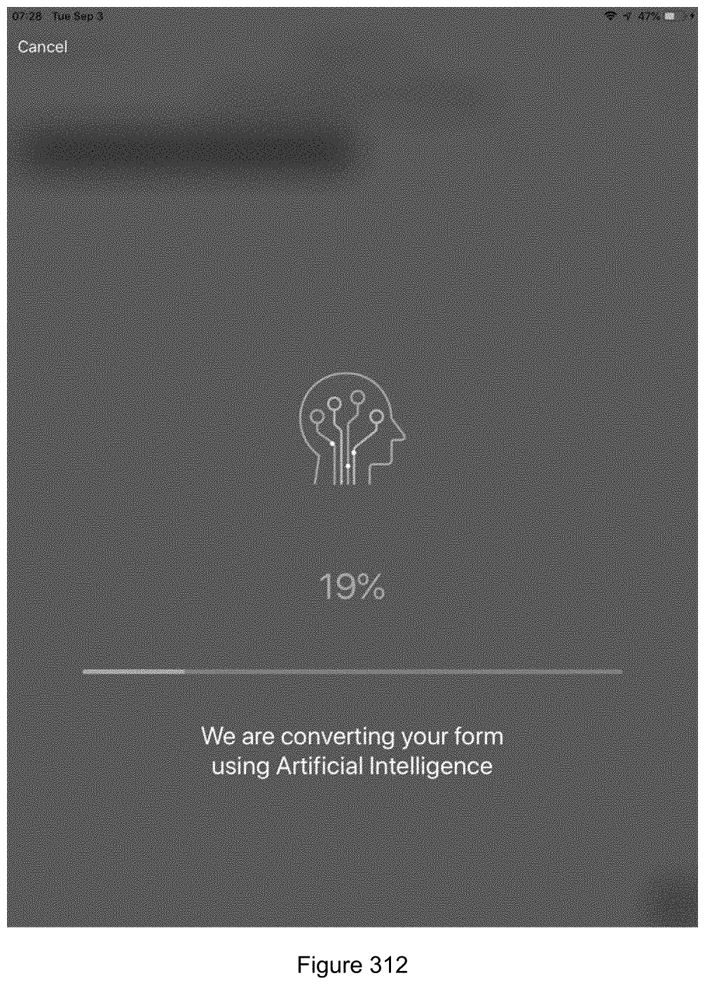

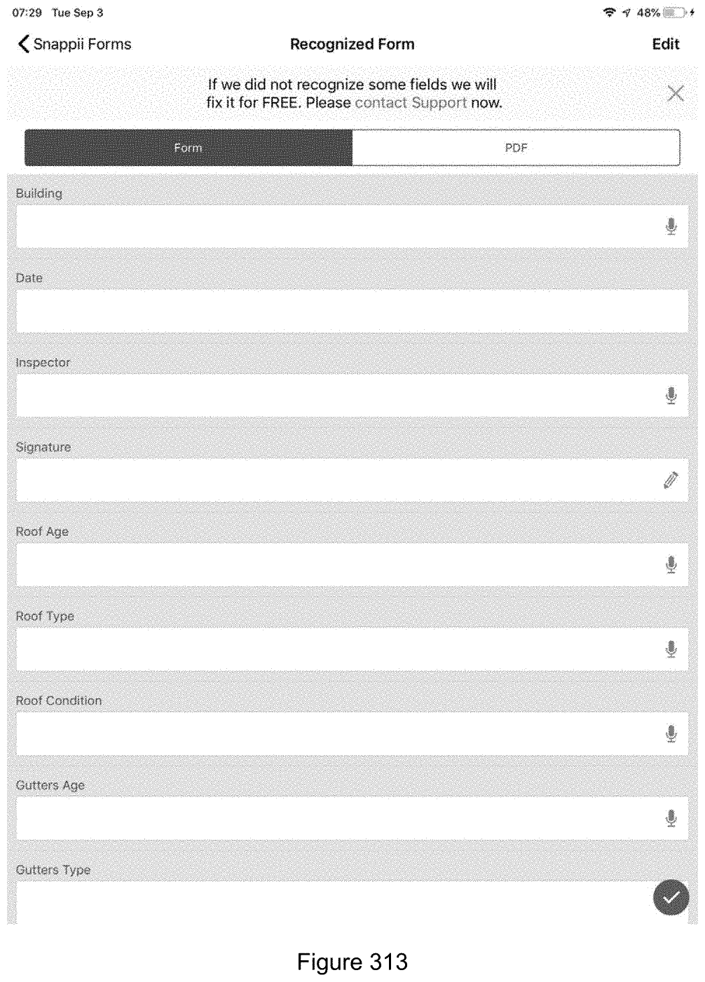

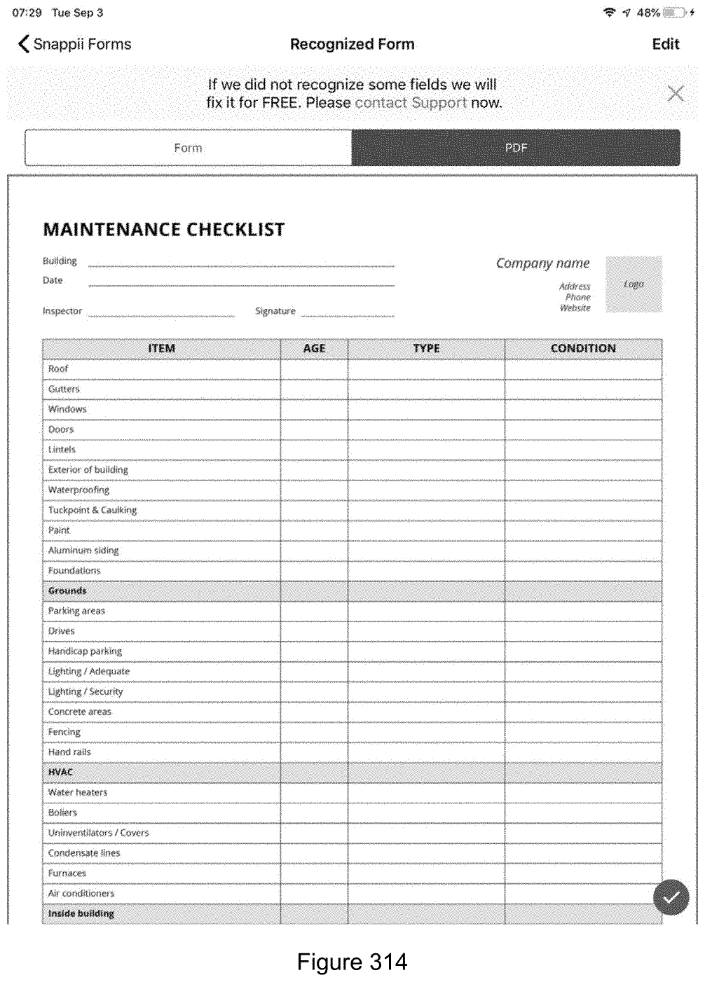

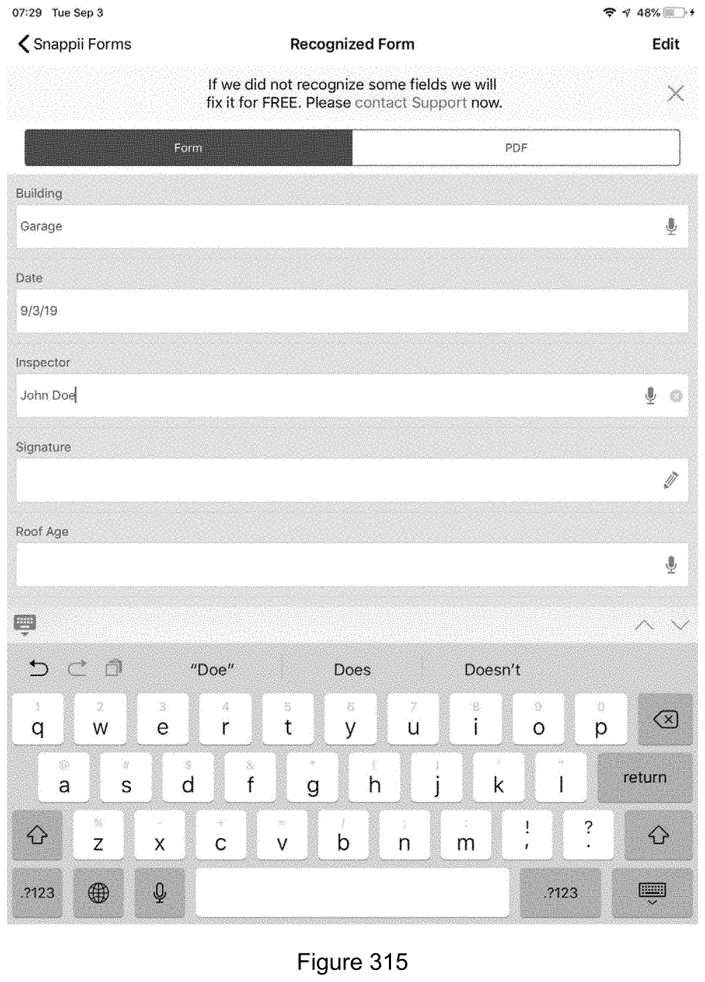

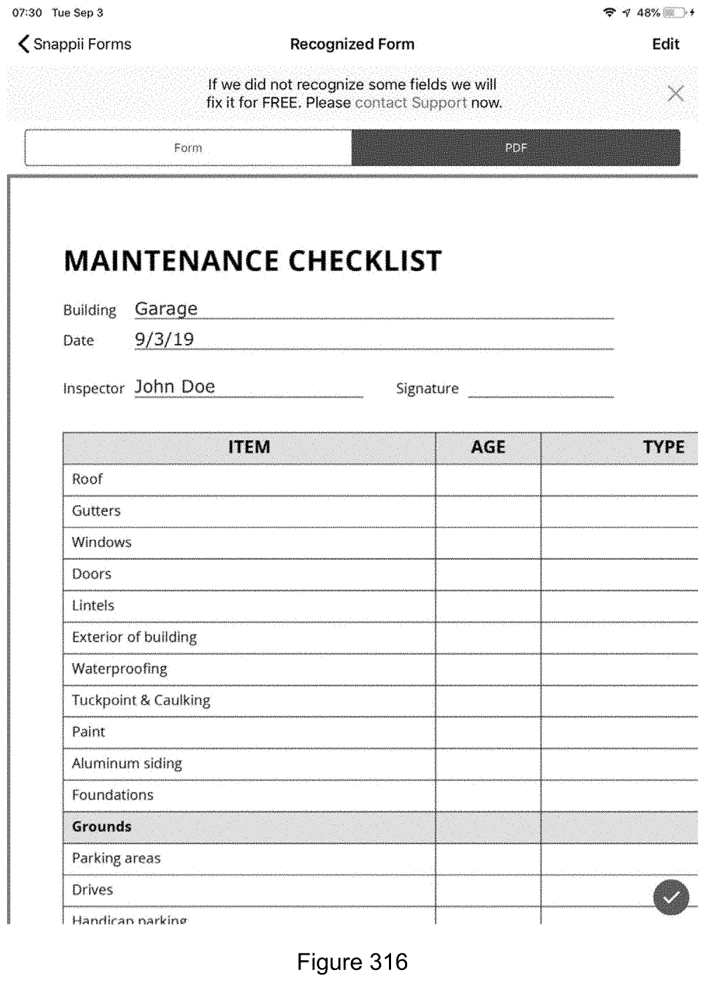

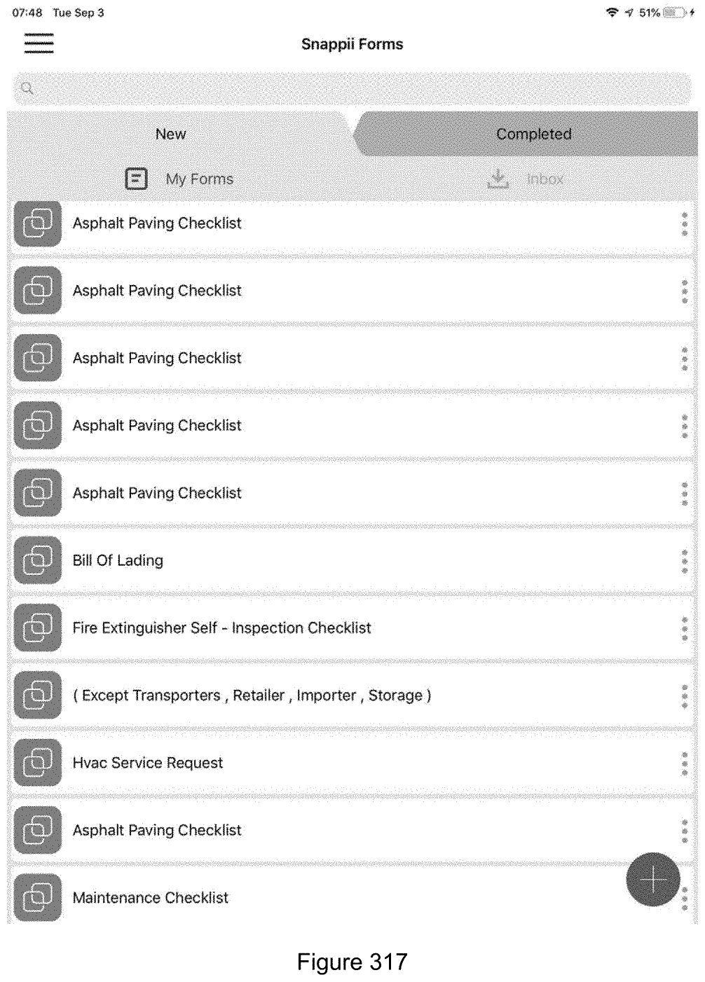

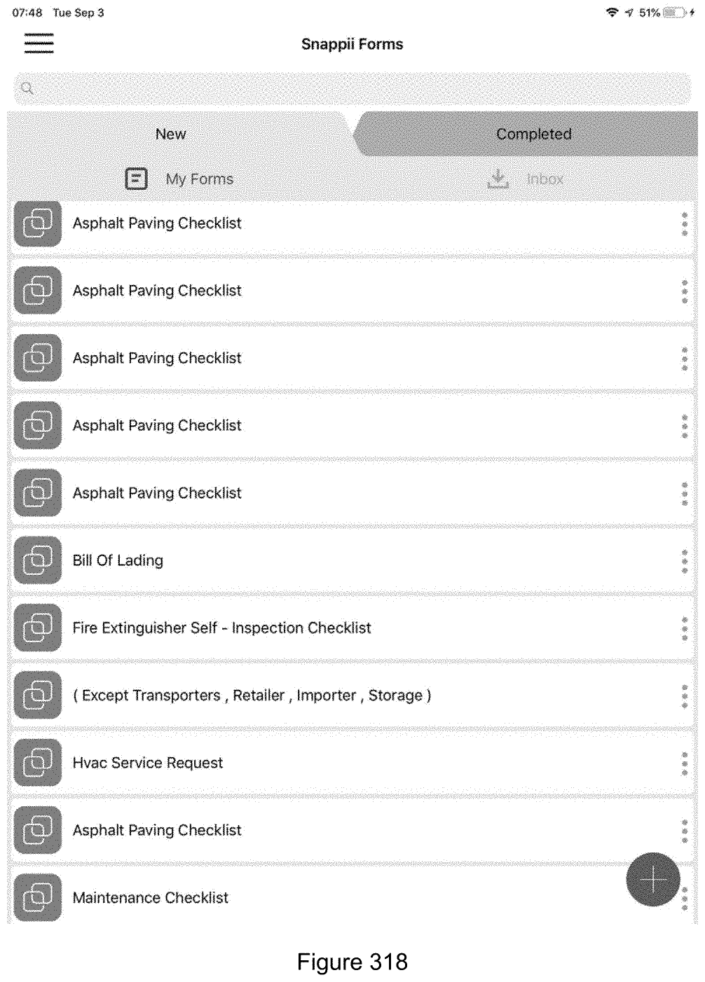

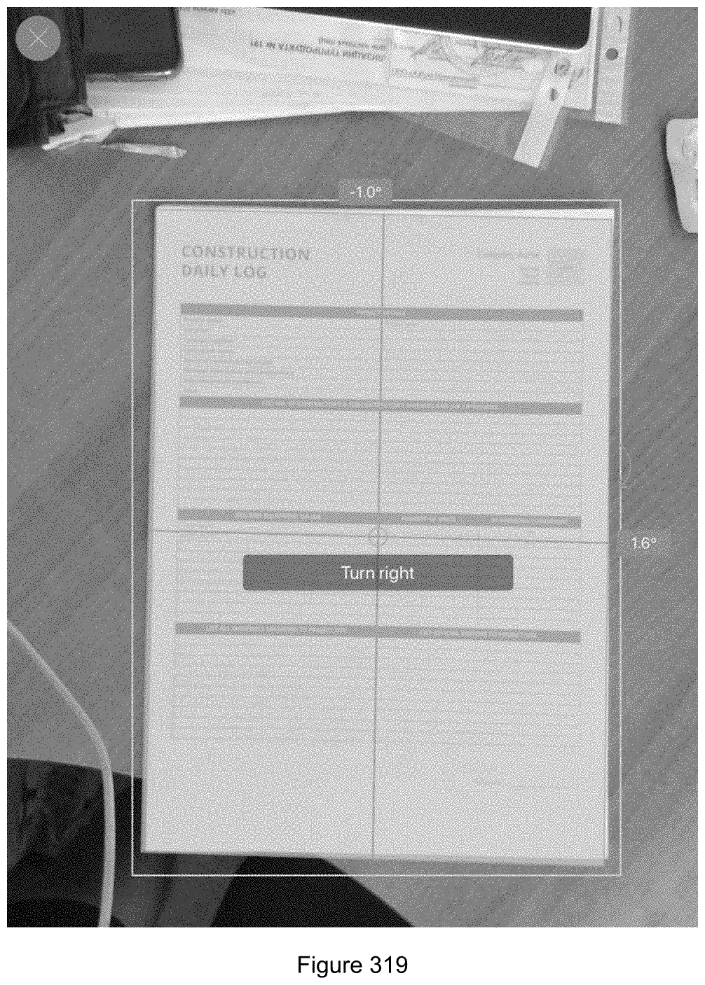

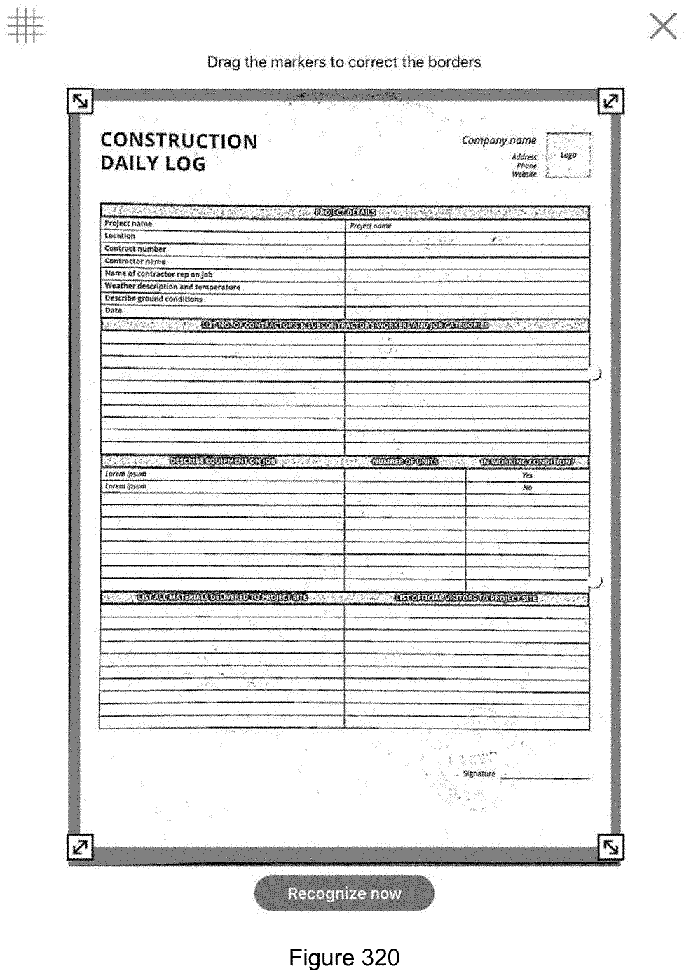

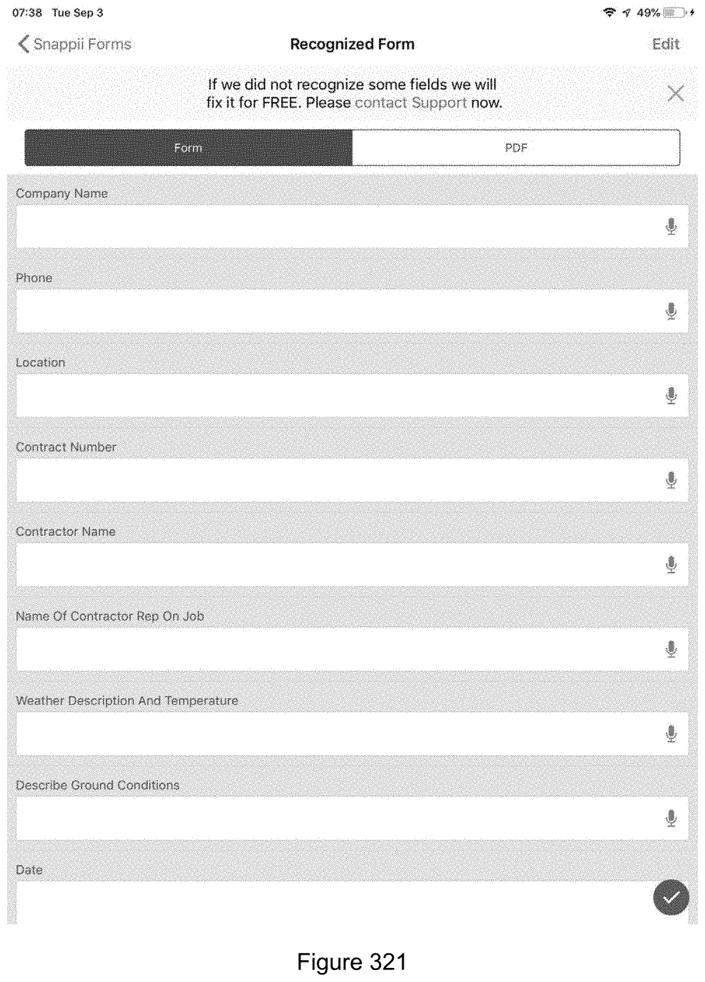

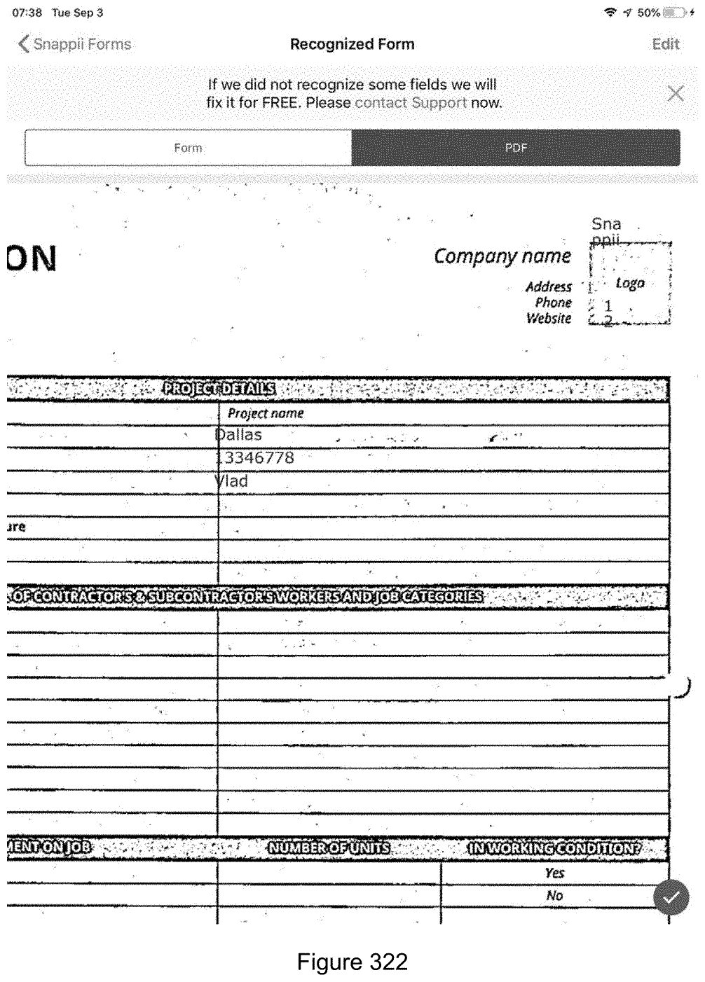

Referring to FIGS. 309-316 and 317-322, user has an option to load a form from Snappii library or upload his own form from a cloud storage or take a new picture by using a smartphone or tablet camera. OFR will complete the form recognition in a few seconds and show a quick preview of the form.

After upload and recognition there will be 2 tabs at the top of the screen; one of them will allow user to preview the mobile friendly form and fill it out while the second tab will present the actual PDF output with the input from tab #1. User can switch back and forth between both modes and the PDF side will reflect all changes that user makes in real time.

Form Editing

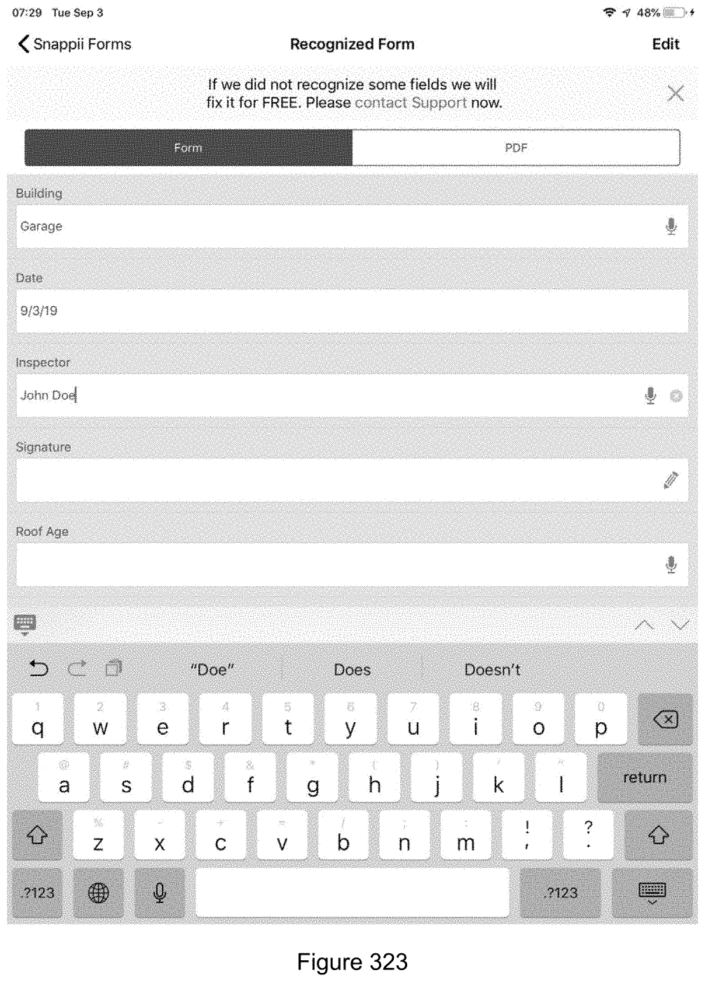

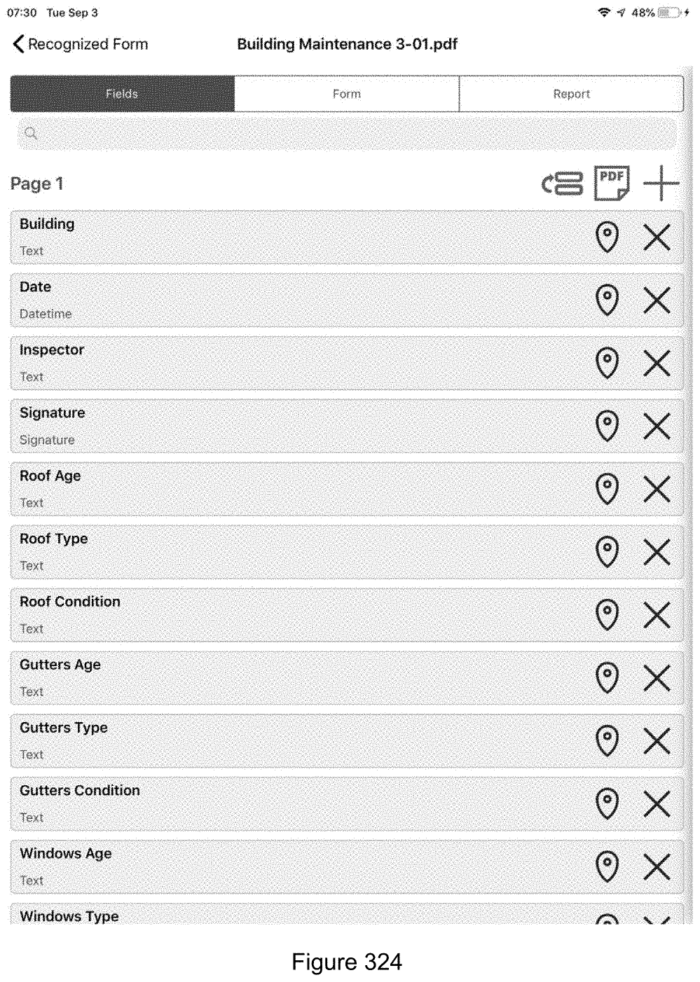

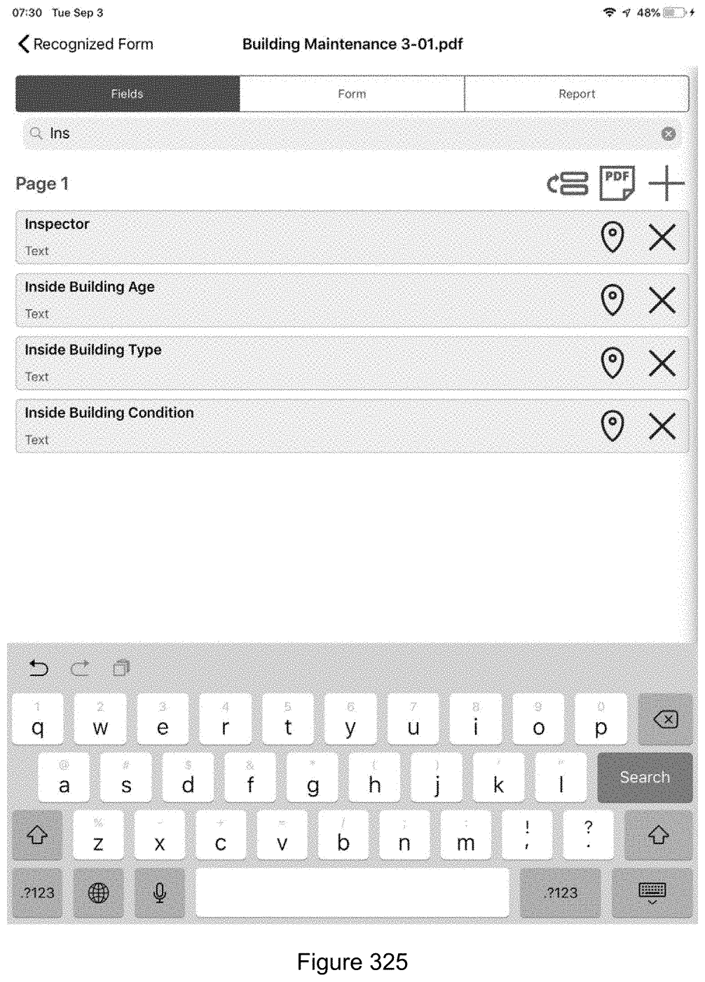

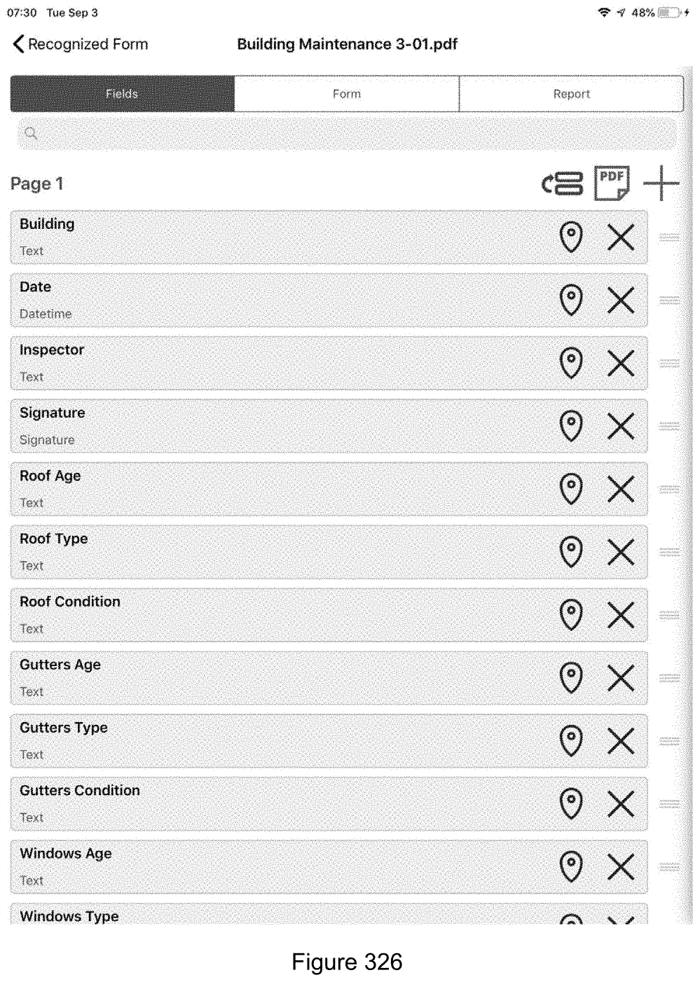

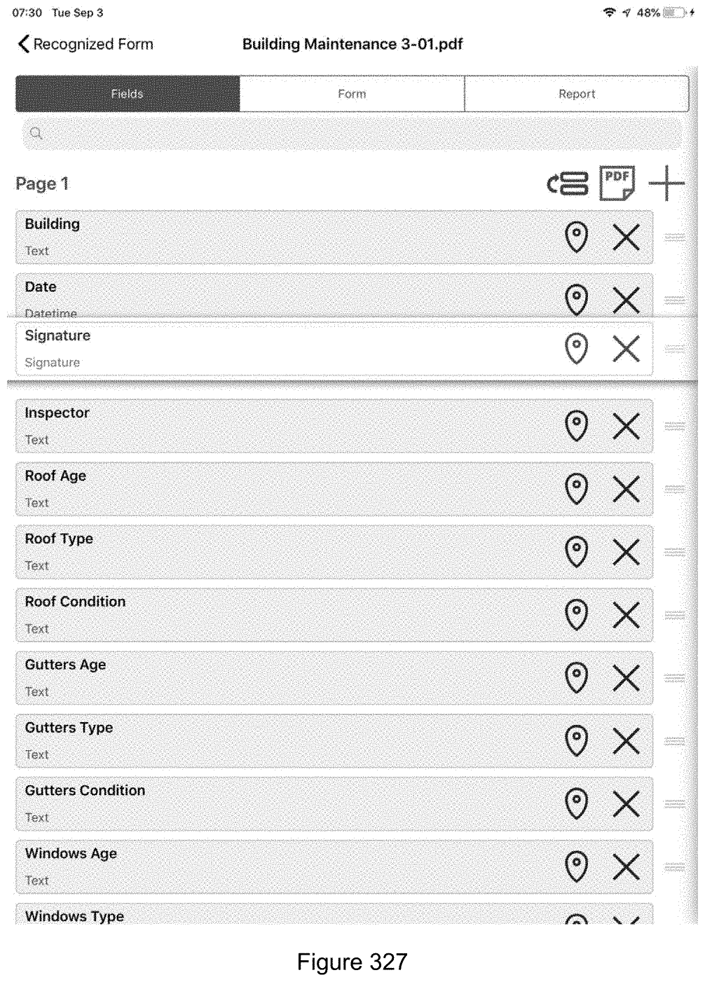

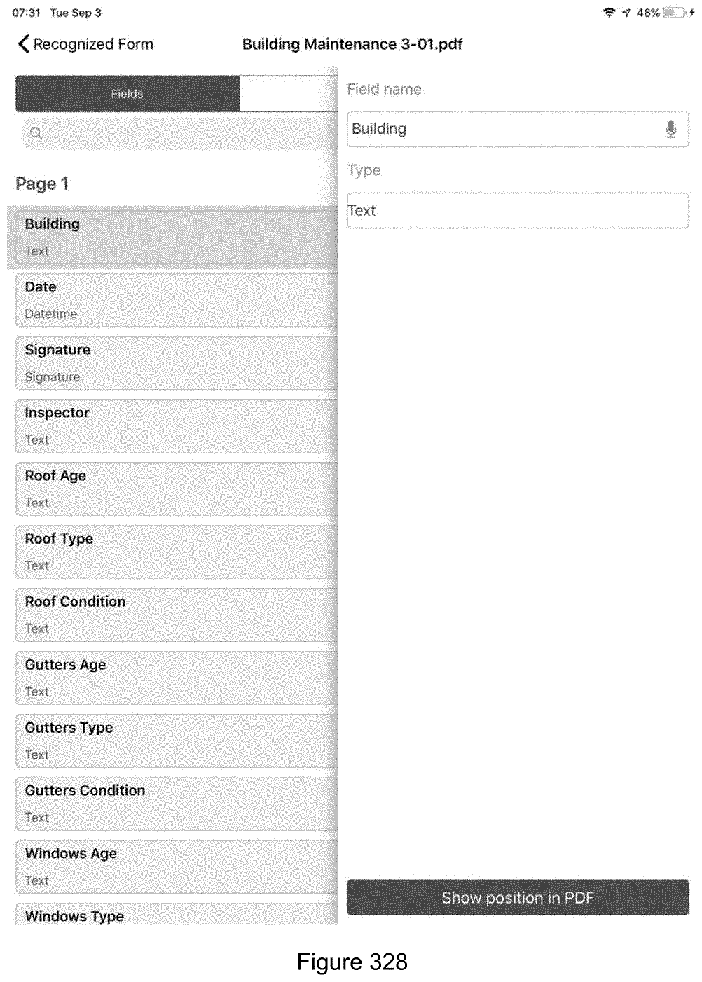

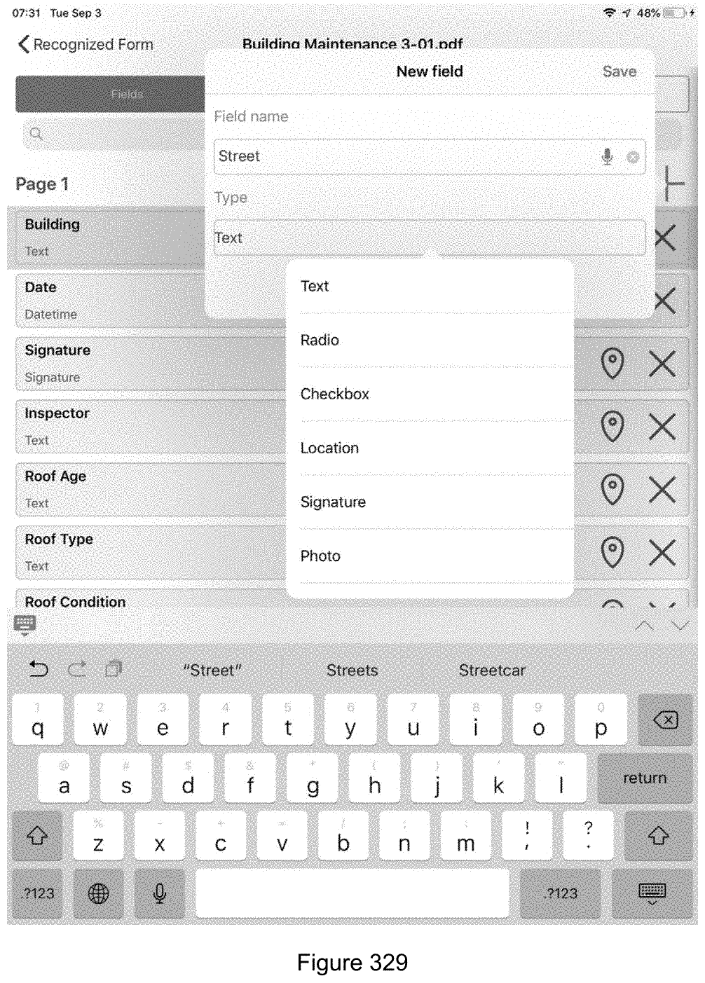

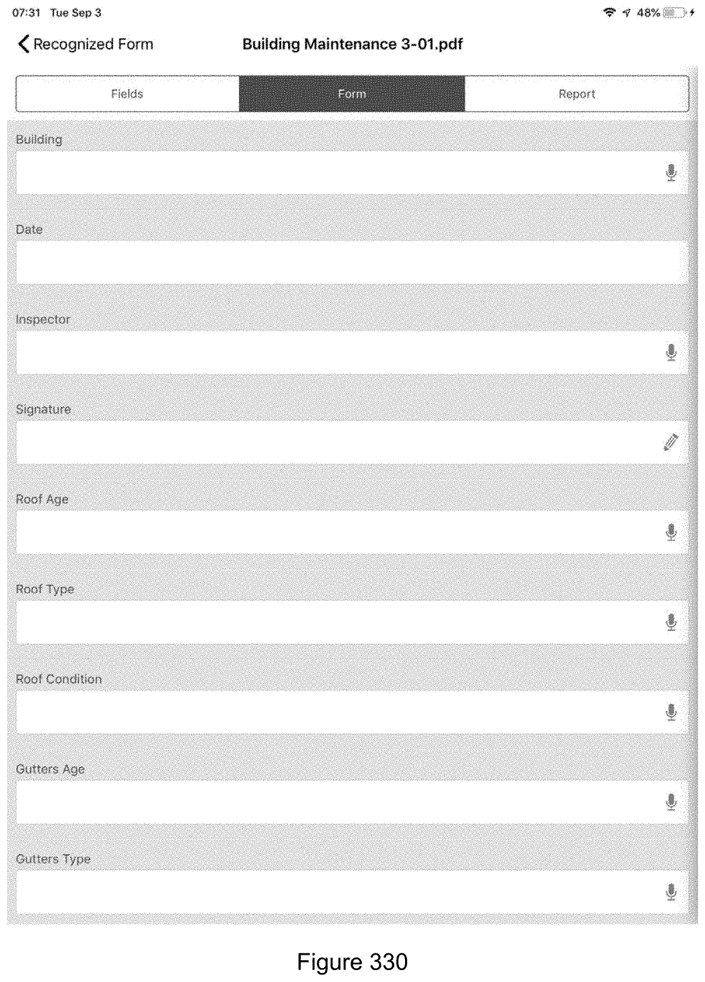

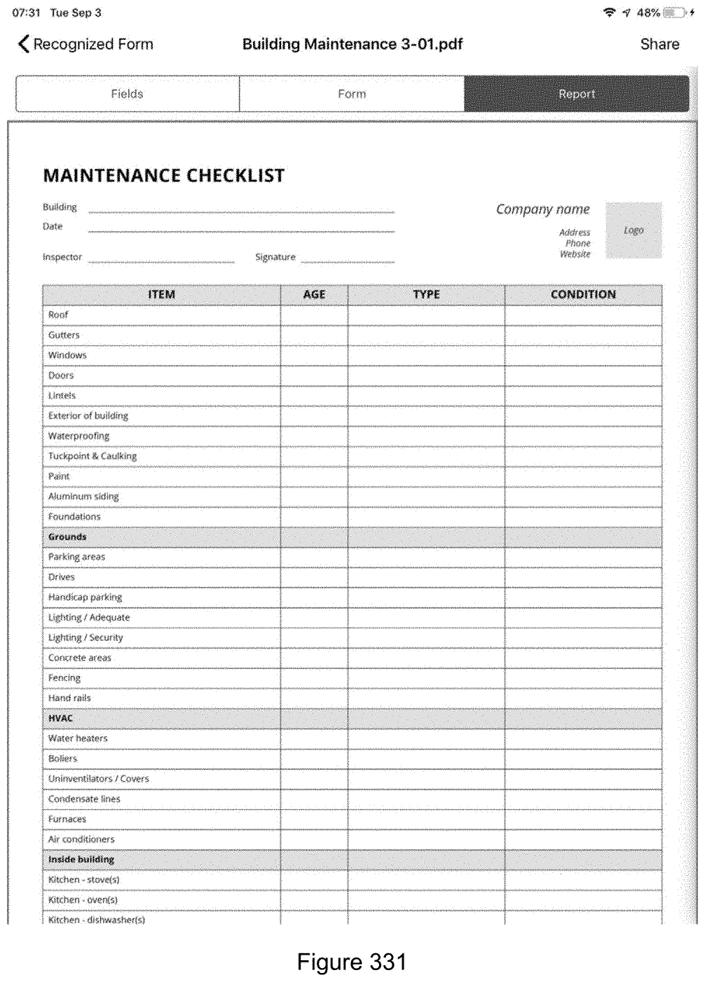

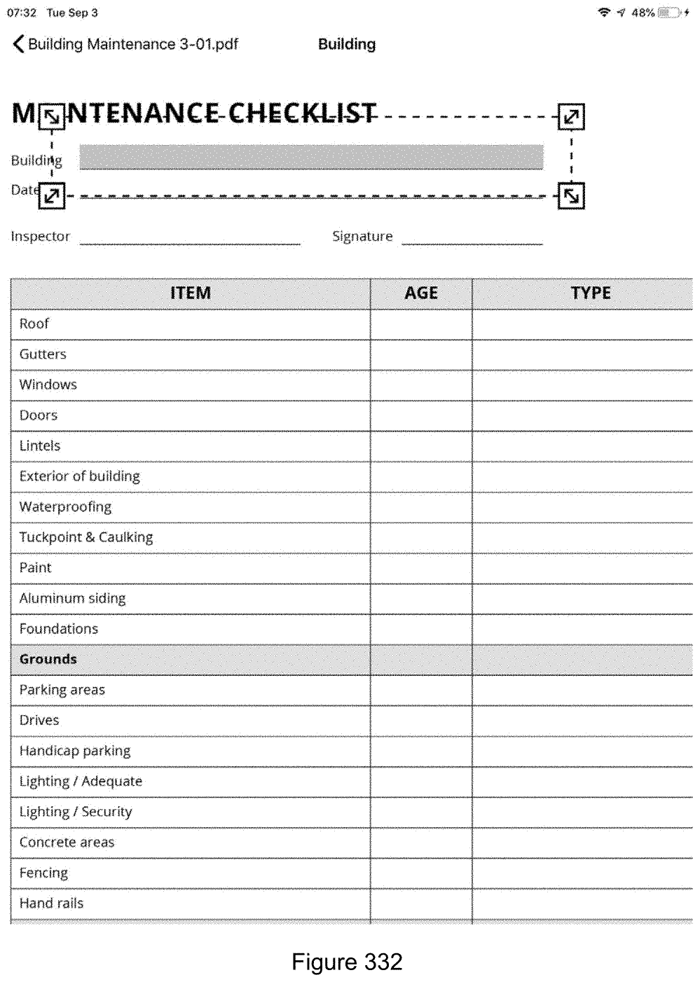

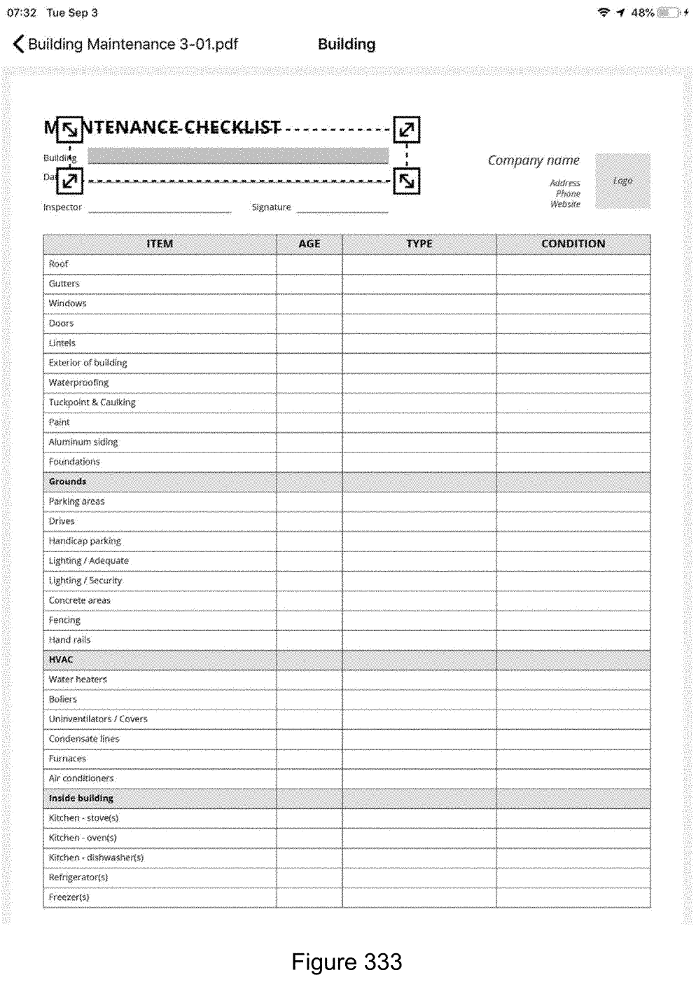

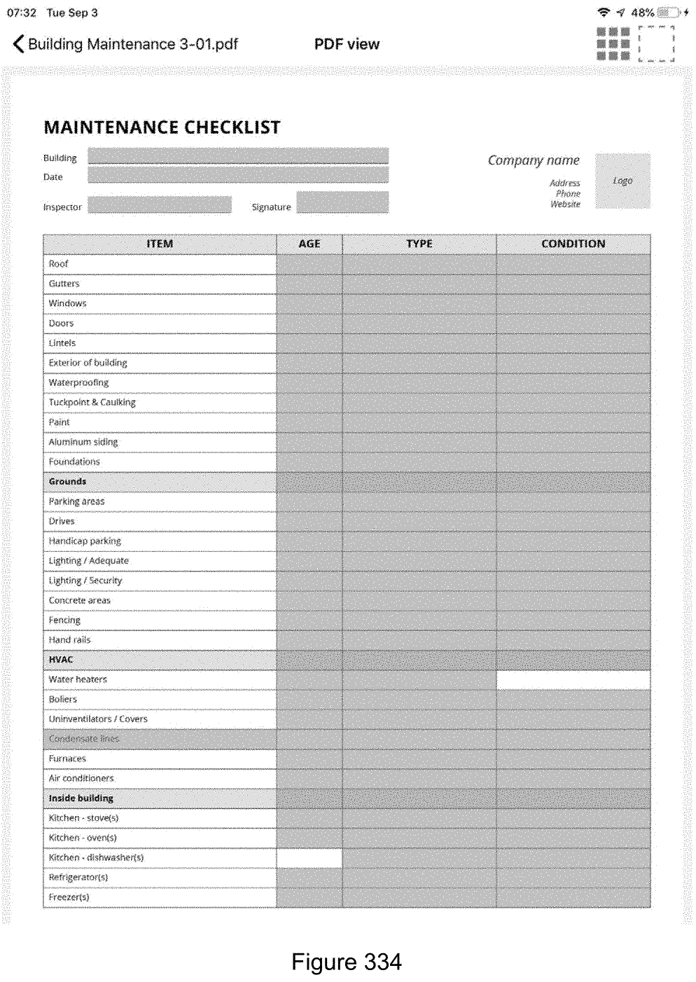

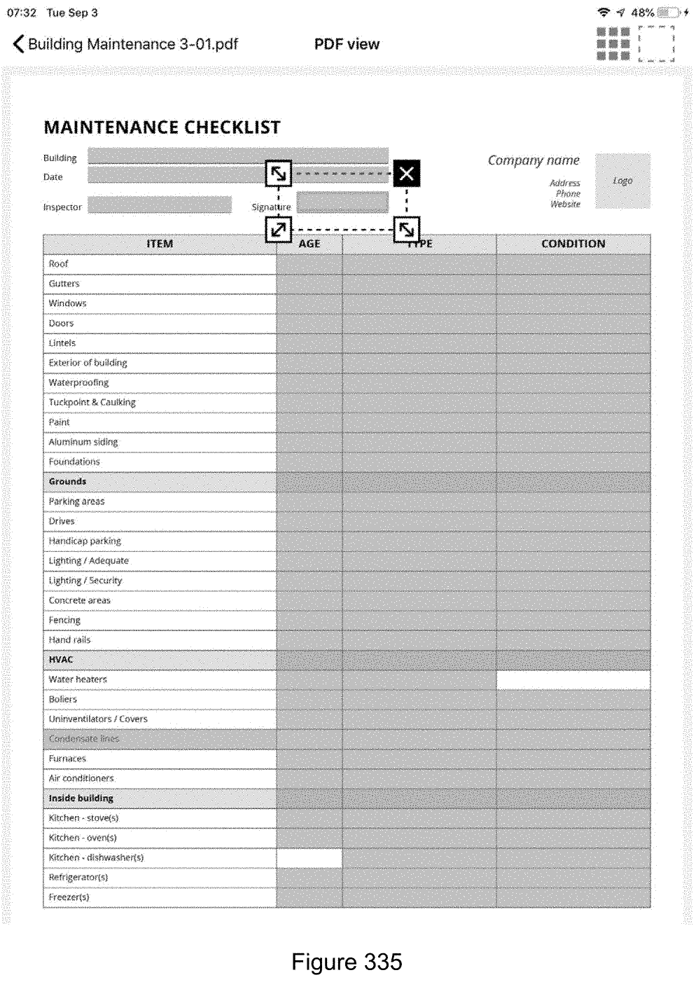

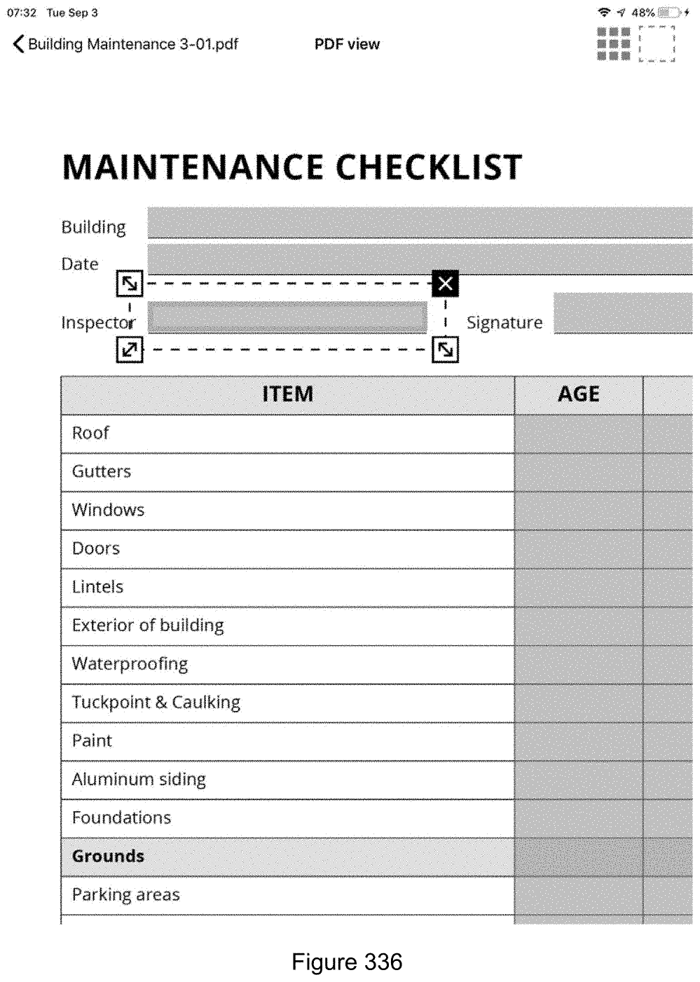

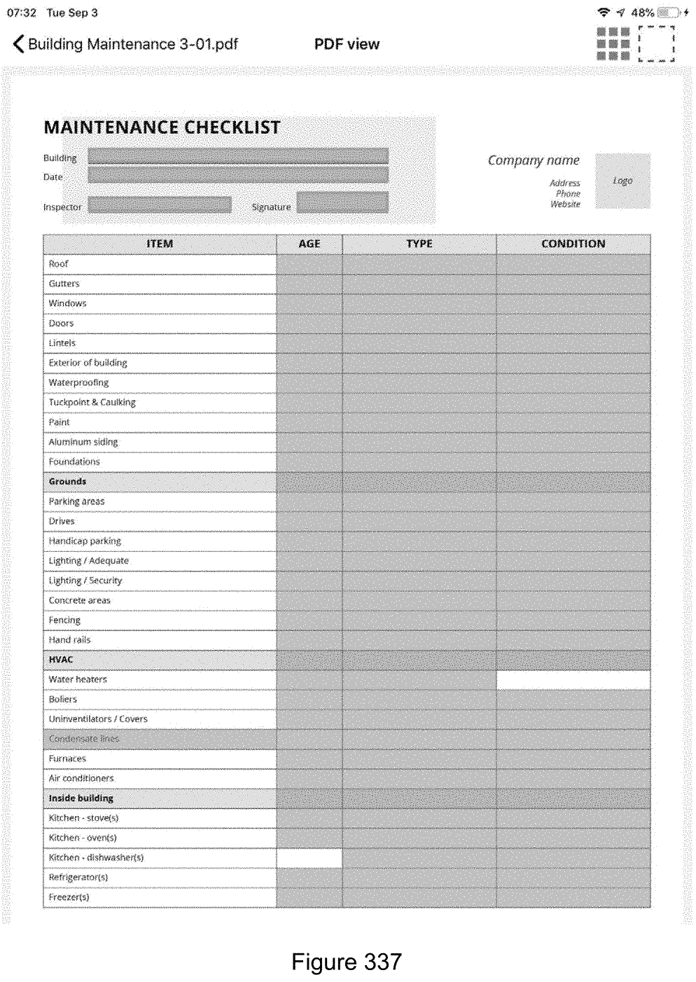

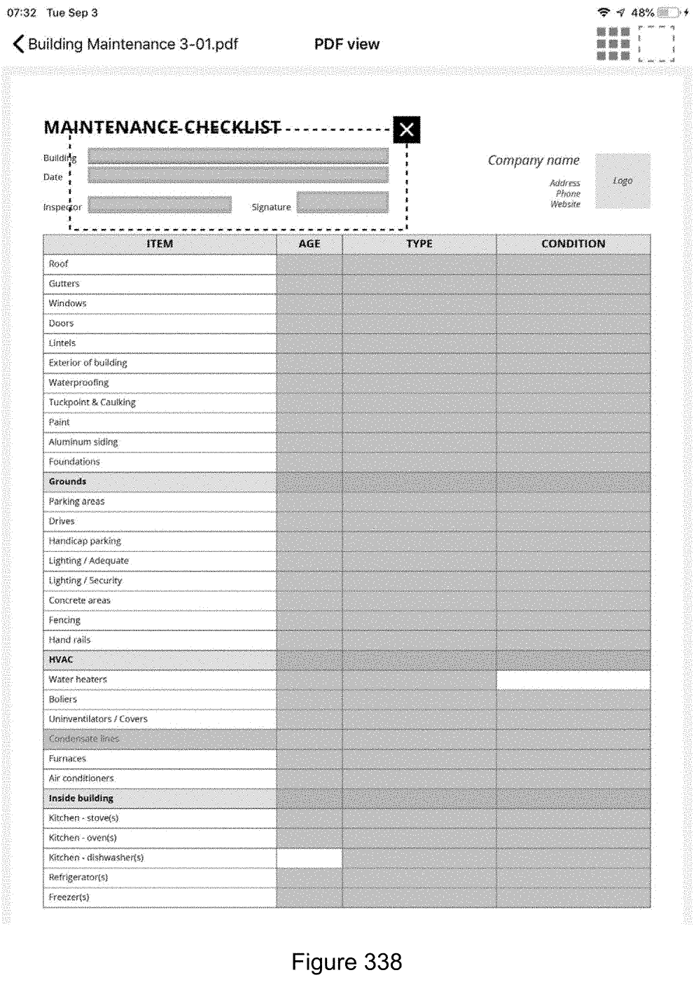

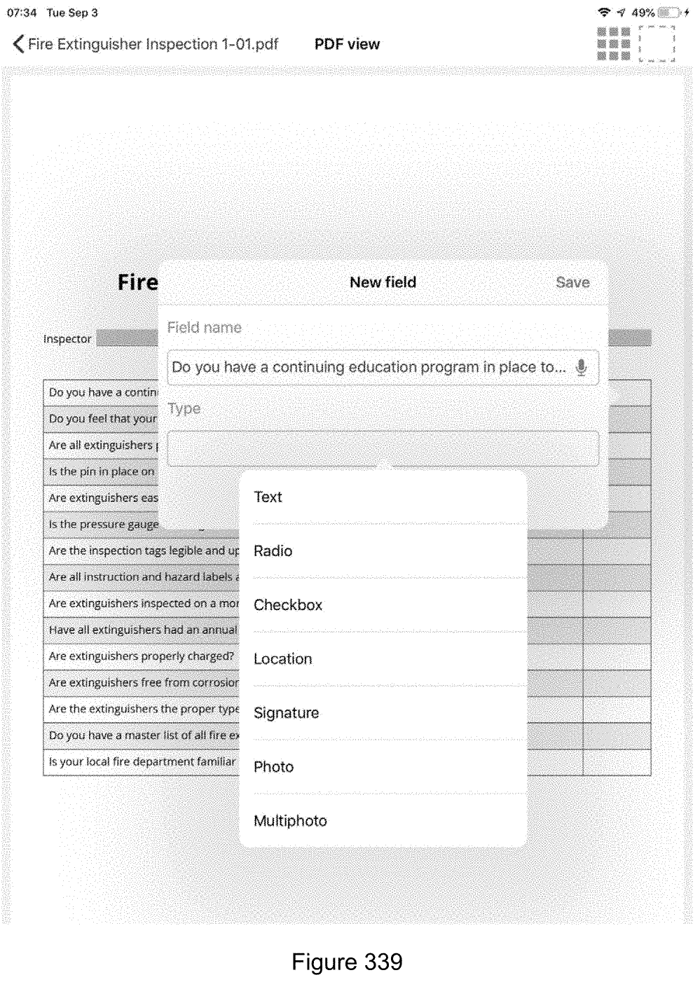

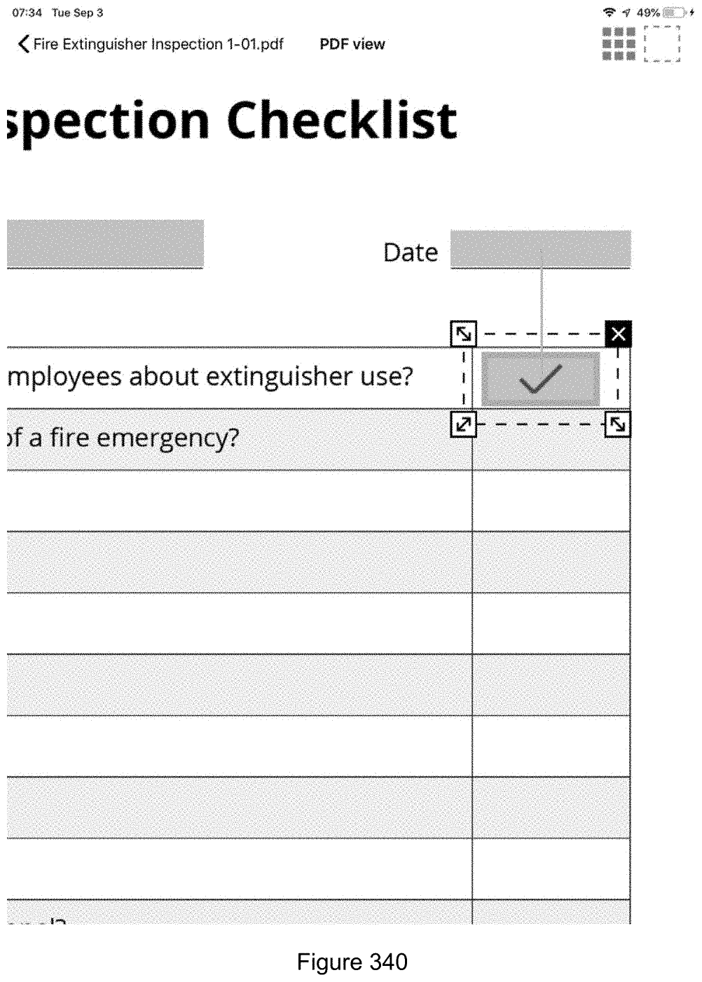

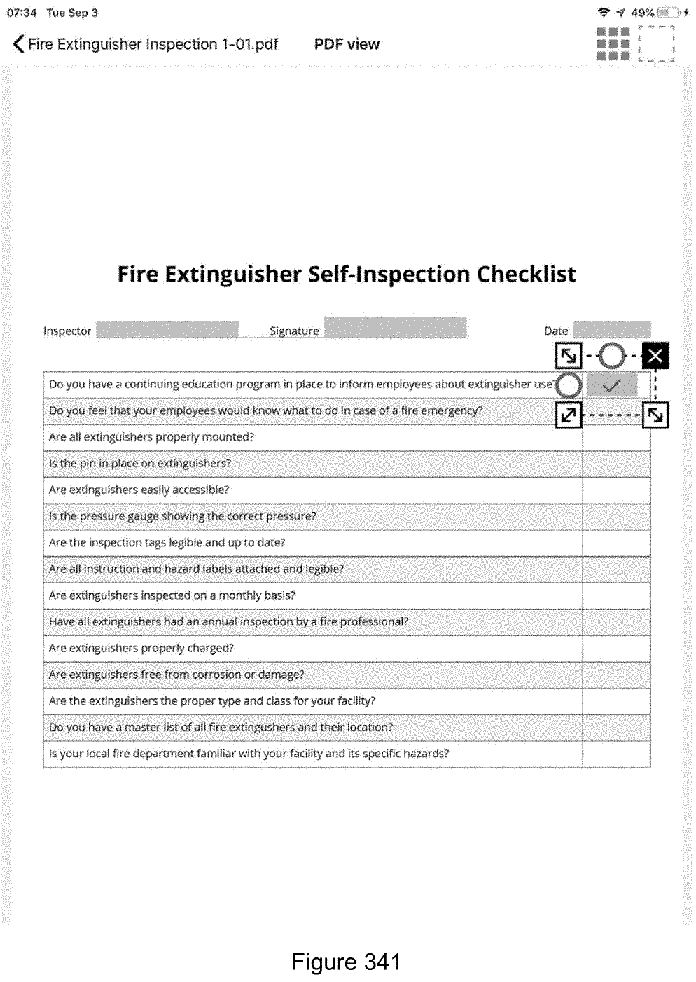

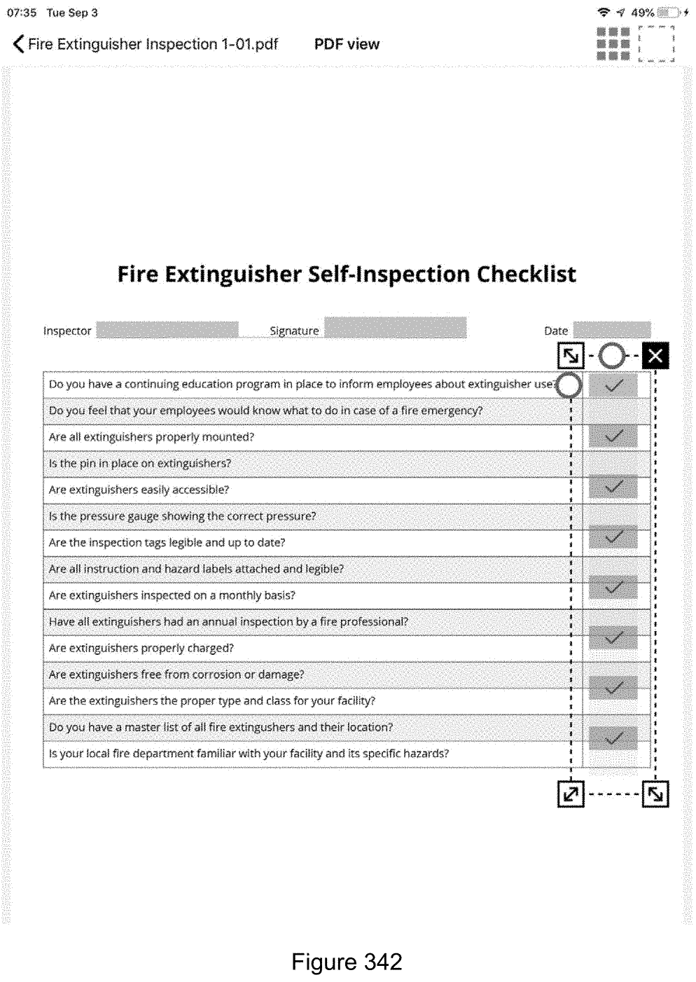

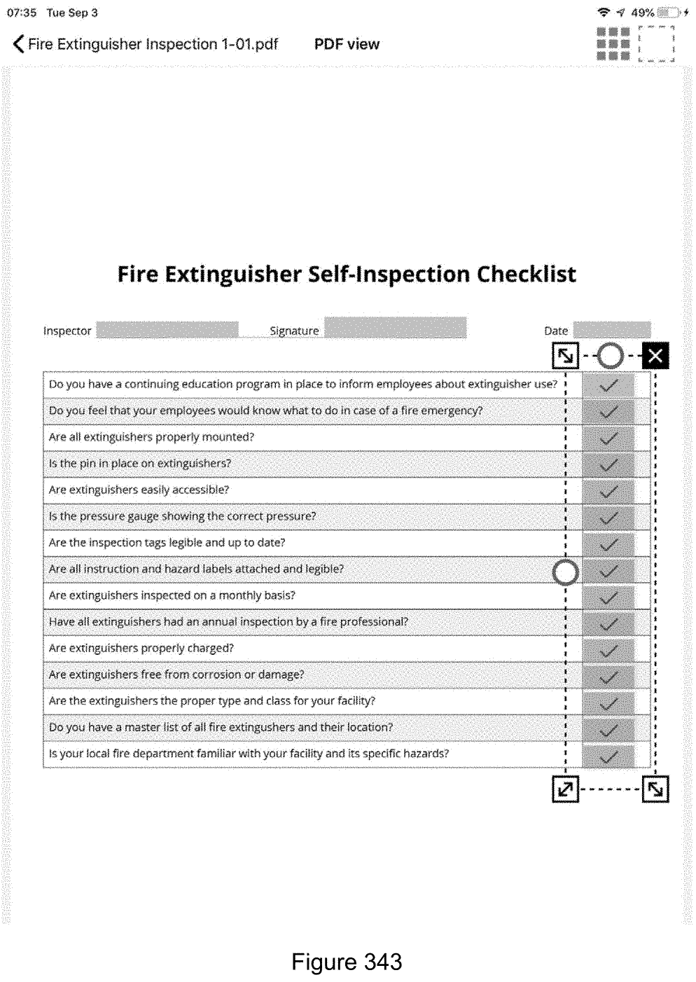

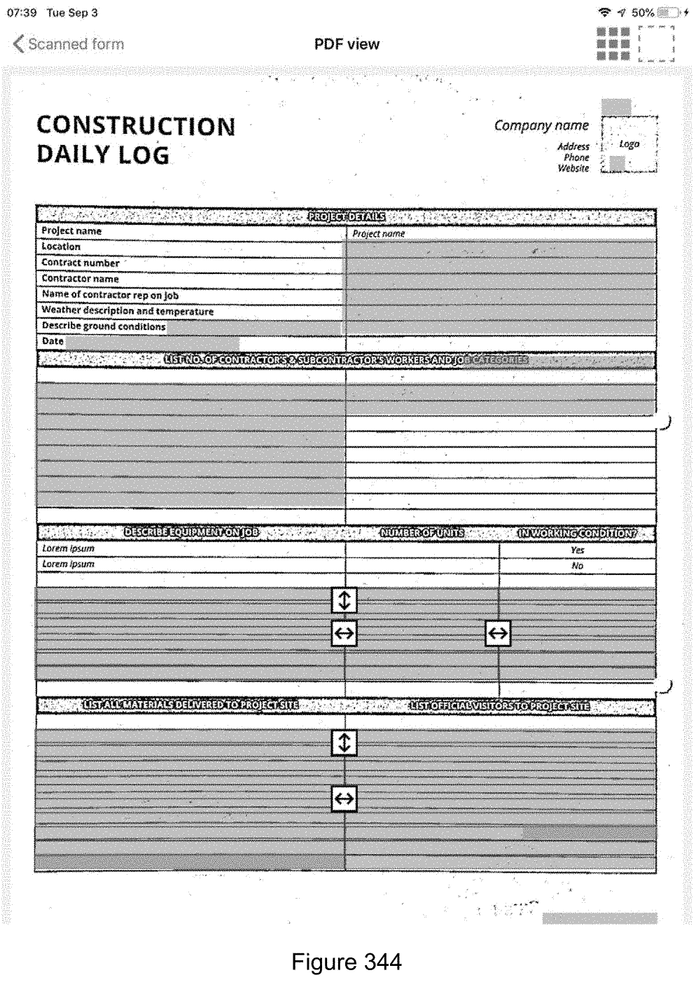

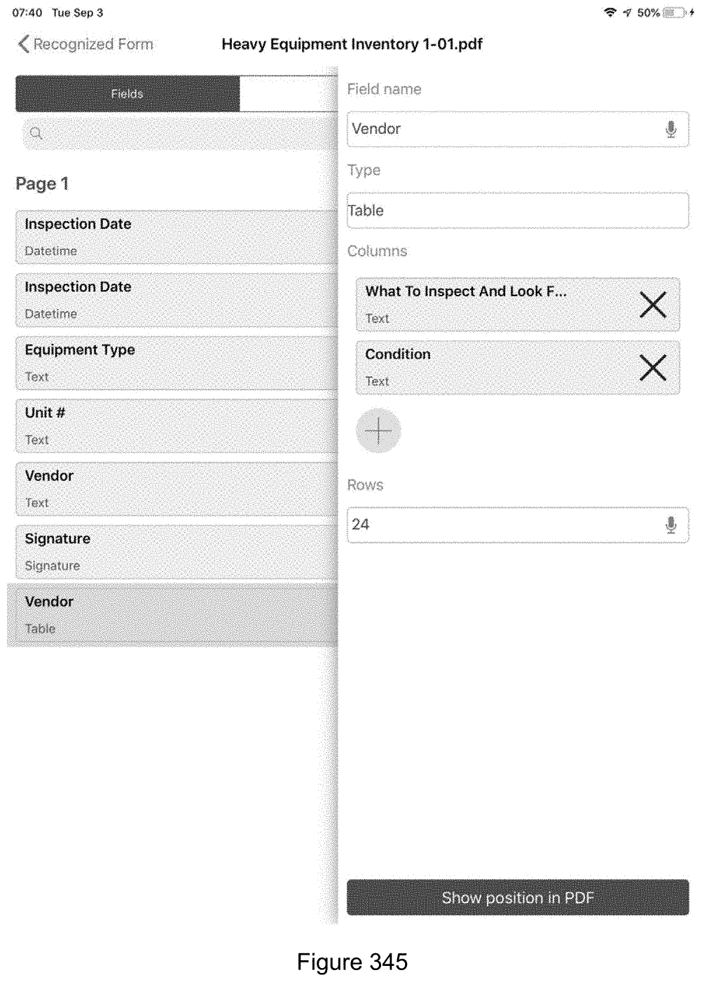

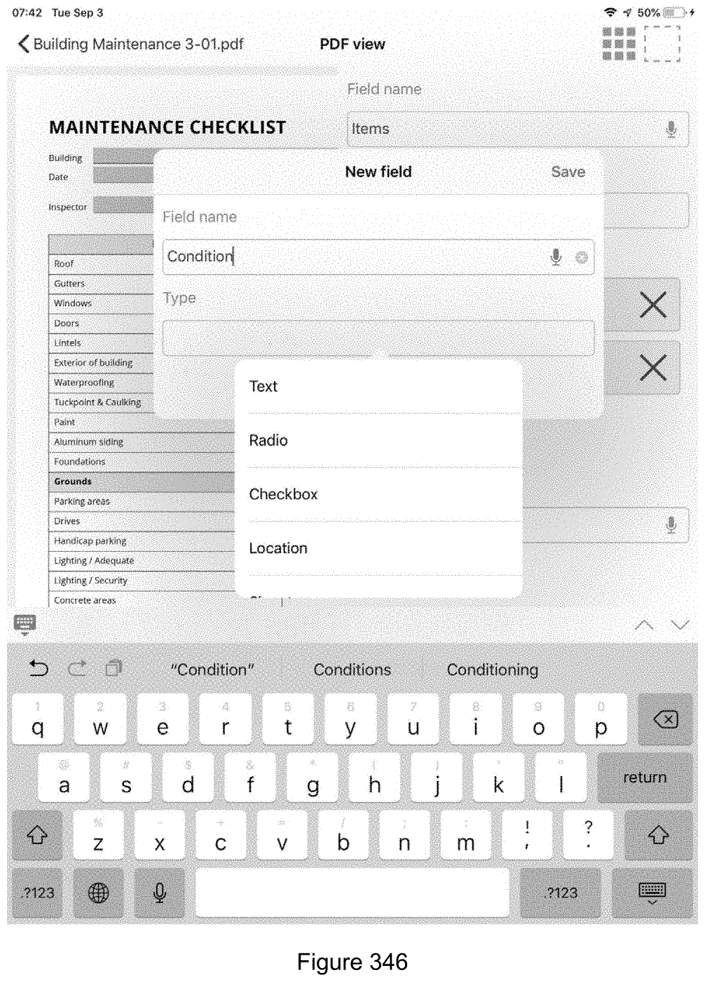

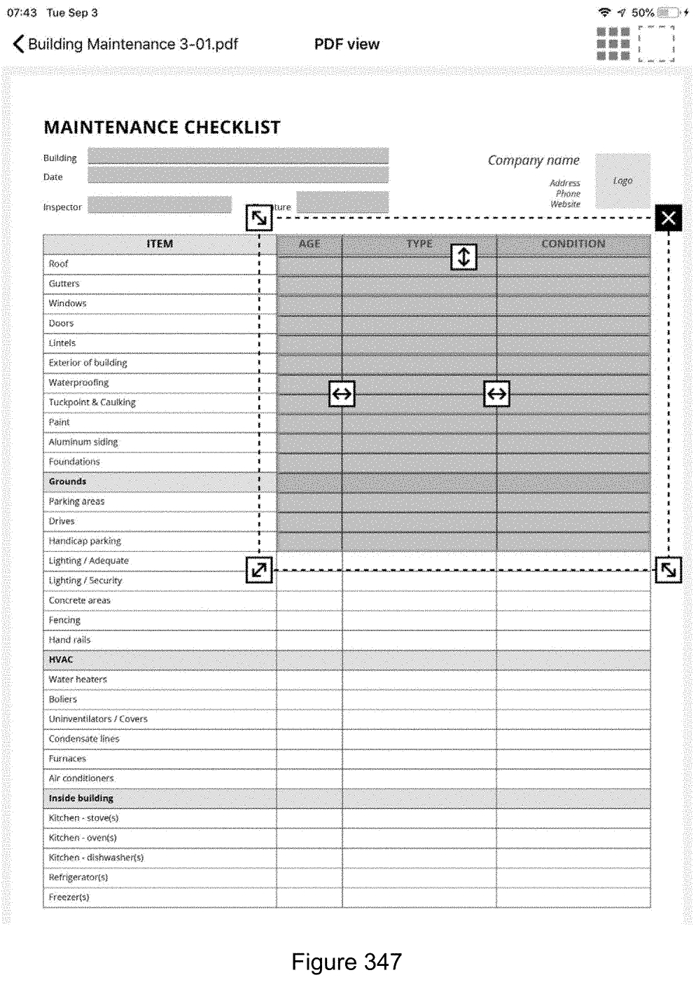

Referring to FIGS. 323-347, in the upper right corner of the screen user will see an Edit button. By pressing that button user gets into a Form Builder mode where he can apply different changes such as field adding, editing, deleting and reordering. All updates will be saved automatically and user can try the updated form on his device immediately.

The Form Builder can consist of 3 segments: Fields, Form and Report

Fields: The list of recognized fields sorted by the order in the uploaded page(s).

User can change/delete or reorder the fields and add new on demand. Fields can be adjusted on the PDF view too.

Form: The preview of an actual mobile friendly form which can be filled out

Report: the presentation of entered data that meets the uploaded PDF file layout and design.

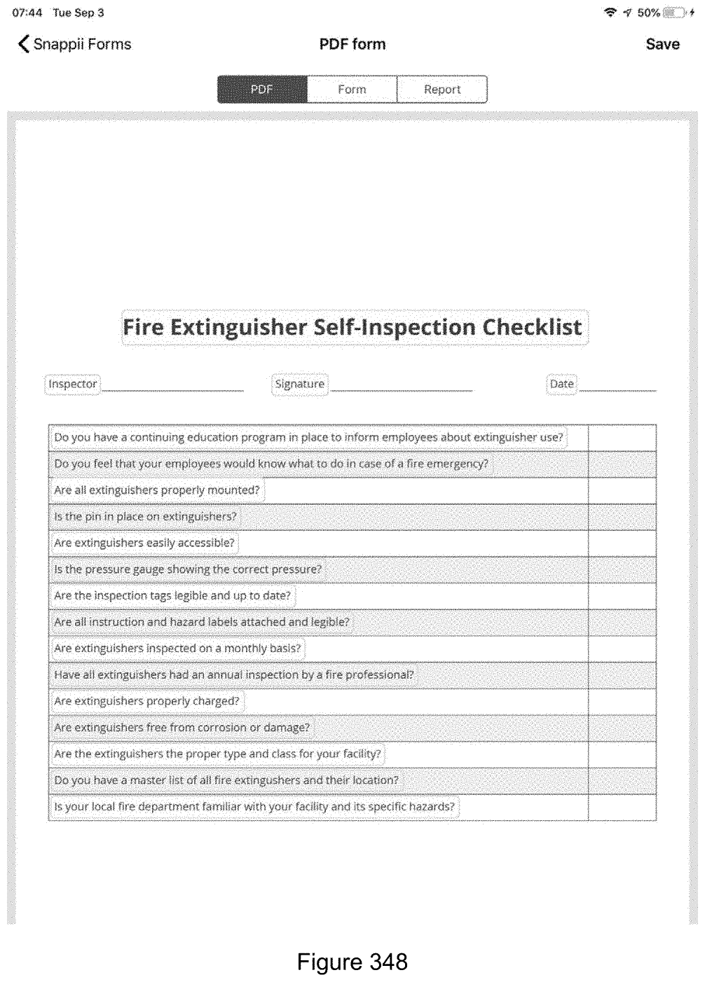

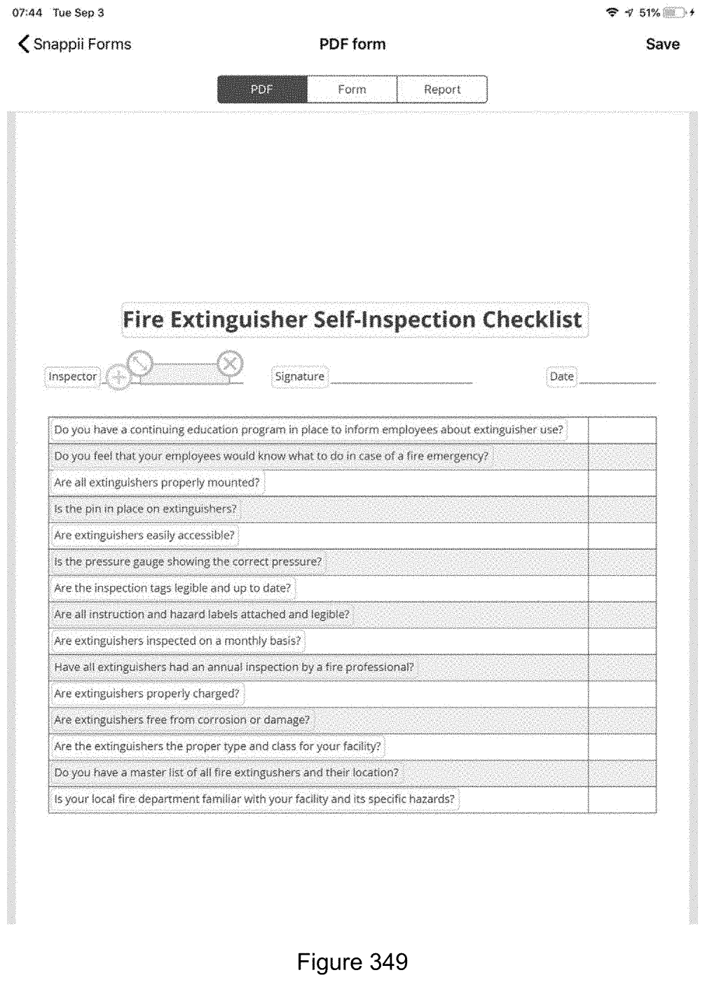

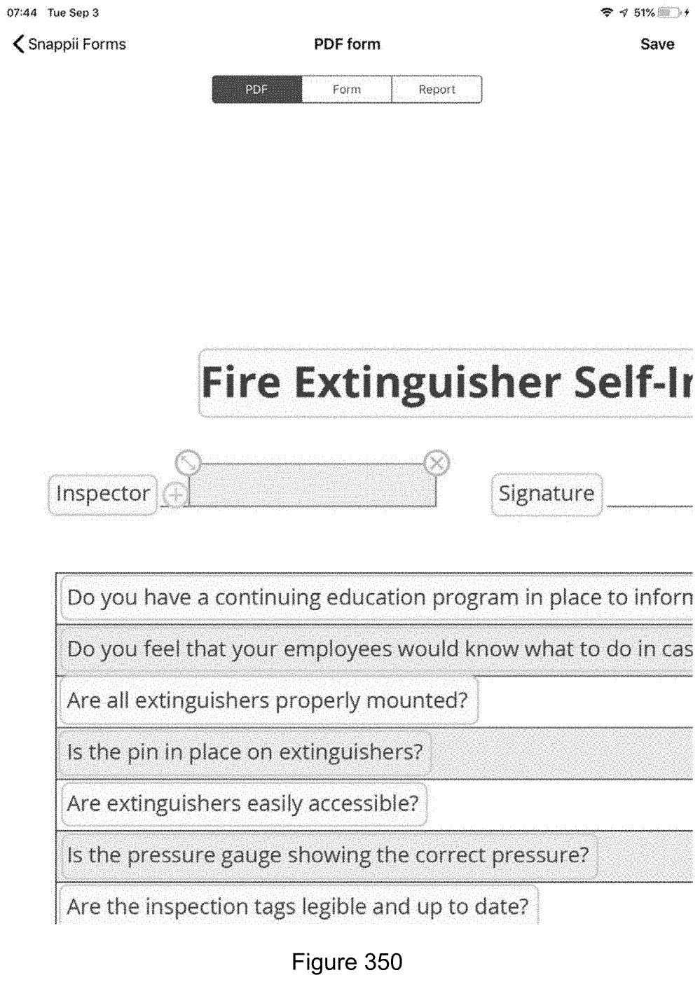

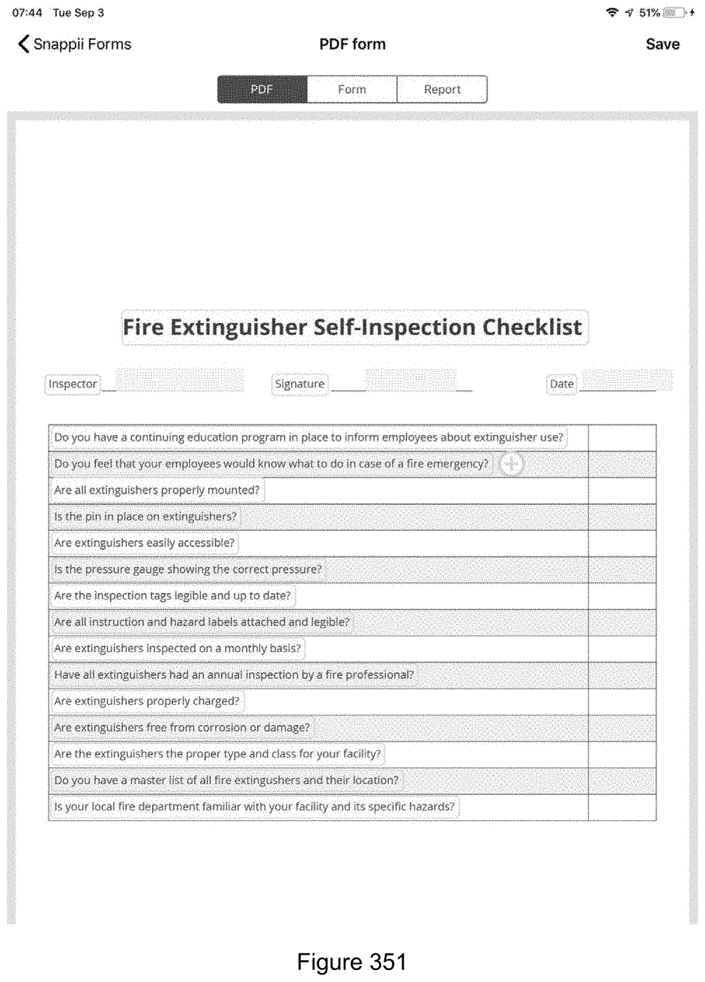

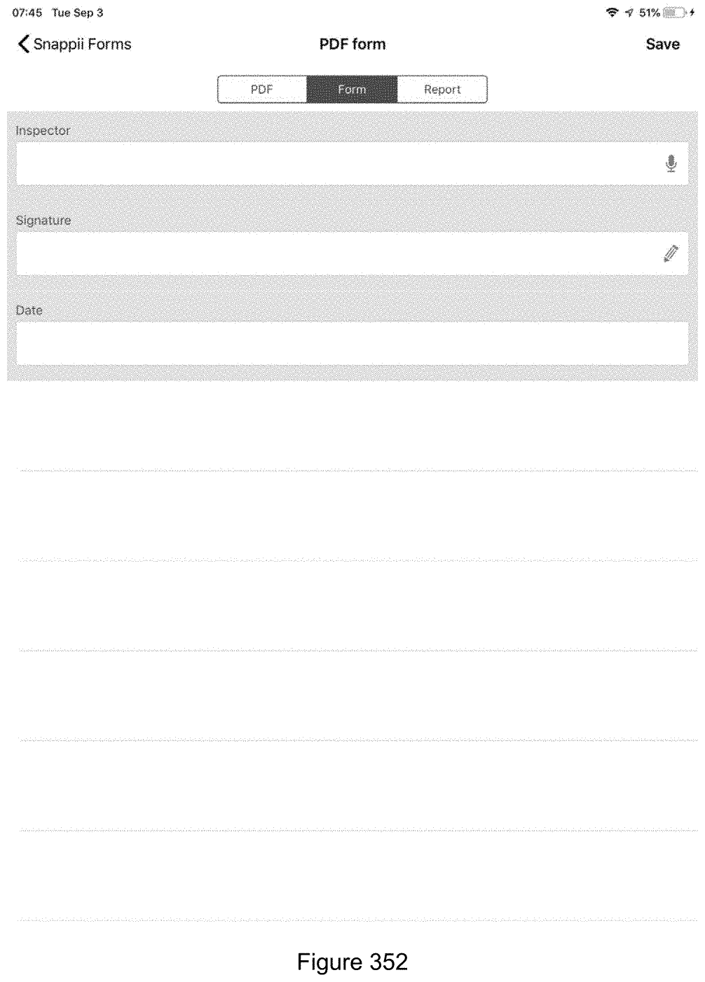

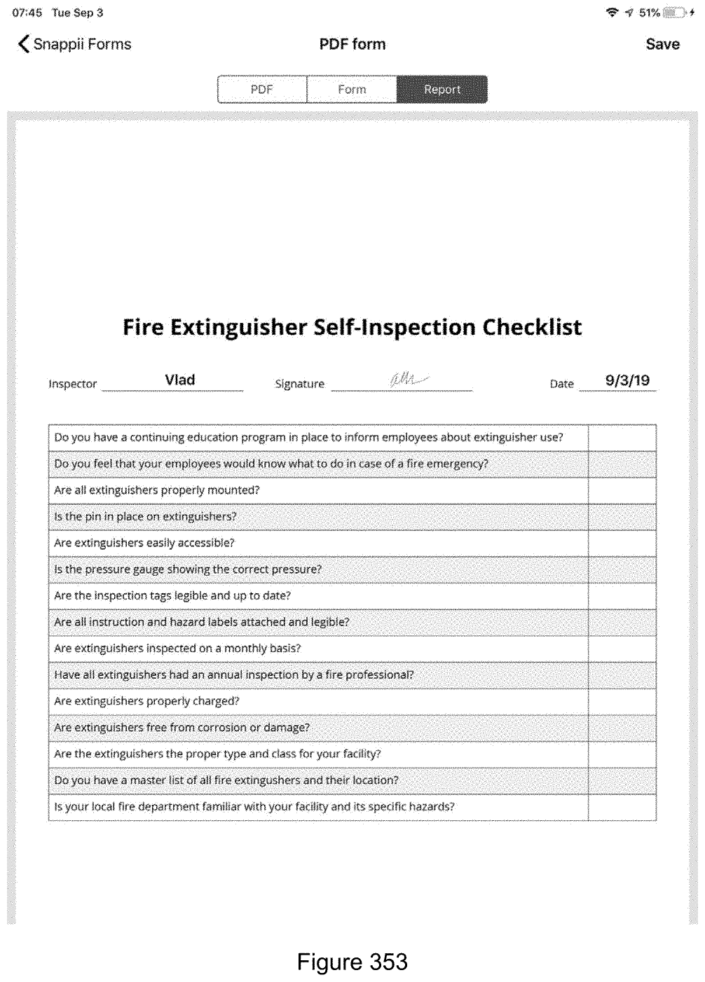

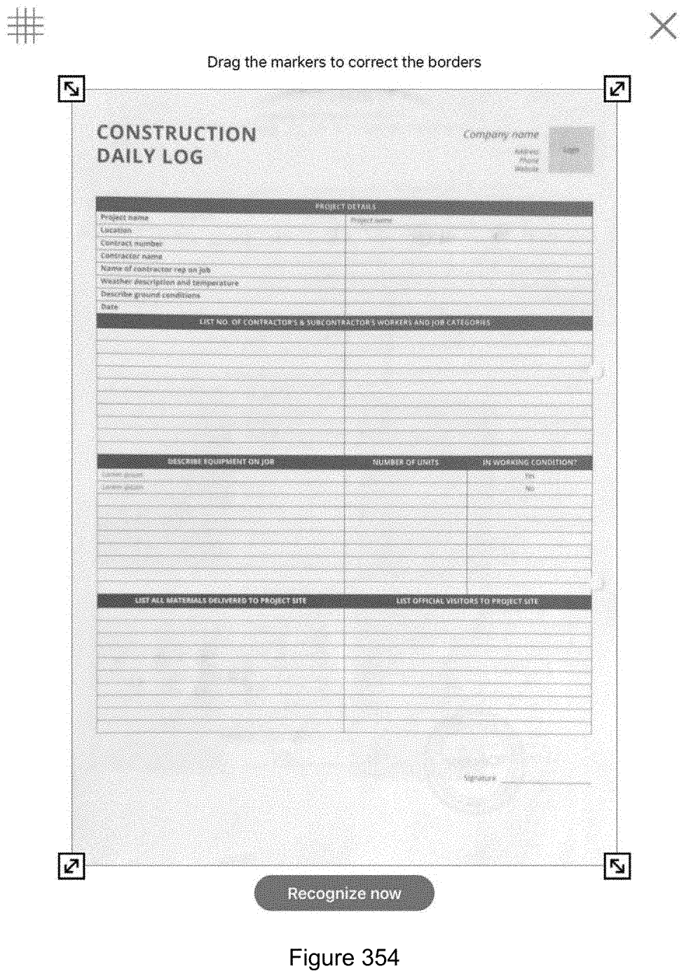

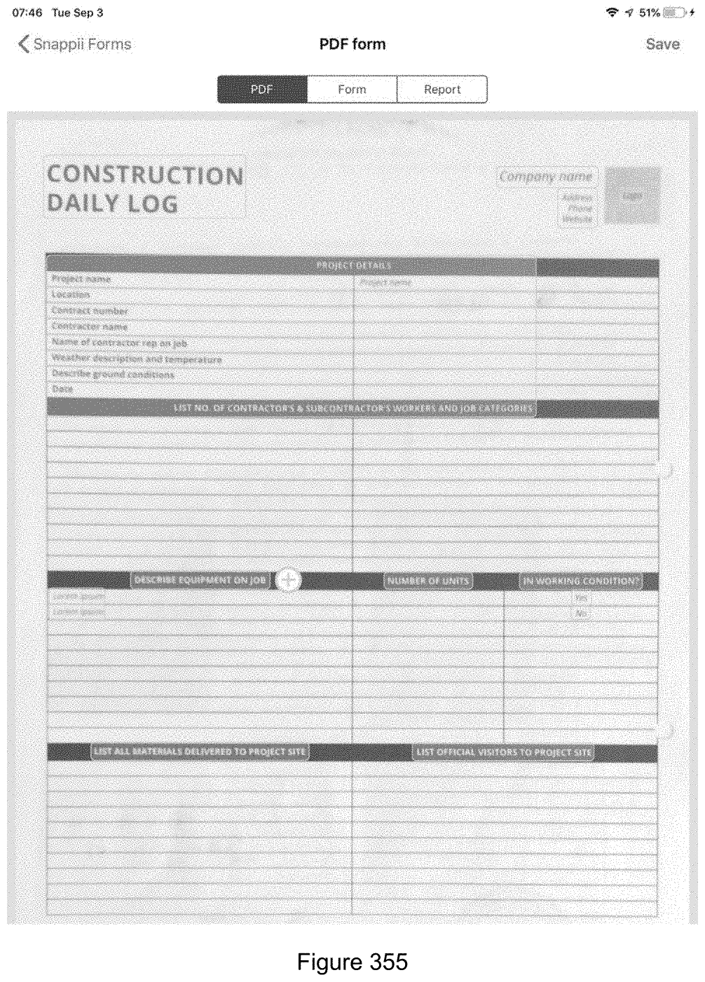

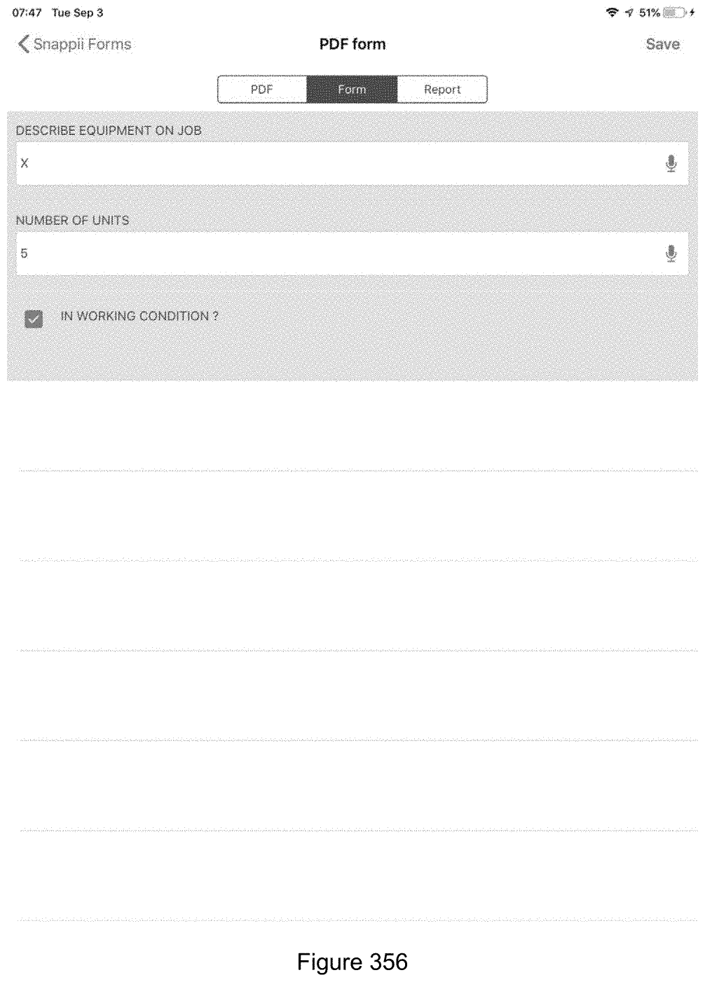

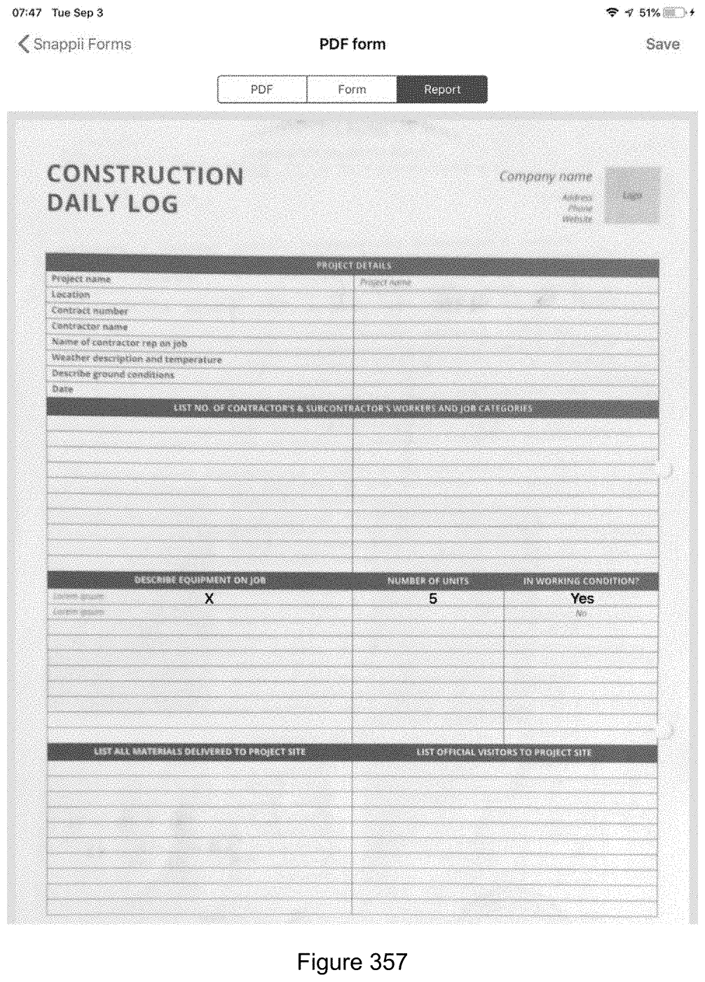

Referring to FIG. 348-357, another option is to load a PDF form as a background without OFR effect. In this case user can create fields and put them all into desired positions on the uploaded PDF template manually.

The above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and so on, including a carrier wave transmitting signals specifying the program instructions, data structures, and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

While the present invention has been shown and described with reference to certain exemplary embodiments thereof, it will be understood by those skilled in the art that various changes in form and details may be made therein without departing from the spirit and scope of the present invention.

I claim:

1. A method for converting documents comprising:
processing a digital image of a document by a first neural network and a second neural network to find desired fields within said document;
creating a fillable vertical form comprising said desired fields from said processed image;
converting said fillable vertical form into an app;
receiving user input via said app to fill said desired fields of said document with said user input; and
storing said document including said fields filled with said user input.

2. The method of claim 1, further comprising selecting said digital image from at least a portion of a PDF document.

3. The method of claim 2, wherein at least said portion of said PDF document comprises at least one of said desired fields.

4. The method of claim 1, further comprising creating said digital image from a non-digital document.

5. The method of claim 1, wherein said storing comprises storing said document including said fields filled with said user input in a PDF format.

6. The method of claim 1, wherein said storing comprises uploading said document including said fields filled with said user input to a cloud-based storage.

7. The method of claim 1, wherein said user input is received from a mobile device displaying said fillable vertical form for interactive input therein.

8. The method of claim 1, wherein said user input is received from a mobile device displaying said fillable vertical form for interactive input therein, and said user input comprises at least one of numerical, text, and/or image data.

9. The method of claim 1, further comprising communicating said document including said fields filled with said user input.

10. The method of claim 9, wherein said communicating comprises e-mailing said document including said fields filled with said user input.

11. A system comprising a microprocessor and non-transient storage for at least one of said processing, said creating, said converting, said receiving, and said storing as claimed in claim 1.

12. A personal communication device comprising a microprocessor and non-transient storage deploying said app as claimed in claim 1.

13. The device of claim 12, further comprising an image capturing and processing optics and/or circuitry for capturing and generating said digital image of said document.

14. The device of claim 12, further comprising wireless and/or wired circuitry for transmitting and/or receiving said digital image and/or said document including said fields filled with said user input.

15. The method as claimed claim 1, wherein said document, said fillable vertical form, and/or said document including said fields filled with said user input is configured to be modifiable in the cloud-based applications.

16. The method as claimed in claim 1, wherein said processing of said digital image of said document to find said desired fields within said document comprises:
extracting textual data from said document by said first neural network; and
finding said desired fields within said document related to said extracted textual data by said second neural network.

17. The method as claimed in claim 1, wherein said processing of said digital image of said document to find said desired fields within said document comprises:
extracting textual data from said document by said first neural network; and
finding said desired fields within said document related to said extracted textual data by said second neural network; and
said method further comprising applying natural language processing (NLP) to process said extracted textual data to determine a mathematical operation to be selectively performed to automatically generate input into at least one of said desired fields based on said NLP processing.
